(19) United States
(12) Patent Application Publication
(10) Pub. No.: US 2023/0319846 A1
(43) Pub. Date: Oct. 5, 2023

(54) METHOD AND APPARATUS OF INDICATING DYNAMIC BEAM SWITCHING VIA DOWNLINK CONTROL INFORMATION

(71) Applicant: Samsung Electronics Co., Ltd., Suwon-si (KR)

(72) Inventors: Dalin Zhu, Allen, TX (US); Emad N. Farag, Flanders, NJ (US); Eko Onggosanusi, Coppell, TX (US)

(21) Appl. No.: 18/188,349

(22) Filed: Mar. 22, 2023

Related U.S. Application Data
(60) Provisional application No. 63/327,203, filed on Apr. 4, 2022.
(60) Provisional application No. 63/425,620, filed on Nov. 15, 2022.
(60) Provisional application No. 63/425,902, filed on Nov. 16, 2022.
(60) Provisional application No. 63/330,178, filed on Apr. 12, 2022.
(60) Provisional application No. 63/330,190, filed on Apr. 12, 2022.

(51) Int. Cl. H04W 72/232

(52) U.S. Cl. CPC H04W 72/232; H04W 72/046

(57) ABSTRACT

Methods and apparatuses for indication of dynamic beam switching via downlink control information (DCI) in a wireless communication system. A method includes receiving radio resource control (RRC) signaling including a parameter indicating a first group of transmission configuration indication (TCI) states and a second group of TCI states; receiving, in a first DCI, a first indicator and a TCI state update; and receiving, in a second DCI, a second indicator. The method further includes determining, based on the first indicator, whether the TCI state update belongs to a first TCI state from the first group of TCI states or a second TCI state from the second group of TCI states; and identifying, based on the second indicator, the first TCI state or the second TCI state to be used for receiving a physical downlink shared channel (PDSCH) or transmitting a physical uplink shared channel (PUSCH).

### CROSS-REFERENCE TO RELATED APPLICATIONS AND CLAIM OF PRIORITY

The present application claims priority to:
U.S. Provisional Patent Application No. 63/327,203, filed on Apr. 4, 2022;
U.S. Provisional Patent Application No. 63/330,178, filed on Apr. 12, 2022;
U.S. Provisional Patent Application No. 63/330,190, filed on Apr. 12, 2022;
U.S. Provisional Patent Application No. 63/425,620, filed on Nov. 15, 2022; and
U.S. Provisional Patent Application No. 63/425,902, filed on Nov. 16, 2022. The contents of the above-identified patent documents are incorporated herein by reference.

### TECHNICAL FIELD

The present disclosure relates generally to wireless communication systems and, more specifically, the present disclosure relates to an indication of dynamic beam switching via downlink control information (DCI) in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to an indication of dynamic beam switching via DCI in a wireless communication system.

In one embodiment, a user equipment (UE) is provided. The UE includes a transceiver configured to receive radio resource control (RRC) signaling including a parameter indicating a first group of transmission configuration indication (TCI) states and a second group of TCI states; receive, in a first DCI, a first indicator and a TCI state update; and receive, in a second DCI, a second indicator. The UE further includes a processor operably coupled to the transceiver. The processor is configured to identify a first TCI state from the first group of TCI states and a second TCI state from the second group of TCI states; determine, based on the first indicator, whether the TCI state update belongs to the first group of TCI states or the second group of TCI states; and identify, based on the second indicator, the first TCI state or the second TCI state to be used for receiving a physical downlink shared channel (PDSCH) or transmitting a physical uplink shared channel (PUSCH).

In another embodiment, a method performed by a UE. The method includes receiving RRC signaling including a parameter indicating a first group of TCI states and a second group of TCI states; receiving, in a first DCI, a first indicator and a TCI state update; and receiving, in a second DCI, a second indicator. The method further includes identifying a first TCI state from the first group of TCI states and a second TCI state from the second group of TCI states; determining, based on the first indicator, whether the TCI state update belongs to the first group of TCI states or the second group of TCI states; and identifying, based on the second indicator, the first TCI state or the second TCI state to be used for receiving a PDSCH or transmitting a PUSCH.

In yet another embodiment, a base station (BS) is provided. The BS includes a transceiver configured to transmit RRC signaling including a parameter indicating a first group of TCI states and a second group of TCI states; transmit, in a first DCI, a first indicator and a TCI state update; and transmit, in a second DCI, a second indicator. The first indicator indicates whether the TCI state update belongs to the first group of TCI states or the second group of TCI states. The second indicator indicates whether a first TCI state from the first group of TCI states or a second TCI state from the second group of TCI states is for a PDSCH or for a PUSCH.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6A illustrates an example of wireless system beam according to embodiments of the present disclosure;

FIG. 6B illustrates an example of multi-beam operation according to embodiments of the present disclosure;

FIG. 7 illustrates an example of antenna structure according to embodiments of the present disclosure; and

FIG. 8 illustrates an example of multiple transmission and reception point system according to embodiments of the present disclosure;

FIG. 9A illustrates an example of indicating the first and second TCI state codepoints according to embodiments of the present disclosure;

FIG. 9B illustrates another example of indicating the first and second TCI state codepoints according to embodiments of the present disclosure;

FIG. 10 illustrates a flowchart of a method of using an SRS resource set indicator to indicate associations between one or more of the indicated TCI states and each of the one or more channels according to embodiments of the present disclosure;

FIG. 11 illustrates yet another example of indicating the first and second TCI state codepoints according to embodiments of the present disclosure; and

FIG. 12 illustrates a flowchart of another method of using an SRS resource set indicator to indicate associations between one or more of the indicated TCI states and each of the one or more channels according to embodiments of the present disclosure.

### DETAILED DESCRIPTION

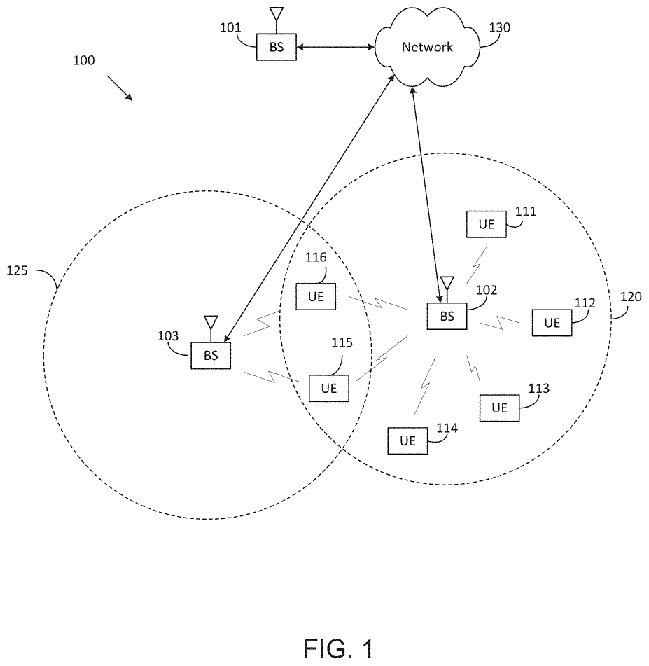

FIG. 1 through FIG. 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and Channel coding”; 3GPP TS 38.213 v16.1.0, “NR; Physical Layer Procedures for Control”; 3GPP TS 38.214 v16.1.0, “NR; Physical Layer Procedures for Data”; 3GPP TS 38.321 v16.1.0, “NR; Medium Access Control (MAC) protocol specification”; and 3GPP TS 38.331 v16.1.0, “NR; Radio Resource Control (RRC) Protocol Specification.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for an indication of dynamic beam switching via DCI in a wireless communication system. In certain embodiments, and one or more of the gNBs 101-103 includes circuitry, programing, or a combination thereof, for an indication of dynamic beam switching via DCI in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

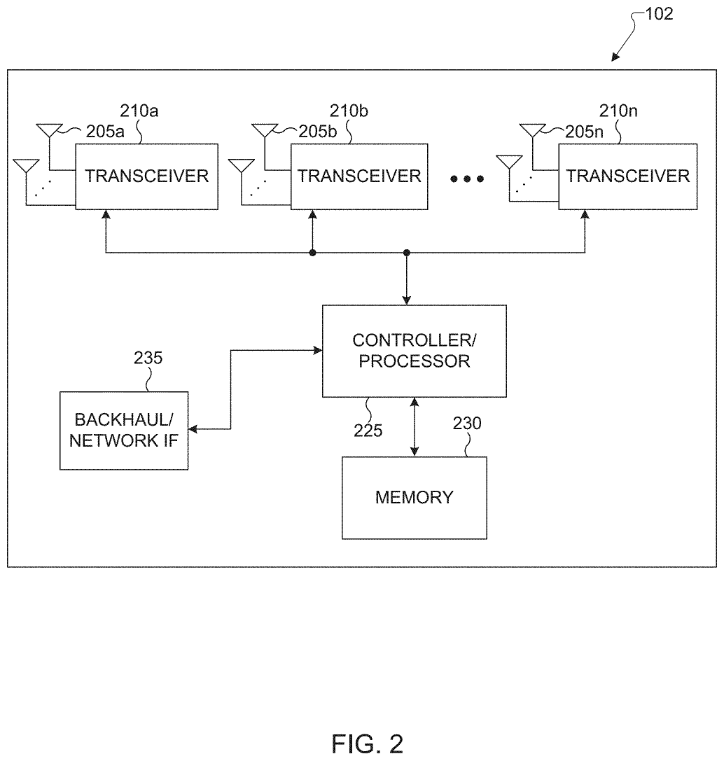

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for an indication of dynamic beam switching via DCI in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

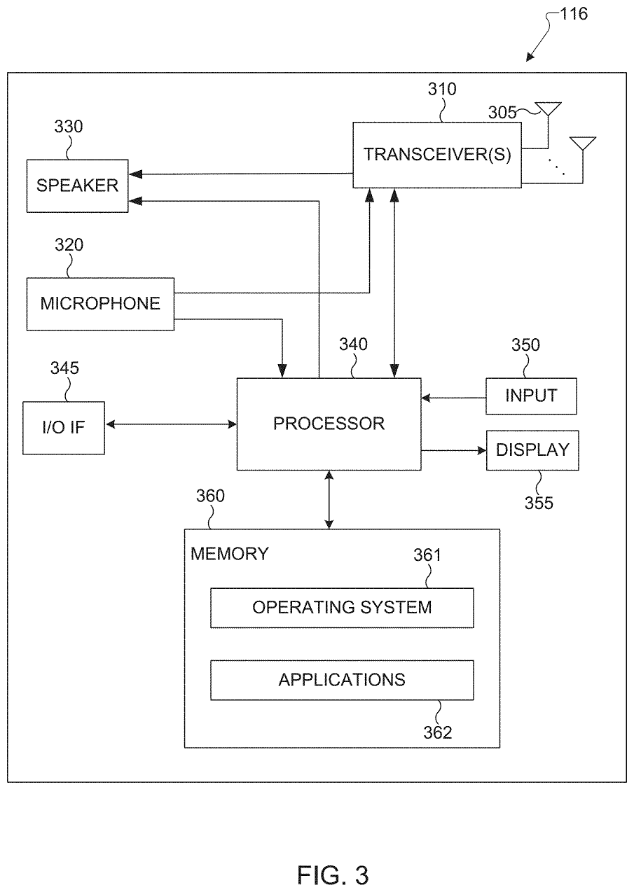

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for an indication of dynamic beam switching via DCI in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

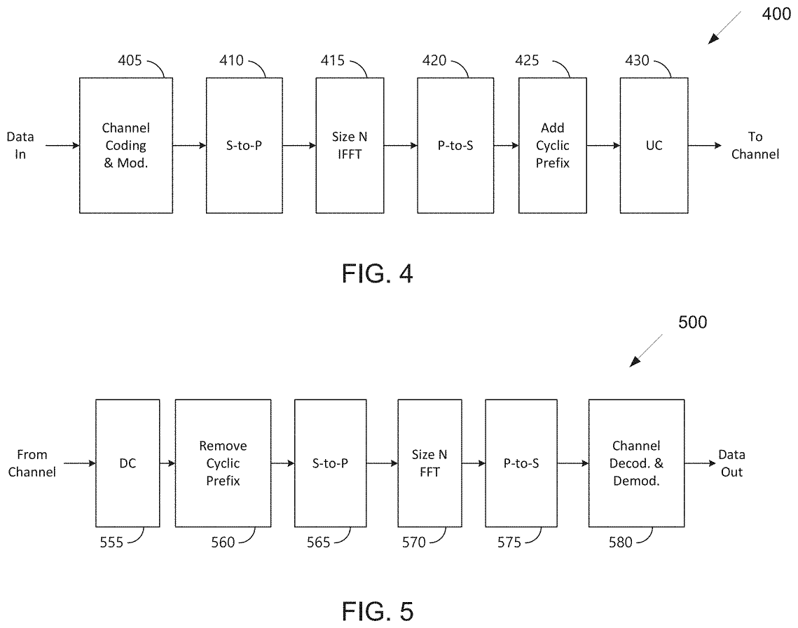

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). In some embodiments, the receive path 500 is configured to receive indication of dynamic beam switching via DCI in a wireless communication system. However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a transmission configuration indication state (TCI state) of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE can determine CSI-RS transmission parameters through DL control signaling or higher layer signaling, such as an RRC signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

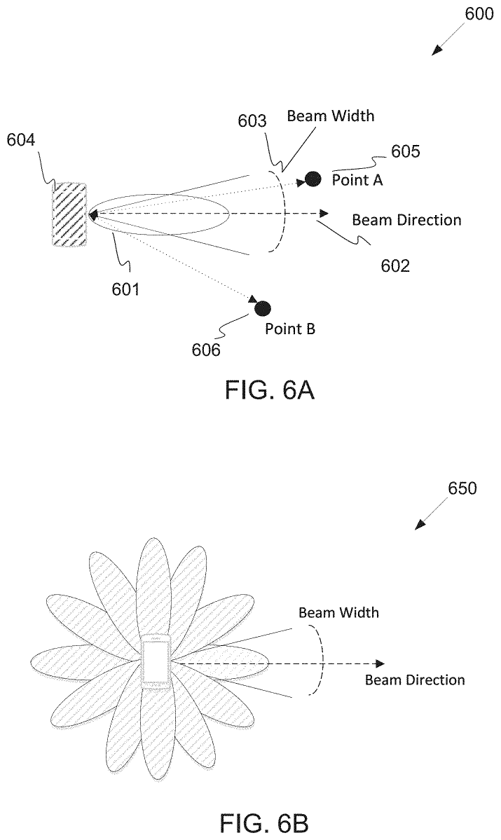

FIG. 6A illustrates an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as point A is within a beam width of a beam traveling in a beam direction and coming from the device 604.

As illustrated in FIG. 6A, a device at point B 606 cannot receive from and transmit to the device 604 as point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrates an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

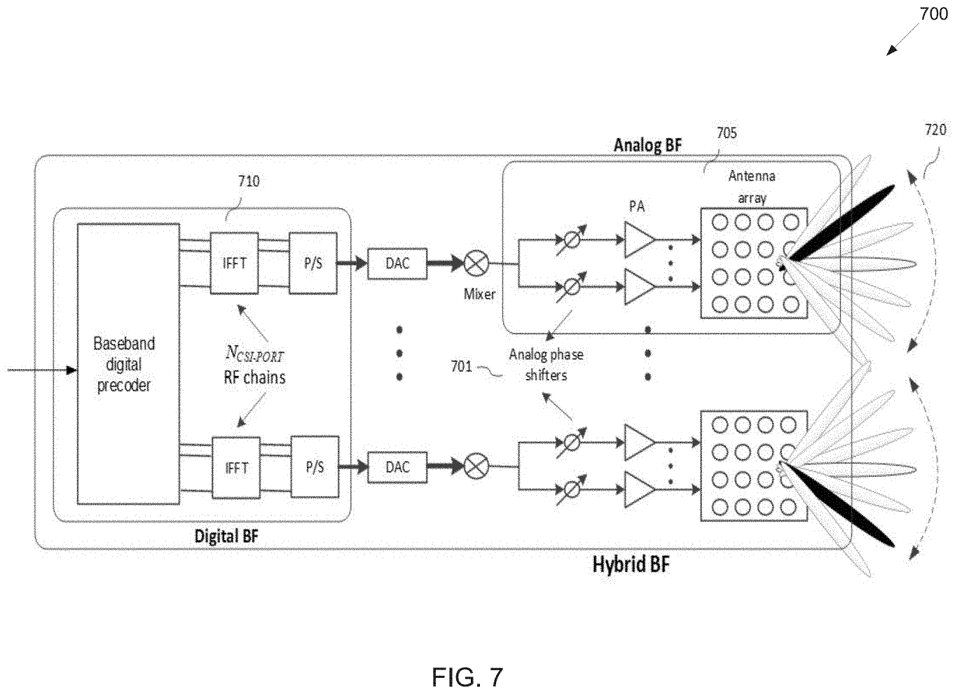

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 7.

FIG. 7 illustrates an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports N_{CSI-PORT}. A digital beamforming unit 710 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100 m distance), larger number of and sharper analog beams (hence larger number of radiators in the array) may be needed to compensate for the additional path loss.

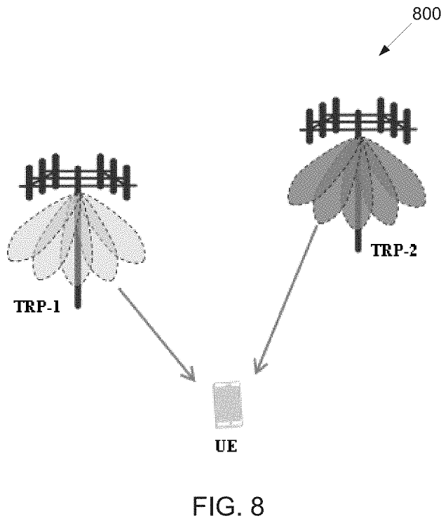

FIG. 8 illustrates an example of multiple transmission and reception point system 800 according to embodiments of the present disclosure. An embodiment of the multiple transmission and reception point system 800 shown in FIG. 8 is for illustration only.

In a multiple transmission and reception point (TRP) system depicted in FIG. 8, the UE could simultaneously receive from multiple physically non-co-located TRPs various channels/RSs such as PDCCHs and/or PDSCHs using either a single receive (RX) panel or multiple RX panels. In this disclosure, a RX panel could correspond to a set of RX antenna elements/ports at the UE, a set of measurement RS resources such as SRS resources, a spatial domain RX filter or etc. Further, a TRP in the multi-TRP system can represent a collection of measurement antenna ports, measurement RS resources and/or control resource sets (CORESETs).

For example, a TRP could be associated with one or more of: (1) a plurality of CSI-RS resources; (2) a plurality of CRIs (CSI-RS resource indices/indicators); (3) a measurement RS resource set, for example, a CSI-RS resource set along with its indicator; (4) a plurality of CORESETs associated with a CORESETPoolIndex; and (5) A plurality of CORESETs associated with a TRP-specific index/indicator/identity.

A cell/TRP in an inter-cell system (e.g., an inter-cell multi-TRP system) could be a non-serving cell/TRP. In this disclosure, the non-serving cell(s) or the non-serving cell TRP(s) could have/broadcast different physical cell IDs (PCIs) and/or other higher layer signaling index values from that of the serving cell or the serving cell TRP (i.e., the serving cell PCI). In one example, the serving cell or the serving cell TRP could be associated with the serving cell ID (SCI) and/or the serving cell PCI. That is, in an inter-cell system, different cells/TRPs could broadcast different PCIs, and/or one or more cells/TRPs (referred to/defined as non-serving cells/TRPs in the present disclosure) could broadcast different PCIs from that of the serving cell/TRP (i.e., the serving cell PCI), and/or one or more cells/TRPs are not associated with valid SCI (e.g., provided by the higher layer parameter ServCellIndex). In the present disclosure, a non-serving cell PCI can also be referred to as an additional PCI, another PCI or a different PCI (with respect to the serving cell PCI).

In Rel. 17, a unified transmission configuration indication (TCI) framework is specified for single-TRP operation, wherein a common beam could be indicated for all UE-dedicated control and/or data channels. To extend the Rel. 17 unified TCI framework to the multi-TRP operation, various design aspects such as means of configurating one or more TCI fields or TCI state codepoints in a downlink control information (DCI) format (e.g., DCI format 1_1 or 1_2 with or without DL assignment) to indicate beams for multiple TRPs need to be specified.

Furthermore, as multiple multi-TRP operation modes such as PDCCH/PDSCH/PUCCH/PUSCH repetitions are supported/specified in Rel. 16/17, means of dynamic switching between different multi-TRP operation modes or dynamic switching between one or more multi-TRP operation modes and the single-TRP operation mode need to be specified under the Rel. 17 unified TCI framework.

The present disclosure considers various design aspects related to DCI based beam indication for multi-TRP operation. In particular, detailed configuration methods of TCI states, TCI fields or TCI state codepoints in DCI format 1_1 or 1_2 with or without DL assignment, and their association with different TRPs in a multi-TRP system, are specified/provided in the present disclosure. This disclosure further specifies various methods to dynamically switch between different multi-TRP operation modes or between one or more multi-TRP operation modes and the single-TRP operation mode under the unified TCI framework.

Specifically, for example, a UE could receive in an uplink DCI (e.g., DCI format 0_1 or 0_2) an indication/indicator to indicate which TCI state(s) indicated in a downlink DCI (e.g., DCI format 1_1 or 1_2 with or without DL assignment) to use/apply for downlink reception or uplink transmission; for another example, one or more existing fields in an uplink DCI (e.g., DCI format 0_1 or 0_2) can be used or repurposed to indicate which TCI state(s) indicated in a downlink DCI (e.g., DCI format 1_1 or 1_2 with or without DL assignment) to use/apply for downlink reception or uplink transmission.

As described in the U.S. patent application Ser. No. 17/584,239 as incorporate by reference for the present disclosure, a unified TCI framework could indicate/include N≥1 DL TCI states and/or M≥1 UL TCI states, wherein the indicated TCI state could be at least one of: (1) a DL TCI state and/or its corresponding/associated TCI state ID; (2) an UL TCI state and/or its corresponding/associated TCI state ID; (3) a joint DL and UL TCI state and/or its corresponding/associated TCI state ID; and (4) separate DL TCI state and UL TCI state and/or their corresponding/associated TCI state ID(s).

There could be various design options/channels to indicate to the UE a beam (i.e., a TCI state) for the transmission/reception of a PDCCH or a PDSCH. As described in the U.S. patent application Ser. No. 17/584,239 as incorporate by reference for the present disclosure: (1) In one example, a MAC CE could be used to indicate to the UE a beam (i.e., a TCI state and/or a TCI state ID) for the transmission/reception of a PDCCH or a PDSCH; and (2) in another example, a DCI could be used to indicate to the UE a beam (i.e., a TCI state and/or a TCI state ID) for the transmission/reception of a PDCCH or a PDSCH.

For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.

For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.

Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of: (1) in case of joint TCI state indication, wherein a same beam is used for DL and UL channels, a joint TCI state that can be used at least for UE-dedicated DL channels and UE-dedicated UL channels; (2) in case of separate TCI state indication, wherein different beams are used for DL and UL channels, a DL TCI state can be used at least for UE-dedicated DL channels; and (3) in case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and all of dedicated PUCCH resources.

As discussed above, a UE could be provided by the network, e.g., via MAC CE or DCI (e.g., DCI format 1_1 or 1_2 with or without DL assignment) based signaling via higher layer parameters DLorJointTCIState or UL-TCIState, M>1 joint DL and UL TCI states or M>1 separate UL TCI states or a first combination of M>1 joint DL and UL TCI states and separate UL TCI states or N>1 separate DL TCI states or a second combination of N>1 joint DL and UL TCI states and separate DL TCI states or a third combination of N>1 joint DL and UL TCI states, separate DL TCI states and separate UL Rel. 17 unified TCI for UE-dedicated reception on PDSCH/PDCCH or dynamic-grant/configured-grant based PUSCH and all of dedicated PUCCH resources.

The UE could be higher layer configured by the network M>1 or N>1 pools of TCI states or TCI state identities (IDs). As aforementioned, here, a TCI state could correspond to a separate DL TCI state provided by DLorJointTCIState, or a separate UL TCI state provided by UL-TCIState, or a joint DL and UL TCI state provided by DLorJointTCIState. Each of the higher layer configured M>1 or N>1 pools of TCI states/TCI state IDs could be associated with an entity ID. In the present disclosure, the entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. In the present disclosure, the UE could be higher layer configured by the network a list of entity IDs or a list of PCIs or a set of PCI indexes with each PCI index pointing to an entry/PCI in the list of PCIs that are higher layer configured to the UE.

In one example, the first pool of TCI states/TCI state IDs could be associated with the lowest PCI value or the first PCI value in the higher layer configured list of PCIs or the lowest PCI index or the first PCI index in the set of PCI indexes or the PCI index pointing to the lowest PCI value in the higher layer configured list of PCIs, the second pool of TCI states/TCI state IDs could be associated with the second lowest PCI value or the second PCI value in the higher layer configured list of PCIs or the second lowest PCI index or the second PCI index in the set of PCI indexes or the PCI index pointing to the second lowest PCI value in the higher layer configured list of PCIs, and so on, and the last pool of TCI states/TCI state IDs could be associated with the highest PCI value or the last PCI value in the higher layer configured list of PCIs or the highest PCI index or the last PCI index in the set of PCI indexes or the PCI index pointing to the highest PCI value in the higher layer configured list of PCIs.

Or equivalently, the m-th (or n-th) pool of TCI states/TCI state IDs could be associated with the m-th (or n-th) lowest (or highest) PCI value or the m-th (or n-th) PCI value in the higher layer configured list of PCIs or the m-th (or n-th) lowest (or highest) PCI index or the first PCI index in the set of PCI indexes or the PCI index pointing to the m-th (or n-th) lowest (or highest) PCI value in the higher layer configured list of PCIs, where m∈{1, . . . , M} and n∈{1, . . . , N}.

For M=2 (or N=2), the first (or second) pool of TCI states/TCI state IDs could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) pool of TCI states/TCI state IDs could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In another example, if the UE is provided in PDCCH-Config two values of CORESETPoolIndex (i.e., 0 and 1), for M=2 (or N=2), the first (or second) pool of TCI states/TCI state IDs could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) pool of TCI states/TCI state IDs could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In yet another example, each of the M>1 (or N>1) pools of TCI states/TCI state IDs could be configured to the UE via a separate higher layer parameter. That is, the UE could be configured by the network M>1 (or N>1) separate higher layer parameters each configuring/indicating a pool of TCI states/TCI state IDs. Furthermore, the higher layer parameter that configures a pool of TCI states/TCI state IDs could also include/indicate an entity ID as described above. For this case, a pool TCI states/TCI state IDs and an entity ID are associated if the pool of TCI states/TCI state IDs and the entity ID are configured/indicated via the same higher layer parameter.

In addition, when the UE is higher layer configured by the network M>1 or N>1 pools of TCI states or TCI state IDs, where each TCI state configured therein corresponds to a separate DL TCI state provided by DLorJointTCIState, or a separate UL TCI state provided by UL-TCIState, or a joint DL and UL TCI state provided by DLorJointTCIState,

In one example, for the m-th (or n-th) pool of TCI states/TCI state IDs comprising K(m) (or K(n)) TCI states/TCI state IDs where m∈{1, . . . , M} and n∈{1, . . . , N}, the TCI state IDs in the m-th (or n-th) pool of TCI states/TCI state IDs or the TCI states in the m-th (or n-th) pool of TCI states/TCI state IDs are indexed according to 0, . . . , K(m)−1 (or K(n)−1) or 1, . . . , K(m) (or K(n)). For example, for M=2 (or N=2), the first pool of TCI states/TCI state IDs could comprise K1 (e.g., 64) TCI states/TCI state IDs, and the second pool of TCI states/TCI state IDs could comprise K2 (e.g., 64) TCI states/TCI state IDs. For this example, the TCI state IDs in the first pool of TCI states/TCI state IDs or the TCI states in the first pool of TCI states/TCI state IDs could be indexed according to 0, . . . , K1−1 (e.g., 0, . . . , 63) or 1, . . . , K1 (e.g., 1, . . . , 64), and the TCI state IDs in the second pool of TCI states/TCI state IDs or the TCI states in the second pool of TCI states/TCI state IDs could be indexed according to 0, . . . , K2−1 (e.g., 0, . . . , 63) or 1, . . . , K2 (e.g., 1, . . . , 64).

In another example, the m-th (or n-th) pool of TCI states/TCI state IDs could comprise K(m) (or K(n)) TCI states/TCI state IDs where m∈{1, . . . , M} and n∈{1, . . . , N}. For this case, the TCI state IDs in the m-th (or n-th) pool of TCI states/TCI state IDs or the TCI states in the m-th (or n-th) pool of TCI states/TCI state IDs are indexed according to Σᵢ₌₁^{m-1}K(i) (or Σⱼ₌₁ⁿ⁻¹K(j)), . . . , Σᵢ₌₁^{m-1}K(i)+K(m)−1 (or Σⱼ₌₁ⁿ⁻¹K(j)+K(n)−1) or Σᵢ₌₁^{m-1}K(i)+1 (or Σⱼ₌₁ⁿ⁻¹(j)+1), . . . , Σᵢ₌₁^{m-1}K(i)+K(m) (or Σⱼ₌₁ⁿ⁻¹K(j)+K(n)), where Σᵢ₌₁⁰K(i)=0 (or Σⱼ₌₁ⁿ⁻¹K(j)=0). For example, for M=2 (or N=2), the first pool of TCI states/TCI state IDs could comprise K1 (e.g., 64) TCI states/TCI state IDs, and the second pool of TCI states/TCI state IDs could comprise K2 (e.g., 64) TCI states/TCI state IDs. For this example, the TCI state IDs in the first pool of TCI states/TCI state IDs or the TCI states in the first pool of TCI states/TCI state IDs could be indexed according to 0, . . . , K1−1 (e.g., 0, . . . , 63) or 1, . . . , K1 (e.g., 1, . . . , 64), and the TCI state IDs in the second pool of TCI states/TCI state IDs or the TCI states in the second pool of TCI states/TCI state IDs could be indexed according to K1, . . . , K1+K2−1 (e.g., 64, . . . , 127) or K1+1, . . . , K1+K2 (e.g., 65, . . . , 128).

Alternatively, the UE could be higher layer configured by the network a single pool of TCI states or TCI state IDs. As aforementioned, here, a TCI state could correspond to a separate DL TCI state provided by DLorJointTCIState, or a separate UL TCI state provided by UL-TCIState, or a joint DL and UL TCI state provided by DLorJointTCIState. A TCI state or TCI state ID configured in the pool of TCI states/TCI state IDs could be associated with an entity ID.

In the present disclosure, the entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. Furthermore, one or more of the TCI states or TCI state IDs configured in the pool of TCI states/TCI state IDs could be associated with the same entity ID, and different TCI states or TCI state IDs configured in the pool of TCI states/TCI state IDs could be associated with different entity IDs. In the present disclosure, the TCI states or TCI state IDs in the pool of TCI states/TCI state IDs could be divided/partitioned into M>1 (or N>1) TCI state groups each comprising one or more TCI states/TCI state IDs. The TCI states or TCI state IDs in the same TCI state group are associated with the same entity ID.

In one example, the m-th (or n-th) TCI state group could comprise K(m) (or K(n)) TCI states/TCI state IDs where m∈{1, . . . , M} and n∈{1, . . . , N}. For this case, the TCI state IDs in the m-th (or n-th) TCI state group or the TCI states in the m-th (or n-th) TCI state group are indexed according to Σᵢ₌₁^{m-1}K(i) (or Σⱼ₌₁ⁿ⁻¹K(j)), . . . , Σᵢ₌₁^{m-1}K(i)+K(m)−1 (or Σⱼ₌₁ⁿ⁻¹K(j)+K(n)−1) or Σᵢ₌₁^{m-1}K(i)+1 (or Σⱼ₌₁ⁿ⁻¹K(j)+1), . . . , Σᵢ₌₁^{m-1}K(i)+K(m) (or Σⱼ₌₁ⁿ⁻¹K(j)+K(n)), where Σᵢ₌₁⁰K(i)=0 (or Σⱼ₌₁ⁿ⁻¹K(j)=0). For example, for M=2 (or N=2), the first TCI state group could comprise K1 (e.g., 32) TCI states/TCI state IDs in the pool of TCI states/TCI state IDs, and the second TCI state group could comprise K2 (e.g., 32) TCI states/TCI state IDs in the pool of TCI states/TCI state IDs. For this example, the TCI state IDs in the first TCI state group or the TCI states in the first TCI state group could be indexed according to 0, . . . , K1−1 (e.g., 0, . . . , 31) or 1, . . . , K1 (e.g., 1, . . . , 32), and the TCI state IDs in the second TCI state group or the TCI states in the second TCI state group could be indexed according to K1, . . . , K1+K2−1 (e.g., 32, . . . , 63) or K1+1, . . . , K1+K2 (e.g., 33, . . . , 65). For this example, the UE could be configured by the network, e.g., via higher layer RRC signaling, the number of TCI states/TCI state IDs (e.g., K(m) or K(n) with m∈{1, . . . , M} and n∈{1, . . . , N}) in each of the TCI state groups (e.g., the m-th or the n-th TCI state group with m∈{1, . . . , M} and n∈{1, . . . , N}) configured in the pool of TCI states/TCI state IDs.

In another example, the UE could be configured by the network M>1 (or N>1) parameters (e.g., higher layer RRC parameters) each associated with/corresponding to/configured for a TCI state group. Each parameter could include/indicate one or more TCI states/TCI state IDs. For this case, the TCI state group associated with the parameter could comprise the one or more TCI states/TCI state IDs configured in the parameter.

In the present disclosure, the UE could be higher layer configured by the network a list of entity IDs or a list of PCIs or a set of PCI indexes with each PCI index pointing to an entry/PCI in the list of PCIs that are higher layer configured to the UE.

In one example, the first TCI state group could be associated with the lowest PCI value or the first PCI value in the higher layer configured list of PCIs or the lowest PCI index or the first PCI index in the set of PCI indexes or the PCI index pointing to the lowest PCI value in the higher layer configured list of PCIs, the second TCI state group could be associated with the second lowest PCI value or the second PCI value in the higher layer configured list of PCIs or the second lowest PCI index or the second PCI index in the set of PCI indexes or the PCI index pointing to the second lowest PCI value in the higher layer configured list of PCIs, and so on, and the last TCI state group could be associated with the highest PCI value or the last PCI value in the higher layer configured list of PCIs or the highest PCI index or the last PCI index in the set of PCI indexes or the PCI index pointing to the highest PCI value in the higher layer configured list of PCIs. Or equivalently, the m-th (or n-th) TCI state group could be associated with the m-th (or n-th) lowest (or highest) PCI value or the m-th (or n-th) PCI value in the higher layer configured list of PCIs or the m-th (or n-th) lowest (or highest) PCI index or the first PCI index in the set of PCI indexes or the PCI index pointing to the m-th (or n-th) lowest (or highest) PCI value in the higher layer configured list of PCIs, where m∈{1, . . . , M} and n∈{1, . . . , N}. For M=2 (or N=2), the first (or second) TCI state group could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state group could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In another example, if the UE is provided in PDCCH-Config two values of CORESETPoolIndex (i.e., 0 and 1), for M=2 (or N=2), the first (or second) TCI state group could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state group could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In yet another example, the (higher layer) parameter that indicates one or more TCI states/TCI state IDs for a TCI state group could also include/indicate an entity ID as described above. For this case, a TCI state group and an entity ID are associated if the TCI state group and the entity ID are associated with the same (higher layer) parameter in the present disclosure.

The UE could receive from the network one or more MAC CE sub-selection/activation commands activating one or more TCI states/TCI state IDs from the one or more TCI state pools or the one or more TCI state groups, used to map up to Nc≥1 (e.g., 8, 16, 32 or 64) TCI state codepoints in a DCI format.

In one example, the UE could receive from the network a MAC CE sub-selection/activation command activating a set of Nc≥1 (e.g., 8, 16, 32 or 64) TCI state codepoints. In the present disclosure, the UE could be higher layer configured by the network a list of entity IDs or a list of PCIs or a set of PCI indexes with each PCI index pointing to an entry/PCI in the list of PCIs that are higher layer configured to the UE.

For example, a codepoint could correspond to a TCI state, wherein the TCI state could be a separate DL TCI state provided by DLorJointTCIState, a separate UL TCI state provided by UL-TCIState or a joint DL and UL TCI state provided by DLorJointTCIState.

Yet for another example, a codepoint could correspond to a pair of two TCI states, wherein the first TCI state in the pair could be a separate DL TCI state provided by DLorJointTCIState, a separate UL TCI state provided by UL-TCIState or a joint DL and UL TCI state provided by DLorJointTCIState, and the second TCI state in the pair could be a separate DL TCI state provided by DLorJointTCIState, a separate UL TCI state provided by UL-TCIState or a joint DL and UL TCI state provided by DLorJointTCIState. For instance, one TCI state in the pair could be for DL channels/signals, and the other TCI state in the pair could be for UL channels/signals.

Yet for another example, for M=2 (or N=2), a codepoint could correspond to a first TCI state and a second TCI state. For this case, the first TCI state could be a separate DL TCI state provided by DLorJointTCIState, a separate UL TCI state provided by UL-TCIState or a joint DL and UL TCI state provided by DLorJointTCIState, and the second TCI state could be a separate DL TCI state provided by DLorJointTCIState, a separate UL TCI state provided by UL-TCIState or a joint DL and UL TCI state provided by DLorJointTCIState. Furthermore, the first TCI state could be activated/selected by the MAC CE from the first (or second) TCI state pool or the first (or second) TCI state group, and the second TCI state could be activated/selected by the MAC CE from the second (or first) TCI state pool or the second (or first) TCI state group.

Yet for another example, for M=2 (or N=2), a codepoint could correspond to a first TCI state and a second TCI state. For this case, the first TCI state could be a separate DL TCI state provided by DLorJointTCIState, a separate UL TCI state provided by UL-TCIState or a joint DL and UL TCI state provided by DLorJointTCIState, and the second TCI state could be a separate DL TCI state provided by DLorJointTCIState, a separate UL TCI state provided by UL-TCIState or a joint DL and UL TCI state provided by DLorJointTCIState.

Furthermore, the first (or second) TCI state could be associated with the entity ID associated with the serving cell PCI/PCI index or the lowest entity ID or the first entity ID in the higher layer configured list of entity IDs, and the second (or first) TCI state could be associated with the entity ID associated with a PCI/PCI index other than the serving cell PCI/PCI index or the highest entity ID value or the last entity ID value in the higher layer configured list of entity IDs.

Alternatively, the first (or second) TCI state could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, for M=2 (or N=2), a codepoint could correspond to a first TCI state and a second TCI state. For this case, the first TCI state could be a separate DL TCI state provided by DLorJointTCIState, a separate UL TCI state provided by UL-TCIState or a joint DL and UL TCI state provided by DLorJointTCIState, and the second TCI state could be a separate DL TCI state provided by DLorJointTCIState, a separate UL TCI state provided by UL-TCIState or a joint DL and UL TCI state provided by DLorJointTCIState.

Furthermore, if the UE is provided in PDCCH-Config two values of CORESETPoolIndex (i.e., 0 and 1), the first (or second) TCI state could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, for M=2 (or N=2), a codepoint could correspond to two pairs of TCI states with each pair comprising two TCI states. The first TCI state in the first pair could be a separate DL TCI state provided by DLorJointTCIState, a separate UL TCI state provided by UL-TCIState or a joint DL and UL TCI state provided by DLorJointTCIState, and the second TCI state in the first pair could be a separate DL TCI state provided by DLorJointTCIState, a separate UL TCI state provided by UL-TCIState or a joint DL and UL TCI state provided by DLorJointTCIState. For instance, one TCI state in the first pair could be for DL channels/signals, and the other TCI state in the first pair could be for UL channels/signals.

Similarly, the first TCI state in the second pair could be a separate DL TCI state provided by DLorJointTCIState, a separate UL TCI state provided by UL-TCIState or a joint DL and UL TCI state provided by DLorJointTCIState, and the second TCI state in the second pair could be a separate DL TCI state provided by DLorJointTCIState, a separate UL TCI state provided by UL-TCIState or a joint DL and UL TCI state provided by DLorJointTCIState. For instance, one TCI state in the second pair could be for DL channels/signals, and the other TCI state in the second pair could be for UL channels/signals. Furthermore, the first and second TCI states in the first pair could be activated/selected by the MAC CE from the first (or second) TCI state pool or the first (or second) TCI state group, and the first and second TCI states in the second pair could be activated/selected by the MAC CE from the second (or first) TCI state pool or the second (or first) TCI state group.

Yet for another example, for M=2 (or N=2), a codepoint could correspond to two pairs of TCI states with each pair comprising two TCI states. The first TCI state in the first pair could be a separate DL TCI state provided by DLorJointTCIState, a separate UL TCI state provided by UL-TCIState or a joint DL and UL TCI state provided by DLorJointTCIState, and the second TCI state in the first pair could be a separate DL TCI state provided by DLorJointTCIState, a separate UL TCI state provided by UL-TCIState or a joint DL and UL TCI state provided by DLorJointTCIState.

For instance, one TCI state in the first pair could be for DL channels/signals, and the other TCI state in the first pair could be for UL channels/signals. Similarly, the first TCI state in the second pair could be a separate DL TCI state provided by DLorJointTCIState, a separate UL TCI state provided by UL-TCIState or a joint DL and UL TCI state provided by DLorJointTCIState, and the second TCI state in the second pair could be a separate DL TCI state provided by DLorJointTCIState, a separate UL TCI state provided by UL-TCIState or a joint DL and UL TCI state provided by DLorJointTCIState. For instance, one TCI state in the second pair could be for DL channels/signals, and the other TCI state in the second pair could be for UL channels/signals.

Furthermore, the first and second TCI states in the first (or second) pair could be associated with the entity ID associated with the serving cell PCI/PCI index or the lowest entity ID value or the first entity ID value in the higher layer configured list of entity IDs, and the first and second TCI states in the second (or first) pair could be associated with the entity ID associated with a PCI/PCI index other than the serving cell PCI/PCI index or the highest entity ID value or the last entity ID value in the higher layer configured list of entity IDs.

Alternatively, the first and second TCI states in the first (or second) pair could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the first and second TCI states in the second (or first) pair could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, for M=2 (or N=2), a codepoint could correspond to two pairs of TCI states with each pair comprising two TCI states. The first TCI state in the first pair could be a separate DL TCI state provided by DLorJointTCIState, a separate UL TCI state provided by UL-TCIState or a joint DL and UL TCI state provided by DLorJointTCIState, and the second TCI state in the first pair could be a separate DL TCI state provided by DLorJointTCIState, a separate UL TCI state provided by UL-TCIState or a joint DL and UL TCI state provided by DLorJointTCIState. For instance, one TCI state in the first pair could be for DL channels/signals, and the other TCI state in the first pair could be for UL channels/signals.

Similarly, the first TCI state in the second pair could be a separate DL TCI state provided by DLorJointTCIState, a separate UL TCI state provided by UL-TCIState or a joint DL and UL TCI state provided by DLorJointTCIState, and the second TCI state in the second pair could be a separate DL TCI state provided by DLorJointTCIState, a separate UL TCI state provided by UL-TCIState or a joint DL and UL TCI state provided by DLorJointTCIState. For instance, one TCI state in the second pair could be for DL channels/signals, and the other TCI state in the second pair could be for UL channels/signals.

Furthermore, if the UE is provided in PDCCH-Config two values of CORESETPoolIndex (i.e., 0 and 1), the first and second TCI states in the first (or second) pair could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the first and second TCI states in the second (or first) pair could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

As aforementioned, one or more of the Nc≥1 (e.g., 8, 16, 32 or 64) TCI state codepoints activated by the MAC CE could correspond to the TCI state codepoints. Furthermore, a “Transmission Configuration Indication” field in DCI format 1_1 or 1_2 with or without DL assignment could indicate a TCI state codepoint from the Nc≥1 (e.g., 8, 16, 32 or 64) activated TCI state codepoints in the present disclosure.

Alternatively, DCI format 1_1 with or without DL assignment or DCI format 1_2 with or without DL assignment could indicate/include a first “Transmission Configuration Indication” field (or denoted by a first TCI field or TCI field 1) indicating a first TCI state codepoint, and a second “Transmission Configuration Indication” field (denoted by a second TCI field or TCI field 2) indicating a second TCI state codepoint. In one example, the first TCI field or the second TCI field could be a new and dedicated TCI field added/configured in the DCI format 1_1 or 1_2 (with or without DL assignment), which is different from the existing DCI fields configured therein. In another example, the first TCI field or the second TCI field could correspond to the existing “Transmission Configuration Indication” field in the DCI format 1_1 or 1_2 (with or without DL assignment). When the two TCI fields are configured in the DCI format 1_1 or 1_2 with or without DL assignment for beam indication, the first or the second TCI state codepoints could be from the Nc≥1 (e.g., 8, 16, 32 or 64) activated TCI state codepoints.

Optionally, the UE could receive from the network an auxiliary MAC CE sub-selection/activation command selecting/activating one or more (Nc′≥1, e.g., Nc′=8, 16, 32 or 64) TCI state codepoints from the set of Nc activated TCI state codepoints as a subset of Nc′ TCI state codepoints. For this case, the “Transmission Configuration Indication” field in DCI format 1_1 or 1_2 with or without DL assignment could indicate a TCI state codepoint from the subset of Nc′≥1 (e.g., 8, 16, 32 or 64) TCI state codepoints, or the first or the second TCI state codepoints indicated by the first or the second TCI fields (if configured) in DCI format 1_1 or 1_2 with or without DL assignment could correspond to a TCI state codepoint from the subset of Nc′>1 (e.g., 8, 16, 32 or 64) TCI state codepoints.

Additionally, if DCI format 1_1 or 1_2 for beam indication is with DL assignment or the number of TCI state codepoints Nc to be activated by MAC CE is smaller than a threshold, the TCI state codepoint indicated in the “Transmission Configuration Indication” field could only correspond to/indicate a single TCI state or a single pair of TCI states (e.g., the TCI state codepoint) for single-TRP operation. If two TCI fields are allowed to be configured in a DCI format for beam indication, and if DCI format 1_1 or 1_2 for beam indication is with DL assignment or the number of TCI state codepoints Nc to be activated by MAC CE is smaller than a threshold, only one TCI field (e.g., either TCI field 1 or TCI field 2) can be configured in the DCI format, and the TCI state codepoint (e.g., either the first TCI state codepoint or the second TCI state codepoint) indicated in the corresponding TCI field could only correspond to/indicate a single TCI state or a single pair of TCI states (e.g., the TCI state codepoint) for single-TRP operation. If DCI format 1_1 or 1_2 for beam indication is with DL assignment or the number of TCI state codepoints Nc to be activated by MAC CE is smaller than a threshold, each of the MAC CE activated TCI state codepoints could only correspond to/indicate a single TCI state or a single pair of TCI states (e.g., the TCI state codepoint) for single-TRP operation. In the present disclosure, the threshold could be (1) fixed, e.g., 8, 16, 32 or 64, or (2) configured by the network via higher layer RRC signaling or/and MAC CE command or/and DCI based signaling.

In another example, for M=2 (or N=2), the UE could receive from the network a MAC CE sub-selection/activation command activating two sets of TCI state codepoints. For this case, the first set could contain NC≥1 (e.g., 8, 16, 32 or 64) TCI state codepoints, and the second set could contain Nc2≥1 (e.g., 8, 16, 32 or 64) TCI state codepoints. Alternatively, the UE could receive from the network a first MAC CE sub-selection/activation command activating a first set of Nc1≥1 (e.g., 8, 16, 32 or 64) TCI state codepoints, and a second MAC CE sub-selection/activation command activating a second set of Nc2≥1 (e.g., 8, 16, 32 or 64) TCI state codepoints.

For example, a codepoint in the first set of codepoints or the second set of codepoints could correspond to a TCI state, wherein the TCI state could be a separate DL TCI state provided by DLorJointTCIState, a separate UL TCI state provided by UL-TCIState or a joint DL and UL TCI state provided by DLorJointTCIState.

Yet for another example, a codepoint in the first set of codepoints or the second set of codepoints could correspond to a pair of two TCI states, wherein the first TCI state in the pair could be a separate DL TCI state provided by DLorJointTCIState, a separate UL TCI state provided by UL-TCIState or a joint DL and UL TCI state provided by DLorJointTCIState, and the second TCI state in the pair could be a separate DL TCI state provided by DLorJointTCIState, a separate UL TCI state provided by UL-TCIState or a joint DL and UL TCI state provided by DLorJointTCIState. For instance, one TCI state in the pair could be for DL channels/signals, and the other TCI state in the pair could be for UL channels/signals.

In the present disclosure, the UE could be higher layer configured by the network a list of entity IDs or a list of PCIs or a set of PCI indexes with each PCI index pointing to an entry/PCI in the list of PCIs that are higher layer configured to the UE.

For example, the TCI states indicated by the first set of TCI state codepoints could be activated/selected by the MAC CE from the first (or second) TCI state pool or the first (or second) TCI state group, and the TCI states indicated by the second set of TCI state codepoints could be activated/selected by the MAC CE from the second (or first) TCI state pool or the second (or first) TCI state group.

For another example, the TCI states indicated by the first (or second) set of TCI state codepoints could be associated with the entity ID associated with the serving cell PCI/PCI index or the lowest entity ID value or the first entity ID value in the higher layer configured list of entity IDs, and the TCI states indicated by the second (or first) set of TCI state codepoints could be associated with the entity ID associated with a PCI/PCI index other than the serving cell PCI/PCI index or the highest entity ID value or the last entity ID value in the higher layer configured list of entity IDs.

Alternatively, the TCI states indicated by the first (or second) set of TCI state codepoints could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the TCI states indicated by the second (or first) set of TCI state codepoints could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, if the UE is provided in PDCCH-Config two values of CORESETPoolIndex (i.e., 0 and 1), the TCI states indicated by the first (or second) set of TCI state codepoints could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the TCI states indicated by the second (or first) set of TCI state codepoints could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, the first MAC CE sub-selection/activation command could include/indicate a first entity ID, and the second MAC CE sub-selection/activation command could include/indicate a second entity ID. In the present disclosure, the first entity ID or the second entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. For this case, the TCI states indicated by the first set of TCI state codepoints activated/selected by the first MAC CE sub-selection/activation command could be associated with the first entity ID, and the TCI states indicated by the second set of TCI state codepoints activated/selected by the second MAC CE sub-selection/activation command could be associated with the second entity ID.

For DCI based beam indication, DCI format 1_1 with or without DL assignment or DCI format 1_2 with or without DL assignment could indicate/include a first “Transmission Configuration Indication” field (or denoted by a first TCI field or TCI field 1) indicating a first TCI state codepoint, and a second “Transmission Configuration Indication” field (denoted by a second TCI field or TCI field 2) indicating a second TCI state codepoint. In one example, the first TCI field or the second TCI field could be a new and dedicated TCI field added/configured in the DCI format 1_1 or 1_2 (with or without DL assignment), which is different from the existing DCI fields configured therein. In another example, the first TCI field or the second TCI field could correspond to the existing “Transmission Configuration Indication” field in the DCI format 1_1 or 1_2 (with or without DL assignment). In yet another example, the first TCI field or the second TCI field could be configured by repurposing one or more of the existing DCI fields in the DCI format 1_1 or 1_2 (with or without DL assignment).

In the present disclosure, the UE could be higher layer configured by the network a list of entity IDs or a list of PCIs or a set of PCI indexes with each PCI index pointing to an entry/PCI in the list of PCIs that are higher layer configured to the UE.

For example, the TCI state(s) indicated by the first TCI state codepoint/the first TCI field could be activated/selected by the MAC CE from the first (or second) TCI state pool or the first (or second) TCI state group, and the TCI state(s) indicated by the second TCI state codepoint/the second TCI field could be activated/selected by the MAC CE from the second (or first) TCI state pool or the second (or first) TCI state group.

For another example, the first (or second) TCI state codepoint/the first (or second) TCI field could be associated with the entity ID associated with the serving cell PCI/PCI index or the lowest entity ID value or the first entity ID value in the higher layer configured list of entity IDs, and the second (or first) TCI state codepoint/the second (or first) TCI field could be associated with the entity ID associated with a PCI/PCI index other than the serving cell PCI/PCI index or the highest entity ID value or the last entity ID value in the higher layer configured list of entity IDs.

Alternatively, the first (or second) TCI state codepoint/the first (or second) TCI field could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state codepoint/the second (or first) TCI field could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, if the UE is provided in PDCCH-Config two values of CORESETPoolIndex (i.e., 0 and 1), the first (or second) TCI state codepoint/the first (or second) TCI field could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state codepoint/the second (or first) TCI field could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Furthermore, in one example, the first TCI field could indicate the first TCI state codepoint from the first set of TCI state codepoints, and the second TCI field could indicate the second TCI state codepoint from the second set of TCI state codepoints.

In another example, the first TCI field could indicate the first TCI state codepoint from the second set of TCI state codepoints, and the second TCI field could indicate the second TCI state codepoint from the first set of TCI state codepoints.

In yet another example, the UE could receive a first one-bit flag for the first TCI field with “0” indicating that the first TCI state codepoint is indicated from the first (or second) set of TCI state codepoints and “1” indicating that the first TCI state codepoint is indicated from the second (or first) set of TCI state codepoints; furthermore, the UE could receive a second one-bit flag for the second TCI field with “0” indicating that the second TCI state codepoint is indicated from the first (or second) set of TCI state codepoints and “1” indicating that the second TCI state codepoint is indicated from the second (or first) set of TCI state codepoints. The UE could be configured by the network via higher layer RRC signaling or MAC CE command or DCI based signaling the first or second one-bit flag indicators.

If DCI format 1_1 or 1_2 for beam indication is with DL assignment or the number of TCI state codepoints Nc1 in the first set of TCI state codepoints to be activated by MAC CE or the number of TCI state codepoints Nc2 in the second set of TCI state codepoints to be activated by MAC CE or the total number of TCI state codepoints Nc1+Nc2 in the first and second sets of TCI state codepoints to be activated by MAC CE is smaller than a threshold, the DCI format 1_1 or 1_2 could only indicate a single TCI field (e.g., either the first or the second TCI field), and the TCI state codepoint (e.g., either the first or the second TCI state codepoint) indicated in the TCI field could only correspond to/indicate a single TCI state or a single pair of TCI states—e.g., selected from either the first set or the second set of TCI state codepoints—for single-TRP operation. In the present disclosure, the threshold could be (1) fixed, e.g., 8, 16, 32 or 64, or (2) configured by the network via higher layer RRC signaling or/and MAC CE command or/and DCI based signaling.

For DCI based beam indication, DCI format 1_1 with or without DL assignment or DCI format 1_2 with or without DL assignment could indicate/include a single “Transmission Configuration Indication” field indicating a TCI state codepoint. A new one-bit flag indicator could be indicated/added in the DCI format 1_1 or 1_2 with or without DL assignment; the one-bit flag indicator is used to indicate mapping/association between the TCI field and a TRP. Alternatively, the new data indicator (NDI) field in the DCI format 1_1 or 1_2 with or without DL assignment could be used to indicate mapping/association between the TCI field and a TRP, and the NDI is toggled with every new transmission. Note that other existing one-bit flag indicator(s) in the DCI format 1_1 or 1_2 with or without DL assignment could also be repurposed to indicate mapping/association between the TCI field and a TRP. In the present disclosure, the UE could be higher layer configured by the network a list of entity IDs or a list of PCIs or a set of PCI indexes with each PCI index pointing to an entry/PCI in the list of PCIs that are higher layer configured to the UE.

For example, if the one-bit flag indicator/NDI is set to “0” or the NDI is toggled, the TCI state(s) indicated by the TCI state codepoint/the TCI field could be activated/selected by the MAC CE from the first (or second) TCI state pool or the first (or second) TCI state group, and if the one-bit flag indicator/NDI is set to “1” or the NDI is not toggled, the TCI state(s) indicated by the TCI state codepoint/the TCI field could be activated/selected by the MAC CE from the second (or first) TCI state pool or the second (or first) TCI state group.

For another example, if the one-bit flag indicator/NDI is set to “0” (or “1”) or the NDI is toggled (or is not toggled), the TCI state codepoint/the TCI field could be associated with the entity ID associated with the serving cell PCI/PCI index or the lowest entity ID value or the first entity ID value in the higher layer configured list of entity IDs, and if the one-bit flag indicator/NDI is set to “1” (or “0”) or the NDI is not toggled (or is toggled), the TCI state codepoint/the TCI field could be associated with the entity ID associated with a PCI/PCI index other than the serving cell PCI/PCI index or the highest entity ID value or the last entity ID value in the higher layer configured list of entity IDs.

Alternatively, if the one-bit flag indicator/NDI is set to “0” (or “1”) or the NDI is toggled (or is not toggled), the TCI state codepoint/the TCI field could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and if the one-bit flag indicator/NDI is set to “1” (or “0”) or the NDI is not toggled (or is toggled), the TCI state codepoint/the TCI field could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, if the UE is provided in PDCCH-Config two values of CORESETPoolIndex (i.e., 0 and 1): if the one-bit flag indicator/NDI is set to “0” (or “1”) or the NDI is toggled (or is not toggled), the TCI state codepoint/the TCI field could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and if the one-bit flag indicator/NDI is set to “1” (or “0”) or the NDI is not toggled (or is toggled), the TCI state codepoint/the TCI field could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In the present disclosure, the UE could be higher layer configured by the network a list of entity IDs or a list of PCIs or a set of PCI indexes with each PCI index pointing to an entry/PCI in the list of PCIs that are higher layer configured to the UE.

In one example, a new one-bit flag indicator could be indicated/added in the DCI format 1_1 or 1_2 with or without DL assignment; the one-bit flag indicator is used to indicate mapping/association between the TCI field/TCI codepoint and a set of codepoints (e.g., the first or second set of codepoints).

Alternatively, the new data indicator (NDI) field in the DCI format 1_1 or 1_2 with or without DL assignment could be used to indicate mapping/association between the TCI field/TCI state codepoint and a set of codepoints (e.g., the first or second set of codepoints), and the NDI is toggled with every new transmission. Note that other existing one-bit flag indicator(s) in the DCI format 1_1 or 1_2 with or without DL assignment could also be repurposed to indicate mapping/association between the TCI field/TCI state codepoint and a set of codepoints (e.g., the first or second set of codepoints). For this case, if the one-bit flag indicator/NDI is set to “0” (or “1”) or the NDI is toggled (or is not toggled), the TCI field could indicate the TCI state codepoint from the first set of TCI state codepoints, and if the one-bit flag indicator/NDI is set to “1” (or “0”) or the NDI is not toggled (or is toggled), the TCI field could indicate the TCI state codepoint from the second set of TCI state codepoints.

In another example, the TCI field could indicate the TCI state codepoint from a third set of TCI state codepoints, wherein the third set of TCI state codepoints comprises one or more TCI state codepoints from the first set of TCI state codepoints and one or more TCI state codepoints from the second set of TCI state codepoints. For instance, the first set of TCI state codepoints could comprise 8 TCI state codepoints, denoted by TCI_0, TCI_1, TCI_2, TCI_3, TCI_4, TCI_5, TCI_6, or TCI_7, and the second set of TCI state codepoints could comprise 8 TCI state codepoints, denoted by TCI_A, TCI_B, TCI_C, TCI_D, TCI_E, TCI_F, TCI_G, or TCI_H. The third set of TCI state codepoints could then comprise TCI_0, TCI_1, TCI_2, TCI_3, TCI_A, TCI_B, TCI_C, and TCI_D.

The third set of TCI state codepoints could comprise any combinations of TCI state codepoints from the first or the second sets. The TCI state codepoints configured in the first or the second sets can be determined/selected into the third set according to at least one of: (1) fixed in the system specifications or (2) configured by the network via higher layer RRC signaling, MAC CE command or dynamic DCI based signaling.

If DCI format 1_1 or 1_2 for beam indication is with DL assignment or the number of TCI state codepoints Nc1 in the first set of TCI state codepoints to be activated by MAC CE or the number of TCI state codepoints Nc2 in the second set of TCI state codepoints to be activated by MAC CE or the total number of TCI state codepoints Nc1+Nc2 in the first and second sets of TCI state codepoints to be activated by MAC CE is smaller than a threshold, the TCI state codepoint indicated in the “Transmission Configuration Indication” field could only correspond to/indicate a single TCI state or a single pair of TCI states—e.g., selected from either the first set or the second set of TCI state codepoints—for single-TRP operation. In the present disclosure, the threshold could be (1) fixed, e.g., 8, 16, 32 or 64, or (2) configured by the network via higher layer RRC signaling or/and MAC CE command or/and DCI based signaling.

A UE could receive in an uplink DCI, e.g., DCI format 0_1 or 0_2, a “SRS resource set indicator” field to indicate one or more SRS resource sets for single-TRP or multi-TRP operations. Alternatively, one or more existing fields in DCI format 0_1 or 0_2 could be used/repurposed to indicate one or more SRS resource sets for single-TRP or multi-TRP operations. Specifically, the “SRS resource set indicator” field in DCI format 0_1 or 0_2 could be a 0-bit or 2-bit indicator configured as follows: if (1) the higher layer parameter txConfig is set to nonCodeBook, and there are two SRS resource sets configured by srs-ResourceSetToAddModList and associated with the usage of value “SRS resource set indicator,” “nonCodeBook SRS resource set indicator,” or (2) the higher layer parameter txConfig is set to codebook, and there are two SRS resource sets configured by srs-ResourceSetToAddModList and associated with the usage of value “SRS resource set indicator,” “codebook SRS resource set indicator,” the “SRS resource set indicator” corresponds to a 2-bit indicator. Otherwise, the “SRS resource set indicator” corresponds to a 0-bit indicator.

When the “SRS resource set indicator” field in DCI format 0_1 or 0_2 is a 2-bit indicator, the corresponding bit fields/indexes could be configured according to TABLE 1.

TABLE 1
“SRS resource set indicator” field in DCI format 0_1 or 0_2

| Bit field mapped | |
|---|---|
| to index | SRS resource set indication |
| 0 | SRS resource indicator field and Precoding |
| | information and number of layers field are |
| | associated with the first SRS resource set; |
| | Second SRS resource indicator field and |
| | Second Precoding information field are |
| | reserved. |
| 1 | SRS resource indicator field and Precoding |
| | information and number of layers field are |
| | associated with the second SRS resource set; |
| | Second SRS resource indicator field and |
| | Second Precoding information field are |
| | reserved. |
| 2 | SRS resource indicator field and Precoding |
| | information and number of layers field are |
| | associated with the first SRS resource set; |
| | Second SRS resource indicator field and |
| | Second Precoding information field are |
| | associated with the second SRS resource set. |
| 3 | SRS resource indicator field and Precoding |
| | information and number of layers field are |
| | associated with the first SRS resource set; |
| | Second SRS resource indicator field and |
| | Second Precoding information field are |
| | associated with the second SRS resource set. |

In TABLE 1, the first and the second SRS resource sets are respectively the ones with lower and higher srs-ResourceSetId of the two SRS resources sets configured by higher layer parameter srs-ResourceSetToAddModList or srs-ResourceSetToAddModListDCI-0-2, and associated with the higher layer parameter usage of value “SRS resource set indicator” nonCodeBook “SRS resource set indicator” if txConfig=nonCodebook or “SRS resource set indicator” codeBook “SRS resource set indicator” if txConfig=codebook. When only one SRS resource set is configured by higher layer parameter srs-ResourceSetToAddModList or srs-ResourceSetToAddModListDCI-0-2, and associated with the higher layer parameter usage of value “SRS resource set indicator” codeBook “SRS resource set indicator” or “SRS resource set indicator” nonCodeBook “SRS resource set indicator” respectively, the first SRS resource set is the SRS resource set.

Furthermore, for DCI format 0_2, the first and second SRS resource sets configured by higher layer parameter srs-ResourceSetToAddModListDCI-0-2 are composed of the first N_{SRS,0_2} SRS resources together with other configurations in the first and second SRS resource sets configured by higher layer parameter srs-ResourceSetToAddModList, if any, and associated with the higher layer parameter usage of value “SRS resource set indicator” codeBook “SRS resource set indicator” or “SRS resource set indicator” nonCodeBook “SRS resource set indicator,” respectively, except for the higher layer parameters “SRS resource set indicator” srs-ResourceSetId “SRS resource set indicator” and “SRS resource set indicator” srs-ResourceldList “SRS resource set indicator.”

In one embodiment of the present disclosure, a UE could receive in one or more CORESETs one or more PDCCH candidates from one or more search space sets configured with a higher layer parameter searchSpaceLinking. The one or more PDCCH candidates configured with the same higher layer parameter searchSpaceLinking could contain/carry/convey the same DCI payload. In the present disclosure, the same DCI payload could correspond to any DCI format, e.g., DCI format 1_1 or 1_2 with or without DL assignment for beam indication or DCI format 0_1 or 0_2. As aforementioned, the UE could receive in a DCI (e.g., DCI format 1_1 or 1_2 with or without DL assignment) M>1 (or N>1) TCI states or M>1 (or N>1) pairs of TCI states indicated by one or more TCI state codepoints (or one or more TCI fields) in the corresponding DCI. One or more of the indicated M>1 (or N>1) TCI states or pairs of TCI states could be associated with/mapped to the one or more CORESETs, in which the one or more PDCCH candidates from the one or more search space sets configured with the same higher layer parameter searchSpaceLinking are received—also referred to as beam indication for PDCCH repetitions.

As discussed above, the UE could receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. In the present disclosure, the SRS resource set indicator in DCI format 0_1 or 0_2 could also be used/applied to indicate at least one of: (1) switching between single-TRP PDCCH reception and multi-TRP PDCCH (repetitions) reception, (2) one or more of the indicated M>1 (or N>1) TCI states or pairs of TCI states to use for the single-TRP PDCCH reception, and (3) switching the order of the indicated M>1 (or N>1) TCI states or pairs of TCI states.

In one example, the UE could first receive in a DCI (e.g., DCI format 1_1 or 1_2 with or without DL assignment) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received. The UE could also receive in an uplink DCI (e.g., DCI format 0_1 or 0_2) a SRS resource set indicator (e.g., in the “SRS resource set indicator” field). For instance, if the bit field of the SRS resource set indicator is set to “00” or “01” or the index of the SRS resource set indicator is set to “0” or “1” according to TABLE 1 or the SRS resource set indicator field is not configured/present, the UE could use only one of the indicated M>1 (or N>1) TCI states or pairs of TCI states to receive/monitor one or more PDCCH candidates in one or more CORESETs—i.e., PDCCH reception in a single-TRP system; if the bit field of the SRS resource set indicator is set to “10” or “11” or the index of the SRS resource set indicator is set to “2” or “3” according to TABLE 1 or the SRS resource set indicator is not configured/present, the UE could use one or more of the indicated M>1 (or N>1) TCI states or pairs of TCI states to receive/monitor one or more PDCCH candidates from one or more search space sets configured with the same higher layer parameter searchSpaceLinking in one or more CORESETs—i.e., PDCCH repetitions reception in a multi-TRP system. More specifically, when the bit field of the SRS resource set indicator is set to “00” or “10” or the index of the SRS resource set indicator is set to “0” or “1” according to TABLE 1 or the SRS resource set indicator is not configured/present (i.e., for the PDCCH reception in a single-TRP system),

For example, the UE could use the first TCI state or the TCI state with the lowest (or highest) TCI state ID among the indicated M>1 (or N>1) TCI states or the separate DL TCI state or the joint DL and UL TCI state in the first pair of TCI states or the separate DL TCI state or the joint DL and UL TCI state in the pair of TCI states associated with the lowest (or highest) TCI state ID among the indicated M>1 (or N>1) pairs of TCI states to receive/monitor one or more PDCCH candidates in one or more CORESETs.

For another example, the UE could use the second TCI state or the TCI state with the second lowest (or second highest) TCI state ID among the indicated M>1 (or N>1) TCI states or the separate DL TCI state or the joint DL and UL TCI state in the second pair of TCI states or the separate DL TCI state or the joint DL and UL TCI state in the pair of TCI states associated with the second lowest (or second highest) TCI state ID among the indicated M>1 (or N>1) pairs of TCI states to receive/monitor one or more PDCCH candidates in one or more CORESETs.

Yet for another example, the UE could use the last TCI state or the TCI state with the highest (or lowest) TCI state ID among the indicated M>1 (or N>1) TCI states or the separate DL TCI state or the joint DL and UL TCI state in the last pair of TCI states or the separate DL TCI state or the joint DL and UL TCI state in the pair of TCI states associated with the highest (or lowest) TCI state ID among the indicated M>1 (or N>1) pairs of TCI states to receive/monitor one or more PDCCH candidates in one or more CORESETs.

Yet for another example, the UE could use the m-th (or n-th) TCI state or the TCI state with the m-th (or n-th) lowest (or highest) TCI state ID among the indicated M>1 (or N>1) TCI states or the separate DL TCI state or the joint DL and UL TCI state in the m-th (or n-th) pair of TCI states or the separate DL TCI state or the joint DL and UL TCI state in the pair of TCI states associated with the m-th (or n-th) lowest (or highest) TCI state ID among the indicated M>1 (or N>1) pairs of TCI states to receive/monitor one or more PDCCH candidates in one or more CORESETs, where m∈{1, . . . , M} and n∈{1, . . . , N}. In this example, the index m (or n) could be determined according to at least one of: (1) fixed in the system specification(s) and (2) configured, e.g., via higher layer RRC signaling or MAC CE command or DCI based signaling, by the network.

Yet for another example, the UE could use the separate DL TCI state or the joint DL and UL TCI state among the indicated M>1 (or N>1) TCI states to receive/monitor one or more PDCCH candidates in one or more CORESETs. In this example, only one of the indicated M>1 (or N>1) TCI states could correspond to a separate DL TCI state or a joint DL and UL TCI state.

Yet for another example, the UE could be higher layer configured by the network a list of K entity IDs. In the present disclosure, an entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. The UE could use the TCI state or the pair of TCI states that is associated with the first entity ID or the second entity ID or the last entity ID or the lowest entity ID or the highest entity ID or the second lowest (or second highest) entity ID or the entity ID associated with the serving cell PCI/PCI index or the entity ID associated with a PCI/PCI index different from the serving cell PCI/PCI index or the k-th entity ID or the k-th lowest (or highest) entity ID among the list of K entity IDs to receive/monitor one or more PDCCH candidates in one or more CORESETs, where k∈{1, . . . , K}. In this example, the index k could be determined according to at least one of: (1) fixed in the system specification(s) and (2) configured, e.g., via higher layer RRC signaling or MAC CE command or DCI based signaling, by the network. Furthermore, K could be equal to M (or N).

Yet for another example, the UE could be higher layer configured by the network a list of L PCIs. The UE could use the TCI state or the pair of TCI states that is associated with the first PCI or the second PCI or the last PCI or the lowest PCI or the highest PCI or the second lowest (or second highest) PCI or the serving cell PCI or a PCI different from the serving cell PCI or the l-th PCI or the l-th lowest (or highest) PCI among the list of L PCIs to receive/monitor one or more PDCCH candidates in one or more CORESETs, where l∈{1, . . . , L}. Alternatively, the UE could determine a list of L PCI indexes 0, . . . , L−1 or 1, . . . , L with each PCI index pointing to an entry in the list of L PCIs. For this case, the UE could use the TCI state or the pair of TCI states that is associated with the first PCI index or the second PCI index or the last PCI index or the lowest PCI index or the highest PCI index or the second lowest (or second highest) PCI index or the serving cell PCI index or a PCI index different from the serving cell PCI index or the l-th PCI index or the l-th lowest (or highest) PCI index among the list of L PCI indexes to receive/monitor one or more PDCCH candidates in one or more CORESETs, where l∈{1, . . . , L}. In this example, the index l could be determined according to at least one of: (1) fixed in the system specification(s) and (2) configured, e.g., via higher layer RRC signaling or MAC CE command or DCI based signaling, by the network. Furthermore, L could be equal to M (or N).

Yet for another example, the UE could be provided in PDCCH-Config two values of CORESETPoolIndex (i.e., 0 and 1) for one or more CORESETs. The UE could use the TCI state or the pair of TCI states that is associated with value 0 of CORESETPoolIndex or value 1 of CORESETPoolIndex or value x of CORESETPoolIndex to receive/monitor one or more PDCCH candidates in one or more CORESETs, where x∈{0, 1}. In this example, the value x could be determined according to at least one of: (1) fixed in the system specification(s) and (2) configured, e.g., via higher layer RRC signaling or MAC CE command or DCI based signaling, by the network.

In another example, the UE could first receive in a DCI (e.g., DCI format 1_1 or 1_2 with or without DL assignment) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received. As discussed above, the UE could receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. If the bit field of the SRS resource set indicator is set to “00” (or “01”) or the index of the SRS resources set indicator is set to “0” (or “1”) according to TABLE 1, the UE could use one of the indicated M>1 (or N>1) TCI states or pairs of TCI states—a primary TCI state or pair of TCI states—to receive/monitor one or more PDCCH candidates in one or more CORESETs—i.e., PDCCH reception in a single-TRP system; if the bit field of the SRS resource set indicator is set to “01” (or “00”) or the index of the SRS resources set indicator is set to “1” (or “0”) according to TABLE 1, the UE could use another one of the indicated M>1 (or N>1) TCI states or pairs of TCI states—a secondary TCI state or pair of TCI states—to receive/monitor one or more PDCCH candidates in one or more CORESETs—i.e., PDCCH reception in a single-TRP system. Various design examples of determining the primary TCI state or pair of TCI states or the secondary TCI state or pair of TCI states are provided below.

For example, the primary TCI state or pair of TCI states could correspond to the first (or second) TCI state or the TCI state with the lowest (or second lowest/highest) TCI state ID among the indicated M>1 (or N>1) TCI states or the separate DL TCI state or the joint DL and UL TCI state in the first (or second) pair of TCI states or the separate DL TCI state or the joint DL and UL TCI state in the pair of TCI states associated with the lowest (or second lowest/highest) TCI state ID among the indicated M>1 (or N>1) pairs of TCI states, and the secondary TCI state or pair of TCI states could correspond to the second (or first) TCI state or the TCI state with the second lowest/highest (or lowest) TCI state ID among the indicated M>1 (or N>1) TCI states or the separate DL TCI state or the joint DL and UL TCI state in the second (or first) pair of TCI states or the separate DL TCI state or the joint DL and UL TCI state in the pair of TCI states associated with the second lowest/highest (or lowest) TCI state ID among the indicated M>1 (or N>1) pairs of TCI states.

For another example, the primary TCI state or pair of TCI states could correspond to the first (or last) TCI state or the TCI state with the lowest (or highest) TCI state ID among the indicated M>1 (or N>1) TCI states or the separate DL TCI state or the joint DL and UL TCI state in the first (or last) pair of TCI states or the separate DL TCI state or the joint DL and UL TCI state in the pair of TCI states associated with the lowest (or highest) TCI state ID among the indicated M>1 (or N>1) pairs of TCI states, and the secondary TCI state or pair of TCI states could correspond to the last (or first) TCI state or the TCI state with the highest (or lowest) TCI state ID among the indicated M>1 (or N>1) TCI states or the separate DL TCI state or the joint DL and UL TCI state in the last (or first) pair of TCI states or the separate DL TCI state or the joint DL and UL TCI state in the pair of TCI states associated with the highest (or lowest) TCI state ID among the indicated M>1 (or N>1) pairs of TCI states.

Yet for another example, the primary TCI state or pair of TCI states could correspond to the m-th (or n-th) TCI state or the TCI state with the m-th (or n-th) lowest (or highest) TCI state ID among the indicated M>1 (or N>1) TCI states or the separate DL TCI state or the joint DL and UL TCI state in the m-th (or n-th) pair of TCI states or the separate DL TCI state or the joint DL and UL TCI state in the pair of TCI states associated with the m-th (or n-th) lowest (or highest) TCI state ID among the indicated M>1 (or N>1) pairs of TCI states, and the secondary TCI state or pair of TCI states could correspond to the m′-th (or n′-th) TCI state or the TCI state with the m′-th (or n′-th) lowest (or highest) TCI state ID among the indicated M>1 (or N>1) TCI states or the separate DL TCI state or the joint DL and UL TCI state in the m′-th (or n′-th) pair of TCI states or the separate DL TCI state or the joint DL and UL TCI state in the pair of TCI states associated with the m′-th (or n′-th) lowest (or highest) TCI state ID among the indicated M>1 (or N>1) pairs of TCI states, where m∈{1, . . . , M}, n∈{1, . . . , N}, m′∈{1, . . . , M} and n′∈{1, . . . , N}. In this example, the index m (or n) and the index m′ (or n′) could be determined according to at least one of: (1) fixed in the system specification(s) and (2) configured, e.g., via higher layer RRC signaling or MAC CE command or DCI based signaling, by the network.

Yet for another example, the primary TCI state or pair of TCI states could correspond to the first (or second) separate DL TCI state or the first (or second) joint DL and UL TCI state among the indicated M>1 (or N>1) TCI states or the pair of TCI states containing the first (or second) separate DL TCI state or the first (or second) joint DL and UL TCI state among the indicated M>1 (or N>1) pairs of TCI states, and the secondary TCI state or pair of TCI states could correspond to the second (or first) separate DL TCI state or the second (or first) joint DL and UL TCI state among the indicated M>1 (or N>1) TCI states or the pair of TCI states containing the second (or first) separate DL TCI state or the second (or first) joint DL and UL TCI state among the indicated M>1 (or N>1) pairs of TCI states. In this example, for beam indication for downlink channels/signals, only the first separate DL TCI state, the second separate DL TCI state, the first joint DL and UL TCI state or the second joint DL and UL TCI state (among the indicated M>1 or N>1 TCI states or pairs of TCI states) are configured/indicated.

Yet for another example, the UE could be higher layer configured by the network a list of K entity IDs. In the present disclosure, an entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. In one example, the primary TCI state or pair of TCI states could correspond to the TCI state or the pair of TCI states that is associated with the first (or second) entity ID or the lowest (or second lowest/highest) entity ID or the entity ID associated with the serving cell PCI/PCI index (or a PCI/PCI index different from the serving cell PCI/PCI index), and the secondary TCI state or pair of TCI states could correspond to the TCI state or the pair of TCI states that is associated with the second (or first) entity ID or the second lowest/highest (or lowest) entity ID or the entity ID associated with a PCI/PCI index different from the serving cell PCI/PCI index (or the serving cell PCI/PCI index). In another example, the primary TCI state or pair of TCI states could correspond to the TCI state or the pair of TCI states that is associated with the first (or last) entity ID or the lowest (or highest) entity ID, and the secondary TCI state or pair of TCI states could correspond to the TCI state or the pair of TCI states that is associated with the last (or first) entity ID or the highest (or lowest) entity ID.

In yet another example, the primary TCI state or pair of TCI states could correspond to the TCI state or the pair of TCI states that is associated with the k-th entity ID or the k-th lowest (or highest) entity ID, and the secondary TCI state or pair of TCI states could correspond to the TCI state or the pair of TCI states that is associated with the k′-th entity ID or the k′-th lowest (or highest) entity ID, where k∈{1, . . . , K} and k′∈{1, . . . , K}. For this case, the index k or the index k′ could be determined according to at least one of: (1) fixed in the system specification(s) and (2) configured, e.g., via higher layer RRC signaling or MAC CE command or DCI based signaling, by the network. Furthermore, K could be equal to M (or N).

Yet for another example, the UE could be higher layer configured by the network a list of L PCIs. In one example, the primary TCI state or pair of TCI states could correspond to the TCI state or the pair of TCI states that is associated with the first (or second) PCI or the lowest (or second lowest/highest) PCI or the serving cell PCI (or a PCI different from the serving cell PCI), and the secondary TCI state or pair of TCI states could correspond to the TCI state or the pair of TCI states that is associated with the second (or first) PCI or the second lowest/highest (or lowest) PCI or a PCI different from the serving cell PCI (or the serving cell PCI). In another example, the primary TCI state or pair of TCI states could correspond to the TCI state or the pair of TCI states that is associated with the first (or last) PCI or the lowest (or highest) PCI, and the secondary TCI state or pair of TCI states could correspond to the TCI state or the pair of TCI states that is associated with the last (or first) PCI or the highest (or lowest) PCI.

In yet another example, the primary TCI state or pair of TCI states could correspond to the TCI state or the pair of TCI states that is associated with the l-th PCI or the l-th lowest (or highest) PCI, and the secondary TCI state or pair of TCI states could correspond to the TCI state or the pair of TCI states that is associated with the l′-th PCI or the l′-th lowest (or highest) PCI, where l∈{1, . . . , L} and l′∈{1, . . . , L}. Alternatively, the UE could determine a list of L PCI indexes 0, . . . , L−1 or 1, . . . , L with each PCI index pointing to an entry in the list of L PCIs. For this case, in one example, the primary TCI state or pair of TCI states could correspond to the TCI state or the pair of TCI states that is associated with the first (or second) PCI index or the lowest (or second lowest/highest) PCI index or the serving cell PCI index (or a PCI index different from the serving cell PCI index), and the secondary TCI state or pair of TCI states could correspond to the TCI state or the pair of TCI states that is associated with the second (or first) PCI index or the second lowest/highest (or lowest) PCI index or a PCI index different from the serving cell PCI index (or the serving cell PCI index); in another example, the primary TCI state or pair of TCI states could correspond to the TCI state or the pair of TCI states that is associated with the first (or last) PCI index or the lowest (or highest) PCI index, and the secondary TCI state or pair of TCI states could correspond to the TCI state or the pair of TCI states that is associated with the last (or first) PCI index or the highest (or lowest) PCI index; in yet another example, the primary TCI state or pair of TCI states could correspond to the TCI state or the pair of TCI states that is associated with the l-th PCI index or the l-th lowest (or highest) PCI index, and the secondary TCI state or pair of TCI states could correspond to the TCI state or the pair of TCI states that is associated with the l′-th TCI index or the l′-th lowest (or highest) PCI index, where l∈{1, . . . , L} and l′∈{1, . . . , L}.

For this case, the index l or the index l′ could be determined according to at least one of: (1) fixed in the system specification(s) and (2) configured, e.g., via higher layer RRC signaling or MAC CE command or DCI based signaling, by the network. Furthermore, L could be equal to M (or N).

Yet for another example, the UE could be provided in PDCCH-Config two values of CORESETPoolIndex (i.e., 0 and 1) for one or more CORESETs. The primary TCI state or pair of TCI states could correspond to the TCI state or the pair of TCI states that is associated with value 0 (or 1) of CORESETPoolIndex or value x of CORESETPoolIndex, and the secondary TCI state or pair of TCI states could correspond to the TCI state or the pair of TCI states that is associated with value 1 (or 0) of CORESETPoolIndex or value x′ of CORESETPoolIndex, where x∈{0, 1} and x′∈{0, 1}. In this example, the value x or the value x′ could be determined according to at least one of: (1) fixed in the system specification(s) and (2) configured, e.g., via higher layer RRC signaling or MAC CE command or DCI based signaling, by the network.

In yet another example, the UE could first receive in a DCI (e.g., DCI format 1_1 or 1_2 with or without DL assignment) M>1 (or N>1) TCI states or pairs of TCI states—denoted and ordered by {TCI state/TCI states pair #a1, TCI state/TCI states pair #a2, . . . , TCI state/TCI states pair #aM (or #aN)}—indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received. As discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the bit field of the SRS resource set indicator is set to “11” (or “10”) or the index of the SRS resource set indicator is set to “3” (or “2”) according to TABLE 1 or the SRS resource set indicator field is not configured/present, the ordering of the indicated M>1 (or N>1) TCI states or pairs of TCI states are reversed, and the UE would follow the order-reversed M>1 (or N>1) TCI states or pairs of TCI states to receive/monitor one or more PDCCH candidates from one or more search space sets configured with the same higher layer parameter searchSpaceLinking in one or more CORESETs associated with the order-reversed M>1 (or N>1) TCI states or pairs of TCI states, and if the bit field of the SRS resource set indicator is set to “10” (or “11”) or the index of the SRS resource set indicator is set to “2” (or “3”) according to TABLE 1 or the SRS resource set indicator field is not configured/present, the UE would follow the indicated M>1 (or N>1) TCI states or pairs of TCI states to receive/monitor one or more PDCCH candidates from one or more search space sets configured with the same higher layer parameter searchSpaceLinking in one or more CORESETs associated with the indicated M>1 (or N>1) TCI states or pairs of TCI states.

If the indicated M>1 (or N>1) TCI states or pairs of TCI states are (ordered as) {TCI state/TCI states pair #a1, TCI state/TCI states pair #a2, . . . , TCI state/TCI states pair #aM (or #aN)}, when the bit field of the SRS resource set indicator is set to “11” (or “10”) or the index of the SRS resource set indicator is set to “3” (or “2”) according to TABLE 1 or the SRS resource set indicator field is not configured/present, the (order-reversed) M>1 (or N>1) TCI states or pairs of TCI states would become to {TCI state/TCI states pair #b1, TCI state/TCI states pair #b2, . . . , TCI state/TCI states pair #bM (or #bN)}, where b1=aM (or aN), b2=a(M−1) or (a(N−1)), . . . , bM (or bN)=a1. For M=2 (or N=2), the UE could first receive in a DCI (e.g., DCI format 1_1 or 1_2 with or without DL assignment) two TCI states or pairs of TCI states—denoted and ordered by {TCI state/TCI states pair #a1, TCI state/TCI states pair #a2}; if the bit field of the SRS resource set indicator is set to “11” (or “10”) or the index of the SRS resource set indicator is set to “3” (or “2”) according to TABLE 1 or the SRS resource set indicator field is not configured/present, the UE would follow the order-reversed two TCI states or pairs of TCI states {TCI state/TCI state pair #a2, TCI state/TCI state pair #a1} to receive/monitor one or more PDCCH candidates from one or more search space sets configured with the same higher layer parameter searchSpaceLinking in one or more CORESETs associated with the order-reversed TCI states or pairs of TCI states {TCI state/TCI state pair #a2, TCI state/TCI state pair #1}, and if the bit field of the SRS resource set indicator is set to “10” (or “11”) or the index of the SRS resource set indicator is set to “2” (or “3”) according to TABLE 1 or the SRS resource set indicator field is not configured/present, the UE would follow the indicated two TCI states or pairs of TCI states {TCI state/TCI state pair #a1, TCI state/TCI state pair #a2} to receive/monitor one or more PDCCH candidates from one or more search space sets configured with the same higher layer parameter searchSpaceLinking in one or more CORESETs associated with the indicated TCI states or pairs of TCI states {TCI state/TCI state pair #a1, TCI state/TCI state pair #a2}.

In yet another example, the UE could first receive in a DCI (e.g., DCI format 1_1 or 1_2 with or without DL assignment) M>1 (or N>1) TCI states or pairs of TCI states—denoted by {TCI state/TCI states pair #a1, TCI state/TCI states pair #a2, . . . , TCI state/TCI states pair #aM (or #aN)}-indicated by one or more TCI state codepoints (or one or more TCI fields), wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received. As discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the bit field of the SRS resource set indicator is set to “10” (or “11”) or the index of the SRS resource set indicator is set to “2” (or “3”) according to TABLE 1, the UE would follow the M>1 (or N>1) TCI states or pairs of TCI states ordered by {TCI state/TCI states pair #a1, TCI state/TCI states pair #a2, . . . , TCI state/TCI states #aM (or #aN)}—a first ordering—to receive/monitor one or more PDCCH candidates from one or more search space sets configured with the same higher layer parameter searchSpaceLinking in one or more CORESETs associated with the M>1 (or N>1) TCI states or pairs of TCI states ordered by {TCI state/TCI states pair #a1, TCI state/TCI states pair #a2, . . . , TCI state/TCI states #aM (or #aN)}, and if the bit field of the SRS resource set indicator is set to “11” (or “10”) or the index of the SRS resource set indicator is set to “3” (or “2”) according to TABLE 1, the UE would follow the M>1 (or N>1) TCI states or pairs of TCI states ordered by {TCI state/TCI states pair #b1, TCI state/TCI states pair #b2, . . . , TCI state/TCI states #bM (or #bN)}—a second ordering—to receive/monitor one or more PDCCH candidates from one or more search space sets configured with the same higher layer parameter searchSpaceLinking in one or more CORESETs associated with the M>1 (or N>1) TCI states or pairs of TCI states ordered by {TCI state/TCI states pair #b1, TCI state/TCI states pair #b2, . . . , TCI state/TCI states #bM (or #bN)}. The first ordering of the TCI states/pairs of TCI states {TCI state/TCI states pair #a1, TCI state/TCI states pair #a2, . . . , TCI state/TCI states #aM (or #aN)} or the second ordering of the TCI states/pairs of TCI states {TCI state/TCI states pair #b1, TCI state/TCI states pair #b2, . . . , TCI state/TCI states #bM (or #bN)} could be determined according to at least one of: (1) fixed in the system specification(s) and (2) configured, e.g., via higher layer RRC signaling or MAC CE command or DCI based signaling, by the network.

For both (1) and (2), b1 could be equal to aM (or aN), b2 could be equal to a(M−1) or (a(N−1)), . . . , bM (or bN) could be equal to a1. For M=2 (or N=2), the UE could first receive in a DCI (e.g., DCI format 1_1 or 1_2 with or without DL assignment) two TCI states or pairs of TCI states—denoted by {TCI state/TCI states pair #a1, TCI state/TCI states pair #a2}; if the bit field of the SRS resource set indicator is set to “10” (or “11”) or the index of the SRS resource set indicator is set to “2” (or “3”) according to TABLE 1, the UE would follow the two TCI states or pairs of TCI states ordered by {TCI state/TCI state pair #a1, TCI state/TCI state pair #a2} to receive/monitor one or more PDCCH candidates from one or more search space sets configured with the same higher layer parameter searchSpaceLinking in one or more CORESETs associated with the two TCI states or pairs of TCI states ordered by {TCI state/TCI state pair #a1, TCI state/TCI state pair #a2}, and if the bit field of the SRS resource set indicator is set to “11” (or “10”) or the index of the SRS resource set indicator is set to “3” (or “2”) according to TABLE 1, the UE would follow the two TCI states or pairs of TCI states ordered by {TCI state/TCI state pair #a2, TCI state/TCI state pair #a1} to receive/monitor one or more PDCCH candidates from one or more search space sets configured with the same higher layer parameter searchSpaceLinking in one or more CORESETs associated with the two TCI states or pairs of TCI states {TCI state/TCI state pair #a2, TCI state/TCI state pair #a1}.

In yet another example, the UE could first receive in a DCI (e.g., DCI format 1_1 or 1_2 with or without DL assignment) M=1 (or N=1) TCI state or pair of TCI states indicated by a TCI state codepoint (or a TCI field). The UE could then receive in a DCI (e.g., DCI format 1_1 or 1_2 with or without DL assignment) M>1 (or N>1) TCI states or pairs of TCI states indicated by one or more TCI state codepoints (or one or more TCI fields), wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received.

For example, the UE would follow the latest indicated M>1 (or N>1) TCI states or pairs of TCI states to receive/monitor one or more PDCCH candidates from one or more search space sets configured with the same higher layer parameter searchSpaceLinking in one or more CORESETs associated with the latest indicated M>1 (or N>1) TCI states or pairs of TCI states—i.e., multi-TRP PDCCH (repetitions) reception.

For another example, the UE could receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the bit field of the SRS resource set indicator is set to “10” or “11” or the index of the SRS resource set indicator is set to “2” or “3” according to TABLE 1 or the SRS resource set indicator field is not configured/present, the UE would follow the latest indicated M>1 (or N>1) TCI states or pairs of TCI states to receive/monitor one or more PDCCH candidates from one or more search space sets configured with the same higher layer parameter searchSpaceLinking in one or more CORESETs associated with the latest indicated M>1 (or N>1) TCI states or pairs of TCI states—i.e., multi-TRP PDCCH (repetitions) reception. If the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to receive/monitor one or more PDCCH candidates in one or more CORESETs—i.e., single-TRP PDCCH reception.

Yet for another example, the UE could receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to receive/monitor one or more PDCCH candidates in one or more CORESETs—i.e., single-TRP PDCCH reception; if the bit field of the SRS resource set indicator is set to “10” or “11” or the index of the SRS resource set indicator is set to “2” or “3” according to TABLE 1 or the SRS resource set indicator field is not configured/present, the UE would follow the latest indicated M>1 (or N>1) TCI states or pairs of TCI states to receive/monitor one or more PDCCH candidates from one or more search space sets configured with the same higher layer parameter searchSpaceLinking in one or more CORESETs associated with the latest indicated M>1 (or N>1) TCI states or pairs of TCI states—i.e., multi-TRP PDCCH (repetitions) reception.

In yet another example, the UE could first receive in a DCI (e.g., DCI format 1_1 or 1_2 with or without DL assignment) M>1 (or N>1) TCI states or pairs of TCI states indicated by one or more TCI state codepoints (or one or more TCI fields), wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received.

As discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. In the present disclosure, the SRS resource set indicator could also indicate one or more of: (1) single-TRP PDCCH reception, (2) multi-TRP PDCCH (repetitions) reception, (3) one or more orderings of the indicated TCI states or pairs of TCI states for single-TRP PDCCH reception or multi-TRP PDCCH (repetitions) reception, and (4) one or more TCI states or pairs of TCI states for single-TRP PDCCH reception or multi-TRP PDCCH (repetitions) reception.

For example, if the bit field of the SRS resource set indicator is set to “00” (or “01”) or the index of the SRS resource set indicator is set to “0” (or “1”) according to TABLE 1, the UE could use only one of the indicated M>1 (or N>1) TCI states or pairs of TCI states to receive/monitor one or more PDCCH candidates in one or more CORESETs—i.e., PDCCH reception in a single-TRP system; if the bit field of the SRS resource set indicator is set to “01” (or “00”) or the index of the SRS resource set indicator is set to “1” (or “0”) according to TABLE 1, the UE could use one or more of the indicated M>1 (or N>1) TCI states or pairs of TCI states to receive/monitor one or more PDCCH candidates from one or more search space sets configured with the same higher layer parameter searchSpaceLinking in one or more CORESETs—i.e., PDCCH repetitions reception in a multi-TRP system.

If the bit field of the SRS resource set indicator is set to “10” (or “11”) or the index of the SRS resource set indicator is set to “2” (or “3”) according to TABLE 1, the UE would follow the ordering of the indicated M>1 (or N>1) TCI states or pairs of TCI states to receive/monitor one or more PDCCH candidates from one or more search space sets configured with the same higher layer parameter searchSpaceLinking in one or more CORESETs associated with the indicated M>1 (or N>1) TCI states or pairs of TCI states; if the bit field of the SRS resource set indicator is set to “11” (or “10”) or the index of the SRS resource set indicator is set to “3” (or “2”) according to TABLE 1, the UE would follow the order-reversed M>1 (or N>1) TCI states or pairs of TCI states to receive/monitor one or more PDCCH candidates from one or more search space sets configured with the same higher layer parameter searchSpaceLinking in one or more CORESETs associated with the order-reversed M>1 (or N>1) TCI states or pairs of TCI states.

Alternatively, if the bit field of the SRS resource set indicator is set to “10” (or “11”) or the index of the SRS resource set indicator is set to “2” (or “3”) according to TABLE 1, the UE would follow a first ordering of the M>1 (or N>1) TCI states or pairs of TCI states to receive/monitor one or more PDCCH candidates from one or more search space sets configured with the same higher layer parameter searchSpaceLinking in one or more CORESETs associated with the M>1 (or N>1) TCI states or pairs of TCI states in the first ordering; if the bit field of the SRS resource set indicator is set to “11” (or “10”) or the index of the SRS resource set indicator is set to “3” (or “2”) according to TABLE 1, the UE would follow a second ordering of the M>1 (or N>1) TCI states or pairs of TCI states to receive/monitor one or more PDCCH candidates from one or more search space sets configured with the same higher layer parameter searchSpaceLinking in one or more CORESETs associated with the M>1 (or N>1) TCI states or pairs of TCI states in the second ordering.

The first and second orderings of TCI states/pairs of TCI states could be determined. Optionally, the bit fields “00” or “01” or the indexes “0” or “1” of the 2-bit SRS resource set indicator in TABLE 1 could be used to indicate the orderings of the M>1 (or N>1) TCI states or pairs of TCI states for multi-TRP PDCCH (repetitions) reception as described above, and the bit fields “10” or “11” or the indexes “2” or “3” of the 2-bit SRS resource set indicator in TABLE 1 could be used to indicate the single-TRP PDCCH reception or the multi-TRP PDCCH (repetitions) reception as described above.

For another example, if the bit field of the SRS resource set indicator is set to “00” (or “01”) or the index of the SRS resource set indicator is set to “0” (or “1”) according to TABLE 1, the UE could use the primary TCI state or pair of TCI states determined from the indicated M>1 (or N>1) TCI states or pairs of TCI states to receive/monitor one or more PDCCH candidates in one or more CORESETs—i.e., PDCCH reception in a single-TRP system; if the bit field of the SRS resource set indicator is set to “01” (or “00”) or the index of the SRS resource set indicator is set to “1” (or “0”) according to TABLE 1, the UE could use the secondary TCI state or pair of TCI states determined from the indicated M>1 (or N>1) TCI states or pairs of TCI states to receive/monitor one or more PDCCH candidates in one or more CORESETs—i.e., PDCCH reception in a single-TRP system; the primary and secondary TCI states/pairs of TCI states could be determined and configured.

If the bit field of the SRS resource set indicator is set to “10” (or “11”) or the index of the SRS resource set indicator is set to “2” (or “3”) according to TABLE 1, the UE would follow the ordering of the indicated M>1 (or N>1) TCI states or pairs of TCI states to receive/monitor one or more PDCCH candidates from one or more search space sets configured with the same higher layer parameter searchSpaceLinking in one or more CORESETs associated with the indicated M>1 (or N>1) TCI states or pairs of TCI states; if the bit field of the SRS resource set indicator is set to “11” (or “10”) or the index of the SRS resource set indicator is set to “1” (or “0”) according to TABLE 1, the UE would follow the order-reversed M>1 (or N>1) TCI states or pairs of TCI states to receive/monitor one or more PDCCH candidates from one or more search space sets configured with the same higher layer parameter searchSpaceLinking in one or more CORESETs associated with the order-reversed M>1 (or N>1) TCI states or pairs of TCI state.

Alternatively, if the bit field of the SRS resource set indicator is set to “10” (or “11”) or the index of the SRS resource set indicator is set to “2” (or “3”) according to TABLE 1, the UE would follow a first ordering of the M>1 (or N>1) TCI states or pairs of TCI states to receive/monitor one or more PDCCH candidates from one or more search space sets configured with the same higher layer parameter searchSpaceLinking in one or more CORESETs associated with the M>1 (or N>1) TCI states or pairs of TCI states in the first ordering; if the bit field of the SRS resource set indicator is set to “11” (or “10”) or the index of the SRS resource set indicator is set to “3” (or “2”) according to TABLE 1, the UE would follow a second ordering of the M>1 (or N>1) TCI states or pairs of TCI states to receive/monitor one or more PDCCH candidates from one or more search space sets configured with the same higher layer parameter searchSpaceLinking in one or more CORESETs associated with the M>1 (or N>1) TCI states or pairs of TCI states in the second ordering. The first and second orderings of TCI states/pairs of TCI states could be determined. Optionally, the bit fields “00” or “01” or the indexes “0” or “1” of the 2-bit SRS resource set indicator in TABLE 1 could be used to indicate the orderings of the M>1 (or N>1) TCI states or pairs of TCI states for multi-TRP PDCCH (repetitions) reception as described above, and the bit fields “10” or “11” or the indexes “2” or “3” of the 2-bit SRS resource set indicator in TABLE 1 could be used to indicate the primary or secondary TCI states/pairs of TCI states for single-TRP PDCCH reception as described above.

Yet for another example, in addition to the 2-bit SRS resource set indicator configured, the UE could also receive in a DCI (e.g., DCI format 1_1 or 1_2 with or without DL assignment or DCI format 0_1 or 0_2) a one-bit indicator. For this design example, a new/dedicated DCI field could be used/configured in the corresponding DCI format to indicate the one-bit indicator; alternatively, one of more of the existing DCI fields in the corresponding DCI format could be used/configured to indicate the one-bit indicator. When the 2-bit SRS resource set indicator indicates the single-TRP PDCCH reception, if the one-bit indicator is set to “0” (or “1”), the UE could use the primary TCI state or pair of TCI states determined from the indicated M>1 (or N>1) TCI states or pairs of TCI states to receive/monitor one or more PDCCH candidates in one or more CORESETs; if the one-bit indicator is set to “1” (or “0”), the UE could use the secondary TCI state or pair of TCI states determined from the indicated M>1 (or N>1) TCI states or pairs of TCI states to receive/monitor one or more PDCCH candidates in one or more CORESETs; the primary and secondary TCI states/pairs of TCI states could be determined/configured.

Yet for another example, the SRS resource set indicator indicated in DCI format 0_1 or 0_2 (e.g., in the “SRS resource set indicator” field) could correspond to a z-bit indicator (z>1, e.g., z=3) with 2\hat{ }z states or bit fields (e.g., 8 states or bit fields for z=3). In this example, a first state or bit field of the z-bit indicator could indicate that the single-TRP PDCCH reception is enabled, a second state or bit field of the z-bit indicator could indicate that the multi-TRP PDCCH (repetitions) reception is enabled, a third state or bit field of the z-bit indicator could indicate that the UE could use the primary TCI state or pair of TCI states for the single-TRP PDCCH reception, a fourth state or bit field of the z-bit indicator could indicate that the UE could use the secondary TCI state or pair of TCI states for the single-TRP PDCCH reception, a fifth state or bit field of the z-bit indicator could indicate an ordering of the M>1 (or N>1) TCI states or pairs of TCI states for the multi-TRP PDCCH (repetitions) reception, a sixth state or bit field of the z-bit indicator could indicate another ordering of the M>1 (or N>1) TCI states or pairs of TCI states for the multi-TRP PDCCH (repetitions) reception.

In yet another example, the UE could first receive in a DCI (e.g., DCI format 1_1 or 1_2 with or without DL assignment) M=1 (or N=1) TCI state or pair of TCI states indicated by a TCI state codepoint (or a TCI field). The UE could then receive in a DCI (e.g., DCI format 1_1 or 1_2 with or without DL assignment) M>1 (or N>1) TCI states or pairs of TCI states indicated by one or more TCI state codepoints (or one or more TCI fields), wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received.

As discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The SRS resource set indicator could indicate one or more of: (1) single-TRP PDCCH reception, (2) multi-TRP PDCCH (repetitions) reception, (3) one or more orderings of the indicated TCI states or pairs of TCI states for single-TRP PDCCH reception or multi-TRP PDCCH (repetitions) reception, and (4) one or more TCI states or pairs of TCI states for single-TRP PDCCH reception or multi-TRP PDCCH (repetitions) reception. The SRS resource set indicator could be configured. For this example, if the SRS resource set indicator indicates that the single-TRP PDCCH reception is enabled, the UE could follow the previously indicated M=1 (or N=1) TCI state or pair of TCI states to receive/monitor one or more PDCCH candidates in one or more CORESETs.

The UE could receive from the network one or more MAC CE activation/sub-selection commands activating one or more sets of TCI states/TCI state IDs from the one or more TCI state pools or the one or more TCI state groups, with each set of activated/selected TCI states/TCI state IDs used to map up to Nc≥1 (e.g., 8, 16, 32 or 64) TCI state codepoints in a DCI format. Here, a TCI state codepoint could be configured. Furthermore, the one or more sets of activated/selected TCI state codepoints could include/contain/comprise one or more of the following.

In one example, a first set of TCI state codepoints for single-TRP PDCCH reception: the UE could receive in a DCI (e.g., DCI format 1_1 or 1_2 with or without DL assignment) M=1 (or N=1) TCI state or pair of TCI states indicated by a TCI state codepoint from the first set of TCI state codepoints; the UE could use the indicated TCI state or pair of TCI states for the single-TRP PDCCH reception.

In another example, a second set of TCI state codepoints for single-TRP PDCCH reception: the UE could receive in a DCI (e.g., DCI format 1_1 or 1_2 with or without DL assignment) M=1 (or N=1) TCI state or pair of TCI states indicated by a TCI state codepoint from the second set of TCI state codepoints; the UE could use the indicated TCI state or pair of TCI states as the primary TCI state or pair of TCI states for the single-TRP PDCCH reception.

In yet another example, a third set of TCI state codepoints for single-TRP PDCCH reception: the UE could receive in a DCI (e.g., DCI format 1_1 or 1_2 with or without DL assignment) M=1 (or N=1) TCI state or pair of TCI states indicated by a TCI state codepoint from the third set of TCI state codepoints; the UE could use the indicated TCI state or pair of TCI states as the secondary TCI state or pair of TCI states for the single-TRP PDCCH reception.

In yet another example, a fourth set of TCI state codepoints for multi-TRP PDCCH (repetitions) reception: the UE could receive in a DCI (e.g., DCI format 1_1 or 1_2 with or without DL assignment) M>1 (or N>1) TCI states or pairs of TCI states indicated by one or more TCI state codepoints from the fourth set of TCI state codepoints, wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received.

In yet another example, a fifth set of TCI state codepoints for multi-TRP PDCCH (repetitions) reception: the UE could receive in a DCI (e.g., DCI format 1_1 or 1_2 with or without DL assignment) M>1 (or N>1) TCI states or pairs of TCI states indicated by one or more TCI state codepoints from the fifth set of TCI state codepoints, wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received. The ordering of the indicated M>1 (or N>1) TCI states or pairs of TCI states from the fifth set could correspond to an ordering of M>1 (or N>1) TCI states or pairs of TCI states (e.g., the first ordering).

In yet another example, a sixth set of TCI state codepoints for multi-TRP PDCCH (repetitions) reception: the UE could receive in a DCI (e.g., DCI format 1_1 or 1_2 with or without DL assignment) M>1 (or N>1) TCI states or pairs of TCI states indicated by one or more TCI state codepoints from the sixth set of TCI state codepoints, wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received. The ordering of the indicated M>1 (or N>1) TCI states or pairs of TCI states from the sixth set could correspond to an ordering of M>1 (or N>1) TCI states or pairs of TCI states (e.g., the second ordering).

The UE could be indicated by the network from which set(s) of TCI state codepoints the indicated one or more TCI states or pairs of TCI states are selected. This indication could be via higher layer RRC signaling or MAC CE command or dynamic DCI based signaling. For instance, the UE could also receive in an uplink DCI (e.g., DCI format 0_1 or 0_2) a y-bit (y≥1) SRS resource set indicator (e.g., in the “SRS resource set indicator” field) to indicate one or more SRS resource sets. Here, the SRS resource set indicator is used to indicate the set(s) of TCI state codepoints. Each state/bit field/index of the y-bit SRS resource set indicator (a total of 2\hat{ }y states or bit fields for the y-bit SRS resource set indicator) could correspond to a set of TCI state codepoints (e.g., the first set, the second set, the third set, the fourth set, the fifth set or the sixth set as specified above). For example, if a UE receives in DCI format 0_1 or 0_2 the y-bit SRS resource set indicator in the “SRS resource set indicator” field (e.g., set to a state or bit field value), the UE could determine the set of TCI state codepoints corresponding to the indicated state or bit field value of the y-bit SRS resource set indicator, from which the indicated one or more TCI states or pairs of TCI states are selected. According to the determined set of TCI state codepoints, the UE could perform/conduct the corresponding single-TRP PDCCH reception or multi-TRP PDCCH (repetitions) reception as discussed above.

In one embodiment, when a UE is configured/provided by the network higher layer parameter repetitionScheme set to one of “fdmSchemeA,” “fdmSchemeB” and “tdmSchemeA” or higher layer parameter repetitionNumber in PDSCH-TimeDomainResourceAllocation, the UE could expect to receive PDSCH repetitions in overlapped or non-overlapped time or frequency domain resources.

When a UE is configured/provided by the network the higher layer parameter repetitionScheme set to “fdmSchemeA” and N>1 (or M>1) TCI states or pairs of TCI states indicated by one or more TCI state codepoints (or one or more TCI fields) in a DCI format (e.g., DCI format 1_1 or 1_2 with or without DL assignment), the UE could receive a single PDSCH transmission occasion of the transport block (TB) with each indicated TCI state or pairs of TCI states associated to a non-overlapping frequency domain resource allocation. A UE may assume that precoding granularity is P_{BWP} resource blocks in the frequency domain, where P_{BWP} can be equal to one of the values among {2, 4, wideband}.

For N=2 or M=2, if P_{BWP} is configured/determined as “wideband,” the first ┌n_{PRB}/2┐ PRBs—referred to as a first PDSCH transmission in the present disclosure—are assigned to a first indicated TCI state/pair of TCI states, and the remaining └n_{PRB}/2┘ PRBs—referred to as a second PDSCH transmission in the present disclosure—are assigned to a second indicated TCI state/pair of TCI states, where n_{PRB} is the total number of allocated PRBs for the UE; if P_{BWP} is configured/determined as one of the values among {2, 4}, even precoding resource block groups (PRGs) within the allocated frequency domain resources—referred to as a first PDSCH transmission in the present disclosure—are assigned to a first indicated TCI state/pair of TCI states, and odd PRGs within the allocated frequency domain resources—referred to as a second PDSCH transmission in the present disclosure—are assigned to a second indicated TCI state/pair of TCI states, wherein the PRGs are numbered continuously in increasing order with the first PRG index equal to 0. In the present disclosure, the first (or second) indicated TCI state/pair of TCI states could correspond to any of the indicated M=2 (or N=2) TCI states/pairs of TCI states.

When a UE is configured/provided by the network the higher layer parameter repetitionScheme set to “fdmSchemeB” and N>1 (or M>1) TCI states or pairs of TCI states indicated by one or more TCI state codepoints (or one or more TCI fields) in a DCI format (e.g., DCI format 1_1 or 1_2 with or without DL assignment), the UE could receive two PDSCH transmission occasions of the same TB with each indicated TCI state/pair of TCI states associated to a PDSCH transmission occasion which has non-overlapping frequency domain resource allocation with respect to the other PDSCH transmission occasion.

A UE may assume that precoding granularity is P_{BWP} resource blocks in the frequency domain, where P_{BWP} can be equal to one of the values among {2, 4, wideband}. For N=2 or M=2, if P_{BWP} is configured/determined as “wideband,” the first ┌n_{PRB}/2┐ PRBs—referred to as a first PDSCH transmission in the present disclosure—are assigned to a first indicated TCI state/pair of TCI states, and the remaining └n_{PRB}/2┘ PRBs—referred to as a second PDSCH transmission in the present disclosure—are assigned to a second indicated TCI state/pair of TCI states, where n_{PRB} is the total number of allocated PRBs for the UE; if P_{BWP} is configured/determined as one of the values among {2, 4}, even precoding resource block groups (PRGs) within the allocated frequency domain resources—referred to as a first PDSCH transmission in the present disclosure—are assigned to a first indicated TCI state/pair of TCI states, and odd PRGs within the allocated frequency domain resources—referred to as a second PDSCH transmission in the present disclosure—are assigned to a second indicated TCI state/pair of TCI states, wherein the PRGs are numbered continuously in increasing order with the first PRG index equal to 0. In the present disclosure, the first (or second) indicated TCI state/pair of TCI states could correspond to any of the indicated M=2 (or N=2) TCI states/pairs of TCI states.

When a UE is configured/provided by the network the higher layer parameter repetitionScheme set to “tdmSchemeA” and N>1 (or M>1) TCI states or pairs of TCI states indicated by one or more TCI state codepoints (or one or more TCI fields) in a DCI format (e.g., DCI format 1_1 or 1_2 with or without DL assignment), the UE could receive two PDSCH transmission occasions of the TB with each indicated TCI state/pair of TCI states associated to a PDSCH transmission occasion which has non-overlapping time domain resource allocation with respect to the other PDSCH transmission occasion and both PDSCH transmission occasions may be received within a given slot. For M=2 or N=2, a first indicated TCI state/pair of TCI states could be applied to the first PDSCH transmission occasion; a second indicated TCI state/pair of TCI states could be applied to the second PDSCH transmission occasion, and the second PDSCH transmission occasion shall have the same number of symbols as the first PDSCH transmission occasion. In the present disclosure, the first (or second) indicated TCI state/pair of TCI states could correspond to any of the indicated M=2 (or N=2) TCI states/pairs of TCI states.

When a UE is configured/provided by the network the higher layer parameter repetitionNumber in PDSCH-TimeDomainResourceAllocation, and N>1 (or M>1) TCI states or pairs of TCI states indicated by one or more TCI state codepoints (or one or more TCI fields) in a DCI format (e.g., DCI format 1_1 or 1_2 with or without DL assignment), the UE may expect to receive multiple slot level PDSCH transmission occasions of the same TB with the indicated M>1 (or N>1) TCI states/pairs of TCI states used across multiple PDSCH transmission occasions in the repetitionNumber consecutive slots. For N=2 or M=2, when the value indicated by repetitionNumber in PDSCH-TimeDomainResourceAllocation equals to two, a first indicated TCI state is applied to the first PDSCH transmission occasion; a second indicated TCI state/pair of TCI states is applied to the second PDSCH transmission occasion. When the value of repetitionNumber in PDSCH-TimeDomainResourceAllocation is larger than two, the UE may be further configured to enable cyclicMapping or sequentialMapping. When cyclicMapping is enabled, a first indicated TCI state/pair of TCI states and a second indicated TCI state/pair of TCI states are applied to the first PDSCH transmission occasion and the second PDSCH transmission occasion, respectively, and the same TCI mapping pattern continues to the remaining PDSCH transmission occasions.

When sequentialMapping is enabled, a first indicated TCI state/pair of TCI states is applied to the first and second PDSCH transmission occasions, and a second indicated TCI state/pair of TCI states is applied to the third and fourth PDSCH transmission occasions, and the same TCI mapping pattern continues to the remaining PDSCH transmission occasions. In the present disclosure, the first (or second) indicated TCI state/pair of TCI states could correspond to any of the indicated M=2 (or N=2) TCI states/pairs of TCI states.

In a multi-TRP system, when a UE is not configured/provided by the network higher layer parameter repetitionScheme or repetitionNumber in PDSCH-TimeDomainResourceAllocation and the UE is indicated by the network M=2 (or N=2) TCI states or pairs of TCI states by one or more TCI state codepoints (or one or more TCI fields) in a DCI format (e.g., DCI format 1_1 or 1_2 with or without DL assignment) and DM-RS port(s) within two code division multiplexing (CDM) groups in the DCI field “Antenna Port(s),” a first indicated TCI state/pair of TCI states could correspond to the CDM group of the first antenna port indicated by the antenna port indication table—referred to as a first PDSCH transmission in the present disclosure, and a second TCI state/pair of TCI states could correspond to the other CDM group—referred to as a second PDSCH transmission in the present disclosure. In the present disclosure, the first (or second) indicated TCI state/pair of TCI states could correspond to any of the indicated M=2 (or N=2) TCI states/pairs of TCI states.

As mentioned, the UE could receive in a DCI (e.g., DCI format 1_1 or 1_2 with or without DL assignment) M>1 (or N>1) TCI states or M>1 (or N>1) pairs of TCI states indicated by one or more TCI state codepoints (or one or more TCI fields) in the corresponding DCI. One or more of the indicated M>1 (or N>1) TCI states or pairs of TCI states could be associated with/mapped to the one or more PDSCH transmissions/transmission occasions. Furthermore, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The SRS resource set indicator could indicate at least one of: (1) switching between single-TRP PDSCH reception and multi-TRP PDSCH (repetitions) reception, (2) one or more of the indicated M>1 (or N>1) TCI states or pairs of TCI states to use for the single-TRP PDSCH reception, and (3) switching the order of the indicated M>1 (or N>1) TCI states or pairs of TCI states.

In one example, the UE could first receive in a DCI (e.g., DCI format 1_1 or 1_2 with or without DL assignment) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more PDSCH transmissions/transmission occasions as described above for the multi-TRP PDSCH (repetitions) reception.

As discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the bit field of the SRS resource set indicator is set to “00” or “01” or the index of the SRS resource set indicator is set to “0” or “1” according to TABLE 1 or the SRS resource set indicator field is not configured/present, the UE could use only one of the indicated M>1 (or N>1) TCI states or pairs of TCI states to receive one or more PDSCHs or one or more layers of a PDSCH—i.e., PDSCH reception in a single-TRP system; if the bit field of the SRS resource set indicator is set to “10” or “11” or the index of the SRS resource set indicator is set to “2” or “3” according to TABLE 1 or the SRS resource set indicator field is not configured/present, the UE could use one or more of the indicated M>1 (or N>1) TCI states or pairs of TCI states to receive PDSCH transmissions/transmission occasions—i.e., PDSCH (repetitions) reception in a multi-TRP system. More specifically, if the bit field of the SRS resource set indicator is set to “00” or “01” or the index of the SRS resource set indicator is set to “0” or “1” according to TABLE 1 or the SRS resource set indicator field is not configured/present (i.e., for the PDSCH reception in a single-TRP system).

For example, the UE could use the first TCI state or the TCI state with the lowest (or highest) TCI state ID among the indicated M>1 (or N>1) TCI states or the separate DL TCI state or the joint DL and UL TCI state in the first pair of TCI states or the separate DL TCI state or the joint DL and UL TCI state in the pair of TCI states associated with the lowest (or highest) TCI state ID among the indicated M>1 (or N>1) pairs of TCI states to receive one or more PDSCHs or one or more layers of a PDSCH.

For another example, the UE could use the second TCI state or the TCI state with the second lowest (or second highest) TCI state ID among the indicated M>1 (or N>1) TCI states or the separate DL TCI state or the joint DL and UL TCI state in the second pair of TCI states or the separate DL TCI state or the joint DL and UL TCI state in the pair of TCI states associated with the second lowest (or second highest) TCI state ID among the indicated M>1 (or N>1) pairs of TCI states to receive one or more PDSCHs or one or more layers of a PDSCH.

Yet for another example, the UE could use the last TCI state or the TCI state with the highest (or lowest) TCI state ID among the indicated M>1 (or N>1) TCI states or the separate DL TCI state or the joint DL and UL TCI state in the last pair of TCI states or the separate DL TCI state or the joint DL and UL TCI state in the pair of TCI states associated with the highest (or lowest) TCI state ID among the indicated M>1 (or N>1) pairs of TCI states to receive one or more PDSCHs or one or more layers of a PDSCH.

Yet for another example, the UE could use the m-th (or n-th) TCI state or the TCI state with the m-th (or n-th) lowest (or highest) TCI state ID among the indicated M>1 (or N>1) TCI states or the separate DL TCI state or the joint DL and UL TCI state in the m-th (or n-th) pair of TCI states or the separate DL TCI state or the joint DL and UL TCI state in the pair of TCI states associated with the m-th (or n-th) lowest (or highest) TCI state ID among the indicated M>1 (or N>1) pairs of TCI states to receive one or more PDSCHs or one or more layers of a PDSCH, where m∈{1, . . . , M} and n∈{1, . . . , N}. In this example, the index m (or n) could be determined according to at least one of: (1) fixed in the system specification(s) and (2) configured, e.g., via higher layer RRC signaling or MAC CE command or DCI based signaling, by the network.

Yet for another example, the UE could use the separate DL TCI state or the joint DL and UL TCI state among the indicated M>1 (or N>1) TCI states to receive one or more PDSCHs or one or more layers of a PDSCH. In this example, only one of the indicated M>1 (or N>1) TCI states could correspond to a separate DL TCI state or a joint DL and UL TCI state.

Yet for another example, the UE could be higher layer configured by the network a list of K entity IDs. In the present disclosure, an entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. The UE could use the TCI state or the pair of TCI states that is associated with the first entity ID or the second entity ID or the last entity ID or the lowest entity ID or the highest entity ID or the second lowest (or second highest) entity ID or the entity ID associated with the serving cell PCI/PCI index or the entity ID associated with a PCI/PCI index different from the serving cell PCI/PCI index or the k-th entity ID or the k-th lowest (or highest) entity ID among the list of K entity IDs to receive one or more PDSCHs or one or more layers of a PDSCH, where k∈{1, . . . , K}. In this example, the index k could be determined according to at least one of: (1) fixed in the system specification(s) and (2) configured, e.g., via higher layer RRC signaling or MAC CE command or DCI based signaling, by the network. Furthermore, K could be equal to M (or N).

Yet for another example, the UE could be higher layer configured by the network a list of L PCIs. The UE could use the TCI state or the pair of TCI states that is associated with the first PCI or the second PCI or the last PCI or the lowest PCI or the highest PCI or the second lowest (or second highest) PCI or the serving cell PCI or a PCI different from the serving cell PCI or the l-th PCI or the l-th lowest (or highest) PCI among the list of L PCIs to receive one or more PDSCHs or one or more layers of a PDSCH, where l∈{1, . . . , L}. Alternatively, the UE could determine a list of L PCI indexes 0, . . . , L−1 or 1, . . . , L with each PCI index pointing to an entry in the list of L PCIs. For this case, the UE could use the TCI state or the pair of TCI states that is associated with the first PCI index or the second PCI index or the last PCI index or the lowest PCI index or the highest PCI index or the second lowest (or second highest) PCI index or the serving cell PCI index or a PCI index different from the serving cell PCI index or the l-th PCI index or the l-th lowest (or highest) PCI index among the list of L PCI indexes to receive one or more PDSCHs or one or more layers of a PDSCH, where l∈{1, . . . , L}. In this example, the index 1 could be determined according to at least one of: (1) fixed in the system specification(s) and (2) configured, e.g., via higher layer RRC signaling or MAC CE command or DCI based signaling, by the network. Furthermore, L could be equal to M (or N).

Yet for another example, the UE could be provided in PDCCH-Config two values of CORESETPoolIndex (i.e., 0 and 1) for one or more CORESETs. The UE could use the TCI state or the pair of TCI states that is associated with value 0 of CORESETPoolIndex or value 1 of CORESETPoolIndex or value x of CORESETPoolIndex to receive one or more PDSCHs or one or more layers of a PDSCH, where x∈{0, 1}. In this example, the value x could be determined according to at least one of: (1) fixed in the system specification(s) and (2) configured, e.g., via higher layer RRC signaling or MAC CE command or DCI based signaling, by the network.

In another example, the UE could first receive in a DCI (e.g., DCI format 1_1 or 1_2 with or without DL assignment) M>1 (or N>1) TCI states or pairs of TCI states indicated by one or more TCI state codepoints (or one or more TCI fields), wherein one or more of the indicated M>1 (or N>1) TCI states or pairs of TCI states could be associated with/mapped to one or more PDSCH transmissions/transmission occasions as described above for the multi-TRP PDSCH (repetitions) reception.

As discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. If the bit field of the SRS resource set indicator is set to “00” (or “01”) or the index of the SRS resource set indicator is set to “0” (or “1”) according to TABLE 1, the UE could use one of the indicated M>1 (or N>1) TCI states or pairs of TCI states—a primary TCI state or pair of TCI states—to receive one or more PDSCHs or one or more layers of a PDSCH—i.e., PDSCH reception in a single-TRP system; if the bit field of the SRS resource set indicator is set to “01” (or “00”) or the index of the SRS resource set indicator is set to “1” (or “0”), the UE could use another one of the indicated M>1 (or N>1) TCI states or pairs of TCI states—a secondary TCI state or pair of TCI states—to receive one or more PDSCHs or one or more layers of a PDSCH—i.e., PDSCH reception in a single-TRP system. Various design examples of determining the primary TCI state or pair of TCI states or the secondary TCI state or pair of TCI states.

In yet another example, the UE could first receive in a DCI (e.g., DCI format 1_1 or 1_2 with or without DL assignment) M>1 (or N>1) TCI states or pairs of TCI states—denoted and ordered by {TCI state/TCI states pair #a1, TCI state/TCI states pair #a2, . . . , TCI state/TCI states pair #aM (or #aN)}—indicated by one or more TCI state codepoints (or one or more TCI fields), wherein one or more of the indicated M>1 (or N>1) TCI states or pairs of TCI states could be associated with/mapped to one or more PDSCH transmissions/PDSCH transmission occasions as described above for the multi-TRP PDSCH (repetitions) reception.

As discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the bit field of the SRS resource set indicator is set to “11” (or “10”) or the index of the SRS resource set indicator is set to “3” (or “2”) according to TABLE 1 or the SRS resource set indicator field is not configured/present, the ordering of the indicated M>1 (or N>1) TCI states or pairs of TCI states are reversed, and the UE would follow the order-reversed M>1 (or N>1) TCI states or pairs of TCI states to receive one or more PDSCH transmissions/PDSCH transmission occasions associated with the order-reversed M>1 (or N>1) TCI states or pairs of TCI states, and if the bit field of the SRS resource set indicator is set to “10” (or “11”) or the index of the SRS resource set indicator is set to “2” (or “3”) according to TABLE 1 or the SRS resource set indicator field is not configured/present, the UE would follow the indicated M>1 (or N>1) TCI states or pairs of TCI states to receive one or more PDSCH transmissions/PDSCH transmission occasions associated with the indicated M>1 (or N>1) TCI states or pairs of TCI states.

If the indicated M>1 (or N>1) TCI states or pairs of TCI states are (ordered as) {TCI state/TCI states pair #a1, TCI state/TCI states pair #a2, . . . , TCI state/TCI states pair #aM (or #aN)}, when the bit field of the SRS resource set indicator is set to “11” (or “10”) or the index of the SRS resource set indicator is set to “3” (or “2”) according to TABLE 1 or the SRS resource set indicator field is not configured/present, the (order-reversed) M>1 (or N>1) TCI states or pairs of TCI states would become to {TCI state/TCI states pair #b1, TCI state/TCI states pair #b2, . . . , TCI state/TCI states pair #bM (or #bN)}, where b1=aM (or aN), b2=a(M−1) or (a(N−1)), . . . , bM (or bN)=a1.

For M=2 (or N=2), the UE could first receive in a DCI (e.g., DCI format 1_1 or 1_2 with or without DL assignment) two TCI states or pairs of TCI states—denoted and ordered by {TCI state/TCI states pair #a1, TCI state/TCI states pair #a2}; if the bit field in the SRS resource set indicator is set to “11” (or “10”) or the index of the SRS resource set indicator is set to “3” (or “2”) according to TABLE 1 or the SRS resource set indicator field is not configured/present, the UE would follow the order-reversed two TCI states or pairs of TCI states {TCI state/TCI state pair #a2, TCI state/TCI state pair #a1} to receive one or more PDSCH transmissions/PDSCH transmission occasions (e.g., the first and second PDSCH transmissions or the first and second PDSCH transmission occasions as described above) associated with the order-reversed TCI states or pairs of TCI states {TCI state/TCI state pair #a2, TCI state/TCI state pair #a1}, and if the bit field of the SRS resource set indicator is set to “10” (or “11”) or the index of the SRS resource set indicator is set to “2” (or “3”) or the SRS resource set indicator field is not configured/present, the UE would follow the indicated two TCI states or pairs of TCI states {TCI state/TCI state pair #a1, TCI state/TCI state pair #a2} to receive one or more PDSCH transmissions/PDSCH transmission occasions (e.g., the first and second PDSCH transmissions or the first and second PDSCH transmission occasions as described above) associated with the indicated TCI states or pairs of TCI states {TCI state/TCI state pair #a1, TCI state/TCI state pair #a2}.

In yet another example, the UE could first receive in a DCI (e.g., DCI format 1_1 or 1_2 with or without DL assignment) M>1 (or N>1) TCI states or pairs of TCI states—denoted by {TCI state/TCI states pair #a1, TCI state/TCI states pair #a2, . . . , TCI state/TCI states pair #aM (or #aN)}-indicated by one or more TCI state codepoints (or one or more TCI fields), wherein one or more of the indicated M>1 (or N>1) TCI states or pairs of TCI states could be associated with/mapped to one or more PDSCH transmissions/PDSCH transmission occasions as described above for the multi-TRP PDSCH (repetitions) reception.

As discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the bit field of the SRS resource set indicator is set to “10” (or “11”) or the index of the SRS resource set indicator is set to “2” (or “3”) according to TABLE 1, the UE would follow the M>1 (or N>1) TCI states or pairs of TCI states ordered by {TCI state/TCI states pair #a1, TCI state/TCI states pair #a2, . . . , TCI state/TCI states #aM (or #aN)}—a first ordering—to receive one or more PDSCH transmissions/transmission occasions associated with the M>1 (or N>1) TCI states or pairs of TCI states ordered by {TCI state/TCI states pair #a1, TCI state/TCI states pair #a2, . . . , TCI state/TCI states #aM (or #aN)}, and if the bit field of the SRS resource set indicator is set to “11” (or “10”) or the index of the SRS resource set indicator is set to “3” (or “2”) according to TABLE 1, the UE would follow the M>1 (or N>1) TCI states or pairs of TCI states ordered by {TCI state/TCI states pair #b1, TCI state/TCI states pair #b2, . . . , TCI state/TCI states #bM (or #bN)}—a second ordering—to receive one or more PDSCH transmissions/transmission occasions associated with the M>1 (or N>1) TCI states or pairs of TCI states ordered by {TCI state/TCI states pair #b 1, TCI state/TCI states pair #b2, . . . , TCI state/TCI states #bM (or #bN)}. The first ordering of the TCI states/pairs of TCI states {TCI state/TCI states pair #a1, TCI state/TCI states pair #a2, . . . , TCI state/TCI states #aM (or #aN)} or the second ordering of the TCI states/pairs of TCI states {TCI state/TCI states pair #b1, TCI state/TCI states pair #b2, . . . , TCI state/TCI states #bM (or #bN)} could be determined according to at least one of: (1) fixed in the system specification(s) and (2) configured, e.g., via higher layer RRC signaling or MAC CE command or DCI based signaling, by the network.

For both (1) and (2), b1 could be equal to aM (or aN), b2 could be equal to a(M−1) or (a(N−1)), . . . , bM (or bN) could be equal to a1. For M=2 (or N=2), the UE could first receive in a DCI (e.g., DCI format 1_1 or 1_2 with or without DL assignment) two TCI states or pairs of TCI states—denoted by {TCI state/TCI states pair #a1, TCI state/TCI states pair #a2}; if the bit field of the SRS resource set indicator is set to “10” (or “11”) or the index of the SRS resource set indicator is set to “2” (or “3”) according to TABLE 1, the UE would follow the two TCI states or pairs of TCI states ordered by {TCI state/TCI state pair #a1, TCI state/TCI state pair #a2} to receive one or more PDSCH transmissions/transmission occasions (e.g., the first and second PDSCH transmissions or the first and second PDSCH transmission occasions as described above) associated with the two TCI states or pairs of TCI states ordered by {TCI state/TCI state pair #a1, TCI state/TCI state pair #a2}, and if the bit field of the SRS resource set indicator is set to “11” (or “10”) or the index of the SRS resource set indicator is set to “3” (or “2”) according to TABLE 1, the UE would follow the two TCI states or pairs of TCI states ordered by {TCI state/TCI state pair #a2, TCI state/TCI state pair #a1} to receive one or more PDSCH transmissions/transmission occasions (e.g., the first and second PDSCH transmissions or the first and second PDSCH transmission occasions as described above) associated with the two TCI states or pairs of TCI states {TCI state/TCI state pair #a2, TCI state/TCI state pair #a1}.

In yet another example, the UE could first receive in a DCI (e.g., DCI format 1_1 or 1_2 with or without DL assignment) M=1 (or N=1) TCI state or pair of TCI states indicated by a TCI state codepoint (or a TCI field) as specified in examples and the corresponding sub-examples in the present disclosure. The UE could then receive in a DCI (e.g., DCI format 1_1 or 1_2 with or without DL assignment) M>1 (or N>1) TCI states or pairs of TCI states indicated by one or more TCI state codepoints (or one or more TCI fields), wherein one or more of the indicated M>1 (or N>1) TCI states or pairs of TCI states could be associated with/mapped to one or more PDSCH transmissions/transmission occasions as described above for the multi-TRP PDSCH (repetitions) reception.

For example, the UE would follow the latest indicated M>1 (or N>1) TCI states or pairs of TCI states to receive one or more PDSCH transmissions/transmission occasions associated with the latest indicated M>1 (or N>1) TCI states or pairs of TCI states—i.e., multi-TRP PDSCH (repetitions) reception.

For another example, as discussed above, the UE could receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the bit field of the SRS resource set indicator is set to “10” or “11” or the index of the SRS resource set indicator is set to “2” or “3” according to TABLE 1 or the SRS resource set indicator field is not configured/present, the UE would follow the latest indicated M>1 (or N>1) TCI states or pairs of TCI states to receive one or more PDSCH transmissions/PDSCH transmission occasions associated with the latest indicated M>1 (or N>1) TCI states or pairs of TCI states—i.e., multi-TRP PDSCH (repetitions) reception. If the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to receive one or more PDSCHs or one or more layers of a PDSCH—i.e., single-TRP PDSCH reception.

Yet for another example, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to receive one or more PDSCHs or one or more layers of a PDSCH—i.e., single-TRP PDSCH reception; if the bit field of the SRS resource set indicator is set to “10” or “11” or the index of the SRS resources set indicator is set to “2” or “3” according to TABLE 1 or the SRS resource set indicator field is not configured/present, the UE would follow the latest indicated M>1 (or N>1) TCI states or pairs of TCI states to receive one or more PDSCH transmissions/transmission occasions associated with the latest indicated M>1 (or N>1) TCI states or pairs of TCI states—i.e., multi-TRP PDSCH (repetitions) reception.

In yet another example, the UE could first receive in a DCI (e.g., DCI format 1_1 or 1_2 with or without DL assignment) M>1 (or N>1) TCI states or pairs of TCI states indicated by one or more TCI state codepoints (or one or more TCI fields), wherein one or more of the indicated M>1 (or N>1) TCI states or pairs of TCI states could be associated with/mapped to one or more PDSCH transmissions/transmission occasions as described above for the multi-TRP PDSCH (repetitions) reception.

As discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. In the present disclosure, the SRS resource set indicator could also indicate one or more of: (1) single-TRP PDSCH reception, (2) multi-TRP PDSCH (repetitions) reception, (3) one or more orderings of the indicated TCI states or pairs of TCI states for single-TRP PDSCH reception or multi-TRP PDSCH (repetitions) reception, and (4) one or more TCI states or pairs of TCI states for single-TRP PDSCH reception or multi-TRP PDSCH (repetitions) reception.

For example, if the bit field of the SRS resource set indicator is set to “00” (or “01”) or the index of the SRS resource set indicator is set to “0” (or “1”) according to TABLE 1, the UE could use only one of the indicated M>1 (or N>1) TCI states or pairs of TCI states to receive one or more PDSCHs or one or more layers of a PDSCH—i.e., PDSCH reception in a single-TRP system; if the bit field of the SRS resource set indicator is set to “01” (or “00”) or the index of the SRS resource set indicator is set to “1” (or “0”) according to TABLE 1, the UE could use one or more of the indicated M>1 (or N>1) TCI states or pairs of TCI states to receive one or more PDSCH transmissions/transmission occasions as described above—i.e., PDSCH (repetitions) reception in a multi-TRP system.

If the bit field of the SRS resource set indicator is set to “10” (or “11”) or the index of the SRS resource set indicator is set to “2” (or “3”) according to TABLE 1, the UE would follow the ordering of the indicated M>1 (or N>1) TCI states or pairs of TCI states to receive one or more PDSCH transmissions/transmission occasions associated with the indicated M>1 (or N>1) TCI states or pairs of TCI states (according to examples in the present disclosure); if the bit field of the SRS resource set indicator is set to “11” (or “10”) or the index of the SRS resource set indicator is set to “3” (or “2”) according to TABLE 1, the UE would follow the order-reversed M>1 (or N>1) TCI states or pairs of TCI states to receive one or more PDSCH transmissions/transmission occasions associated with the order-reversed M>1 (or N>1) TCI states or pairs of TCI states (according to examples in the present disclosure).

Alternatively, if the bit field of the SRS resource set indicator is set to “10” (or “11”) or the index of the SRS resource set indicator is set to “2” (or “3”) according to TABLE 1, the UE would follow a first ordering of the M>1 (or N>1) TCI states or pairs of TCI states to receive one or more PDSCH transmissions/transmission occasions associated with the M>1 (or N>1) TCI states or pairs of TCI states in the first ordering; if the bit field of the SRS resource set indicator is set to “11” (or “10”) or the index of the SRS resource set indicator is set to “3” (or “2”) according to TABLE 1, the UE would follow a second ordering of the M>1 (or N>1) TCI states or pairs of TCI states to receive one or more PDSCH transmissions/transmission occasions associated with the M>1 (or N>1) TCI states or pairs of TCI states in the second ordering.

The first and second orderings of TCI states/pairs of TCI states could be determined. Optionally, the bit fields “00” or “01” or the indexes “0” or “1” of the 2-bit SRS resource set indicator could be used to indicate the orderings of the M>1 (or N>1) TCI states or pairs of TCI states for multi-TRP PDSCH (repetitions) reception as described above, and the bit fields “10” or “11” or the indexes “2” or “3” of the 2-bit SRS resource set indicator could be used to indicate the single-TRP PDSCH reception or the multi-TRP PDSCH (repetitions) reception as described above.

For another example, if the bit field of the SRS resource set indicator is set to “00” (or “01”) or the index of the SRS resource set indicator is set to “0” (or “1”) according to TABLE 1, the UE could use the primary TCI state or pair of TCI states determined from the indicated M>1 (or N>1) TCI states or pairs of TCI states to receive one or more PDSCHs or one or more layers of a PDSCH—i.e., PDSCH reception in a single-TRP system; if the bit field of the SRS resource set indicator is set to “10” (or “00”) or the index of the SRS resource set indicator is set to “1” (or “0”) according to TABLE 1, the UE could use the secondary TCI state or pair of TCI states determined from the indicated M>1 (or N>1) TCI states or pairs of TCI states to receive one or more PDSCHs or one or more layers of a PDSCH—i.e., PDSCH reception in a single-TRP system; the primary and secondary TCI states/pairs of TCI states could be determined/configured.

If the bit field of the SRS resource set indicator is set to “10” (or “11”) or the index of the SRS resource set indicator is set to “2” (or “3”) according to TABLE 1, the UE would follow the ordering of the indicated M>1 (or N>1) TCI states or pairs of TCI states to receive one or more PDSCH transmissions/transmission occasions associated with the indicated M>1 (or N>1) TCI states or pairs of TCI states (according to examples in the present disclosure); if the bit field of the SRS resource set indicator is set to “11” (or “10”) or the index of the SRS resource set indicator is set to “3” (or “2”) according to TABLE 1, the UE would follow the order-reversed M>1 (or N>1) TCI states or pairs of TCI states to receive one or more PDSCH transmissions/transmission occasions associated with the order-reversed M>1 (or N>1) TCI states or pairs of TCI states (according to examples in the present disclosure).

Alternatively, if the bit field of the SRS resource set indicator is set to “10” (or “11”) or the index of the SRS resource set indicator is set to “2” (or “3”) according to TABLE 1, the UE would follow a first ordering of the M>1 (or N>1) TCI states or pairs of TCI states to receive one or more PDSCH transmissions/transmission occasions associated with the M>1 (or N>1) TCI states or pairs of TCI states in the first ordering; if the bit field of the SRS resource set indicator is set to “11” (or “10”) or the index of the SRS resource set indicator is set to “3” (or “2”) according to TABLE 1, the UE would follow a second ordering of the M>1 (or N>1) TCI states or pairs of TCI states to receive one or more PDSCH transmissions/transmission occasions associated with the M>1 (or N>1) TCI states or pairs of TCI states in the second ordering. The first and second orderings of TCI states/pairs of TCI states could be determined. Optionally, the bit fields “00” or “01” or the indexes “0” or “1” of the 2-bit SRS resource set indicator could be used to indicate the orderings of the M>1 (or N>1) TCI states or pairs of TCI states for multi-TRP PDSCH (repetitions) reception as described above, and the bit fields “10” or “11” or the indexes “2” or “3” of the 2-bit SRS resource set indicator could be used to indicate the primary or secondary TCI states/pairs of TCI states for single-TRP PDSCH reception as described above.

Yet for another example, in addition to the 2-bit SRS resource set indicator configured according to examples, the UE could also receive in a DCI (e.g., DCI format 1_1 or 1_2 with or without DL assignment) a one-bit indicator. For this design example, a new/dedicated DCI field could be used/configured in the corresponding DCI format to indicate the one-bit indicator; alternatively, one of more of the existing DCI fields in the corresponding DCI format could be used/configured to indicate the one-bit indicator. When the 2-bit SRS resource set indicator indicates the single-TRP PDSCH reception, if the one-bit indicator is set to “0” (or “1”), the UE could use the primary TCI state or pair of TCI states determined from the indicated M>1 (or N>1) TCI states or pairs of TCI states to receive one or more PDSCHs or one or more layers of a PDSCH; if the one-bit indicator is set to “1” (or “0”), the UE could use the secondary TCI state or pair of TCI states determined from the indicated M>1 (or N>1) TCI states or pairs of TCI states to receive one or more PDSCHs or one or more layers of a PDSCH; the primary and secondary TCI states/pairs of TCI states could be determined/configured.

Yet for another example, the SRS resource set indicator indicated in DCI format 0_1 or 0_2 (e.g., in the “SRS resource set indicator” field) could correspond to a z-bit indicator (z>1, e.g., z=3) with 2\hat{ }z states (e.g., 8 states or bit fields for z=3). In this example, a first state or bit field of the z-bit indicator could indicate that the single-TRP PDSCH reception is enabled according to examples and the corresponding sub-examples in the present disclosure, a second state or bit field of the z-bit indicator could indicate that the multi-TRP PDSCH (repetitions) reception is enabled, a third state or bit field of the z-bit indicator could indicate that the UE could use the primary TCI state or pair of TCI states for the single-TRP PDSCH reception, a fourth state or bit field of the z-bit indicator could indicate that the UE could use the secondary TCI state or pair of TCI states for the single-TRP PDSCH reception, a fifth state or bit field of the z-bit indicator could indicate an ordering of the M>1 (or N>1) TCI states or pairs of TCI states for the multi-TRP PDSCH (repetitions) reception, a sixth state or bit field of the z-bit indicator could indicate another ordering of the M>1 (or N>1) TCI states or pairs of TCI states for the multi-TRP PDSCH (repetitions) reception.

In yet another example, the UE could first receive in a DCI (e.g., DCI format 1_1 or 1_2 with or without DL assignment) M=1 (or N=1) TCI state or pair of TCI states indicated by a TCI state codepoint (or a TCI field). The UE could then receive in a DCI (e.g., DCI format 1_1 or 1_2 with or without DL assignment) M>1 (or N>1) TCI states or pairs of TCI states indicated by one or more TCI state codepoints (or one or more TCI fields), wherein one or more of the indicated M>1 (or N>1) TCI states or pairs of TCI states could be associated with/mapped to one or more PDSCH transmissions/PDSCH transmission occasions as described above for the multi-TRP PDSCH (repetitions) reception.

As discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The SRS resource set indicator could indicate one or more of: (1) single-TRP PDSCH reception, (2) multi-TRP PDSCH (repetitions) reception, (3) one or more orderings of the indicated TCI states or pairs of TCI states for single-TRP PDSCH reception or multi-TRP PDSCH (repetitions) reception, and (4) one or more TCI states or pairs of TCI states for single-TRP PDSCH reception or multi-TRP PDSCH (repetitions) reception. The SRS resource set indicator could be configured. For this example, if the SRS resource set indicator indicates that the single-TRP PDSCH reception is enabled, the UE could follow the previously indicated M=1 (or N=1) TCI state or pair of TCI states to receive one or more PDSCHs or one or more layers of a PDSCH.

The UE could receive from the network one or more MAC CE activation/sub-selection commands activating one or more sets of TCI states/TCI state IDs from the one or more TCI state pools or the one or more TCI state groups, with each set of activated/selected TCI states/TCI state IDs used to map up to Nc≥1 (e.g., 8, 16, 32 or 64) TCI state codepoints in a DCI format. Here, a TCI state codepoint could be configured. Furthermore, the one or more sets of activated/selected TCI state codepoints could include/contain/comprise one or more of the following examples.

In one example, a first set of TCI state codepoints for single-TRP PDSCH reception: the UE could receive in a DCI (e.g., DCI format 1_1 or 1_2 with or without DL assignment) M=1 (or N=1) TCI state or pair of TCI states indicated by a TCI state codepoint from the first set of TCI state codepoints; the UE could use the indicated TCI state or pair of TCI states for the single-TRP PDSCH reception.

In another example, a second set of TCI state codepoints for single-TRP PDSCH reception: the UE could receive in a DCI (e.g., DCI format 1_1 or 1_2 with or without DL assignment) M=1 (or N=1) TCI state or pair of TCI states indicated by a TCI state codepoint from the second set of TCI state codepoints; the UE could use the indicated TCI state or pair of TCI states as the primary TCI state or pair of TCI states for the single-TRP PDSCH reception.

In yet another example, a third set of TCI state codepoints for single-TRP PDSCH reception: the UE could receive in a DCI (e.g., DCI format 1_1 or 1_2 with or without DL assignment) M=1 (or N=1) TCI state or pair of TCI states indicated by a TCI state codepoint from the third set of TCI state codepoints; the UE could use the indicated TCI state or pair of TCI states as the secondary TCI state or pair of TCI states for the single-TRP PDSCH reception.

In yet another example, a fourth set of TCI state codepoints for multi-TRP PDSCH (repetitions) reception: the UE could receive in a DCI (e.g., DCI format 1_1 or 1_2 with or without DL assignment) M>1 (or N>1) TCI states or pairs of TCI states indicated by one or more TCI state codepoints from the fourth set of TCI state codepoints, wherein one or more of the indicated M>1 (or N>1) TCI states or pairs of TCI states could be associated with/mapped to one or more PDSCH transmissions/transmission occasions as described above for the multi-TRP PDSCH (repetitions) reception.

In yet another example, a fifth set of TCI state codepoints for multi-TRP PDSCH (repetitions) reception: the UE could receive in a DCI (e.g., DCI format 1_1 or 1_2 with or without DL assignment) M>1 (or N>1) TCI states or pairs of TCI states indicated by one or more TCI state codepoints from the fifth set of TCI state codepoints, wherein one or more of the indicated M>1 (or N>1) TCI states or pairs of TCI states could be associated with/mapped to one or more PDSCH transmissions/transmission occasions as described above for the multi-TRP PDSCH (repetitions) reception. The ordering of the indicated M>1 (or N>1) TCI states or pairs of TCI states from the fifth set could correspond to an ordering of M>1 (or N>1) TCI states or pairs of TCI states (e.g., the first ordering).

In yet another example, a sixth set of TCI state codepoints for multi-TRP PDSCH (repetitions) reception: the UE could receive in a DCI (e.g., DCI format 1_1 or 1_2 with or without DL assignment) M>1 (or N>1) TCI states or pairs of TCI states indicated by one or more TCI state codepoints from the sixth set of TCI state codepoints, wherein one or more of the indicated M>1 (or N>1) TCI states or pairs of TCI states could be associated with/mapped to one or more PDSCH transmissions/transmission occasions as described above for the multi-TRP PDSCH (repetitions) reception. The ordering of the indicated M>1 (or N>1) TCI states or pairs of TCI states from the sixth set could correspond to an ordering of M>1 (or N>1) TCI states or pairs of TCI states (e.g., the second ordering).

The UE could be indicated by the network from which set(s) of TCI state codepoints the indicated one or more TCI states or pairs of TCI states are selected. This indication could be via higher layer RRC signaling or MAC CE command or dynamic DCI based signaling. For instance, the UE could also receive in an uplink DCI (e.g., DCI format 0_1 or 0_2) a y-bit (y≥1) SRS resource set indicator (e.g., in the “SRS resource set indicator” field) to indicate one or more SRS resource sets. Here, the SRS resource set indicator is used to indicate the set(s) of TCI state codepoints. Each state/bit field/index of the y-bit SRS resource set indicator (a total of 2\hat{ }y states or bit fields for the y-bit SRS resource set indicator) could correspond to a set of TCI state codepoints (e.g., the first set, the second set, the third set, the fourth set, the fifth set or the sixth set as specified above).

For example, if a UE receives in DCI format 0_1 or 0_2 the y-bit SRS resource set indicator in the “SRS resource set indicator” field (e.g., set to a state or bit field value), the UE could determine the set of TCI state codepoints corresponding to the indicated state or bit field value of the y-bit SRS resource set indicator, from which the indicated one or more TCI states or pairs of TCI states are selected. According to the determined set of TCI state codepoints, the UE could perform/conduct the corresponding single-TRP PDSCH reception or multi-TRP PDSCH (repetitions) reception as discussed above.

In one embodiment of the present disclosure, a UE could be configured with a number of slots, denoted by N_{pucch}, for PUCCH transmission repetitions. The UE could also be configured with two SRS resource sets (e.g., provided by srs-ResourceSetToAddModList or srs-ResourceSetToAddModListDCI-0-2) with higher layer parameter usage in SRS-ResourceSet set to “codebook” or “noncodebook” for PUSCH transmission repetitions. As aforementioned, the UE could receive in a DCI (e.g., DCI format 1_1 or 1_2 with or without DL assignment) M>1 (or N>1) TCI states or M>1 (or N>1) pairs of TCI states indicated by one or more TCI state codepoints (or one or more TCI fields) in the corresponding DCI. One or more of the indicated M>1 (or N>1) TCI states or pairs of TCI states could be associated with/mapped to one or more PUCCH transmission repetitions or one or more PUSCH transmission repetitions.

When a UE is configured with a number of slots N_{pucch} for PUCCH transmission repetitions, the indicated N>1 (or M>1) TCI states or pairs of TCI states could be alternated per N_{pucch} repetitions of the PUCCH transmission, where N_{pucch}=1 if higher layer parameter mappingPattern=“cyclicMapping”; else, N_{pucch}=N (or M). For instance, for N=2 (or M=2), a first and a second indicated TCI states/pairs of TCI states could be alternated per N_{pucch} repetitions of the PUCCH transmission, where N_{pucch}=1 if the higher layer parameter mappingPattern=“cyclicMapping”; else, N_{pucch}=2. In the present disclosure, the first (or second) indicated TCI state/pair of TCI states could correspond to any of the indicated M=2 (or N=2) TCI states/pairs of TCI states.

When a UE is configured with two SRS resource sets (e.g., provided by srs-ResourceSetToAddModList or srs-ResourceSetToAddModListDCI-0-2) with higher layer parameter usage in SRS-ResourceSet set to “codebook” or “noncodebook,” for PUSCH repetition Type A, in case K>1 consecutive slots, the same symbol allocation is applied across the K consecutive slots and the PUSCH is limited to a single transmission layer. The UE shall repeat the TB across the K consecutive slots applying the same symbol allocation in each slot—also referred to as PUSCH transmission repetitions.

In one example, (1) when K=2, M=2 or N=2, a first and a second indicated TCI states/pairs of TCI states are applied to the first and second slots of 2 consecutive slots, respectively; (2) when K>2 and cyclicMapping in PUSCH-Config is enabled, the indicated TCI state/pair of TCI states n (or m) is applied to the n-th (or m-th) slot of K consecutive slots, and the same TCI state(s) mapping pattern continues to the remaining slots of K consecutive slots. For M=2 or N=2, a first and a second indicated TCI states/pairs of TCI states are applied to the first and second slots of K consecutive slots, respectively, and the same TCI state(s) mapping pattern continues to the remaining slots of K consecutive slots; (3) when K>2 and sequentialMapping in PUSCH-Config is enabled, the indicated TCI state/pair of TCI states n (or m) is applied to the n-th (or m-th) and (n+1)-th (or (m+1)-th) slots of K consecutive slots, and the same TCI state(s) mapping pattern continues to the remaining slots of K consecutive slots.

For M=2 or N=2, a first indicated TCI state/pair of TCI states is applied to the first and second slots of K consecutive slots, and a second indicated TCI state/pair of TCI states is applied to the third and fourth slots of K consecutive slots, and the same TCI state(s) mapping pattern continues to the remaining slots of K consecutive slots. In the present disclosure, the first (or second) indicated TCI state/pair of TCI states could correspond to any of the indicated M=2 (or N=2) TCI states/pairs of TCI states. In this example, the first and second indicated TCI states/pairs of TCI states could correspond to the first and second TCI states/pairs of TCI states of/within the indicated M=2 (or N=2) TCI states/pairs of TCI states, respectively.

In another example, (1) when K=2, M=2 or N=2, a second and a first indicated TCI states/pairs of TCI states are applied to the first and second slots of 2 consecutive slots, respectively; (2) when K>2 and cyclicMapping in PUSCH-Config is enabled, for M=2 or N=2, a second and a first indicated TCI states/pairs of TCI states are applied to the first and second slots of K consecutive slots, respectively, and the same TCI state(s) mapping pattern continues to the remaining slots of K consecutive slots; (3) when K>2 and sequentialMapping in PUSCH-Config is enabled, for M=2 or N=2, a second indicated TCI state/pair of TCI states is applied to the first and second slots of K consecutive slots, and a first indicated TCI state/pair of TCI states is applied to the third and fourth slots of K consecutive slots, and the same TCI state(s) mapping pattern continues to the remaining slots of K consecutive slots. In the present disclosure, the first (or second) indicated TCI state/pair of TCI states could correspond to any of the indicated M=2 (or N=2) TCI states/pairs of TCI states. In this example, the first and second indicated TCI states/pairs of TCI states could correspond to the first and second TCI states/pairs of TCI states of/within the indicated M=2 (or N=2) TCI states/pairs of TCI states, respectively.

When a UE is configured with two SRS resource sets (e.g., provided by srs-ResourceSetToAddModList or srs-ResourceSetToAddModListDCI-0-2) with higher layer parameter usage in SRS-ResourceSet set to “codebook” or “noncodebook,” for PUSCH repetition Type B, in case K>1 consecutive slots, the same symbol allocation is applied across the K consecutive slots and the PUSCH is limited to a single transmission layer. The UE shall repeat the TB across the K consecutive slots applying the same symbol allocation in each slot—also referred to as PUSCH (nominal) transmission repetitions. One or more of the indicated M>1 (or N>1) TCI states/pairs of TCI states could be associated/mapped to nominal PUSCH repetitions. The association/mapping between the indicated TCI states/pairs of TCI states and the nominal PUSCH repetitions could be determined for PUSCH Type A repetition by considering nominal repetitions instead of slots.

Furthermore, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The SRS resource set indicator could indicate one or more of: (1) switching between single-TRP PUCCH or PUSCH transmission and multi-TRP PUCCH or PUSCH (repetitions) transmission, (2) one or more of the indicated M>1 (or N>1) TCI states or pairs of TCI states to use for the single-TRP PUCCH or PUSCH transmission, and (3) switching the order of the indicated M>1 (or N>1) TCI states or pairs of TCI states for multi-TRP PUCCH or PUSCH (repetitions) transmission.

In one example, the UE could first receive in a DCI (e.g., DCI format 1_1 or 1_2 with or without DL assignment) M>1 (or N>1) TCI states or pairs of TCI states indicated by one or more TCI state codepoints (or one or more TCI fields), wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission.

As discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the bit field of the SRS resource set indicator is set to “00” or “01” or the index of the SRS resource set indicator is set to “0” or “1” according to TABLE 1 or the SRS resource set indicator field is not configured/present, the UE could use only one of the indicated M>1 (or N>1) TCI states or pairs of TCI states to transmit PUCCH(s) or PUSCH(s)—i.e., PUCCH or PUSCH transmission in a single-TRP system; if the bit field of the SRS resource set indicator is set to “10” or “11” or the index of the SRS resource set indicator is set to “2” or “3” or the SRS resource set indicator field is not configured/present, the UE could use one or more of the indicated M>1 (or N>1) TCI states or pairs of TCI states to transmit PUCCH transmission repetitions or PUSCH transmission repetitions—i.e., PUCCH or PUSCH (repetitions) transmission in a multi-TRP system. More specifically, if the bit field of the SRS resource set indicator is set to “00” or “01” or the index of the SRS resource set indicator is set to “0” or “1” according to TABLE 1 or the SRS resource set indicator field is not configured/present (i.e., for the PUCCH or PUSCH transmission in a single-TRP system),

For example, the UE could use the first TCI state or the TCI state with the lowest (or highest) TCI state ID among the indicated M>1 (or N>1) TCI states or the separate UL TCI state or the joint DL and UL TCI state in the first pair of TCI states or the separate UL TCI state or the joint DL and UL TCI state in the pair of TCI states associated with the lowest (or highest) TCI state ID among the indicated M>1 (or N>1) pairs of TCI states to transmit the PUCCH(s) or PUSCH(s).

For another example, the UE could use the second TCI state or the TCI state with the second lowest (or second highest) TCI state ID among the indicated M>1 (or N>1) TCI states or the separate UL TCI state or the joint DL and UL TCI state in the second pair of TCI states or the separate UL TCI state or the joint DL and UL TCI state in the pair of TCI states associated with the second lowest (or second highest) TCI state ID among the indicated M>1 (or N>1) pairs of TCI states to transmit the PUCCH(s) or PUSCH(s).

Yet for another example, the UE could use the last TCI state or the TCI state with the highest (or lowest) TCI state ID among the indicated M>1 (or N>1) TCI states or the separate UL TCI state or the joint DL and UL TCI state in the last pair of TCI states or the separate UL TCI state or the joint DL and UL TCI state in the pair of TCI states associated with the highest (or lowest) TCI state ID among the indicated M>1 (or N>1) pairs of TCI states to transmit the PUCCH(s) or PUSCH(s).

Yet for another example, the UE could use the m-th (or n-th) TCI state or the TCI state with the m-th (or n-th) lowest (or highest) TCI state ID among the indicated M>1 (or N>1) TCI states or the separate UL TCI state or the joint DL and UL TCI state in the m-th (or n-th) pair of TCI states or the separate UL TCI state or the joint DL and UL TCI state in the pair of TCI states associated with the m-th (or n-th) lowest (or highest) TCI state ID among the indicated M>1 (or N>1) pairs of TCI states to transmit the PUCCH(s) or PUSCH(s), where m∈{1, . . . , M} and n∈{1, . . . , N}. In this example, the index m (or n) could be determined according to at least one of: (1) fixed in the system specification(s) and (2) configured, e.g., via higher layer RRC signaling or MAC CE command or DCI based signaling, by the network.

Yet for another example, the UE could use the separate UL TCI state or the joint DL and UL TCI state among the indicated M>1 (or N>1) TCI states to transmit the PUCCH(s) or PUSCH(s). In this example, only one of the indicated M>1 (or N>1) TCI states could correspond to a separate UL TCI state or a joint DL and UL TCI state.

Yet for another example, the UE could be higher layer configured by the network a list of K entity IDs. In the present disclosure, an entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. The UE could use the TCI state or the pair of TCI states that is associated with the first entity ID or the second entity ID or the last entity ID or the lowest entity ID or the highest entity ID or the second lowest (or second highest) entity ID or the entity ID associated with the serving cell PCI/PCI index or the entity ID associated with a PCI/PCI index different from the serving cell PCI/PCI index or the k-th entity ID or the k-th lowest (or highest) entity ID among the list of K entity IDs to transmit the PUCCH(s) or PUSCH(s), where k∈{1, . . . , K}. In this example, the index k could be determined according to at least one of: (1) fixed in the system specification(s) and (2) configured, e.g., via higher layer RRC signaling or MAC CE command or DCI based signaling, by the network. Furthermore, K could be equal to M (or N).

Yet for another example, the UE could be higher layer configured by the network a list of L PCIs. The UE could use the TCI state or the pair of TCI states that is associated with the first PCI or the second PCI or the last PCI or the lowest PCI or the highest PCI or the second lowest (or second highest) PCI or the serving cell PCI or a PCI different from the serving cell PCI or the l-th PCI or the l-th lowest (or highest) PCI among the list of L PCIs to transmit the PUCCH(s) or PUSCH(s), where l∈{1, . . . , L}.

Alternatively, the UE could determine a list of L PCI indexes 0, . . . , L−1 or 1, . . . , L with each PCI index pointing to an entry in the list of L PCIs. For this case, the UE could use the TCI state or the pair of TCI states that is associated with the first PCI index or the second PCI index or the last PCI index or the lowest PCI index or the highest PCI index or the second lowest (or second highest) PCI index or the serving cell PCI index or a PCI index different from the serving cell PCI index or the l-th PCI index or the l-th lowest (or highest) PCI index among the list of L PCI indexes to transmit the PUCCH(s) or PUSCH(s), where l∈{1, . . . , L}. In this example, the index l could be determined according to at least one of: (1) fixed in the system specification(s) and (2) configured, e.g., via higher layer RRC signaling or MAC CE command or DCI based signaling, by the network. Furthermore, L could be equal to M (or N).

Yet for another example, the UE could be provided in PDCCH-Config two values of CORESETPoolIndex (i.e., 0 and 1) for one or more CORESETs. The UE could use the TCI state or the pair of TCI states that is associated with value 0 of CORESETPoolIndex or value 1 of CORESETPoolIndex or value x of CORESETPoolIndex to transmit the PUCCH(s) or PUSCH(s), where x∈{0, 1}. In this example, the value x could be determined according to at least one of: (1) fixed in the system specification(s) and (2) configured, e.g., via higher layer RRC signaling or MAC CE command or DCI based signaling, by the network.

In another example, the UE could first receive in a DCI (e.g., DCI format 1_1 or 1_2 with or without DL assignment) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission.

As discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP and multi-TRP operation. If the bit field of the SRS resource set indicator is set to “00” (or “01”) or the index of the SRS resource set indicator is set to “0” (or “1”) according to TABLE 1, the UE could use one of the indicated M>1 (or N>1) TCI states or pairs of TCI states—a primary TCI state or pair of TCI states—to transmit PUCCH(s) or PUSCH(s)—i.e., PUCCH or PUSCH transmission in a single-TRP system; if the bit field of the SRS resource set indicator is set to “01” (or “00”) or the index of the SRS resource set indicator is set to “1” (or “0”) according to TABLE 1, the UE could use another one of the indicated M>1 (or N>1) TCI states or pairs of TCI states—a secondary TCI state or pair of TCI states—to transmit PUCCH(s) or PUSCH(s)—i.e., PUCCH or PUSCH transmission in a single-TRP system. Various design examples of determining the primary TCI state or pair of TCI states or the secondary TCI state or pair of TCI states are provided in the present disclosure.

In yet another example, the UE could first receive in a DCI (e.g., DCI format 1_1 or 1_2 with or without DL assignment) M>1 (or N>1) TCI states or pairs of TCI states—denoted and ordered by {TCI state/TCI states pair #a1, TCI state/TCI states pair #a2, . . . , TCI state/TCI states pair #aM (or #aN)}—indicated by one or more TCI state codepoints (or one or more TCI fields), wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) reception.

As discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the bit field of the SRS resource set indicator is set to “11” (or “10”) or the index of the SRS resource set indicator is set to “3” (or “2”) according to TABLE 1 or the SRS resource set indicator field is not configured/present, the ordering of the indicated M>1 (or N>1) TCI states or pairs of TCI states are reversed, and the UE would follow the order-reversed M>1 (or N>1) TCI states or pairs of TCI states to transmit one or more PUCCH transmission repetitions or PUSCH transmission repetitions associated with the order-reversed M>1 (or N>1) TCI states or pairs of TCI states, and if the bit field of the SRS resource set indicator is set to “10” (or “11”) or the index of the SRS resource set indicator is set to “2” (or “3”) according to TABLE 1 or the SRS resource set indicator field is not configured/present, the UE would follow the indicated M>1 (or N>1) TCI states or pairs of TCI states to transmit one or more PUCCH transmission repetitions or PUSCH transmission repetitions associated with the indicated M>1 (or N>1) TCI states or pairs of TCI states.

If the indicated M>1 (or N>1) TCI states or pairs of TCI states are (ordered as) {TCI state/TCI states pair #a1, TCI state/TCI states pair #a2, . . . , TCI state/TCI states pair #aM (or #aN)}, when the bit field of the SRS resource set indicator is set to “11” (or “10”) or the index of the SRS resource set indicator is set to “3” (or “2”) according to TABLE 1 or the SRS resource set indicator field is not configured/present, the (order-reversed) M>1 (or N>1) TCI states or pairs of TCI states would become to {TCI state/TCI states pair #b1, TCI state/TCI states pair #b2, . . . , TCI state/TCI states pair #bM (or #bN)}, where b1=aM (or aN), b2=a(M−1) or (a(N−1)), . . . , bM (or bN)=a1. For M=2 (or N=2), the UE could first receive in a DCI (e.g., DCI format 1_1 or 1_2 with or without DL assignment) two TCI states or pairs of TCI states—denoted and ordered by {TCI state/TCI states pair #a1, TCI state/TCI states pair #a2}; if the bit field of the SRS resource set indicator is set to “11” (or “10”) or the index of the SRS resource set indicator is set to “3” (or “2”) according to TABLE 1 or the SRS resource set indicator field is not configured/present, the UE would follow the order-reversed two TCI states or pairs of TCI states {TCI state/TCI state pair #a2, TCI state/TCI state pair #a1} to transmit one or more PUCCH transmission repetitions or PUSCH transmission repetitions associated with the order-reversed TCI states or pairs of TCI states {TCI state/TCI state pair #a2, TCI state/TCI state pair #a1}, and if the bit field of the SRS resource set indicator is set to “10” (or “11”) or the index of the SRS resource set indicator is set to “2” (or “3”) according to TABLE 1 or the SRS resource set indicator field is not configured/present, the UE would follow the indicated two TCI states or pairs of TCI states {TCI state/TCI state pair #a1, TCI state/TCI state pair #a2} to transmit one or more PUCCH transmission repetitions or PUSCH transmission repetitions associated with the indicated TCI states or pairs of TCI states {TCI state/TCI state pair #a1, TCI state/TCI state pair #a2}.

In yet another example, the UE could first receive in a DCI (e.g., DCI format 1_1 or 1_2 with or without DL assignment) M>1 (or N>1) TCI states or pairs of TCI states—denoted by {TCI state/TCI states pair #a1, TCI state/TCI states pair #a2, . . . , TCI state/TCI states pair #aM (or #aN)}-indicated by one or more TCI state codepoints (or one or more TCI fields), wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission.

As discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the bit field of the SRS resource set indicator is set to “10” (or “11”) or the index of the SRS resource set indicator is set to “2” (or “3”) according to TABLE 1, the UE would follow the M>1 (or N>1) TCI states or pairs of TCI states ordered by {TCI state/TCI states pair #a1, TCI state/TCI states pair #a2, . . . , TCI state/TCI states #aM (or #aN)}—a first ordering—to transmit one or more PUCCH transmission repetitions or PUSCH transmission repetitions associated with the M>1 (or N>1) TCI states or pairs of TCI states ordered by {TCI state/TCI states pair #a1, TCI state/TCI states pair #a2, . . . , TCI state/TCI states #aM (or #aN)}, and if the bit field of the SRS resource set indicator is set to “11” (or “10”) or the index of the SRS resource set indicator is set to “3” (or “2”) according to TABLE 1, the UE would follow the M>1 (or N>1) TCI states or pairs of TCI states ordered by {TCI state/TCI states pair #b1, TCI state/TCI states pair #b2, . . . , TCI state/TCI states #bM (or #bN)}—a second ordering—to transmit one or more PUCCH transmission repetitions or PUSCH transmission repetitions associated with the M>1 (or N>1) TCI states or pairs of TCI states ordered by {TCI state/TCI states pair #b1, TCI state/TCI states pair #b2, . . . , TCI state/TCI states #bM (or #bN)}.

The first ordering of the TCI states/pairs of TCI states {TCI state/TCI states pair #a1, TCI state/TCI states pair #a2, . . . , TCI state/TCI states #aM (or #aN)} or the second ordering of the TCI states/pairs of TCI states {TCI state/TCI states pair #b1, TCI state/TCI states pair #b2, . . . , TCI state/TCI states #bM (or #bN)} could be determined according to at least one of: (1) fixed in the system specification(s) and (2) configured, e.g., via higher layer RRC signaling or MAC CE command or DCI based signaling, by the network. For both (1) and (2), b1 could be equal to aM (or aN), b2 could be equal to a(M−1) or (a(N−1)), . . . , bM (or bN) could be equal to a1. For M=2 (or N=2), the UE could first receive in a DCI (e.g., DCI format 1_1 or 1_2 with or without DL assignment) two TCI states or pairs of TCI states—denoted by {TCI state/TCI states pair #a1, TCI state/TCI states pair #a2}; if the bit field of the SRS resource set indicator is set to “10” (or “11”) or the index of the SRS resource set indicator is set to “2” (or “3”) according to TABLE 1, the UE would follow the two TCI states or pairs of TCI states ordered by {TCI state/TCI state pair #a1, TCI state/TCI state pair #a2} to transmit one or more PUCCH transmission repetitions or PUSCH transmission repetitions associated with the two TCI states or pairs of TCI states ordered by {TCI state/TCI state pair #a1, TCI state/TCI state pair #a2}, and if the bit field of the SRS resource set indicator is set to “11” (or “10”) or the index of the SRS resource set indicator is set to “3” (or “2”) according to TABLE 1, the UE would follow the two TCI states or pairs of TCI states ordered by {TCI state/TCI state pair #a2, TCI state/TCI state pair #a1} to transmit one or more PUCCH transmission repetitions or PUSCH transmission repetitions associated with the two TCI states or pairs of TCI states {TCI state/TCI state pair #a2, TCI state/TCI state pair #a1}.

In yet another example, the UE could first receive in a DCI (e.g., DCI format 1_1 or 1_2 with or without DL assignment) M=1 (or N=1) TCI state or pair of TCI states indicated by a TCI state codepoint (or a TCI field). The UE could then receive in a DCI (e.g., DCI format 1_1 or 1_2 with or without DL assignment) M>1 (or N>1) TCI states or pairs of TCI states indicated by one or more TCI state codepoints (or one or more TCI fields), wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission.

For example, the UE would follow the latest indicated M>1 (or N>1) TCI states or pairs of TCI states to transmit one or more PUCCH transmission repetitions or PUSCH transmission repetitions associated with the latest indicated M>1 (or N>1) TCI states or pairs of TCI states—i.e., multi-TRP PUCCH or PUSCH (repetitions) transmission.

For another example, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the bit field of the SRS resource set indicator is set to “10” or “11” or the index of the SRS resource set indicator is set to “2” or “3” according to TABLE 1 or the SRS resource set indicator field is not configured/present, the UE would follow the latest indicated M>1 (or N>1) TCI states or pairs of TCI states to transmit one or more PUCCH transmission repetitions or PUSCH transmission repetitions associated with the latest indicated M>1 (or N>1) TCI states or pairs of TCI states—i.e., multi-TRP PUCCH or PUSCH (repetitions) transmission. If the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to transmit PUCCH(s) or PUSCH(s)—i.e., single-TRP PUCCH or PUSCH transmission.

Yet for another example, as discussed above, the UE could receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to transmit PUCCH(s) or PUSCH(s)—i.e., single-TRP PUCCH or PUSCH transmission; if the bit field of the SRS resource set indicator is set to “10” or “11” or the index of the SRS resource set indicator is set to “2” or “3” according to TABLE 1 or the SRS resource set indicator field is not configured/present, the UE would follow the latest indicated M>1 (or N>1) TCI states or pairs of TCI states to transmit one or more PUCCH transmission repetitions or PUSCH transmission repetitions associated with the latest indicated M>1 (or N>1) TCI states or pairs of TCI states—i.e., multi-TRP PUCCH or PUSCH (repetitions) transmission.

In yet another example, the UE could first receive in a DCI (e.g., DCI format 1_1 or 1_2 with or without DL assignment) M>1 (or N>1) TCI states or pairs of TCI states indicated by one or more TCI state codepoints (or one or more TCI fields), wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission.

As discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP and multi-TRP operation. The SRS resource set indicator could indicate one or more of: (1) single-TRP PUCCH or PUSCH transmission, (2) multi-TRP PUCCH or PUSCH (repetitions) transmission, (3) one or more orderings of the indicated TCI states or pairs of TCI states for single-TRP PUCCH or PUSCH transmission or multi-TRP PUCCH or PUSCH (repetitions) transmission, and (4) one or more TCI states or pairs of TCI states for single-TRP PUCCH or PUSCH transmission or multi-TRP PUCCH or PUSCH (repetitions) transmission.

For example, if the bit field of the SRS resource set indicator is set to “00” (or “01”) or the index of the SRS resource set indicator is set to “0” (or “1”) according to TABLE 1, the UE could use only one of the indicated M>1 (or N>1) TCI states or pairs of TCI states to transmit PUCCH(s) or PUSCH(s)—i.e., PUCCH or PUSCH transmission in a single-TRP system; if the bit field of the SRS resource set indicator is set to “01” (or “00”) or the index of the SRS resource set indicator is set to “1” (or “O”) according to TABLE 1, the UE could use one or more of the indicated M>1 (or N>1) TCI states or pairs of TCI states to transmit one or more PUCCH transmission repetitions or PUSCH transmission repetitions as described above—i.e., PUCCH or PUSCH (repetitions) transmission in a multi-TRP system. If the bit field of the SRS resource set indicator is set to “10” (or “11”) or the index of the SRS resource set indicator is set to “2” (or “3”) according to TABLE 1, the UE would follow the ordering of the indicated M>1 (or N>1) TCI states or pairs of TCI states to transmit one or more PUCCH transmission repetitions or PUSCH transmission repetitions associated with the indicated M>1 (or N>1) TCI states or pairs of TCI states; if the bit field of the SRS resource set indicator is set to “11” (or “10”) or the index of the SRS resource set indicator is set to “3” (or “2”) according to TABLE 1, the UE would follow the order-reversed M>1 (or N>1) TCI states or pairs of TCI states to transmit one or more PUCCH transmission repetitions or PUSCH transmission repetitions associated with the order-reversed M>1 (or N>1) TCI states or pairs of TCI states.

Alternatively, if the bit field of the SRS resource set indicator is set to “10” (or “11”) or the index of the SRS resource set indicator is set to “2” (or “3”) according to TABLE 1, the UE would follow a first ordering of the M>1 (or N>1) TCI states or pairs of TCI states to transmit one or more PUCCH transmission repetitions or PUSCH transmission repetitions associated with the M>1 (or N>1) TCI states or pairs of TCI states in the first ordering; if the bit field of the SRS resource set indicator is set to “11” (or “10”) or the index of the SRS resource set indicator is set to “3” (or “2”) according to TABLE 1, the UE would follow a second ordering of the M>1 (or N>1) TCI states or pairs of TCI states to transmit one or more PUCCH transmission repetitions or PUSCH transmission repetitions associated with the M>1 (or N>1) TCI states or pairs of TCI states in the second ordering. The first and second orderings of TCI states/pairs of TCI states could be determined.

Optionally, the bit fields “00” or “01” or the indexes “0” or “1” of the 2-bit SRS resource set indicator could be used to indicate the orderings of the M>1 (or N>1) TCI states or pairs of TCI states for multi-TRP PUCCH or PUSCH (repetitions) transmission as described above, and the bit fields “10” or “11” or the indexes “2” or “3” of the 2-bit SRS resource set indicator could be used to indicate the single-TRP PUCCH/PUSCH transmission or the multi-TRP PUCCH/PUSCH (repetitions) transmission as described above.

For another example, if the bit field of the SRS resource set indicator is set to “00” (or “01”) or the index of the SRS resource set indicator is set to “0” (or “1”) according to TABLE 1, the UE could use the primary TCI state or pair of TCI states determined from the indicated M>1 (or N>1) TCI states or pairs of TCI states to transmit PUCCH(s) or PUSCH(s)—i.e., PUCCH or PUSCH transmission in a single-TRP system; if the bit field of the SRS resource set indicator is set to “01” (or “00”) or the index of the SRS resource set indicator is set to “1” (or “2”) according to TABLE 1, the UE could use the secondary TCI state or pair of TCI states determined from the indicated M>1 (or N>1) TCI states or pairs of TCI states to transmit PUCCH(s) or PUSCH(s)—i.e., PUCCH or PUSCH transmission in a single-TRP system; the primary and secondary TCI states/pairs of TCI states could be determined/configured.

If the bit field of the SRS resource set indicator is set to “10” (or “11”) or the index of the SRS resource set indicator is set to “2” (or “3”) according to TABLE 1, the UE would follow the ordering of the indicated M>1 (or N>1) TCI states or pairs of TCI states to transmit one or more PUCCH transmission repetitions or PUSCH transmission repetitions associated with the indicated M>1 (or N>1) TCI states or pairs of TCI states (according to examples in the present disclosure); if the bit field of the SRS resource set indicator is set to “11” (or “10”) or the index of the SRS resource set indicator is set to “3” (or “2”) according to TABLE 1, the UE would follow the order-reversed M>1 (or N>1) TCI states or pairs of TCI states to transmit one or more PUCCH transmission repetitions or PUSCH transmission repetitions associated with the order-reversed M>1 (or N>1) TCI states or pairs of TCI states.

Alternatively, if the bit field of the SRS resource set indicator is set to “10” (or “11”) or the index of the SRS resource set indicator is set to “2” (or “3”) according to TABLE 1, the UE would follow a first ordering of the M>1 (or N>1) TCI states or pairs of TCI states to transmit one or more PUCCH transmission repetitions or PUSCH transmission repetitions associated with the M>1 (or N>1) TCI states or pairs of TCI states in the first ordering; if the bit field of the SRS resource set indicator is set to “11” (or “10”) or the index of the SRS resource set indicator is set to “3” (or “2”) according to TABLE 1, the UE would follow a second ordering of the M>1 (or N>1) TCI states or pairs of TCI states to transmit one or more PUCCH transmission repetitions or PUSCH transmission repetitions associated with the M>1 (or N>1) TCI states or pairs of TCI states in the second ordering.

The first and second orderings of TCI states/pairs of TCI states could be determined. Optionally, the bit fields “00” or “01” or the indexes “0” or “1” of the 2-bit SRS resource set indicator could be used to indicate the orderings of the M>1 (or N>1) TCI states or pairs of TCI states for multi-TRP PUCCH or PUSCH (repetitions) transmission as described above, and the bit fields “10” or “11” or the indexes “2” or “3” of the 2-bit SRS resource set indicator could be used to indicate the primary or secondary TCI states/pairs of TCI states for single-TRP PUCCH or PUSCH transmission as described above.

Yet for another example, in addition to the 2-bit SRS resource set indicator, the UE could also receive in a DCI (e.g., DCI format 1_1 or 1_2 with or without DL assignment) a one-bit indicator. For this design example, a new/dedicated DCI field could be used/configured in the corresponding DCI format to indicate the one-bit indicator; alternatively, one of more of the existing DCI fields in the corresponding DCI format could be used/configured to indicate the one-bit indicator. When the 2-bit SRS resource set indicator indicates the single-TRP PUCCH or PUSCH transmission, if the one-bit indicator is set to “0” (or “1”), the UE could use the primary TCI state or pair of TCI states determined from the indicated M>1 (or N>1) TCI states or pairs of TCI states to transmit PUCCH(s) or PUSCH(s); if the one-bit indicator is set to “1” (or “0”), the UE could use the secondary TCI state or pair of TCI states determined from the indicated M>1 (or N>1) TCI states or pairs of TCI states to transmit PUCCH(s) or PUSCH(s); the primary and secondary TCI states/pairs of TCI states could be determined/configured.

Yet for another example, the SRS resource set indicator indicated in DCI format 0_1 or 0_2 (e.g., in the “SRS resource set indicator” field) could correspond to a z-bit indicator (z>1, e.g., z=3) with 2\hat{ }z states or bit fields (e.g., 8 states or bit fields for z=3). In this example, a first state or bit field of the z-bit indicator could indicate that the single-TRP PUCCH or PUSCH transmission is enabled, a second state or bit field of the z-bit indicator could indicate that the multi-TRP PUCCH or PUSCH (repetitions) transmission is enabled, a third state or bit field of the z-bit indicator could indicate that the UE could use the primary TCI state or pair of TCI states for the single-TRP PUCCH or PUSCH transmission, a fourth state or bit field of the z-bit indicator could indicate that the UE could use the secondary TCI state or pair of TCI states for the single-TRP PUCCH or PUSCH transmission, a fifth state or bit field of the z-bit indicator could indicate an ordering of the M>1 (or N>1) TCI states or pairs of TCI states for the multi-TRP PUCCH or PUSCH (repetitions) transmission, a sixth state or bit field of the z-bit indicator could indicate another ordering of the M>1 (or N>1) TCI states or pairs of TCI states for the multi-TRP PUCCH or PUSCH (repetitions) transmission.

In yet another example, the UE could first receive in a DCI (e.g., DCI format 1_1 or 1_2 with or without DL assignment) M=1 (or N=1) TCI state or pair of TCI states indicated by a TCI state codepoint (or a TCI field). The UE could then receive in a DCI (e.g., DCI format 1_1 or 1_2 with or without DL assignment) M>1 (or N>1) TCI states or pairs of TCI states indicated by one or more TCI state codepoints (or one or more TCI fields), wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission.

Furthermore, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The SRS resource set indicator could indicate one or more of: (1) single-TRP PUCCH or PUSCH transmission, (2) multi-TRP PUCCH or PUSCH (repetitions) transmission, (3) one or more orderings of the indicated TCI states or pairs of TCI states for single-TRP PUCCH/PUSCH transmission or multi-TRP PUCCH/PUSCH (repetitions) transmission, and (4) one or more TCI states or pairs of TCI states for single-TRP PUCCH/PUSCH transmission or multi-TRP PUCCH/PUSCH (repetitions) transmission. The SRS resource set indicator could be configured.

For this example, if the SRS resource set indicator indicates that the single-TRP PUCCH or PUSCH transmission is enabled, the UE could follow the previously indicated M=1 (or N=1) TCI state or pair of TCI states to transmit PUCCH(s) or PUSCH(s).

The UE could receive from the network one or more MAC CE activation/sub-selection commands activating one or more sets of TCI states/TCI state IDs from the one or more TCI state pools or the one or more TCI state groups, with each set of activated/selected TCI states/TCI state IDs used to map up to Nc≥1 (e.g., 8, 16, 32 or 64) TCI state codepoints in a DCI format. Here, a TCI state codepoint could be configured.

Furthermore, the one or more sets of activated/selected TCI state codepoints could include/contain/comprise one or more of the following examples.

In one example, a first set of TCI state codepoints for single-TRP PUCCH or PUSCH transmission: the UE could receive in a DCI (e.g., DCI format 1_1 or 1_2 with or without DL assignment) M=1 (or N=1) TCI state or pair of TCI states indicated by a TCI state codepoint from the first set of TCI state codepoints; the UE could use the indicated TCI state or pair of TCI states for the single-TRP PUCCH or PUSCH transmission.

In another example, a second set of TCI state codepoints for single-TRP PUCCH or PUSCH transmission: the UE could receive in a DCI (e.g., DCI format 1_1 or 1_2 with or without DL assignment) M=1 (or N=1) TCI state or pair of TCI states indicated by a TCI state codepoint from the second set of TCI state codepoints; the UE could use the indicated TCI state or pair of TCI states as the primary TCI state or pair of TCI states for the single-TRP PUCCH or PUSCH transmission.

In yet another example, a third set of TCI state codepoints for single-TRP PUCCH or PUSCH transmission: the UE could receive in a DCI (e.g., DCI format 1_1 or 1_2 with or without DL assignment) M=1 (or N=1) TCI state or pair of TCI states indicated by a TCI state codepoint from the third set of TCI state codepoints; the UE could use the indicated TCI state or pair of TCI states as the secondary TCI state or pair of TCI states for the single-TRP PUCCH or PUSCH transmission.

In yet another example, a fourth set of TCI state codepoints for multi-TRP PUCCH or PUSCH (repetitions) transmission: the UE could receive in a DCI (e.g., DCI format 1_1 or 1_2 with or without DL assignment) M>1 (or N>1) TCI states or pairs of TCI states indicated by one or more TCI state codepoints from the fourth set of TCI state codepoints, wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission.

In yet another example, a fifth set of TCI state codepoints for multi-TRP PUCCH or PUSCH (repetitions) transmission: the UE could receive in a DCI (e.g., DCI format 1_1 or 1_2 with or without DL assignment) M>1 (or N>1) TCI states or pairs of TCI states indicated by one or more TCI state codepoints from the fifth set of TCI state codepoints, wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission. The ordering of the indicated M>1 (or N>1) TCI states or pairs of TCI states from the fifth set could correspond to an ordering of M>1 (or N>1) TCI states or pairs of TCI states (e.g., the first ordering).

In yet another example, a sixth set of TCI state codepoints for multi-TRP PUCCH or PUSCH (repetitions) transmission: the UE could receive in a DCI (e.g., DCI format 1_1 or 1_2 with or without DL assignment) M>1 (or N>1) TCI states or pairs of TCI states indicated by one or more TCI state codepoints from the sixth set of TCI state codepoints, wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission. The ordering of the indicated M>1 (or N>1) TCI states or pairs of TCI states from the sixth set could correspond to an ordering of M>1 (or N>1) TCI states or pairs of TCI states (e.g., the second ordering).

The UE could be indicated by the network from which set(s) of TCI state codepoints the indicated one or more TCI states or pairs of TCI states are selected. This indication could be via higher layer RRC signaling or MAC CE command or dynamic DCI based signaling. For instance, the UE could also receive in an uplink DCI (e.g., DCI format 0_1 or 0_2) a y-bit (y≥1) SRS resource set indicator (e.g., in the “SRS resource set indicator” field) to indicate one or more SRS resource sets. Here, the SRS resource set indicator is used to indicate the set(s) of TCI state codepoints. Each state/bit field/index of the y-bit SRS resource set indicator (a total of 2\hat{ }y states or bit fields for the y-bit SRS resource set indicator) could correspond to a set of TCI state codepoints (e.g., the first set, the second set, the third set, the fourth set, the fifth set or the sixth set as specified above).

For example, if a UE receives in DCI format 0_1 or 0_2 the y-bit SRS resource set indicator in the “SRS resource set indicator” field (e.g., set to a state or bit field value), the UE could determine the set of TCI state codepoints corresponding to the indicated state or bit field value of the y-bit SRS resource set indicator, from which the indicated one or more TCI states or pairs of TCI states are selected. According to the determined set of TCI state codepoints, the UE could perform/conduct the corresponding single-TRP PUCCH or PUSCH transmission or multi-TRP PUCCH or PUSCH (repetitions) transmission as discussed above.

Throughout the present disclosure, when the UE is configured with two SRS resource sets—including a first SRS resource set and a second SRS resource set—with higher layer parameter usage in each of the SRS-ResourceSet's set to ‘codebook’ or ‘noncodebook’, the PUSCH transmission repetitions or occasions as specified herein in the present disclosure—including a first PUSCH transmission repetition/occasion and a second PUSCH transmission repetition/occasion—are respectively associated to the first and the second SRS resource sets. Furthermore, throughout the present disclosure, unless otherwise specified, associating the first (indicated) TCI state/pair of TCI states to the PUSCH transmission repetition(s) is equivalent to associating the first (indicated) TCI state/pair of TCI states to the first (or second) PUSCH transmission repetition/occasion, and associating the second (indicated) TCI state/pair of TCI states to the PUSCH transmission repetition(s) is equivalent to associating the second (indicated) TCI state/pair of TCI states to the second (or first) PUSCH transmission repetition/occasion.

In one embodiment, a UE could receive in an uplink DCI (e.g., DCI format 0_1 or 0_2) a SRS resource set indicator (e.g., in the “SRS resource set indicator” field) to indicate one or more SRS resource sets for single-TRP or multi-TRP operation according to TABLE 1 in the present disclosure. The SRS resource set indicator could also indicate one or more of: (1) single-TRP transmission/reception or multi-TRP (repetitions) transmission/reception, (2) one or more orderings of the indicated TCI states/pairs of TCI states and (3) which TCI state/pair of TCI states to use if the single-TRP transmission/reception is enabled/configured, for one or more different channels. Here, the one or more different channels could correspond to: (a) PDCCH and PDSCH, (b) PDCCH and PUCCH, (c) PDCCH and PUSCH, (d) PDSCH and PUCCH, (e) PDSCH and PUSCH, (f) PUCCH and PUSCH, (g) PDCCH, PDSCH and PUCCH, (h) PDCCH, PDSCH and PUSCH, (i) PDCCH, PUCCH and PUSCH, (j) PDSCH, PUCCH and PUSCH or (k) PDCCH, PDSCH, PUCCH and PUSCH. In this embodiment:

The SRS resource set indicator for PDCCH could be configured/indicated for each of the one or more channels.

The SRS resource set indicator for PDCCH could be configured/indicated for each of the one or more channels.

The SRS resource set indicator for PDCCH could be used/applied to indicate TCI state(s)/pair(s) of TCI states ordering for each of the one or more channels.

The SRS resource set indicator for PDCCH could be used/applied to indicate TCI state(s)/pair(s) of TCI states ordering for each of the one or more channels.

The SRS resource set indicator for PDCCH could be configured/indicated for each of the one or more channels.

The SRS resource set indicator for PDCCH, PUCCH, or PUSCH could be configured/indicated for each of the one or more channels.

The SRS resource set indicator for PDCCH, PUCCH, or PUSCH could be configured/indicated for each of the one or more channels.

The SRS resource set indicator for PDCCH, PDSCH, PUCCH, or PUSCH could be configured/indicated for each of the one or more channels.

The UE could receive from the network one or more MAC CE activation/sub-selection commands activating one or more sets of TCI states/TCI state IDs from the one or more TCI state pools or the one or more TCI state groups, with each set of activated/selected TCI states/TCI state IDs used to map up to Nc≥1 (e.g., 8, 16, 32 or 64) TCI state codepoints in a DCI format. Here, a TCI state codepoint could be configured. Furthermore, the one or more sets of activated/selected TCI state codepoints could include/contain/comprise one or more of the following.

In one example, a first set of TCI state codepoints for single-TRP transmission/reception of each of the one or more channels: the UE could receive in a DCI (e.g., DCI format 1_1 or 1_2 with or without DL assignment) M=1 (or N=1) TCI state or pair of TCI states indicated by a TCI state codepoint from the first set of TCI state codepoints; the UE could use the indicated TCI state or pair of TCI states for the single-TRP transmission/reception of each of the one or more channels.

In another example, a second set of TCI state codepoints for single-TRP transmission/reception of each of the one or more channels: the UE could receive in a DCI (e.g., DCI format 1_1 or 1_2 with or without DL assignment) M=1 (or N=1) TCI state or pair of TCI states indicated by a TCI state codepoint from the second set of TCI state codepoints; the UE could use the indicated TCI state or pair of TCI states as the primary TCI state or pair of TCI states for the single-TRP transmission/reception of each of the one or more channels.

In yet another example, a third set of TCI state codepoints for single-TRP transmission/reception of each of the one or more channels: the UE could receive in a DCI (e.g., DCI format 1_1 or 1_2 with or without DL assignment) M=1 (or N=1) TCI state or pair of TCI states indicated by a TCI state codepoint from the third set of TCI state codepoints; the UE could use the indicated TCI state or pair of TCI states as the secondary TCI state or pair of TCI states for the single-TRP transmission/reception of each of the one or more channels.

In yet another example, a fourth set of TCI state codepoints for multi-TRP (repetitions) transmission/reception of each of the one or more channels: the UE could receive in a DCI (e.g., DCI format 1_1 or 1_2 with or without DL assignment) M>1 (or N>1) TCI states or pairs of TCI states indicated by one or more TCI state codepoints from the fourth set of TCI state codepoints, wherein one or more of the indicated M>1 (or N>1) TCI states or pairs of TCI states could be used for the multi-TRP (repetitions) transmission/reception of each of the one or more channels.

In yet another example, a fifth set of TCI state codepoints for multi-TRP (repetitions) transmission/reception of each of the one or more channels: the UE could receive in a DCI (e.g., DCI format 1_1 or 1_2 with or without DL assignment) M>1 (or N>1) TCI states or pairs of TCI states indicated by one or more TCI state codepoints from the fifth set of TCI state codepoints, wherein one or more of the indicated M>1 (or N>1) TCI states or pairs of TCI states could be used for the multi-TRP (repetitions) transmission/reception of each of the one or more channels. The ordering of the indicated M>1 (or N>1) TCI states or pairs of TCI states from the fifth set could correspond to an ordering of M>1 (or N>1) TCI states or pairs of TCI states (e.g., the first ordering) discussed in the present disclosure.

In yet another example, a sixth set of TCI state codepoints for multi-TRP (repetitions) transmission/reception of each of the one or more channels: the UE could receive in a DCI (e.g., DCI format 1_1 or 1_2 with or without DL assignment) M>1 (or N>1) TCI states or pairs of TCI states indicated by one or more TCI state codepoints from the sixth set of TCI state codepoints, wherein one or more of the indicated M>1 (or N>1) TCI states or pairs of TCI states could be used for the multi-TRP (repetitions) transmission/reception of each of the one or more channels. The ordering of the indicated M>1 (or N>1) TCI states or pairs of TCI states from the sixth set could correspond to an ordering of M>1 (or N>1) TCI states or pairs of TCI states (e.g., the second ordering) discussed in the present disclosure.

In yet another example, the UE could be indicated by the network from which set(s) of TCI state codepoints the indicated one or more TCI states or pairs of TCI states are selected. This indication could be via higher layer RRC signaling or MAC CE command or dynamic DCI based signaling. For instance, the UE could also receive in an uplink DCI (e.g., DCI format 0_1 or 0_2) a y-bit (y≥1) SRS resource set indicator (e.g., in the “SRS resource set indicator” field) to indicate one or more SRS resource sets. Here, the SRS resource set indicator is used to indicate the set(s) of TCI state codepoints. Each state/bit field/index of the y-bit SRS resource set indicator (a total of 2\hat{ }y states or bit fields for the y-bit SRS resource set indicator) could correspond to a set of TCI state codepoints (e.g., the first set, the second set, the third set, the fourth set, the fifth set or the sixth set as specified above).

For example, if a UE receives in DCI format 0_1 or 0_2 the y-bit SRS resource set indicator in the “SRS resource set indicator” field (e.g., set to a state or bit field value), the UE could determine the set of TCI state codepoints corresponding to the indicated state or bit field value of the y-bit SRS resource set indicator, from which the indicated one or more TCI states or pairs of TCI states are selected. According to the determined set of TCI state codepoints, the UE could perform/conduct the corresponding single-TRP PDCCH or PDSCH reception or PUCCH or PUSCH transmission or multi-TRP PDCCH or PDSCH (repetitions) reception or PUCCH or PUSCH (repetitions) transmission as discussed above.

As specified herein in the present disclosure, the UE could be indicated/provided by the network, e.g., in a beam indication DCI (e.g., DCI format 1_1/1_2 with or without DL assignment), a first TCI state/pair of TCI states and a second TCI state/pair of TCI states by one or more TCI codepoints of one or more TCI fields in the beam indication DCI, wherein an indicated TCI state could be a joint DL and UL TCI state provided by DLorJoint-TCIState or a separate DL TCI state provided by DLorJoint-TCIState or a separate UL TCI state provided by UL-TCIState—e.g., both of the first and second indicated TCI states/pairs of TCI states could be joint DL and UL TCI states each provided by DLorJoint-TCIState or both of the first and second indicated TCI states/pairs of TCI states could be separate UL TCI states each provided by UL-TCIState.

Furthermore, the UE could also receive in an uplink DCI (e.g., DCI format 0_1 or 0_2) a x-bit indicator (x≥0, e.g., x=0, x=1, x=2, and etc.), wherein the uplink DCI could schedule one or more PUSCH transmissions that are associated with a SRS resource set and the x-bit indicator could be a new DCI indicator field introduced in the corresponding DCI format (e.g., 0_1 or 0_2) or by repurposing one or more field bits of one or more existing DCI fields in the corresponding DCI format (e.g., 0_1 or 0_2).

Furthermore, the presence of the x-bit indicator in the corresponding DCI format could be configured/configurable by RRC. When/if the x-bit indicator as described above in the present disclosure is not configured or not present or absent in the corresponding DCI format, x=0, i.e., the corresponding DCI indicator field is 0 bit; otherwise, when/if the x-bit indicator as described above in the present disclosure is configured or present, x≥1. For instance, as described herein in the present disclosure, the x-bit indicator could correspond to the SRS resource set indicator in DCI 0_1/0_2.

In one example, x=1. For this case, when/if the 1-bit indicator is set to “0” (or “1”), the UE could use a reference signal provided/indicated in the first indicated TCI state/pair of TCI states as a reference for determining UL TX spatial filter for PUSCH, e.g., scheduled by the uplink DCI (e.g., DCI format 0_1 or 0_2) and associated with the SRS resource set. When/if the 1-bit indicator is set to “1” (or “0”), the UE could use a reference signal provided/indicated in the second indicated TCI state/pair of TCI states as a reference for determining UL TX spatial filter for PUSCH, e.g., scheduled by the uplink DCI (e.g., DCI format 0_1 or 0_2) and associated with the SRS resource set.

In another example, x=2. For this case, when/if the 2-bit indicator (or the SRS resource set indicator) is set to “00” (or “01,” “10” or “11”), the UE could use a reference signal provided/indicated in the first indicated TCI state/pair of TCI states as a reference for determining UL TX spatial filter for PUSCH, e.g., scheduled by the uplink DCI (e.g., DCI format 0_1 or 0_2) and associated with the SRS resource set; when/if the 2-bit indicator (or the SRS resource set indicator) is set to “01” (or “00” or “10” or “11”), the UE could use a reference signal provided/indicated in the second indicated TCI state/pair of TCI states as a reference for determining UL TX spatial filter for PUSCH, e.g., scheduled by the uplink DCI (e.g., DCI format 0_1 or 0_2) and associated with the SRS resource set; when/if the 2-bit indicator (or the SRS resource set indicator) is set to “10” (or “00” or “01” or “11”), the UE could respectively use a reference signal provided/indicated in the first indicated TCI state/pair of TCI states and a reference signal provided/indicated in the second indicated TCI state/pair of TCI states as references for determining UL TX spatial filters to simultaneously transmit PUSCHs, e.g., scheduled by the uplink DCI (e.g., DCI format 0_1 or 0_2) and associated with the SRS resource set; and when/if the 2-bit indicator (or the SRS resource set indicator) is set to “11” (or “00” or “01” or “10”), the UE could respectively use a reference signal provided/indicated in the second indicated TCI state/pair of TCI states and a reference signal provided/indicated in the first indicated TCI state/pair of TCI states as references for determining UL TX spatial filters to simultaneously transmit PUSCHs, e.g., scheduled by the uplink DCI (e.g., DCI format 0_1 or 0_2) and associated with the SRS resource set.

As discussed above/herein in the present disclosure, the UE could use the x-bit DCI indicator field in an uplink DCI, e.g., DCI format 0_1/0_2, that schedules/activates the PUSCH(s) as specified herein in the present disclosure to determine one or more of the unified TCI states/pairs of TCI states indicated in the beam indication DCI, e.g., DCI format 1_1/1_2 with or without DL assignment, for determining UL TX filter(s) for the PUSCH(s), when/if one or more of the following conditions for associating/mapping the UL DCI (and therefore, the x-bit indicator indicated/provided/carried therein) and the beam indication DCI (and therefore, the unified TCI state(s)/pair(s) of TCI states indicated/provided/carried therein) are achieved/satisfied.

In one example, when/if the UL DCI (and therefore, the x-bit indicator indicated/provided/carried therein) and the beam indication DCI (and therefore, the unified TCI state(s)/pair(s) of TCI states indicated/provided/carried therein) is received in the same slot. For example, in the same slot, the UL DCI could be received later (or earlier) in time than the beam indication DCI. For another example, in the same slot, the UL DCI could be received in the same OFDM symbol(s) as the beam indication DCI.

In another example, when/if the UL DCI (and therefore, the x-bit indicator indicated/provided/carried therein) and the beam indication DCI (and therefore, the unified TCI state(s)/pair(s) of TCI states indicated/provided/carried therein) is received within a time window. The time window or the value of the time window could be fixed in the system specifications. Alternatively, the UE could be indicated/configured/provided by the network, e.g., via higher layer RRC signaling/parameter and/or MAC CE command and/or dynamic DCI based L1 signaling, the time window or the value of the time window. For example, in/within the time window, the UL DCI could be received later (or earlier) in time than the beam indication DCI. For another example, in/within the time window, the UL DCI could be received in the same OFDM symbol(s) as the beam indication DCI.

In yet another example, when/if the UL DCI (and therefore, the x-bit indicator indicated/provided/carried therein) is received T_1 later (or earlier) than the reception of the beam indication DCI (and therefore, the unified TCI state(s)/pair(s) of TCI states indicated/provided/carried therein). For instance, T_1 could be in OFDM symbols, slots, mini-slots, and etc. The value of T1 could be fixed in the system specifications. Alternatively, the UE could be indicated/configured/provided by the network, e.g., via higher layer RRC signaling/parameter and/or MAC CE command and/or dynamic DCI based L1 signaling, the value of T1.

In yet another example, when/if the UL DCI (and therefore, the x-bit indicator indicated/provided/carried therein) is received T_2 later (or earlier) than the time when the TCI state(s)/pair(s) of TCI states indicated in in the beam indication DCI applies or becomes effective. The time when the TCI state(s)/pair(s) of TCI states indicated in the beam indication DCI applies or becomes effective from the first slot that is at least BeamAppTime_r17 symbols after the last symbol of the PUCCH with HARQ-ACK information corresponding to the beam indication DCI carrying the TCI state(s) indication and without DL assignment, or corresponding to the PDSCH scheduling/scheduled by the beam indication DCI carrying the TCI state(s) indication and/or when/if the indicated TCI state(s) is different from the previously indicated one(s). For instance, T_2 could be in OFDM symbols, slots, mini-slots, and etc. The value of T2 could be fixed in the system specifications, e.g., T2=0. Alternatively, the UE could be indicated/configured/provided by the network, e.g., via higher layer RRC signaling/parameter and/or MAC CE command and/or dynamic DCI based L1 signaling, the value of T2.

In yet another example, when/if the indicated TCI state(s) indicated/provided in the beam indication DCI is different from the previously indicated one(s), the UE is not expected to or would not use the x-bit DCI indicator field in the uplink DCI that is received earlier in time than the beam indication DCI to determine the unified TCI state(s)/pair(s) of TCI states indicated in the beam indication DCI for determining UL TX filter(s) for the PUSCH(s). For this case, the UE could only use the x-bit DCI indicator field in the uplink DCI that is received later in time than the beam indication DCI—according to one or more of the design examples specified herein in the present disclosure—to determine the unified TCI state(s)/pair(s) of TCI states indicated in the beam indication DCI for determining UL TX filter(s) for the PUSCH(s).

In yet another example, when/if the UL DCI (and therefore, the x-bit indicator indicated/provided/carried therein) and the beam indication DCI (and therefore, the unified TCI state(s)/pair(s) of TCI states indicated/provided/carried therein) have the same identifiers (IDs) indicated/provided therein. In the UL DCI, e.g., DCI format 0_1/0_2, and/or the beam indication DCI, e.g., DCI format 1_1/1_2, the ID field could be a new DCI field dedicated for associating/mapping the UL DCI and the beam indication DCI. Alternatively, the ID could be via repurposing one or more field bits of one or more existing DCI fields in the corresponding UL DCI format, e.g., 0_1/0_2, or the corresponding DL (beam indication) DCI format, e.g., 1_1/1_2.

In yet another example, when/if the UL DCI (and therefore, the x-bit indicator indicated/provided/carried therein) and the beam indication DCI (and therefore, the unified TCI state(s)/pair(s) of TCI states indicated/provided/carried therein) are received in CORESET(s) associated/configured with the same entity ID, wherein an entity ID could be a CORESET ID/index, a CORESET pool index/CORESETPoolIndex, a CORESETGroupIndex/CORESET group index, a RS set ID/index, a PCI, a PCI index and etc.

Additionally, when/if the x-bit indicator specified herein in the present disclosure is not configured/present or x=0 or the corresponding SRS resource set indicator in DCI 0_1/0_2 is not configured/present.

In one example, the UE could use a reference signal provided/indicated in the first indicated TCI state/pair of TCI states as a reference for determining UL TX spatial filter for PUSCH, e.g., scheduled by the uplink DCI (e.g., DCI format 0_1 or 0_2).

In another example, the UE could use a reference signal provided/indicated in the second indicated TCI state/pair of TCI states as a reference for determining UL TX spatial filter for PUSCH, e.g., scheduled by the uplink DCI (e.g., DCI format 0_1 or 0_2).

In yet another example, the UE could respectively use a reference signal provided/indicated in the first indicated TCI state/pair of TCI states and a reference signal provided/indicated in the second indicated TCI state/pair of TCI states as references for determining UL TX spatial filters to simultaneously transmit PUSCHs, e.g., scheduled by the uplink DCI (e.g., DCI format 0_1 or 0_2).

In yet another example, the UE could respectively use a reference signal provided/indicated in the second indicated TCI state/pair of TCI states and a reference signal provided/indicated in the first indicated TCI state/pair of TCI states as references for determining UL TX spatial filters to simultaneously transmit PUSCHs, e.g., scheduled by the uplink DCI (e.g., DCI format 0_1 or 0_2).

In yet another example, the UE could be configured/indicated/provided by the network, e.g., via higher layer RRC signaling/parameter, a y-bit indicator, where y≥1—e.g., y=1 or y=2. For y=1, when/if the 1-bit indicator is set to “0” (or “1”), the UE could use a reference signal provided/indicated in the first indicated TCI state/pair of TCI states as a reference for determining UL TX spatial filter for PUSCH, e.g., scheduled by the uplink DCI (e.g., DCI format 0_1 or 0_2), and when/if the 1-bit indicator is set to “1” (or “0”), the UE could use a reference signal provided/indicated in the second indicated TCI state/pair of TCI states as a reference for determining UL TX spatial filter for PUSCH, e.g., scheduled by the uplink DCI (e.g., DCI format 0_1 or 0_2).

In yet another example, the UE could be configured/indicated/provided by the network, e.g., via higher layer RRC signaling/parameter, a y-bit indicator, where y≥1—e.g., y=1 or y=2. For y=2, when/if the 2-bit indicator is set to “00” (or “01,” “10” or “11”), the UE could use a reference signal provided/indicated in the first indicated TCI state/pair of TCI states as a reference for determining UL TX spatial filter for PUSCH, e.g., scheduled by the uplink DCI (e.g., DCI format 0_1 or 0_2); when/if the 2-bit indicator is set to “01” (or “00” or “10” or “11”), the UE could use a reference signal provided/indicated in the second indicated TCI state/pair of TCI states as a reference for determining UL TX spatial filter for PUSCH, e.g., scheduled by the uplink DCI (e.g., DCI format 0_1 or 0_2); when/if the 2-bit indicator is set to “10” (or “00” or “01” or “11”), the UE could respectively use a reference signal provided/indicated in the first indicated TCI state/pair of TCI states and a reference signal provided/indicated in the second indicated TCI state/pair of TCI states as references for determining UL TX spatial filters to simultaneously transmit PUSCHs, e.g., scheduled by the uplink DCI (e.g., DCI format 0_1 or 0_2); and when/if the 2-bit indicator is set to “11” (or “00” or “01” or “10”), the UE could respectively use a reference signal provided/indicated in the second indicated TCI state/pair of TCI states and a reference signal provided/indicated in the first indicated TCI state/pair of TCI states as references for determining UL TX spatial filters to simultaneously transmit PUSCHs, e.g., scheduled by the uplink DCI (e.g., DCI format 0_1 or 0_2).

In yet another example, the UE could use reference signal(s) provided/indicated in the TCI state(s)/pair(s) of TCI states indicated in the TCI field(s) (e.g., via one or more TCI codepoints) of the beam indication DCI as reference(s) for determining UL TX spatial filter for PUSCH, e.g., scheduled by the uplink DCI (e.g., DCI format 0_1 or 0_2).

In yet another example, the UE could use reference signal(s) provided/indicated in the TCI state(s)/pair(s) of TCI states—indicated in the TCI field(s) (e.g., via one or more TCI codepoints) of the beam indication DCI—that is associated with PDCCH(s)/DCI(s)/CORESET(s) that schedules/activates the PUSCH(s) as reference(s) for determining UL TX spatial filter for the PUSCH(s).

The UE could be provided/configured/indicated by the network, e.g., via higher layer RRC signaling and/or MAC CE command and/or dynamic DCI based L1 signaling, two SRS resource sets—a first SRS resource set and a second SRS resource set—each provided by SRS-ResourceSet, wherein each SRS resource set could include/contain one or more SRS resources and could be codebook based or non-codebook based. The two SRS resource sets could be (one-to-one) associated/mapped to the two indicated TCI states/pairs of TCI states as specified herein in the present disclosure.

In one example, the association/mapping between the two configured SRS resource sets and the two indicated TCI states/pairs of TCI states is fixed in the system specifications. For instance, the first configured SRS resource set (either codebook-based or non-codebook based) could be associated/mapped to the first (or second) indicated TCI state/pair of TCI states, and the second configured SRS resource set (either codebook-based or non-codebook based) could be associated/mapped to the second (or first) indicated TCI state/pair of TCI states.

In another example, the UE could be indicated/provided/configured by the network, e.g., via higher layer RRC signaling/parameter and/or MAC CE command and/or dynamic DCI based L1 signaling, the mapping/association between the configured two SRS resource sets and the two indicated unified TCI states/pairs of TCI states.

For the first configured SRS resource set (e.g., provided by SRS-ResourceSet0) as specified herein in the present disclosure, following examples can be provided.

In one example, when/if the UE is provided/configured by the network, e.g., via higher layer RRC signaling and/or MAC CE command and/or dynamic DCI based L1 signaling, “followUnifiedTCIState” for the first configured SRS resource set or the first configured SRS resource set is configured/associated with “followUnifiedTCIState,” the UE could follow one or more of the design examples (e.g., those specified in examples) specified herein in the present disclosure to determine the indicated TCI state(s) for the first SRS resource set. The UE could then use reference signal(s) provided/indicated in the indicated TCI state(s) associated with the first configured SRS resource set as reference(s) for determining UL TX spatial filter for PUSCH, e.g., scheduled by the uplink DCI (e.g., DCI format 0_1 or 0_2) and associated with the first configured SRS resource set. When/if the UE is not provided/configured by the network, e.g., via higher layer RRC signaling and/or MAC CE command and/or dynamic DCI based L1 signaling, “followUnifiedTCIState” for the first configured SRS resource set or the first configured SRS resource set is not configured/associated with “followUnifiedTCIState,” the UE could follow one or more of the design examples (e.g., the x-bit indicator specified in examples, wherein now, the x-bit indicator is associated with/configured for the first SRS resource set) specified herein in the present disclosure to determine the indicated TCI state(s)—and therefore, the corresponding reference signal(s)/reference(s) for determining the UL TX spatial filter(s)—for PUSCH(s) scheduled by the DCI format 0_1/0_2 and associated with the first SRS resource set.

In another example, when/if the x-bit indicator—e.g., associated with/configured for the first SRS resource set—specified herein in the present disclosure is not configured/present or x=0 or the corresponding SRS resource set indicator in DCI 0_1/0_2 is not configured/present, the UE could follow one or more of the design examples specified herein in the present disclosure to determine the indicated TCI state(s) for the first SRS resource set. The UE could then use reference signal(s) provided/indicated in the indicated TCI state(s) associated with the first configured SRS resource set as reference(s) for determining UL TX spatial filter for PUSCH, e.g., scheduled by the uplink DCI (e.g., DCI format 0_1 or 0_2) and associated with the first configured SRS resource set. When/if the x-bit indicator—e.g., associated with/configured for the second SRS resource set—specified in the present disclosure is configured/present and/or set to valid values such as x=1 or x=2 or the corresponding SRS resource set indicator in DCI 0_1/0_2 is configured/present, the UE could follow one or more of the design examples (e.g., the x-bit indicator, wherein now, the x-bit indicator is associated with/configured for the first SRS resource set) specified herein in the present disclosure to determine the indicated TCI state(s)—and therefore, the corresponding reference signal(s)/reference(s) for determining the UL TX spatial filter(s)—for PUSCH(s) scheduled by the DCI format 0_1/0_2 and associated with the first SRS resource set.

For the second configured SRS resource set (e.g., provided by SRS-ResourceSet1) as specified herein in the present disclosure, following examples can be provided.

In one example, when/if the UE is provided/configured by the network, e.g., via higher layer RRC signaling and/or MAC CE command and/or dynamic DCI based L1 signaling, “followUnifiedTCIState” for the second configured SRS resource set or the second configured SRS resource set is configured/associated with “followUnifiedTCIState,” the UE could follow one or more of the design examples specified herein in the present disclosure to determine the indicated TCI state(s) for the second SRS resource set. The UE could then use reference signal(s) provided/indicated in the indicated TCI state(s) associated with the second configured SRS resource set as reference(s) for determining UL TX spatial filter for PUSCH, e.g., scheduled by the uplink DCI (e.g., DCI format 0_1 or 0_2) and associated with the second configured SRS resource set. When/if the UE is not provided/configured by the network, e.g., via higher layer RRC signaling and/or MAC CE command and/or dynamic DCI based L1 signaling, “followUnifiedTCIState” for the second configured SRS resource set or the second configured SRS resource set is not configured/associated with “followUnifiedTCIState,” the UE could follow one or more of the design examples (e.g., the x-bit indicator, wherein now, the x-bit indicator is associated with/configured for the second SRS resource set) specified herein in the present disclosure to determine the indicated TCI state(s)—and therefore, the corresponding reference signal(s)/reference(s) for determining the UL TX spatial filter(s)—for PUSCH(s) scheduled by the DCI format 0_1/0_2 and associated with the second SRS resource set.

In another example, when/if the x-bit indicator—e.g., associated with/configured for the second SRS resource set—specified herein in the present disclosure is not configured/present or x=0 or the corresponding SRS resource set indicator in DCI 0_1/0_2 is not configured/present, the UE could follow one or more of the design examples specified herein in the present disclosure to determine the indicated TCI state(s) for the second SRS resource set. The UE could then use reference signal(s) provided/indicated in the indicated TCI state(s) associated with the second configured SRS resource set as reference(s) for determining UL TX spatial filter for PUSCH, e.g., scheduled by the uplink DCI (e.g., DCI format 0_1 or 0_2) and associated with the second configured SRS resource set.

When/if the x-bit indicator—e.g., associated with/configured for the second SRS resource set—specified in the present disclosure is configured/present and/or set to valid values such as x=1 or x=2 or the corresponding SRS resource set indicator in DCI 0_1/0_2 is configured/present, the UE could follow one or more of the design examples (e.g., the x-bit indicator, wherein now, the x-bit indicator is associated with/configured for the second SRS resource set) specified herein in the present disclosure to determine the indicated TCI state(s)—and therefore, the corresponding reference signal(s)/reference(s) for determining the UL TX spatial filter(s)—for PUSCH(s) scheduled by the DCI format 0_1/0_2 and associated with the second SRS resource set.

In Rel. 17, a unified transmission configuration indication (TCI) framework is specified for single-TRP operation, wherein a common beam could be indicated for all UE-dedicated control and/or data channels. To extend the Rel. 17 unified TCI framework to the multi-TRP operation, various design aspects such as means of configurating one or more TCI fields or TCI state codepoints to indicate beams for multiple TRPs need to be specified. Furthermore, as multiple multi-TRP operation modes such as PDCCH/PDSCH/PUCCH/PUSCH repetitions are supported/specified in Rel. 16/17, means of dynamic switching between different multi-TRP operation modes or dynamic switching between one or more multi-TRP operation modes and the single-TRP operation mode via beam indication need to be specified.

The present disclosure provides various design aspects related to DCI based beam indication for multi-TRP operation. In particular, detailed configuration methods of TCI states, TCI fields or TCI state codepoints—e.g., via repurposing one or more existing DCI fields—in an uplink DCI such as DCI format 0_0, 0_1 or 0_2, and their association with different TRPs in a multi-TRP system, are specified/provided in the present disclosure. This disclosure further specifies various methods to dynamically switch between different multi-TRP operation modes or between one or more multi-TRP operation modes and the single-TRP operation mode via beam/TCI state indication.

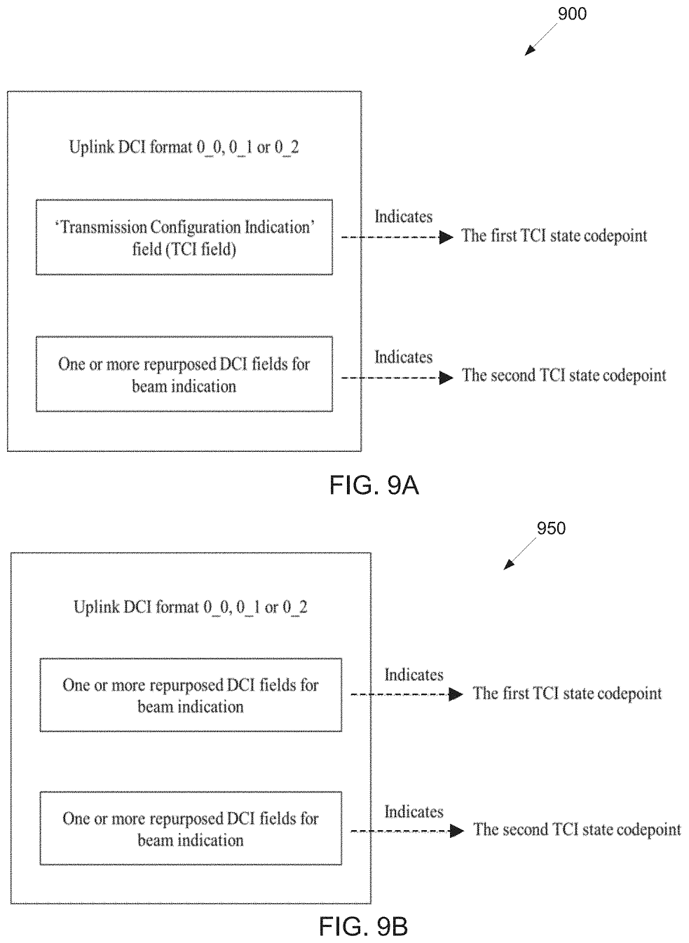

FIG. 9A illustrates an example of an indication of the first and second TCI state codepoints 900 according to embodiments of the present disclosure. An embodiment of the indication of the first and second TCI state codepoints 900 shown in FIG. 9A is for illustration only.

FIG. 9B illustrates another example of an indication of the first and second TCI state codepoints 950 according to embodiments of the present disclosure. An embodiment of the indication of the first and second TCI state codepoints 950 shown in FIG. 9B is for illustration only.

As aforementioned, one or more of the Nc≥1 (e.g., 8, 16, 32 or 64) TCI state codepoints activated by the MAC CE could correspond to the TCI state codepoints.

In one example, two “Transmission Configuration Indication” fields could be indicated/configured in an uplink DCI such as DCI format 0_0, 0_1 or 0_2. In particular, a first TCI field could be configured/indicated/included in an uplink DCI such as DCI format 0_0, 0_1 or 0_2 indicating a first TCI state codepoint from the Nc≥1 (e.g., 8, 16, 32 or 64) activated TCI state codepoints determined, and a second TCI field could be configured/indicated/included in an uplink DCI such as DCI format 0_0, 0_1 or 02 indicating a second TCI state codepoint from the Nc≥1 (e.g., 8, 16, 32 or 64) activated TCI state codepoints determined.

For example, the first TCI field could be provided by “Transmission Configuration Indication” or “Transmission Configuration Indication 0” or “Transmission Configuration Indication 1” in the corresponding DCI format, and the second TCI field could be provided by “Transmission Configuration Indication” or “Transmission Configuration Indication 1” or “Transmission Configuration Indication 2” in the corresponding DCI format. For another example, the first and second TCI fields could be according to the order in which they appear in the corresponding DCI format descriptions in the 3GPP standard specification TS 38.212.

In another example, a “Transmission Configuration Indication” field could be indicated/configured/included in an uplink DCI such as DCI format 0_0, 0_1 or 0_2 indicating a first TCI state codepoint from the Nc≥1 (e.g., 8, 16, 32 or 64) activated TCI state codepoints determined. Furthermore, one or more reserved fields in DCI format 0_0, 0_1 or 0_2 could be repurposed to indicate a second TCI state codepoint from the Nc≥1 (e.g., 8, 16, 32 or 64) activated TCI state codepoints determined.

In FIG. 9A, an example of indicating the first and second TCI state codepoints in DCI format 0_0, 0_1 or 0_2 is presented. For DCI format 0_0, one or more DCI fields could be reserved for beam indication, which could correspond to one or more of: “Frequency domain resource assignment” field, “Time domain resource assignment” field, “Frequency hopping flag” field, “Modulation and coding scheme” field, “New data indicator” field, “Redundancy version” field, “HARQ process number” field, “TPC command for scheduled PUSCH” field, “ChannelAccess-CPext” field, “Padding bits” field and “UL/SUL indicator” field. For DCI format 0_1, one or more DCI fields could be reserved for beam indication, which could correspond to one or more of: “HARQ-ACK bitmap” field, “TPC command for scheduled PUSCH” field, “UL/SUL indicator” field, “Frequency domain resource assignment” field, “Time domain resource assignment” field, “Frequency hopping flag” field, “Modulation and coding scheme” field, “New data indicator” field, “Redundancy version” field, “HARQ process number” field, “1^{st} downlink assignment index” field, “2^{nd} downlink assignment index” field, “TPC command for scheduled PUSCH” field, “Second TPC command for scheduled PUSCH” field, “SRS resource set indicator” field, “SRS resource indicator” field, “Second SRS resource indicator” field, “Precoding information and number of layers” field, “Second precoding information” field, “Antenna ports” field, “SRS request” field, “SRS offset indicator” field, “CSI request” field, “CBG transmission information (CBGTI)” field, “PTRS-DMRS association” field, “Second PTRS-DMRS association” field, “beta_offset indicator” field, “DMRS sequence initialization” field, “UL-SCH indicator” field, “ChannelAccess-CPext-CAPC” field, “Open-loop power control parameter set indication” field, “Priority indicator” field, “Invalid symbol pattern indicator” field, “Minimum applicable scheduling offset indicator” field, “SCell dormancy indication” field, “Sidelink assignment index” field and “PDCCH monitoring adaptation indication” field. For DCI format 0_2, one or more DCI fields could be reserved for beam indication, which could correspond to one or more of: “UL/SUL indicator” field, “Frequency domain resource assignment” field, “Time domain resource assignment” field, “Frequency hopping flag” field, “Modulation and coding scheme” field, “New data indicator” field, “Redundancy version” field, “HARQ process number” field, “Downlink assignment index” field, “TPC command for scheduled PUSCH” field, “Second TPC command for scheduled PUSCH” field, “SRS resource set indicator” field, “SRS resource indicator” field, “Second SRS resource indicator” field, “Precoding information and number of layers” field, “Second precoding information” field, “Antenna ports” field, “SRS request” field, “SRS offset indicator” field, “CSI request” field, “PTRS-DMRS association” field, “Second PTRS-DMRS association” field, “beta_offset indicator” field, “DMRS sequence initialization” field, “UL-SCH indicator” field, “ChannelAccess-CPext-CAPA” field, “Open-loop power control parameter set indication” field, “Priority indicator” field, “Invalid symbol pattern indicator” field and “PDCCH monitoring adaptation indication” field.

For example, one or more of the reserved DCI field(s) for beam indication in DCI format 0_0, 0_1 or 0_2—as described above—could be used for indicating the second TCI state codepoint. For another example, only the reserved DCI field(s) for beam indication (in DCI format 0_0, 0_1 or 0_2) with a fixed bit size that does not depend on RRC configuration could be used for indicating the second TCI state codepoint. Yet for another example, only the reserved DCI field(s) for beam indication (in DCI format 0_0, 0_1 or 0_2) with a minimum bit size greater than zero that does not depend on RRC configuration could be used for indicating the second TCI state codepoint.

In particular, the bits corresponding to the reserved DCI field(s) for indicating the second TCI state codepoint could start from one of: (1) the first (according to the order in which it appears in the DCI format description in the 3GPP standard specification TS 38.212) reserved field in the DCI format for indicating the second TCI state codepoint, then the second reserved field for indicating the second TCI state codepoint, and so on until the second TCI state codepoint has been allocated to reserved bits, and (2) the last (according to the order in which it appears in the DCI format description in the 3GPP standard specification TS 38.212) reserved field in the DCI format for indicating the second TCI state codepoint, then the second last reserved field for indicating the second TCI state codepoint, and so on until the second TCI state codepoint has been allocated to reserved bits.

In another example, one or more reserved fields in DCI format 0_0, 0_1 or 0_2 could be repurposed to indicate a first TCI state codepoints and a second TCI state codepoint, wherein the first TCI state codepoint and the second TCI state codepoint are from the Nc≥1 (e.g., 8, 16, 32 or 64) activated TCI state codepoints determined. For DCI format 0_0, one or more DCI fields could be reserved for beam indication, which could correspond to one or more of: “Frequency domain resource assignment” field, “Time domain resource assignment” field, “Frequency hopping flag” field, “Modulation and coding scheme” field, “New data indicator” field, “Redundancy version” field, “HARQ process number” field, “TPC command for scheduled PUSCH” field, “ChannelAccess-CPext” field, “Padding bits” field and “UL/SUL indicator” field. For DCI format 0_1, one or more DCI fields could be reserved for beam indication, which could correspond to one or more of: “HARQ-ACK bitmap” field, “TPC command for scheduled PUSCH” field, “UL/SUL indicator” field, “Frequency domain resource assignment” field, “Time domain resource assignment” field, “Frequency hopping flag” field, “Modulation and coding scheme” field, “New data indicator” field, “Redundancy version” field, “HARQ process number” field, “1^{st} downlink assignment index” field, “2^{nd} downlink assignment index” field, “TPC command for scheduled PUSCH” field, “Second TPC command for scheduled PUSCH” field, “SRS resource set indicator” field, “SRS resource indicator” field, “Second SRS resource indicator” field, “Precoding information and number of layers” field, “Second precoding information” field, “Antenna ports” field, “SRS request” field, “SRS offset indicator” field, “CSI request” field, “CBG transmission information (CBGTI)” field, “PTRS-DMRS association” field, “Second PTRS-DMRS association” field, “beta_offset indicator” field, “DMRS sequence initialization” field, “UL-SCH indicator” field, “ChannelAccess-CPext-CAPC” field, “Open-loop power control parameter set indication” field, “Priority indicator” field, “Invalid symbol pattern indicator” field, “Minimum applicable scheduling offset indicator” field, “SCell dormancy indication” field, “Sidelink assignment index” field and “PDCCH monitoring adaptation indication” field. For DCI format 0_2, one or more DCI fields could be reserved for beam indication, which could correspond to one or more of: “UL/SUL indicator” field, “Frequency domain resource assignment” field, “Time domain resource assignment” field, “Frequency hopping flag” field, “Modulation and coding scheme” field, “New data indicator” field, “Redundancy version” field, “HARQ process number” field, “Downlink assignment index” field, “TPC command for scheduled PUSCH” field, “Second TPC command for scheduled PUSCH” field, “SRS resource set indicator” field, “SRS resource indicator” field, “Second SRS resource indicator” field, “Precoding information and number of layers” field, “Second precoding information” field, “Antenna ports” field, “SRS request” field, “SRS offset indicator” field, “CSI request” field, “PTRS-DMRS association” field, “Second PTRS-DMRS association” field, “beta_offset indicator” field, “DMRS sequence initialization” field, “UL-SCH indicator” field, “ChannelAccess-CPext-CAPA” field, “Open-loop power control parameter set indication” field, “Priority indicator” field, “Invalid symbol pattern indicator” field and “PDCCH monitoring adaptation indication” field.

For example, one or more of the reserved DCI field(s) for beam indication in DCI format 0_0, 0_1 or 0_2—as described above—could be used for indicating the first and second TCI state codepoints. For another example, only the reserved DCI field(s) for beam indication (in DCI format 0_0, 0_1 or 0_2) with a fixed bit size that does not depend on RRC configuration could be used for indicating the first and second TCI state codepoints. Yet for another example, only the reserved DCI field(s) for beam indication (in DCI format 0_0, 0_1 or 0_2) with a minimum bit size greater than zero that does not depend on RRC configuration could be used for indicating the first and second TCI state codepoints. In particular, the bits corresponding to the reserved DCI field(s) for indicating the first and second TCI state codepoints could start from one of: (1) the first (according to the order in which it appears in the DCI format description in the 3GPP standard specification TS 38.212) reserved field in the DCI format for indicating the first and second TCI state codepoints, then the second reserved field for indicating the first and second TCI state codepoints, and so on until the first and second TCI state codepoints have been allocated to reserved bits, and (2) the last (according to the order in which it appears in the DCI format description in the 3GPP standard specification TS 38.212) reserved field in the DCI format for indicating the first and second TCI state codepoints, then the second last reserved field for indicating the first and second TCI state codepoints, and so on until the first and second TCI state codepoints have been allocated to reserved bits.

Optionally, the UE could receive from the network an auxiliary MAC CE sub-selection/activation command selecting/activating one or more (Nc′≥1, e.g., Nc′=8, 16, 32 or 64) TCI state codepoints from the set of Nc activated TCI state codepoints as a subset of Nc′ TCI state codepoints. For this case, the first TCI state codepoint or the second TCI state codepoint could be from the subset of Nc′≥1 (e.g., 8, 16, 32 or 64) TCI state codepoints.

Additionally, if the number of TCI state codepoints Nc to be activated by MAC CE is smaller than a threshold, the TCI state codepoint indicated in the “Transmission Configuration Indication” field could only correspond to/indicate a single TCI state or a single pair of TCI states (e.g., the TCI state codepoint) for single-TRP operation. If the number of TCI state codepoints Nc to be activated by MAC CE is smaller than a threshold, (1) the TCI state(s)/TCI state codepoint(s) can only be indicated/configured in the dedicated “Transmission Configuration Indication” field in the corresponding DCI format—e.g., the first TCI state codepoint indicated in the TCI field, (2) none of the existing DCI fields or none of the reserved DCI fields for beam indication in the corresponding DCI format would be repurposed to indicate TCI state(s)/TCI state codepoint(s)—e.g., the second TCI state codepoint, or (3) none of the existing DCI fields or none of the reserved DCI fields for beam indication in the corresponding DCI format would be repurposed to indicate the second TCI state codepoint (or the first TCI state codepoint), while one or more of the existing DCI fields or reserved DCI fields for beam indication in the corresponding DCI format would be repurposed to indicate the first TCI state codepoint (or the second TCI state codepoint); furthermore, the first TCI state codepoint (or the second TCI state codepoint) could only correspond to/indicate a single TCI state or a single pair of TCI states for single-TRP operation. If the number of TCI state codepoints Nc to be activated by MAC CE is smaller than a threshold, each of the MAC CE activated TCI state codepoints could only correspond to/indicate a single TCI state or a single pair of TCI states (e.g., the TCI state codepoint) for single-TRP operation. In the present disclosure, the threshold could be (1) fixed, e.g., 8, 16, 32 or 64, or (2) configured by the network via higher layer RRC signaling or/and MAC CE command or/and DCI based signaling.

For DCI based beam indication, in one example, a “Transmission Configuration Indication” field could be indicated/configured/included in DCI format 0_0, 0_1 or 0_2 indicating a first TCI state codepoint, and one or more DCI fields in DCI format 0_0, 0_1 or 0_2 reserved for beam indication could be repurposed to indicate a second TCI state codepoint; in another example, one or more DCI fields in DCI format 0_0, 0_1 or 0_2 reserved for beam indication could be repurposed to indicate both the first and second TCI state codepoints. In the present disclosure, the UE could be higher layer configured by the network a list of entity IDs or a list of PCIs or a set of PCI indexes with each PCI index pointing to an entry/PCI in the list of PCIs that are higher layer configured to the UE.

For example, the TCI state(s) indicated by the first TCI state codepoint (e.g., indicated by the TCI field or by one or more repurposed DCI fields reserved for beam indication) could be activated/selected by the MAC CE from the first (or second) TCI state pool or the first (or second) TCI state group, and the TCI state(s) indicated by the second TCI state codepoint (e.g., indicated by one or more repurposed DCI fields reserved for beam indication) could be activated/selected by the MAC CE from the second (or first) TCI state pool or the second (or first) TCI state group.

For another example, the first (or second) TCI state codepoint (e.g., indicated by the TCI field or by one or more repurposed DCI fields reserved for beam indication) could be associated with the entity ID associated with the serving cell PCI/PCI index or the lowest entity ID value or the first entity ID value in the higher layer configured list of entity IDs, and the second (or first) TCI state codepoint (e.g., indicated by one or more repurposed DCI fields reserved for beam indication or by the TCI field) could be associated with the entity ID associated with a PCI/PCI index other than the serving cell PCI/PCI index or the highest entity ID value or the last entity ID value in the higher layer configured list of entity IDs.

Alternatively, the first (or second) TCI state codepoint (e.g., indicated by the TCI field or by one or more repurposed DCI fields reserved for beam indication) could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state codepoint (e.g., indicated by one or more repurposed DCI fields reserved for beam indication or by the TCI field) could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, if the UE is provided in PDCCH-Config two values of CORESETPoolIndex (i.e., 0 and 1), the first (or second) TCI state codepoint (e.g., indicated by the TCI field or by one or more repurposed DCI fields reserved for beam indication) could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state codepoint (e.g., indicated by one or more repurposed DCI fields reserved for beam indication or by the TCI field) could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In one example, the first TCI state codepoint (e.g., indicated by the TCI field or by one or more repurposed DCI fields reserved for beam indication) could be from the first set of TCI state codepoints, and the second TCI state codepoint (e.g., indicated by one or more repurposed DCI fields reserved for beam indication) could be from the second set of TCI state codepoints.

In another example, the first TCI state codepoint (e.g., indicated by the TCI field or by one or more repurposed DCI fields reserved for beam indication) could be from the second set of TCI state codepoints, and the second TCI state codepoint (e.g., indicated by one or more repurposed DCI fields reserved for beam indication) could be from the first set of TCI state codepoints.

In yet another example, the UE could receive a first one-bit flag for the first TCI state codepoint (e.g., indicated by the TCI field or by one or more repurposed DCI fields reserved for beam indication) with “0” indicating that the first TCI state codepoint is indicated from the first (or second) set of TCI state codepoints and “1” indicating that the first TCI state codepoint is indicated from the second (or first) set of TCI state codepoints; furthermore, the UE could receive a second one-bit flag for the second TCI state codepoint (e.g., indicated by one or more repurposed DCI fields reserved for beam indication) with “0” indicating that the second TCI state codepoint is indicated from the first (or second) set of TCI state codepoints and “1” indicating that the second TCI state codepoint is indicated from the second (or first) set of TCI state codepoints. The UE could be configured by the network via higher layer RRC signaling or MAC CE command or DCI based signaling the first or second one-bit flag indicators.

If the number of TCI state codepoints Nc1 in the first set of TCI state codepoints to be activated by MAC CE or the number of TCI state codepoints Nc2 in the second set of TCI state codepoints to be activated by MAC CE or the total number of TCI state codepoints Nc1+Nc2 in the first and second sets of TCI state codepoints to be activated by MAC CE is smaller than a threshold, (1) the TCI state(s)/TCI state codepoint(s) can only be indicated/configured in the dedicated “Transmission Configuration Indication” field in the corresponding DCI format—e.g., the first TCI state codepoint indicated in the TCI field, (2) none of the existing DCI fields or none of the reserved DCI fields for beam indication in the corresponding DCI format would be repurposed to indicate TCI state(s)/TCI state codepoint(s)—e.g., the second TCI state codepoint, or (3) none of the existing DCI fields or none of the reserved DCI fields for beam indication in the corresponding DCI format would be repurposed to indicate the second TCI state codepoint (or the first TCI state codepoint), while one or more of the existing DCI fields or reserved DCI fields for beam indication in the corresponding DCI format would be repurposed to indicate the first TCI state codepoint (or the second TCI state codepoint); furthermore, the first TCI state codepoint (or the second TCI state codepoint) could only correspond to/indicate a single TCI state or a single pair of TCI states—e.g., selected from either the first set or the second set of TCI state codepoints—for single-TRP operation.

In the present disclosure, the threshold could be (1) fixed, e.g., 8, 16, 32 or 64, or (2) configured by the network via higher layer RRC signaling or/and MAC CE command or/and DCI based signaling.

In one embodiment, a UE could receive in one or more CORESETs one or more PDCCH candidates from one or more search space sets configured with a higher layer parameter searchSpaceLinking. The one or more PDCCH candidates configured with the same higher layer parameter searchSpaceLinking could contain/carry/convey the same DCI payload. In the present disclosure, the same DCI payload could correspond to any DCI format, e.g., DCI format 1_1 or 1_2 with or without DL assignment for beam indication or DCI format 0_0, 0_1 or 0_2. As aforementioned, the UE could receive in an uplink DCI (e.g., DCI format 0_0, 0_1 or 0_2) one or more TCI states or pairs of TCI states indicated by the first and second TCI state codepoints in the corresponding DCI.

As discussed above, the first TCI state codepoint could be indicated in the first TCI field in the corresponding DCI format, and the second TCI state codepoint could be indicated in the second TCI field in the corresponding DCI format; alternatively, the first TCI state codepoint could be indicated in the TCI field in the corresponding DCI format, and the second TCI state codepoint could be indicated by repurposing one or more DCI fields reserved for beam indication in the corresponding DCI format; optionally, the first TCI state codepoint could be indicated by repurposing one or more DCI fields reserved for beam indication in the corresponding DCI format, and the second TCI state codepoint could be indicated by repurposing one or more DCI fields reserved for beam indication in the corresponding DCI format.

One or more of the indicated TCI states or pairs of TCI states by the first or second TCI state codepoints could be associated with/mapped to the one or more CORESETs, in which the one or more PDCCH candidates from the one or more search space sets configured with the same higher layer parameter searchSpaceLinking are received—also referred to as beam indication for PDCCH repetitions.

Furthermore, the UE could receive in a DCI (e.g., DCI format 1_1 or 1_2 with or without DL assignment) one or more bits to indicate at least one of: (1) switching between single-TRP PDCCH reception and multi-TRP PDCCH (repetitions) reception, (2) which TCI state codepoint(s), and therefore, the corresponding indicated TCI states or pairs of TCI states, to use for the single-TRP PDCCH reception, and (3) switching the order of the indicated first and second TCI state codepoints (and therefore, the corresponding indicated TCI states or pairs of TCI states). One or more new/dedicated DCI fields could be added/included/incorporated in the corresponding DCI format to indicate the one or more bits.

Alternatively, one or more of the existing DCI fields in the corresponding DCI format could be repurposed to indicate the one or more bits. In addition, as discussed above, the UE could receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. In the present disclosure, the SRS resource set indicator in DCI format 0_1 or 0_2 could also be used/applied to indicate at least one of: (1) switching between single-TRP PDCCH reception and multi-TRP PDCCH (repetitions) reception, (2) one or more of the indicated M>1 (or N>1) TCI states or pairs of TCI states to use for the single-TRP PDCCH reception, and (3) switching the order of the indicated M>1 (or N>1) TCI states or pairs of TCI states.

In one example, the UE could first receive in an uplink DCI (e.g., DCI format 0_0, 0_1 or 0_2) the first and second TCI state codepoints configured/indicated, wherein a TCI state codepoint could correspond a TCI state or pair of TCI states, and one or more of the indicated TCI states or pairs of TCI states by the first or second TCI state codepoints could be associated with/mapped to one or more CORESETs, in which one or more PDCCH candidates in one or more search space sets configured with the higher layer parameter searchSpaceLinking are received.

The UE could also receive in a DCI (e.g., DCI format 1_1 or 1_2 with or without DL assignment) a one-bit flag indicator for PDCCH. For this design example, a new/dedicated DCI field could be used/configured in the corresponding DCI format to indicate the one-bit flag indicator; alternatively, one or more of the existing DCI fields in the corresponding DCI format could be used/configured to indicate the one-bit flag indicator. Optionally, the UE could receive in an uplink DCI (e.g., DCI format 0_1 or 0_2) a SRS resource set indicator (e.g., in the “SRS resource set indicator” field). For instance, if the one-bit flag indicator for PDCCH is set to “1” (or “0”) or “enabled,” or if the bit field of the SRS resource set indicator is set to “00” or “01” or the index of the SRS resource set indicator is set to “0” or “1” according to TABLE 1 or the SRS resource set indicator field is not configured/present, the UE could use the TCI state(s) or pair(s) of TCI states indicated by one of the first and second TCI state codepoints to receive/monitor one or more PDCCH candidates in one or more CORESETs—i.e., PDCCH reception in a single-TRP system; if the one-bit flag indicator for PDCCH is set to “0” (or “1”) or “disabled,” or if the bit field of the SRS resource set indicator is set to “10” or “11” or the index of the SRS resource set indicator is set to “2” or “3” according to TABLE 1 or the SRS resource set indicator is not configured/present, the UE could use the TCI states or pairs of TCI states indicated by both of the first and second TCI state codepoints to receive/monitor one or more PDCCH candidates from one or more search space sets configured with the same higher layer parameter searchSpaceLinking in one or more CORESETs—i.e., PDCCH repetitions reception in a multi-TRP system.

More specifically, if the one-bit flag indicator for PDCCH is set to “1” (or “0”) or “enabled,” or when the bit field of the SRS resource set indicator is set to “00” or “10” or the index of the SRS resource set indicator is set to “0” or “1” according to TABLE 1 or the SRS resource set indicator is not configured/present (i.e., for the PDCCH reception in a single-TRP system),

For example, the UE could use the TCI state(s)/pair(s) of TCI states indicated in the TCI field in the corresponding DCI format (e.g., DCI format 1_1 or 1_2 with or without DL assignment) to receive/monitor one or more PDCCH candidates in one or more CORESETs.

For another example, the UE could use one or more of the TCI states/pairs of TCI states indicated by the first TCI state codepoint (e.g., indicated by the TCI field in the corresponding DCI format or by repurposing one or more DCI fields reserved for beam indication in the corresponding DCI format) to receive/monitor one or more PDCCH candidates in one or more CORESETs.

Yet for another example, the UE could use one or more of the TCI states/pairs of TCI states indicated by the second TCI state codepoint (e.g., indicated by repurposing one or more DCI fields reserved for beam indication in the corresponding DCI format) to receive/monitor one or more PDCCH candidates in one or more CORESETs.

Yet for another example, the UE could use the separate DL TCI state or the joint DL and UL TCI state among the indicated TCI states by the first and second TCI state codepoints to receive/monitor one or more PDCCH candidates in one or more CORESETs. In this example, only one of the indicated TCI states by the first and second TCI state codepoints could correspond to a separate DL TCI state or a joint DL and UL TCI state.

Yet for another example, the UE could be higher layer configured by the network a list of K entity IDs. In the present disclosure, an entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. The UE could use the TCI state or the pair of TCI states indicated by the first or second TCI state codepoint that is associated with the first entity ID or the second entity ID or the last entity ID or the lowest entity ID or the highest entity ID or the second lowest (or second highest) entity ID or the entity ID associated with the serving cell PCI/PCI index or the entity ID associated with a PCI/PCI index different from the serving cell PCI/PCI index or the k-th entity ID or the k-th lowest (or highest) entity ID among the list of K entity IDs to receive/monitor one or more PDCCH candidates in one or more CORESETs, where k∈{1, . . . , K}.

In this example, the index k could be determined according to at least one of: (1) fixed in the system specification(s) and (2) configured, e.g., via higher layer RRC signaling or MAC CE command or DCI based signaling, by the network. Furthermore, K could be equal to M (or N) or 2.

Yet for another example, the UE could be higher layer configured by the network a list of L PCIs. The UE could use the TCI state or the pair of TCI states indicated by the first or second TCI state codepoint that is associated with the first PCI or the second PCI or the last PCI or the lowest PCI or the highest PCI or the second lowest (or second highest) PCI or the serving cell PCI or a PCI different from the serving cell PCI or the l-th PCI or the l-th lowest (or highest) PCI among the list of L PCIs to receive/monitor one or more PDCCH candidates in one or more CORESETs, where l∈{1, . . . , L}.

Alternatively, the UE could determine a list of L PCI indexes 0, . . . , L−1 or 1, . . . , L with each PCI index pointing to an entry in the list of L PCIs. For this case, the UE could use the TCI state or the pair of TCI states indicated by the first or second TCI state codepoint that is associated with the first PCI index or the second PCI index or the last PCI index or the lowest PCI index or the highest PCI index or the second lowest (or second highest) PCI index or the serving cell PCI index or a PCI index different from the serving cell PCI index or the l-th PCI index or the l-th lowest (or highest) PCI index among the list of L PCI indexes to receive/monitor one or more PDCCH candidates in one or more CORESETs, where l∈{1, . . . , L}. In this example, the index l could be determined according to at least one of: (1) fixed in the system specification(s) and (2) configured, e.g., via higher layer RRC signaling or MAC CE command or DCI based signaling, by the network. Furthermore, L could be equal to M (or N) or 2.

Yet for another example, the UE could be provided in PDCCH-Config two values of CORESETPoolIndex (i.e., 0 and 1) for one or more CORESETs. The UE could use the TCI state or the pair of TCI states indicated by the first or second TCI state codepoint that is associated with value 0 of CORESETPoolIndex or value 1 of CORESETPoolIndex or value x of CORESETPoolIndex to receive/monitor one or more PDCCH candidates in one or more CORESETs, where x∈{0, 1}. In this example, the value x could be determined according to at least one of: (1) fixed in the system specification(s) and (2) configured, e.g., via higher layer RRC signaling or MAC CE command or DCI based signaling, by the network.

For the above design examples, the first TCI state codepoint could be indicated by the first TCI field in the corresponding DCI format 0_0, 0_1 or 0_2 or by the TCI field in the corresponding DCI format 0_0, 0_1 or 0_2 or by repurposing one or more DCI fields in the corresponding DCI format 0_0, 0_1 or 0_2 reserved for beam indication, and the second TCI state codepoint could be indicated by the second TCI field in the corresponding DCI format 0_0, 0_1 or 0_2 or by repurposing one or more DCI fields in the corresponding DCI format 0_0, 0_1 or 0_2 reserved for beam indication.

In another example, the UE could first receive in an uplink DCI (e.g., DCI format 0_0, 0_1 or 0_2) the first and second TCI state codepoints configured/indicated, wherein a TCI state codepoint could correspond a TCI state or pair of TCI states, and one or more of the indicated TCI states or pairs of TCI states by the first or second TCI state codepoints could be associated with/mapped to one or more CORESETs, in which one or more PDCCH candidates in one or more search space sets configured with the higher layer parameter searchSpaceLinking are received.

The UE could also receive in a DCI (e.g., DCI format 1_1 or 1_2 with or without DL assignment) a one-bit indicator for PDCCH. For this design example, a new/dedicated DCI field could be used/configured in the corresponding DCI format to indicate the one-bit indicator; alternatively, one or more of the existing DCI fields in the corresponding DCI format could be used/configured to indicate the one-bit indicator.

In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. If the one-bit indicator for PDCCH is set to “0” (or “1”), or if the bit field of the SRS resource set indicator is set to “00” (or “01”) or the index of the SRS resources set indicator is set to “0” (or “1”) according to TABLE 1, the UE could use the TCI state(s) or pair(s) of TCI states indicated by a primary TCI state codepoint to receive/monitor one or more PDCCH candidates in one or more CORESETs—i.e., PDCCH reception in a single-TRP system; if the one-bit indicator for PDCCH is set to “1” (or “0”), or if the bit field of the SRS resource set indicator is set to “01” (or “00”) or the index of the SRS resources set indicator is set to “1” (or “0”) according to TABLE 1, the UE could use the TCI state(s) or pair(s) of TCI states indicated by a secondary TCI state codepoint to receive/monitor one or more PDCCH candidates in one or more CORESETs—i.e., PDCCH reception in a single-TRP system. Various design examples of determining the primary TCI state codepoint or the secondary TCI state codepoint are provided below.

For example, the primary TCI state codepoint could correspond to the first (or second) TCI state codepoint, and the secondary TCI state codepoint could correspond to the second (or first) TCI state codepoint.

For another example, the UE could be higher layer configured by the network a list of K entity IDs. In the present disclosure, an entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. In one example, the primary TCI state codepoint could correspond to the first or second TCI state codepoint that is associated with the first (or second) entity ID or the lowest (or second lowest/highest) entity ID or the entity ID associated with the serving cell PCI/PCI index (or a PCI/PCI index different from the serving cell PCI/PCI index), and the secondary TCI state codepoint could correspond to the first or second TCI state codepoint that is associated with the second (or first) entity ID or the second lowest/highest (or lowest) entity ID or the entity ID associated with a PCI/PCI index different from the serving cell PCI/PCI index (or the serving cell PCI/PCI index).

In another example, the primary TCI state codepoint could correspond to the first or second TCI state codepoint that is associated with the first (or last) entity ID or the lowest (or highest) entity ID, and the secondary TCI state codepoint could correspond to the first or second TCI state codepoint that is associated with the last (or first) entity ID or the highest (or lowest) entity ID. In yet another example, the primary TCI state codepoint could correspond to the first or second TCI state codepoint that is associated with the k-th entity ID or the k-th lowest (or highest) entity ID, and the secondary TCI state codepoint could correspond to the first or second TCI state codepoint that is associated with the k′-th entity ID or the k′-th lowest (or highest) entity ID, where k∈{1, . . . , K} and k′∈{1, . . . , K}. For this case, the index k or the index k′ could be determined according to at least one of: (1) fixed in the system specification(s) and (2) configured, e.g., via higher layer RRC signaling or MAC CE command or DCI based signaling, by the network. Furthermore, K could be equal to M (or N) or 2.

Yet for another example, the UE could be higher layer configured by the network a list of L PCIs. In one example, the primary TCI state codepoint could correspond to the first or second TCI state codepoint that is associated with the first (or second) PCI or the lowest (or second lowest/highest) PCI or the serving cell PCI (or a PCI different from the serving cell PCI), and the secondary TCI state codepoint could correspond to the first or second TCI state codepoint that is associated with the second (or first) PCI or the second lowest/highest (or lowest) PCI or a PCI different from the serving cell PCI (or the serving cell PCI).

In another example, the primary TCI state codepoint could correspond to the first or second TCI state codepoint that is associated with the first (or last) PCI or the lowest (or highest) PCI, and the secondary TCI state codepoint could correspond to the first or second TCI state codepoint that is associated with the last (or first) PCI or the highest (or lowest) PCI. In yet another example, the primary TCI state codepoint could correspond to the first or second TCI state codepoint that is associated with the l-th PCI or the l-th lowest (or highest) PCI, and the secondary TCI state codepoint could correspond to the first or second TCI state codepoint that is associated with the l′-th PCI or the l′-th lowest (or highest) PCI, where l∈{1, . . . , L} and l′∈{1, . . . , L}. Alternatively, the UE could determine a list of L PCI indexes 0, . . . , L−1 or 1, . . . , L with each PCI index pointing to an entry in the list of L PCIs. For this case, in one example, the primary TCI state codepoint could correspond to the first or second TCI state codepoint that is associated with the first (or second) PCI index or the lowest (or second lowest/highest) PCI index or the serving cell PCI index (or a PCI index different from the serving cell PCI index), and the secondary TCI state codepoint could correspond to the first or second TCI state codepoint that is associated with the second (or first) PCI index or the second lowest/highest (or lowest) PCI index or a PCI index different from the serving cell PCI index (or the serving cell PCI index); in another example, the primary TCI state codepoint could correspond to the first or second TCI state codepoint that is associated with the first (or last) PCI index or the lowest (or highest) PCI index, and the secondary TCI state codepoint could correspond to the first or second TCI state codepoint that is associated with the last (or first) PCI index or the highest (or lowest) PCI index; in yet another example, the primary TCI state codepoint could correspond to the first or second TCI state codepoint that is associated with the l-th PCI index or the l-th lowest (or highest) PCI index, and the secondary TCI state codepoint could correspond to the first or second TCI state codepoint that is associated with the l′-th PCI index or the l′-th lowest (or highest) PCI index, where l∈{1, . . . , L} and l′∈{1, . . . , L}. For this case, the index l or the index l′ could be determined according to at least one of: (1) fixed in the system specification(s) and (2) configured, e.g., via higher layer RRC signaling or MAC CE command or DCI based signaling, by the network. Furthermore, L could be equal to M (or N).

Yet for another example, the UE could be provided in PDCCH-Config two values of CORESETPoolIndex (i.e., 0 and 1) for one or more CORESETs. The primary TCI state codepoint could correspond to the first or second TCI state codepoint that is associated with value 0 (or 1) of CORESETPoolIndex or value x of CORESETPoolIndex, and the secondary TCI state codepoint could correspond to the first or second TCI state codepoint that is associated with value 1 (or 0) of CORESETPoolIndex or value x′ of CORESETPoolIndex, where x∈{0, 1} and x′∈{0, 1}. In this example, the value x or the value x′ could be determined according to at least one of: (1) fixed in the system specification(s) and (2) configured, e.g., via higher layer RRC signaling or MAC CE command or DCI based signaling, by the network.

For the above design examples, the first TCI state codepoint could be indicated by the first TCI field in the corresponding DCI format 0_0, 0_1 or 0_2 or by the TCI field in the corresponding DCI format 0_0, 0_1 or 0_2 or by repurposing one or more DCI fields in the corresponding DCI format 0_0, 0_1 or 0_2 reserved for beam indication as specified in examples and the second TCI state codepoint could be indicated by the second TCI field in the corresponding DCI format 0_0, 0_1 or 0_2 or by repurposing one or more DCI fields in the corresponding DCI format 0_0, 0_1 or 0_2 reserved for beam indication.

In yet another example, the UE could first receive in an uplink DCI (e.g., DCI format 0_0, 0_1 or 0_2) the first and second TCI state codepoints configured/indicated, wherein a TCI state codepoint could correspond a TCI state or pair of TCI states, and one or more of the indicated TCI states or pairs of TCI states by the first or second TCI state codepoints could be associated with/mapped to one or more CORESETs, in which one or more PDCCH candidates in one or more search space sets configured with the higher layer parameter searchSpaceLinking are received. The UE could also receive in a DCI (e.g., DCI format 1_1 or 1_2 with or without DL assignment) a one-bit flag indicator to indicate TCI state codepoints ordering for PDCCH.

For this design example, a new/dedicated DCI field could be used/configured in the corresponding DCI format to indicate the one-bit flag indicator; alternatively, one or more of the existing DCI fields in the corresponding DCI format could be used/configured to indicate the one-bit flag indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit flag indicator is set to “1” (or “0”) or “enabled,” or if the bit field of the SRS resource set indicator is set to “11” (or “10”) or the index of the SRS resource set indicator is set to “3” (or “2”) according to TABLE 1 or the SRS resource set indicator field is not configured/present, the UE would first use the second TCI state codepoint followed by the first TCI state codepoint, and therefore the corresponding indicated TCI states/pair(s) of TCI states, to receive/monitor one or more PDCCH candidates from one or more search space sets configured with the same higher layer parameter searchSpaceLinking in one or more CORESETs associated with the TCI states/pair(s) of TCI states indicated by the second TCI state codepoint followed by the first TCI state codepoint, and if the one-bit flag indicator is set to “0” (or “1”) or “disabled,” or if the bit field of the SRS resource set indicator is set to “10” (or “11”) or the index of the SRS resource set indicator is set to “2” (or “3”) according to TABLE 1 or the SRS resource set indicator field is not configured/present, the UE would first use the first TCI state codepoint followed by the second TCI state codepoint, and therefore the corresponding indicated TCI states/pair(s) of TCI states, to receive/monitor one or more PDCCH candidates from one or more search space sets configured with the same higher layer parameter searchSpaceLinking in one or more CORESETs associated with the TCI states/pair(s) of TCI states indicated by the first TCI state codepoint followed by the second TCI state codepoint.

For this example, the first TCI state codepoint could be indicated by the first TCI field in the corresponding DCI format 0_0, 0_1 or 0_2 or by the TCI field in the corresponding DCI format 0_0, 0_1 or 0_2 or by repurposing one or more DCI fields in the corresponding DCI format 0_0, 0_1 or 0_2 reserved for beam indication, and the second TCI state codepoint could be indicated by the second TCI field in the corresponding DCI format 0_0, 0_1 or 0_2 or by repurposing one or more DCI fields in the corresponding DCI format 0_0, 0_1 or 0_2 reserved for beam indication.

In yet another example, the UE could first receive in an DCI (e.g., DCI format 0_0, 0_1 or 0_2) the first and second TCI state codepoints configured/indicated, wherein a TCI state codepoint could correspond a TCI state or pair of TCI, and one or more of the indicated TCI states or pairs of TCI states by the first or second TCI state codepoints could be associated with/mapped to one or more CORESETs, in which one or more PDCCH candidates in one or more search space sets configured with the higher layer parameter searchSpaceLinking are received. The UE could also receive in a DCI (e.g., DCI format 1_1 or 1_2 with or without DL assignment) a one-bit indicator to indicate TCI state codepoints ordering for PDCCH. For this design example, a new/dedicated DCI field could be used/configured in the corresponding DCI format to indicate the one-bit indicator; alternatively, one or more of the existing DCI fields in the corresponding DCI format could be used/configured to indicate the one-bit indicator.

In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit indicator is set to “0” (or “1”), or if the bit field of the SRS resource set indicator is set to “10” (or “11”) or the index of the SRS resource set indicator is set to “2” (or “3”) according to TABLE 1, the UE would first use TCI state codepoint x followed by TCI state codepoint y (a first ordering), and therefore the corresponding indicated TCI states/pair(s) of TCI states, to receive/monitor one or more PDCCH candidates from one or more search space sets configured with the same higher layer parameter searchSpaceLinking in one or more CORESETs associated with the TCI states/pair(s) of TCI states indicated by TCI state codepoint x followed by TCI state codepoint y, and if the one-bit flag indicator is set to “1” (or “0”), or if the bit field of the SRS resource set indicator is set to “11” (or “10”) or the index of the SRS resource set indicator is set to “3” (or “2”) according to TABLE 1, the UE would first use TCI state codepoint y followed by TCI state codepoint x (a second ordering), and therefore the corresponding indicated TCI states/pair(s) of TCI states, to receive/monitor one or more PDCCH candidates from one or more search space sets configured with the same higher layer parameter searchSpaceLinking in one or more CORESETs associated with the TCI states/pair(s) of TCI states indicated by TCI state codepoint y followed by TCI state codepoint x.

The first ordering of the indicated TCI state codepoints {TCI state codepoint x, TCI state codepoint y} or the second ordering of the indicated TCI state codepoints {TCI state codepoint y, TCI state codepoint x} could be determined according to at least one of: (1) fixed in the system specification(s) and (2) configured, e.g., via higher layer RRC signaling or MAC CE command or DCI based signaling, by the network. For both (1) and (2), TCI state codepoint x could correspond to the first (or second) TCI state codepoint, and TCI state codepoint y could correspond to the second (or first) TCI state codepoint. For this example, the first TCI state codepoint could be indicated by the first TCI field in the corresponding DCI format 0_0, 0_1 or 0_2 or by the TCI field in the corresponding DCI format 0_0, 0_1 or 0_2 or by repurposing one or more DCI fields in the corresponding DCI format 0_0, 0_1 or 0_2 reserved for beam indication and the second TCI state codepoint could be indicated by the second TCI field in the corresponding DCI format 0_0, 0_1 or 0_2 or by repurposing one or more DCI fields in the corresponding DCI format 0_0, 0_1 or 0_2 reserved for beam indication.

In yet another example, the UE could first receive in an uplink DCI (e.g., DCI format 0_0, 0_1 or 0_2) M=1 (or N=1) TCI state or pair of TCI states indicated by a TCI state codepoint (or a TCI field). The UE could then receive in an uplink DCI (e.g., DCI format 0_0, 0_1 or 0_2) the first and second TCI state codepoints configured/indicated, wherein a TCI state codepoint could correspond a TCI state or pair of TCI states, and one or more of the indicated TCI states or pairs of TCI states by the first or second TCI state codepoints could be associated with/mapped to one or more CORESETs, in which one or more PDCCH candidates in one or more search space sets configured with the higher layer parameter searchSpaceLinking are received.

For example, the UE would follow the latest indicated TCI states or pairs of TCI states by the first and second TCI state codepoints to receive/monitor one or more PDCCH candidates from one or more search space sets configured with the same higher layer parameter searchSpaceLinking in one or more CORESETs—i.e., multi-TRP PDCCH (repetitions) reception.

For another example, the UE could receive in a DCI (e.g., DCI format 1_1 or 1_2 with or without DL assignment) a one-bit flag indicator for PDCCH. For this design example, a new/dedicated DCI field could be used/configured in the corresponding DCI format to indicate the one-bit flag indicator; alternatively, one or more of the existing DCI fields in the corresponding DCI format could be used/configured to indicate the one-bit flag indicator. In addition, the UE could receive in an uplink DCI (e.g., DCI format 0_1 or 0_2) a SRS resource set indicator (e.g., in the “SRS resource set indicator” field) to indicate one or more SRS resource sets for single-TRP or multi-TRP operation.

For instance, if the one-bit flag indicator for PDCCH is set to “1” (or “0”) or “enabled,” or if the bit field of the SRS resource set indicator is set to “10” or “11” or the index of the SRS resource set indicator is set to “2” or “3” according to TABLE 1 or the SRS resource set indicator field is not configured/present, the UE would follow the latest indicated TCI states or pairs of TCI states by the first and second TCI state codepoints to receive/monitor one or more PDCCH candidates from one or more search space sets configured with the same higher layer parameter searchSpaceLinking in one or more CORESETs—i.e., multi-TRP PDCCH (repetitions) reception. If the one-bit flag indicator for PDCCH is set to “0” (or “1”) or “disabled,” or if the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to receive/monitor one or more PDCCH candidates in one or more CORESETs—i.e., single-TRP PDCCH reception.

Yet for another example, the UE could receive in a DCI (e.g., DCI format 1_1 or 1_2 with or without DL assignment) a one-bit indicator for PDCCH. For this design example, a new/dedicated DCI field could be used/configured in the corresponding DCI format to indicate the one-bit indicator; alternatively, one or more of the existing DCI fields in the corresponding DCI format could be used/configured to indicate the one-bit indicator. In addition, the UE could receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit indicator for PDCCH is set to “0” (or “1”), or if the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to receive/monitor one or more PDCCH candidates in one or more CORESETs—i.e., single-TRP PDCCH reception; if the one-bit indicator for PDCCH is set to “1” (or “0”), or if the bit field of the SRS resource set indicator is set to “10” or “11” or the index of the SRS resource set indicator is set to “2” or “3” according to TABLE 1 or the SRS resource set indicator field is not configured/present, the UE would follow the latest indicated TCI states or pairs of TCI states by the first and second TCI state codepoints to receive/monitor one or more PDCCH candidates from one or more search space sets configured with the same higher layer parameter searchSpaceLinking in one or more CORESETs—i.e., multi-TRP PDCCH (repetitions) reception.

For the design examples discussed in the present disclosure, the first TCI state codepoint could be indicated by the first TCI field in the corresponding DCI format 0_0, 0_1 or 0_2 or by the TCI field in the corresponding DCI format 0_0, 0_1 or 0_2 or by repurposing one or more DCI fields in the corresponding DCI format 0_0, 0_1 or 0_2 reserved for beam indication, and the second TCI state codepoint could be indicated by the second TCI field in the corresponding DCI format 0_0, 0_1 or 0_2 or by repurposing one or more DCI fields in the corresponding DCI format 0_0, 0_1 or 0_2 reserved for beam indication.

In yet another example, the UE could first receive in an uplink DCI (e.g., DCI format 0_0, 0_1 or 0_2) the first and second TCI state codepoints configured/indicated, wherein a TCI state codepoint could correspond a TCI state or pair of TCI states, and one or more of the indicated TCI states or pairs of TCI states by the first or second TCI state codepoints could be associated with/mapped to one or more CORESETs, in which one or more PDCCH candidates in one or more search space sets configured with the higher layer parameter searchSpaceLinking are received. The UE could also receive in a DCI (e.g., DCI format 1_1 or 1_2 with or without DL assignment) a multi-bit (>1 bit, e.g., 2-bit) indicator for PDCCH. For this design example, a new/dedicated DCI field could be used/configured in the corresponding DCI format to indicate the multi-bit indicator; alternatively, one or more of the existing DCI fields in the corresponding DCI format could be used/configured to indicate the multi-bit indicator.

In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The multi-bit indicator for PDCCH or the SRS resource set indicator could indicate one or more of: (1) single-TRP PDCCH reception, (2) multi-TRP PDCCH (repetitions) reception, (3) one or more orderings of the indicated TCI state codepoints for single-TRP PDCCH reception or multi-TRP PDCCH (repetitions) reception, and (4) one or more TCI state codepoints for single-TRP PDCCH reception or multi-TRP PDCCH (repetitions) reception.

For example, the multi-bit indicator could correspond to a 2-bit indicator with four states “00,” “01,” “10” and “11.” For instance, if the 2-bit indicator is set to “00” (or “01”), or if the bit field of the SRS resource set indicator is set to “00” (or “01”) or the index of the SRS resource set indicator is set to “0” (or “1”) according to TABLE 1, the UE could use the TCI state(s) or pair(s) of TCI states indicated by one of the first and second TCI state codepoints to receive/monitor one or more PDCCH candidates in one or more CORESETs—i.e., PDCCH reception in a single-TRP system; if the 2-bit indicator is set to “01” (or “00”), or if the bit field of the SRS resource set indicator is set to “01” (or “00”) or the index of the SRS resource set indicator is set to “1” (or “0”) according to TABLE 1, the UE could use the TCI states or pairs of TCI states indicated by both of the first and second TCI state codepoints to receive/monitor one or more PDCCH candidates from one or more search space sets configured with the same higher layer parameter searchSpaceLinking in one or more CORESETs—i.e., PDCCH repetitions reception in a multi-TRP system.

If the 2-bit indicator is set to “10” (or “11”), or if the bit field of the SRS resource set indicator is set to “10” (or “11”) or the index of the SRS resource set indicator is set to “2” (or “3”) according to TABLE 1, the UE would first use the first TCI state codepoint followed by the second TCI state codepoint, and therefore the corresponding indicated TCI states/pair(s) of TCI states, to receive/monitor one or more PDCCH candidates from one or more search space sets configured with the same higher layer parameter searchSpaceLinking in one or more CORESETs associated with the TCI states/pair(s) of TCI states indicated by the first TCI state codepoint followed by the second TCI state codepoint; if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would first use the second TCI state codepoint followed by the first TCI state codepoint, and therefore the corresponding indicated TCI states/pair(s) of TCI states, to receive/monitor one or more PDCCH candidates from one or more search space sets configured with the same higher layer parameter searchSpaceLinking in one or more CORESETs associated with the TCI states/pair(s) of TCI states indicated by the second TCI state codepoint followed by the first TCI state codepoint (according to examples in the present disclosure).

Alternatively, if the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow a first ordering of the indicated TCI state codepoints, and therefore the corresponding indicated TCI states/pair(s) of TCI states, to receive/monitor one or more PDCCH candidates from one or more search space sets configured with the same higher layer parameter searchSpaceLinking in one or more CORESETs associated with the TCI states/pair(s) of TCI states indicated by the TCI state codepoints in the first ordering; if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow a second ordering of the indicated TCI state codepoints, and therefore the corresponding indicated TCI states/pair(s) of TCI states, to receive/monitor one or more PDCCH candidates from one or more search space sets configured with the same higher layer parameter searchSpaceLinking in one or more CORESETs associated with the TCI states/pair(s) of TCI states indicated by the TCI state codepoints in the second ordering. The first and second orderings of the indicated (first and second) TCI state codepoints could be determined based on embodiments and examples provided in the present disclosure.

Optionally, “00” or “01” of the 2-bit indicator, or the bit fields “00” or “01” or the indexes “0” or “1” of the 2-bit SRS resource set indicator in TABLE 1, could be used to indicate the orderings of the indicated (first and second) TCI state codepoints for multi-TRP PDCCH (repetitions) reception as described above, and “10” or “11” of the 2-bit indicator, or the bit fields “10” or “11” or the indexes “2” or “3” of the 2-bit SRS resource set indicator in TABLE 1, could be used to indicate the single-TRP PDCCH reception or the multi-TRP PDCCH (repetitions) reception as described above.

For another example, the multi-bit indicator could correspond to a 2-bit indicator with four states “00,” “01,” “10” and “11.” For instance, if the 2-bit indicator is set to “00” (or “01”), or if the bit field of the SRS resource set indicator is set to “00” (or “01”) or the index of the SRS resource set indicator is set to “0” (or “1”) according to TABLE 1, the UE could use the primary TCI state codepoint, and therefore the corresponding indicated TCI state(s)/pair(s) of TCI states, to receive/monitor one or more PDCCH candidates in one or more CORESETs—i.e., PDCCH reception in a single-TRP system; if the 2-bit indicator is set to “01” (or “00”), or if the bit field of the SRS resource set indicator is set to “01” (or “00”) or the index of the SRS resource set indicator is set to “1” (or “0”) according to TABLE 1, the UE could use the secondary TCI state codepoint, and therefore the corresponding TCI state(s)/pair(s) of TCI states, to receive/monitor one or more PDCCH candidates in one or more CORESETs—i.e., PDCCH reception in a single-TRP system; the primary and secondary TCI state codepoints could be determined/configured.

If the 2-bit indicator is set to “10” (or “11”), or if the bit field of the SRS resource set indicator is set to “10” (or “11”) or the index of the SRS resource set indicator is set to “2” (or “3”) according to TABLE 1, the UE would first use the first TCI state codepoint followed by the second TCI state codepoint, and therefore the corresponding indicated TCI states/pair(s) of TCI states, to receive/monitor one or more PDCCH candidates from one or more search space sets configured with the same higher layer parameter searchSpaceLinking in one or more CORESETs associated with the TCI states/pair(s) of TCI states indicated by the first TCI state codepoint followed by the second TCI state codepoint; if the 2-bit indicator is set to “11” (or “10”), or if the bit field of the SRS resource set indicator is set to “11” (or “10”) or the index of the SRS resource set indicator is set to “1” (or “0”) according to TABLE 1, the UE would first use the second TCI state codepoint followed by the first TCI state codepoint, and therefore the corresponding indicated TCI states/pair(s) of TCI states, to receive/monitor one or more PDCCH candidates from one or more search space sets configured with the same higher layer parameter searchSpaceLinking in one or more CORESETs associated with the TCI states/pair(s) of TCI states indicated by the second TCI state codepoint followed by the first TCI state codepoint.

Alternatively, if the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow a first ordering of the indicated TCI state codepoints, and therefore the corresponding indicated TCI states/pair(s) of TCI states, to receive/monitor one or more PDCCH candidates from one or more search space sets configured with the same higher layer parameter searchSpaceLinking in one or more CORESETs associated with the TCI states/pair(s) of TCI states indicated by the TCI state codepoints in the first ordering; if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow a second ordering of the indicated TCI state codepoints, and therefore the corresponding indicated TCI states/pair(s) of TCI states, to receive/monitor one or more PDCCH candidates from one or more search space sets configured with the same higher layer parameter searchSpaceLinking in one or more CORESETs associated with the TCI states/pair(s) of TCI states indicated by the TCI state codepoints in the second ordering. The first and second orderings of the indicated (first and second) TCI state codepoints could be determined.

Optionally, “00” or “01” of the 2-bit indicator, or the bit fields “00” or “01” or the indexes “0” or “1” of the 2-bit SRS resource set indicator in TABLE 1, could be used to indicate the orderings of the indicated (first and second) TCI state codepoints for multi-TRP PDCCH (repetitions) reception as described above, and “10” or “11” of the 2-bit indicator, or the bit fields “10” or “11” or the indexes “2” or “3” of the 2-bit SRS resource set indicator in TABLE 1, could be used to indicate the primary or secondary TCI state codepoints for single-TRP PDCCH reception as described above.

Yet for another example, the multi-bit indicator could correspond to a 2-bit indicator with four states “00,” “01,” “10” and “11,” configured. In addition to the 2-bit indicator or the 2-bit SRS resource set indicator configured, the UE could also receive in a DCI (e.g., DCI format 1_1 or 1_2 with or without DL assignment or DCI format 0_0, 0_1 or 0_2) a one-bit indicator. For this design example, a new/dedicated DCI field could be used/configured in the corresponding DCI format to indicate the one-bit indicator; alternatively, one or more of the existing DCI fields in the corresponding DCI format could be used/configured to indicate the one-bit indicator. When the 2-bit indicator or the 2-bit SRS resource set indicator indicates the single-TRP PDCCH reception, if the one-bit indicator is set to “0” (or “1”), the UE could use the primary TCI state codepoint, and therefore the corresponding indicated TCI state(s)/pair(s) of TCI states, to receive/monitor one or more PDCCH candidates in one or more CORESETs; if the one-bit indicator is set to “1” (or “0”), the UE could use the secondary TCI state codepoint, and therefore the corresponding indicated TCI state(s)/pair(s) of TCI states, to receive/monitor one or more PDCCH candidates in one or more CORESETs; the primary and secondary TCI state codepoints could be determined/configured.

Yet for another example, the multi-bit indicator or the SRS resource set indicator indicated in DCI format 0_1 or 0_2 (e.g., in the “SRS resource set indicator” field) could correspond to a z-bit indicator (z>1, e.g., z=3) with 2\hat{ }z states or bit fields (e.g., 8 states or bit fields for z=3). In this example, a first state or bit field of the z-bit indicator could indicate that the single-TRP PDCCH reception is enabled, a second state or bit field of the z-bit indicator could indicate that the multi-TRP PDCCH (repetitions) reception is enabled, a third state or bit field of the z-bit indicator could indicate that the UE could use the primary TCI state codepoint (and therefore the corresponding indicated TCI state(s)/pair(s) of TCI states) for the single-TRP PDCCH reception, a fourth state or bit field of the z-bit indicator could indicate that the UE could use the secondary TCI state codepoint (and therefore the corresponding indicated TCI state(s)/pair(s) of TCI states) for the single-TRP PDCCH reception, a fifth state or bit field of the z-bit indicator could indicate an ordering of the indicated (first and second) TCI state codepoints for the multi-TRP PDCCH (repetitions) reception, a sixth state or bit field of the z-bit indicator could indicate another ordering of the indicated (first and second) TCI state codepoints for the multi-TRP PDCCH (repetitions) reception.

For the above design examples, the first TCI state codepoint could be indicated by the first TCI field in the corresponding DCI format 0_0, 0_1 or 0_2 or by the TCI field in the corresponding DCI format 0_0, 0_1 or 0_2 or by repurposing one or more DCI fields in the corresponding DCI format 0_0, 0_1 or 0_2 reserved for beam indication, and the second TCI state codepoint could be indicated by the second TCI field in the corresponding DCI format 0_0, 0_1 or 0_2 or by repurposing one or more DCI fields in the corresponding DCI format 0_0, 0_1 or 0_2 reserved for beam indication.

In yet another example, the UE could first receive in an uplink DCI (e.g., DCI format 0_0, 0_1 or 0_2) M=1 (or N=1) TCI state or pair of TCI states indicated by a TCI state codepoint (or a TCI field). The UE could then receive in a DCI (e.g., DCI format 0_0, 0_1 or 0_2) the first and second TCI state codepoints configured/indicated, wherein a TCI state codepoint could correspond a TCI state or pair of TCI states, and one or more of the indicated TCI states or pairs of TCI states by the first or second TCI state codepoints could be associated with/mapped to one or more CORESETs, in which one or more PDCCH candidates in one or more search space sets configured with the higher layer parameter searchSpaceLinking are received.

Furthermore, the UE could receive in a DCI (e.g., DCI format 1_1 or 1_2 with or without DL assignment) a multi-bit (>1 bit, e.g., 2-bit) indicator for PDCCH. For this design example, a new/dedicated DCI field could be used/configured in the corresponding DCI format to indicate the multi-bit indicator; alternatively, one or more of the existing DCI fields in the corresponding DCI format could be used/configured to indicate the multi-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation.

The multi-bit indicator for PDCCH or the SRS resource set indicator could indicate one or more of: (1) single-TRP PDCCH reception, (2) multi-TRP PDCCH (repetitions) reception, (3) one or more orderings of the indicated TCI state codepoints for single-TRP PDCCH reception or multi-TRP PDCCH (repetitions) reception, and (4) one or more TCI state codepoints for single-TRP PDCCH reception or multi-TRP PDCCH (repetitions) reception. The multi-bit indicator or the SRS resource set indicator could be configured. For this example, if the multi-bit indicator or the SRS resource set indicator indicates that the single-TRP PDCCH reception is enabled, the UE could follow the previously indicated M=1 (or N=1) TCI state or pair of TCI states to receive/monitor one or more PDCCH candidates in one or more CORESETs.

Furthermore, for this example, the first TCI state codepoint could be indicated by the first TCI field in the corresponding DCI format 0_0, 0_1 or 0_2 or by the TCI field in the corresponding DCI format 0_0, 0_1 or 0_2 as specified in examples or by repurposing one or more DCI fields in the corresponding DCI format 0_0, 0_1 or 0_2 reserved for beam indication as specified in examples and the second TCI state codepoint could be indicated by the second TCI field in the corresponding DCI format 0_0, 0_1 or 0_2 or by repurposing one or more DCI fields in the corresponding DCI format 0_0, 0_1 or 0_2 reserved for beam indication.

As aforementioned, the UE could receive in an uplink DCI (e.g., DCI format 0_0, 0_1 or 0_2) one or more TCI states or pairs of TCI states indicated by the first and second TCI state codepoints in the corresponding DCI. As discussed above, the first TCI state codepoint could be indicated in the first TCI field in the corresponding DCI format, and the second TCI state codepoint could be indicated in the second TCI field in the corresponding DCI format; alternatively, the first TCI state codepoint could be indicated in the TCI field in the corresponding DCI format, and the second TCI state codepoint could be indicated by repurposing one or more DCI fields reserved for beam indication in the corresponding DCI format; optionally, the first TCI state codepoint could be indicated by repurposing one or more DCI fields reserved for beam indication in the corresponding DCI format, and the second TCI state codepoint could be indicated by repurposing one or more DCI fields reserved for beam indication in the corresponding DCI format.

Furthermore, the UE could receive in a DCI (e.g., DCI format 1_1 or 1_2 with or without DL assignment) one or more bits to indicate at least one of: (1) switching between single-TRP PDSCH reception and multi-TRP PDSCH (repetitions) reception, (2) which TCI state codepoint(s), and therefore, the corresponding indicated TCI states or pairs of TCI states, to use for the single-TRP PDSCH reception, and (3) switching the order of the indicated first and second TCI state codepoints (and therefore, the corresponding indicated TCI states or pairs of TCI states). One or more new/dedicated DCI fields could be added/included/incorporated in the corresponding DCI format to indicate the one or more bits.

Alternatively, one or more of the existing DCI fields in the corresponding DCI format could be repurposed to indicate the one or more bits. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The SRS resource set indicator could indicate at least one of: (1) switching between single-TRP PDSCH reception and multi-TRP PDSCH (repetitions) reception, (2) one or more of the indicated M>1 (or N>1) TCI states or pairs of TCI states to use for the single-TRP PDSCH reception, and (3) switching the order of the indicated M>1 (or N>1) TCI states or pairs of TCI states.

In one example, the UE could first receive in an uplink DCI (e.g., DCI format 0_0, 0_1 or 0_2) the first and second TCI state codepoints configured/indicated, wherein a TCI state codepoint could correspond a TCI state or pair of TCI states, and one or more of the indicated TCI states or pairs of TCI states by the first or second TCI state codepoints could be associated with/mapped to one or more PDSCH transmissions/transmission occasions as described above for the multi-TRP PDSCH (repetitions) reception. The UE could also receive in a DCI (e.g., DCI format 1_1 or 1_2 with or without DL assignment) a one-bit flag indicator for PDSCH. For this design example, a new/dedicated DCI field could be used/configured in the corresponding DCI format to indicate the one-bit flag indicator; alternatively, one or more of the existing DCI fields in the corresponding DCI format could be used/configured to indicate the one-bit flag indicator.

In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit flag indicator for PDSCH is set to “1” (or “0”) or “enabled,” or if the bit field of the SRS resource set indicator is set to “00” or “01” or the index of the SRS resource set indicator is set to “0” or “1” according to TABLE 1 or the SRS resource set indicator field is not configured/present, the UE could use the TCI state(s) or pair(s) of TCI states indicated by one of the first and second TCI state codepoints to receive one or more PDSCHs or one or more layers of a PDSCH—i.e., PDSCH reception in a single-TRP system; if the one-bit flag indicator for PDSCH is set to “0” (or “1”) or “disabled,” or if the bit field of the SRS resource set indicator is set to “10” or “11” or the index of the SRS resource set indicator is set to “2” or “3” according to TABLE 1 or the SRS resource set indicator field is not configured/present, the UE could use the TCI states or pairs of TCI states indicated by both of the first and second TCI state codepoints to receive PDSCH transmissions/transmission occasions—i.e., PDSCH (repetitions) reception in a multi-TRP system.

More specifically, if the one-bit flag indicator for PDSCH is set to “1” (or “0”) or “enabled,” or if the bit field of the SRS resource set indicator is set to “00” or “01” or the index of the SRS resource set indicator is set to “0” or “1” according to TABLE 1 or the SRS resource set indicator field is not configured/present (i.e., for the PDSCH reception in a single-TRP system),

For example, the UE could use the TCI state(s)/pair(s) of TCI states indicated in the TCI field in the corresponding DCI format (e.g., DCI format 0_0, 0_1 or 0_2) to receive one or more PDSCHs or one or more layers of a PDSCH.

For another example, the UE could use one or more of the TCI states/pairs of TCI states indicated by the first TCI state codepoint (e.g., indicated by the TCI field in the corresponding DCI format or by repurposing one or more DCI fields reserved for beam indication in the corresponding DCI format) to receive one or more PDSCHs or one or more layers of a PDSCH.

Yet for another example), the UE could use one or more of the TCI states/pairs of TCI states indicated by the second TCI state codepoint (e.g., indicated by repurposing one or more DCI fields reserved for beam indication in the corresponding DCI format) to receive one or more PDSCHs or one or more layers of a PDSCH.

Yet for another example, the UE could use the separate DL TCI state or the joint DL and UL TCI state among the indicated TCI states by the first and second TCI state codepoints to receive one or more PDSCHs or one or more layers of a PDSCH. In this example, only one of the indicated TCI states by the first and second TCI state codepoints could correspond to a separate DL TCI state or a joint DL and UL TCI state.

Yet for another example, the UE could be higher layer configured by the network a list of K entity IDs. In the present disclosure, an entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. The UE could use the TCI state or the pair of TCI states indicated by the first or second TCI state codepoint that is associated with the first entity ID or the second entity ID or the last entity ID or the lowest entity ID or the highest entity ID or the second lowest (or second highest) entity ID or the entity ID associated with the serving cell PCI/PCI index or the entity ID associated with a PCI/PCI index different from the serving cell PCI/PCI index or the k-th entity ID or the k-th lowest (or highest) entity ID among the list of K entity IDs to receive one or more PDSCHs or one or more layers of a PDSCH, where k∈{11, . . . , K}.

In this example, the index k could be determined according to at least one of: (1) fixed in the system specification(s) and (2) configured, e.g., via higher layer RRC signaling or MAC CE command or DCI based signaling, by the network. Furthermore, K could be equal to M (or N) or 2.

Yet for another example, the UE could be higher layer configured by the network a list of L PCIs. The UE could use the TCI state or the pair of TCI states indicated by the first or second TCI state codepoint that is associated with the first PCI or the second PCI or the last PCI or the lowest PCI or the highest PCI or the second lowest (or second highest) PCI or the serving cell PCI or a PCI different from the serving cell PCI or the l-th PCI or the l-th lowest (or highest) PCI among the list of L PCIs to receive one or more PDSCHs or one or more layers of a PDSCH, where l∈{1, . . . , L}.

Alternatively, the UE could determine a list of L PCI indexes 0, . . . , L−1 or 1, . . . , L with each PCI index pointing to an entry in the list of L PCIs. For this case, the UE could use the TCI state or the pair of TCI states indicated by the first or second TCI state codepoint that is associated with the first PCI index or the second PCI index or the last PCI index or the lowest PCI index or the highest PCI index or the second lowest (or second highest) PCI index or the serving cell PCI index or a PCI index different from the serving cell PCI index or the l-th PCI index or the l-th lowest (or highest) PCI index among the list of L PCI indexes to receive one or more PDSCHs or one or more layers of a PDSCH, where l∈{1, . . . , L}. In this example, the index l could be determined according to at least one of: (1) fixed in the system specification(s) and (2) configured, e.g., via higher layer RRC signaling or MAC CE command or DCI based signaling, by the network. Furthermore, L could be equal to M (or N) or 2.

Yet for another example, the UE could be provided in PDCCH-Config two values of CORESETPoolIndex (i.e., 0 and 1) for one or more CORESETs. The UE could use the TCI state or the pair of TCI states indicated by the first or second TCI state codepoint that is associated with value 0 of CORESETPoolIndex or value 1 of CORESETPoolIndex or value x of CORESETPoolIndex to receive one or more PDSCHs or one or more layers of a PDSCH, where x∈{0, 1}. In this example, the value x could be determined according to at least one of: (1) fixed in the system specification(s) and (2) configured, e.g., via higher layer RRC signaling or MAC CE command or DCI based signaling, by the network.

For the design examples provided in the present disclosure, the first TCI state codepoint could be indicated by the first TCI field in the corresponding DCI format 0_0, 0_1 or 0_2 or by the TCI field in the corresponding DCI format 0_0, 0_1 or 0_2 or by repurposing one or more DCI fields in the corresponding DCI format 0_0, 0_1 or 0_2 reserved for beam indication, and the second TCI state codepoint could be indicated by the second TCI field in the corresponding DCI format 0_0, 0_1 or 0_2 or by repurposing one or more DCI fields in the corresponding DCI format 0_0, 0_1 or 0_2 reserved for beam indication.

In another example, the UE could first receive in an uplink DCI (e.g., DCI format 0_0, 0_1 or 0_2) the first and second TCI state codepoints configured/indicated, wherein a TCI state codepoint could correspond a TCI state or pair of TCI states, and one or more of the indicated TCI states or pairs of TCI states by the first or second TCI state codepoints could be associated with/mapped to one or more PDSCH transmissions/transmission occasions as described above for the multi-TRP PDSCH (repetitions) reception. The UE could also receive in a DCI (e.g., DCI format 1_1 or 1_2 with or without DL assignment) a one-bit indicator for PDSCH.

For this design example, a new/dedicated DCI field could be used/configured in the corresponding DCI format to indicate the one-bit indicator; alternatively, one or more of the existing DCI fields in the corresponding DCI format could be used/configured to indicate the one-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. If the one-bit indicator for PDSCH is set to “0” (or “1”), or if the bit field of the SRS resource set indicator is set to “00” (or “01”) or the index of the SRS resource set indicator is set to “0” (or “1”) according to TABLE 1, the UE could use the TCI state(s) or pair(s) of TCI states indicated by a primary TCI state codepoint to receive one or more PDSCHs or one or more layers of a PDSCH—i.e., PDSCH reception in a single-TRP system; if the one-bit indicator for PDSCH is set to “1” (or “O”), or if the bit field of the SRS resource set indicator is set to “01” (or “00”) or the index of the SRS resource set indicator is set to “1” (or “0”), the UE could use the TCI state(s) or pair(s) of TCI states indicated by a secondary TCI state codepoint to receive one or more PDSCHs or one or more layers of a PDSCH—i.e., PDSCH reception in a single-TRP system.

Various design examples of determining the primary TCI state codepoint or the secondary TCI state codepoint are provided in the present disclosure. For this example, the first TCI state codepoint could be indicated by the first TCI field in the corresponding DCI format 0_0, 0_1 or 0_2 or by the TCI field in the corresponding DCI format 0_0, 0_1 or 0_2 or by repurposing one or more DCI fields in the corresponding DCI format 0_0, 0_1 or 0_2 reserved for beam indication, and the second TCI state codepoint could be indicated by the second TCI field in the corresponding DCI format 0_0, 0_1 or 0_2 or by repurposing one or more DCI fields in the corresponding DCI format 0_0, 0_1 or 0_2 reserved for beam indication.

In yet another example, the UE could first receive in an uplink DCI (e.g., DCI format 0_0, 0_1 or 0_2) the first and second TCI state codepoints configured/indicated, wherein a TCI state codepoint could correspond a TCI state or pair of TCI states, and one or more of the indicated TCI states or pairs of TCI states by the first or second TCI state codepoints could be associated with/mapped to one or more PDSCH transmissions/PDSCH transmission occasions as described above for the multi-TRP PDSCH (repetitions) reception. The UE could also receive in a DCI (e.g., DCI format 1_1 or 1_2 with or without DL assignment) a one-bit flag indicator to indicate TCI state codepoints ordering for PDSCH.

For this design example, a new/dedicated DCI field could be used/configured in the corresponding DCI format to indicate the one-bit flag indicator; alternatively, one or more of the existing DCI fields in the corresponding DCI format could be used/configured to indicate the one-bit flag indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit flag indicator is set to “1” (or “0”) or “enabled,” or if the bit field of the SRS resource set indicator is set to “11” (or “10”) or the index of the SRS resource set indicator is set to “3” (or “2”) according to TABLE 1 or the SRS resource set indicator field is not configured/present, the UE would first use the second TCI state codepoint followed by the first TCI state codepoint, and therefore the corresponding indicated TCI states/pair(s) of TCI states, to receive one or more PDSCH transmissions/PDSCH transmission occasions associated with the TCI states/pair(s) of TCI states indicated by the second TCI state codepoint followed by the first TCI state codepoint, and if the one-bit flag indicator is set to “0” (or “1”) or “disabled,” or if the bit field of the SRS resource set indicator is set to “10” (or “11”) or the index of the SRS resource set indicator is set to “2” (or “3”) according to TABLE 1 or the SRS resource set indicator field is not configured/present, the UE would first use the first TCI state codepoint followed by the second TCI state codepoint, and therefore the corresponding indicated TCI states/pair(s) of TCI states, to receive one or more PDSCH transmissions/PDSCH transmission occasions associated with the TCI states/pair(s) of TCI states indicated by the first TCI state codepoint followed by the second TCI state codepoint.

For this example, the first TCI state codepoint could be indicated by the first TCI field in the corresponding DCI format 0_0, 0_1 or 0_2 or by the TCI field in the corresponding DCI format 0_0, 0_1 or 0_2 or by repurposing one or more DCI fields in the corresponding DCI format 0_0, 0_1 or 0_2 reserved for beam indication, and the second TCI state codepoint could be indicated by the second TCI field in the corresponding DCI format 0_0, 0_1 or 0_2 or by repurposing one or more DCI fields in the corresponding DCI format 0_0, 0_1 or 0_2 reserved for beam indication.

In yet another example, the UE could first receive in an uplink DCI (e.g., DCI format 0_0, 0_1 or 0_2) the first and second TCI state codepoints configured/indicated, wherein a TCI state codepoint could correspond a TCI state or pair of TCI states, and one or more of the indicated TCI states or pairs of TCI states by the first or second TCI state codepoints could be associated with/mapped to one or more PDSCH transmissions/PDSCH transmission occasions as described above for the multi-TRP PDSCH (repetitions) reception. The UE could also receive in a DCI (e.g., DCI format 1_1 or 1_2 with or without DL assignment) a one-bit indicator to indicate TCI state codepoints ordering for PDSCH. For this design example, a new/dedicated DCI field could be used/configured in the corresponding DCI format to indicate the one-bit indicator; alternatively, one or more of the existing DCI fields in the corresponding DCI format could be used/configured to indicate the one-bit indicator.

In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit indicator is set to “0” (or “1”), or if the bit field of the SRS resource set indicator is set to “10” (or “11”) or the index of the SRS resource set indicator is set to “2” (or “3”) according to TABLE 1, the UE would first use TCI state codepoint x followed by TCI state codepoint y (a first ordering), and therefore the corresponding indicated TCI states/pair(s) of TCI states, to receive one or more PDSCH transmissions/transmission occasions associated with the TCI states/pair(s) of TCI states indicated by TCI state codepoint x followed by TCI state codepoint y, and if the one-bit indicator is set to “1” (or “0”), or if the bit field of the SRS resource set indicator is set to “11” (or “10”) or the index of the SRS resource set indicator is set to “3” (or “2”) according to TABLE 1, the UE would first use TCI state codepoint y followed by TCI state codepoint x (a second ordering), and therefore the corresponding indicated TCI states/pair(s) of TCI states, to receive one or more PDSCH transmissions/transmission occasions associated with the TCI states/pair(s) of TCI states indicated by TCI state codepoint y followed by TCI state codepoint x. The first ordering of the indicated TCI state codepoints {TCI state codepoint x, TCI state codepoint y} or the second ordering of the indicated TCI state codepoints {TCI state codepoint y, TCI state codepoint x} could be determined according to at least one of: (1) fixed in the system specification(s) and (2) configured, e.g., via higher layer RRC signaling or MAC CE command or DCI based signaling, by the network.

For both (1) and (2), TCI state codepoint x could correspond to the first (or second) TCI state codepoint, and TCI state codepoint y could correspond to the second (or first) TCI state codepoint. For this example, the first TCI state codepoint could be indicated by the first TCI field in the corresponding DCI format 0_0, 0_1 or 0_2 or by the TCI field in the corresponding DCI format 0_0, 0_1 or 0_2 or by repurposing one or more DCI fields in the corresponding DCI format 0_0, 0_1 or 0_2 reserved for beam indication, and the second TCI state codepoint could be indicated by the second TCI field in the corresponding DCI format 0_0, 0_1 or 0_2 or by repurposing one or more DCI fields in the corresponding DCI format 0_0, 0_1 or 0_2 reserved for beam indication.

In yet another example, the UE could first receive in an uplink DCI (e.g., DCI format 0_0, 0_1 or 0_2) M=1 (or N=1) TCI state or pair of TCI states indicated by a TCI state codepoint (or a TCI field). The UE could then receive in an uplink DCI (e.g., DCI format 0_0, 0_1 or 0_2) the first and second TCI state codepoints configured/indicated, wherein a TCI state codepoint could correspond a TCI state or pair of TCI states, and one or more of the indicated TCI states or pairs of TCI states by the first or second TCI state codepoints could be associated with/mapped to one or more PDSCH transmissions/transmission occasions as described above for the multi-TRP PDSCH (repetitions) reception.

For example, the UE would follow the latest indicated TCI states or pairs of TCI states by the first and second TCI state codepoints to receive one or more PDSCH transmissions/transmission occasions—i.e., multi-TRP PDSCH (repetitions) reception.

For another example, the UE could receive in a DCI (e.g., DCI format 1_1 or 1_2 with or without DL assignment) a one-bit flag indicator for PDSCH. For this design example, a new/dedicated DCI field could be used/configured in the corresponding DCI format to indicate the one-bit flag indicator; alternatively, one or more of the existing DCI fields in the corresponding DCI format could be used/configured to indicate the one-bit flag indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation.

For instance, if the one-bit flag indicator for PDSCH is set to “1” (or “0”) or “enabled,” or if the bit field of the SRS resource set indicator is set to “10” or “11” or the index of the SRS resource set indicator is set to “2” or “3” according to TABLE 1 or the SRS resource set indicator field is not configured/present, the UE would follow the latest indicated TCI states or pairs of TCI states by the first and second TCI state codepoints to receive one or more PDSCH transmissions/PDSCH transmission occasions—i.e., multi-TRP PDSCH (repetitions) reception. If the one-bit flag indicator for PDSCH is set to “0” (or “1”) or “disabled,” or if the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to receive one or more PDSCHs or one or more layers of a PDSCH—i.e., single-TRP PDSCH reception.

Yet for another example, the UE could receive in a DCI (e.g., DCI format 1_1 or 1_2 with or without DL assignment) a one-bit indicator for PDSCH. For this design example, a new/dedicated DCI field could be used/configured in the corresponding DCI format to indicate the one-bit indicator; alternatively, one or more of the existing DCI fields in the corresponding DCI format could be used/configured to indicate the one-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit indicator for PDSCH is set to “0” (or “1”), or if the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to receive one or more PDSCHs or one or more layers of a PDSCH—i.e., single-TRP PDSCH reception; if the one-bit indicator for PDSCH is set to “1” (or “0”), or if the bit field of the SRS resource set indicator is set to “10” or “11” or the index of the SRS resources set indicator is set to “2” or “3” according to TABLE 1 or the SRS resource set indicator field is not configured/present, the UE would follow the latest indicated TCI states or pairs of TCI states by the first and second TCI state codepoints to receive one or more PDSCH transmissions/transmission occasions—i.e., multi-TRP PDSCH (repetitions) reception.

For the above design examples, the first TCI state codepoint could be indicated by the first TCI field in the corresponding DCI format 0_0, 0_1 or 0_2 or by the TCI field in the corresponding DCI format 0_0, 0_1 or 0_2 or by repurposing one or more DCI fields in the corresponding DCI format 0_0, 0_1 or 0_2 reserved for beam indication, and the second TCI state codepoint could be indicated by the second TCI field in the corresponding DCI format 0_0, 0_1 or 0_2 or by repurposing one or more DCI fields in the corresponding DCI format 0_0, 0_1 or 0_2 reserved for beam indication.

In yet another example, the UE could first receive in an uplink DCI (e.g., DCI format 0_0, 0_1 or 0_2) the first and second TCI state codepoints configured/indicated, wherein a TCI state codepoint could correspond a TCI state or pair of TCI states, and one or more of the indicated TCI states or pairs of TCI states by the first or second TCI state codepoints could be associated with/mapped to one or more PDSCH transmissions/transmission occasions as described above for the multi-TRP PDSCH (repetitions) reception. The UE could also receive in a DCI (e.g., DCI format 1_1 or 1_2 with or without DL assignment) a multi-bit (>1 bit, e.g., 2-bit) indicator for PDSCH.

For this design example, a new/dedicated DCI field could be used/configured in the corresponding DCI format to indicate the multi-bit indicator; alternatively, one or more of the existing DCI fields in the corresponding DCI format could be used/configured to indicate the multi-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The multi-bit indicator for PDSCH or the SRS resource set indicator could indicate one or more of: (1) single-TRP PDSCH reception, (2) multi-TRP PDSCH (repetitions) reception, (3) one or more orderings of the indicated TCI state codepoints for single-TRP PDSCH reception or multi-TRP PDSCH (repetitions) reception, and (4) one or more TCI state codepoints for single-TRP PDSCH reception or multi-TRP PDSCH (repetitions) reception.

For example, the multi-bit indicator could correspond to a 2-bit indicator with four states “00,” “01,” “10” and “11.” For instance, if the 2-bit indicator is set to “00” (or “01”), or if the bit field of the SRS resource set indicator is set to “00” (or “01”) or the index of the SRS resource set indicator is set to “0” (or “1”) according to TABLE 1, the UE could use the TCI state(s) or pair(s) of TCI states indicated by one of the first and second TCI state codepoints to receive one or more PDSCHs or one or more layers of a PDSCH—i.e., PDSCH reception in a single-TRP system; if the 2-bit indicator is set to “01” (or “00”), or if the bit field of the SRS resource set indicator is set to “01” (or “00”) or the index of the SRS resource set indicator is set to “1” (or “0”) according to TABLE 1, the UE could use the TCI states or pairs of TCI states indicated by both of the first and second TCI state codepoints to receive one or more PDSCH transmissions/transmission occasions as described above—i.e., PDSCH (repetitions) reception in a multi-TRP system.

If the 2-bit indicator is set to “10” (or “11”), or if the bit field of the SRS resource set indicator is set to “10” (or “11”) or the index of the SRS resource set indicator is set to “2” (or “3”) according to TABLE 1, the UE would first use the first TCI state codepoint followed by the second TCI state codepoint, and therefore the corresponding indicated TCI states/pair(s) of TCI states, to receive one or more PDSCH transmissions/transmission occasions associated with the TCI states/pair(s) of TCI states indicated by the first TCI state codepoint followed by the second TCI state codepoint; if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would first use the second TCI state codepoint followed by the first TCI state codepoint, and therefore the corresponding indicated TCI states/pair(s) of TCI states, to receive one or more PDSCH transmissions/transmission occasions associated with the TCI states/pair(s) of TCI states indicated by the second TCI state codepoint followed by the first TCI state codepoint (according to examples in the present disclosure).

Alternatively, if the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow a first ordering of the indicated TCI state codepoints, and therefore the corresponding indicated TCI states/pair(s) of TCI states, to receive one or more PDSCH transmissions/transmission occasions associated with the TCI states/pair(s) of TCI states indicated by the TCI state codepoints in the first ordering; if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow a second ordering of the indicated TCI state codepoints, and therefore the corresponding indicated TCI states/pair(s) of TCI states, to receive one or more PDSCH transmissions/transmission occasions associated with the TCI states/pair(s) of TCI states indicated by the TCI state codepoints in the second ordering. The first and second orderings of the indicated (first and second) TCI state codepoints could be according to examples provided in the present disclosure.

Optionally, “00” or “01” of the 2-bit indicator, or the bit fields “00” or “01” or the indexes “0” or “1” of the 2-bit SRS resource set indicator, could be used to indicate the orderings of the indicated (first and second) TCI state codepoints for multi-TRP PDSCH (repetitions) reception as described above, and “10” or “11” of the 2-bit indicator, or the bit fields “10” or “11” or the indexes “2” or “3” of the 2-bit SRS resource set indicator, could be used to indicate the single-TRP PDSCH reception or the multi-TRP PDSCH (repetitions) reception as described above.

For another example, the multi-bit indicator could correspond to a 2-bit indicator with four states “00,” “01,” “10” and “11.” For instance, if the 2-bit indicator is set to “00” (or “01”), or if the bit field of the SRS resource set indicator is set to “00” (or “01”) or the index of the SRS resource set indicator is set to “0” (or “1”) according to TABLE 1, the UE could use the primary TCI state codepoint, and therefore the corresponding indicated TCI state(s)/pair(s) of TCI states, to receive one or more PDSCHs or one or more layers of a PDSCH—i.e., PDSCH reception in a single-TRP system; if the 2-bit indicator is set to “01” (or “00”), or if the bit field of the SRS resource set indicator is set to “10” (or “00”) or the index of the SRS resource set indicator is set to “1” (or “0”) according to TABLE 1, the UE could use the secondary TCI state codepoint, and therefore the corresponding TCI state(s)/pair(s) of TCI states, to receive one or more PDSCHs or one or more layers of a PDSCH—i.e., PDSCH reception in a single-TRP system; the primary and secondary TCI state codepoints could be determined/configured.

If the 2-bit indicator is set to “10” (or “11”), or if the bit field of the SRS resource set indicator is set to “10” (or “11”) or the index of the SRS resource set indicator is set to “2” (or “3”) according to TABLE 1, the UE would first use the first TCI state codepoint followed by the second TCI state codepoint, and therefore the corresponding indicated TCI states/pair(s) of TCI states, to receive one or more PDSCH transmissions/transmission occasions associated with the TCI states/pair(s) of TCI states indicated by the first TCI state codepoint followed by the second TCI state codepoint; if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would first use the second TCI state codepoint followed by the first TCI state codepoint, and therefore the corresponding indicated TCI states/pair(s) of TCI states, to receive one or more PDSCH transmissions/transmission occasions associated with the TCI states/pair(s) of TCI states indicated by the second TCI state codepoint followed by the first TCI state codepoint.

Alternatively, if the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow a first ordering of the indicated TCI state codepoints, and therefore the corresponding indicated TCI states/pair(s) of TCI states, to receive one or more PDSCH transmissions/transmission occasions associated with the TCI states/pair(s) of TCI states indicated by the TCI state codepoints in the first ordering; if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow a second ordering of the indicated TCI state codepoints, and therefore the corresponding indicated TCI states/pair(s) of TCI states, to receive one or more PDSCH transmissions/transmission occasions associated with the TCI states/pair(s) of TCI states indicated by the TCI state codepoints in the second ordering. The first and second orderings of the indicated (first and second) TCI state codepoints could be according to examples provided in the present disclosure.

Optionally, “00” or “01” of the 2-bit indicator, or the bit fields “00” or “01” or the indexes “0” or “1” of the 2-bit SRS resource set indicator, could be used to indicate the orderings of the indicated (first and second) TCI state codepoints for multi-TRP PDSCH (repetitions) reception as described above, and “10” or “11” of the 2-bit indicator, or the bit fields “10” or “11” or the indexes “2” or “3” of the 2-bit SRS resource set indicator, could be used to indicate the primary or secondary TCI state codepoints for single-TRP PDSCH reception as described above.

Yet for another example, the multi-bit indicator could correspond to a 2-bit indicator with four states “00,” “01,” “10” and “11,” configured according to those specified in examples. In addition to the 2-bit indicator or the 2-bit SRS resource set indicator configured according to examples provided in the present disclosure, the UE could also receive in a DCI (e.g., DCI format 1_1 or 1_2 with or without DL assignment) a one-bit indicator. For this design example, a new/dedicated DCI field could be used/configured in the corresponding DCI format to indicate the one-bit indicator; alternatively, one or more of the existing DCI fields in the corresponding DCI format could be used/configured to indicate the one-bit indicator. When the 2-bit indicator or the 2-bit SRS resource set indicator indicates the single-TRP PDSCH reception, if the one-bit indicator is set to “0” (or “1”), the UE could use the primary TCI state codepoint, and therefore the corresponding indicated TCI state(s)/pair(s) of TCI states, to receive one or more PDSCHs or one or more layers of a PDSCH; if the one-bit indicator is set to “1” (or “0”), the UE could use the secondary TCI state codepoint, and therefore the corresponding indicated TCI state(s)/pair(s) of TCI states, to receive one or more PDSCHs or one or more layers of a PDSCH; the primary and secondary TCI state codepoints could be determined/configured according to examples provided in the present disclosure.

Yet for another example, the multi-bit indicator or the SRS resource set indicator could correspond to a z-bit indicator (z>1, e.g., z=3) with 2\hat{ }z states (e.g., 8 states or bit fields for z=3). In this example, a first state or bit field of the z-bit indicator could indicate that the single-TRP PDSCH reception is enabled according to examples and the corresponding sub-examples in the present disclosure, a second state or bit field of the z-bit indicator could indicate that the multi-TRP PDSCH (repetitions) reception is enabled according to examples and the corresponding sub-examples in the present disclosure, a third state or bit field of the z-bit indicator could indicate that the UE could use the primary TCI state codepoint (and therefore the corresponding indicated TCI state(s)/pair(s) of TCI states) for the single-TRP PDSCH reception, a fourth state or bit field of the z-bit indicator could indicate that the UE could use the secondary TCI state codepoint (and therefore the corresponding indicated TCI state(s)/pair(s) of TCI states) for the single-TRP PDSCH reception, a fifth state or bit field of the z-bit indicator could indicate an ordering of the indicated (first and second) TCI state codepoints for the multi-TRP PDSCH (repetitions) reception, a sixth state or bit field of the z-bit indicator could indicate another ordering of the indicated (first and second) TCI state codepoints for the multi-TRP PDSCH (repetitions) reception.

For the design examples provided in the present disclosure, the first TCI state codepoint could be indicated by the first TCI field in the corresponding DCI format 0_0, 0_1 or 0_2 or by the TCI field in the corresponding DCI format 0_0, 0_1 or 0_2 or by repurposing one or more DCI fields in the corresponding DCI format 0_0, 0_1 or 0_2 reserved for beam indication, and the second TCI state codepoint could be indicated by the second TCI field in the corresponding DCI format 0_0, 0_1 or 0_2 or by repurposing one or more DCI fields in the corresponding DCI format 0_0, 0_1 or 0_2 reserved for beam indication.

In yet another example, the UE could first receive in an uplink DCI (e.g., DCI format 0_0, 0_1 or 0_2) M=1 (or N=1) TCI state or pair of TCI states indicated by a TCI state codepoint (or a TCI field). The UE could then receive in an uplink DCI (e.g., DCI format 0_0, 0_1 or 0_2) the first and second TCI state codepoints configured/indicated according examples provided in the present disclosure, wherein a TCI state codepoint could correspond a TCI state or pair of TCI states, and one or more of the indicated TCI states or pairs of TCI states by the first or second TCI state codepoints could be associated with/mapped to one or more PDSCH transmissions/PDSCH transmission occasions as described above for the multi-TRP PDSCH (repetitions) reception.

Furthermore, the UE could receive in a DCI (e.g., DCI format 1_1 or 1_2 with or without DL assignment) a multi-bit (>1 bit, e.g., 2-bit) indicator for PDSCH. For this design example, a new/dedicated DCI field could be used/configured in the corresponding DCI format to indicate the multi-bit indicator; alternatively, one or more of the existing DCI fields in the corresponding DCI format could be used/configured to indicate the multi-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The multi-bit indicator for PDSCH or the SRS resource set indicator could indicate one or more of: (1) single-TRP PDSCH reception, (2) multi-TRP PDSCH (repetitions) reception, (3) one or more orderings of the indicated TCI state codepoints for single-TRP PDSCH reception or multi-TRP PDSCH (repetitions) reception, and (4) one or more TCI state codepoints for single-TRP PDSCH reception or multi-TRP PDSCH (repetitions) reception.

The multi-bit indicator or the SRS resource set indicator could be configured according to examples provided in the present disclosure. For this example, if the multi-bit indicator or the SRS resource set indicator indicates that the single-TRP PDSCH reception is enabled, the UE could follow the previously indicated M=1 (or N=1) TCI state or pair of TCI states to receive one or more PDSCHs or one or more layers of a PDSCH (as discussed in examples and the corresponding sub-examples in the present disclosure).

Furthermore, for this example, the first TCI state codepoint could be indicated by the first TCI field in the corresponding DCI format 0_0, 0_1 or 0_2 as specified in examples or by the TCI field in the corresponding DCI format 0_0, 0_1 or 0_2 or by repurposing one or more DCI fields in the corresponding DCI format 0_0, 0_1 or 0_2 reserved for beam indication and the second TCI state codepoint could be indicated by the second TCI field in the corresponding DCI format 0_0, 0_1 or 0_2 or by repurposing one or more DCI fields in the corresponding DCI format 0_0, 0_1 or 0_2 reserved for beam indication.

Furthermore, the UE could receive in a DCI (e.g., DCI format 1_1 or 1_2 with or without DL assignment) one or more bits to indicate at least one of: (1) switching between single-TRP PUCCH or PUSCH transmission and multi-TRP PUCCH or PUSCH (repetitions) transmission, (2) which TCI state codepoint(s), and therefore, the corresponding indicated TCI states or pairs of TCI states, to use for the single-TRP PUCCH or PUSCH transmission, and (3) switching the order of the indicated first and second TCI state codepoints (and therefore, the corresponding indicated TCI states or pairs of TCI states) for multi-TRP PUCCH or PUSCH (repetitions) transmission.

In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The SRS resource set indicator could also indicate one or more of: (1) switching between single-TRP PUCCH or PUSCH transmission and multi-TRP PUCCH or PUSCH (repetitions) transmission, (2) one or more of the indicated M>1 (or N>1) TCI states or pairs of TCI states to use for the single-TRP PUCCH or PUSCH transmission, and (3) switching the order of the indicated M>1 (or N>1) TCI states or pairs of TCI states for multi-TRP PUCCH or PUSCH (repetitions) transmission.

In one example, the UE could first receive in an uplink DCI (e.g., DCI format 0_0, 0_1 or 0_2) the first and second TCI state codepoints configured/indicated according to examples provided in the present disclosure, wherein a TCI state codepoint could correspond a TCI state or pair of TCI states and the corresponding sub-examples in the present disclosure, and one or more of the indicated TCI states or pairs of TCI states by the first or second TCI state codepoints could be associated with/mapped to one or more PUCCH transmission repetitions or PUSCH transmission repetitions as described above for the multi-TRP PUCCH or PUSCH (repetitions) transmission. The UE could also receive in a DCI (e.g., DCI format 1_1 or 1_2 with or without DL assignment) a one-bit flag indicator for PUCCH or PUSCH.

For this design example, a new/dedicated DCI field could be used/configured in the corresponding DCI format to indicate the one-bit flag indicator; alternatively, one or more of the existing DCI fields in the corresponding DCI format could be used/configured to indicate the one-bit flag indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit flag indicator for PUCCH or PUSCH is set to “1” (or “0”) or “enabled,” or if the bit field of the SRS resource set indicator is set to “00” or “01” or the index of the SRS resource set indicator is set to “0” or “1” according to TABLE 1 or the SRS resource set indicator field is not configured/present, the UE could use the TCI state(s) or pair(s) of TCI states indicated by one of the first and second TCI state codepoints to transmit PUCCH(s) or PUSCH(s)—i.e., PUCCH or PUSCH transmission in a single-TRP system; if the one-bit flag indicator for PUCCH or PUSCH is set to “0” (or “1”) or “disabled,” or if the bit field of the SRS resource set indicator is set to “10” or “11” or the index of the SRS resource set indicator is set to “2” or “3” or the SRS resource set indicator field is not configured/present, the UE could use the TCI states or pairs of TCI states indicated by both of the first and second TCI state codepoints to transmit PUCCH transmission repetitions or PUSCH transmission repetitions—i.e., PUCCH or PUSCH (repetitions) transmission in a multi-TRP system.

More specifically, if the one-bit flag indicator for PUCCH or PUSCH is set to “1” (or “0”) or “enabled,” or if the bit field of the SRS resource set indicator is set to “00” or “01” or the index of the SRS resource set indicator is set to “0” or “1” according to TABLE 1 or the SRS resource set indicator field is not configured/present (i.e., for the PUCCH or PUSCH transmission in a single-TRP system),

For example, the UE could use the TCI state(s)/pair(s) of TCI states indicated in the TCI field in the corresponding DCI format (e.g., DCI format 0_0, 0_1 or 0_2) to transmit the PUCCH(s) or PUSCH(s).

For another example, the UE could use one or more of the TCI states/pairs of TCI states indicated by the first TCI state codepoint (e.g., indicated by the TCI field in the corresponding DCI format or by repurposing one or more DCI fields reserved for beam indication in the corresponding DCI format) to transmit the PUCCH(s) or PUSCH(s).

Yet for another example, the UE could use one or more of the TCI states/pairs of TCI states indicated by the second TCI state codepoint (e.g., indicated by repurposing one or more DCI fields reserved for beam indication in the corresponding DCI format) to transmit the PUCCH(s) or PUSCH(s).

Yet for another example, the UE could use the separate UL TCI state or the joint DL and UL TCI state among the indicated TCI states by the first and second TCI state codepoints to transmit the PUCCH(s) or PUSCH(s). In this example, only one of the indicated TCI states by the first and second TCI state codepoints could correspond to a separate UL TCI state or a joint DL and UL TCI state.

Yet for another example, the UE could be higher layer configured by the network a list of K entity IDs. In the present disclosure, an entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. The UE could use the TCI state or the pair of TCI states indicated by the first or second TCI state codepoint that is associated with the first entity ID or the second entity ID or the last entity ID or the lowest entity ID or the highest entity ID or the second lowest (or second highest) entity ID or the entity ID associated with the serving cell PCI/PCI index or the entity ID associated with a PCI/PCI index different from the serving cell PCI/PCI index or the k-th entity ID or the k-th lowest (or highest) entity ID among the list of K entity IDs to transmit the PUCCH(s) or PUSCH(s), where k∈{1, . . . , K}. In this example, the index k could be determined according to at least one of: (1) fixed in the system specification(s) and (2) configured, e.g., via higher layer RRC signaling or MAC CE command or DCI based signaling, by the network. Furthermore, K could be equal to M (or N) or 2.

Yet for another example, the UE could be higher layer configured by the network a list of L PCIs. The UE could use the TCI state or the pair of TCI states indicated by the first or second TCI state codepoint that is associated with the first PCI or the second PCI or the last PCI or the lowest PCI or the highest PCI or the second lowest (or second highest) PCI or the serving cell PCI or a PCI different from the serving cell PCI or the l-th PCI or the l-th lowest (or highest) PCI among the list of L PCIs to transmit the PUCCH(s) or PUSCH(s), where l∈{1, . . . , L}.

Alternatively, the UE could determine a list of L PCI indexes 0, . . . , L−1 or 1, . . . , L with each PCI index pointing to an entry in the list of L PCIs. For this case, the UE could use the TCI state or the pair of TCI states indicated by the first or second TCI state codepoint that is associated with the first PCI index or the second PCI index or the last PCI index or the lowest PCI index or the highest PCI index or the second lowest (or second highest) PCI index or the serving cell PCI index or a PCI index different from the serving cell PCI index or the l-th PCI index or the l-th lowest (or highest) PCI index among the list of L PCI indexes to transmit the PUCCH(s) or PUSCH(s), where l∈{1, . . . , L}. In this example, the index l could be determined according to at least one of: (1) fixed in the system specification(s) and (2) configured, e.g., via higher layer RRC signaling or MAC CE command or DCI based signaling, by the network. Furthermore, L could be equal to M (or N) or 2.

Yet for another example, the UE could be provided in PDCCH-Config two values of CORESETPoolIndex (i.e., 0 and 1) for one or more CORESETs. The UE could use the TCI state or the pair of TCI states indicated by the first or second TCI state codepoint that is associated with value 0 of CORESETPoolIndex or value 1 of CORESETPoolIndex or value x of CORESETPoolIndex to transmit the PUCCH(s) or PUSCH(s), where x∈{0, 1}. In this example, the value x could be determined according to at least one of: (1) fixed in the system specification(s) and (2) configured, e.g., via higher layer RRC signaling or MAC CE command or DCI based signaling, by the network.

For the design examples provided in the present disclosure, the first TCI state codepoint could be indicated by the first TCI field in the corresponding DCI format 0_0, 0_1 or 0_2 or by the TCI field in the corresponding DCI format 0_0, 0_1 or 0_2 or by repurposing one or more DCI fields in the corresponding DCI format 0_0, 0_1 or 0_2 reserved for beam indication, and the second TCI state codepoint could be indicated by the second TCI field in the corresponding DCI format 0_0, 0_1 or 0_2 or by repurposing one or more DCI fields in the corresponding DCI format 0_0, 0_1 or 0_2 reserved for beam indication.

In another example, the UE could first receive in an uplink DCI (e.g., DCI format 0_0, 0_1 or 0_2) the first and second TCI state codepoints configured/indicated according to the examples provided in the present disclosure, wherein a TCI state codepoint could correspond a TCI state or pair of TCI states, and one or more of the indicated TCI states or pairs of TCI states by the first or second TCI state codepoints could be associated with/mapped to one or more PUCCH transmission repetitions or PUSCH transmission repetitions as described above for the multi-TRP PUCCH or PUSCH (repetitions) transmission. The UE could also receive in a DCI (e.g., DCI format 1_1 or 1_2 with or without DL assignment) a one-bit indicator for PUCCH or PUSCH.

For this design example, a new/dedicated DCI field could be used/configured in the corresponding DCI format to indicate the one-bit indicator; alternatively, one or more of the existing DCI fields in the corresponding DCI format could be used/configured to indicate the one-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP and multi-TRP operation. If the one-bit indicator for PUCCH or PUSCH is set to “0” (or “1”), or if the bit field of the SRS resource set indicator is set to “00” (or “01”) or the index of the SRS resource set indicator is set to “0” (or “1”) according to TABLE 1, the UE could use the TCI state(s) or pair(s) of TCI states indicated by a primary TCI state codepoint to transmit PUCCH(s) or PUSCH(s)—i.e., PUCCH or PUSCH transmission in a single-TRP system; if the one-bit indicator for PUCCH or PUSCH is set to “1” (or “0”), or if the bit field of the SRS resource set indicator is set to “01” (or “00”) or the index of the SRS resource set indicator is set to “1” (or “0”) according to TABLE 1, the UE could use the TCI state(s) or pair(s) of TCI states indicated by a secondary TCI state codepoint to transmit PUCCH(s) or PUSCH(s)—i.e., PUCCH or PUSCH transmission in a single-TRP system.

Various design examples of determining the primary TCI state codepoint or the secondary TCI state codepoint are provided in the present disclosure. For this example, the first TCI state codepoint could be indicated by the first TCI field in the corresponding DCI format 0_0, 0_1 or 0_2 or by the TCI field in the corresponding DCI format 0_0, 0_1 or 0_2 or by repurposing one or more DCI fields in the corresponding DCI format 0_0, 0_1 or 0_2 reserved for beam indication, and the second TCI state codepoint could be indicated by the second TCI field in the corresponding DCI format 0_0, 0_1 or 0_2 or by repurposing one or more DCI fields in the corresponding DCI format 0_0, 0_1 or 0_2 reserved for beam indication.

In yet another example, the UE could first receive in an uplink DCI (e.g., DCI format 0_0, 0_1 or 0_2) the first and second TCI state codepoints configured/indicated according to the example in the present disclosure, wherein a TCI state codepoint could correspond a TCI state or pair of TCI states as specified in examples and the corresponding sub-examples in the present disclosure, and one or more of the indicated TCI states or pairs of TCI states by the first or second TCI state codepoints could be associated with/mapped to one or more PUCCH transmission repetitions or PUSCH transmission repetitions as described above for the multi-TRP PUCCH or PUSCH (repetitions) reception. The UE could also receive in a DCI (e.g., DCI format 1_1 or 1_2 with or without DL assignment) a one-bit flag indicator to indicate TCI state codepoints ordering for PUCCH or PUSCH. For this design example, a new/dedicated DCI field could be used/configured in the corresponding DCI format to indicate the one-bit flag indicator; alternatively, one or more of the existing DCI fields in the corresponding DCI format could be used/configured to indicate the one-bit flag indicator.

In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit flag indicator is set to “1” (or “0”) or “enabled,” or if the bit field of the SRS resource set indicator is set to “11” (or “10”) or the index of the SRS resource set indicator is set to “3” (or “2”) according to TABLE 1 or the SRS resource set indicator field is not configured/present, the UE would first use the second TCI state codepoint followed by the first TCI state codepoint, and therefore the corresponding indicated TCI states/pair(s) of TCI states, to transmit one or more PUCCH transmission repetitions or PUSCH transmission repetitions associated with the TCI states/pair(s) of TCI states indicated by the second TCI state codepoint followed by the first TCI state codepoint, and if the one-bit flag indicator is set to “0” (or “1”) or “disabled,” or if the bit field of the SRS resource set indicator is set to “10” (or “11”) or the index of the SRS resource set indicator is set to “2” (or “3”) according to TABLE 1 or the SRS resource set indicator field is not configured/present, the UE would first use the first TCI state codepoint followed by the second TCI state codepoint, and therefore the corresponding indicated TCI states/pair(s) of TCI states, to transmit one or more PUCCH transmission repetitions or PUSCH transmission repetitions associated with the TCI states/pair(s) of TCI states indicated by the first TCI state codepoint followed by the second TCI state codepoint.

For this example, the first TCI state codepoint could be indicated by the first TCI field in the corresponding DCI format 0_0, 0_1 or 0_2 as specified in examples or by the TCI field in the corresponding DCI format 0_0, 0_1 or 0_2 as specified in examples or by repurposing one or more DCI fields in the corresponding DCI format 0_0, 0_1 or 0_2 reserved for beam indication as specified in examples and the second TCI state codepoint could be indicated by the second TCI field in the corresponding DCI format 0_0, 0_1 or 0_2 as specified in examples or by repurposing one or more DCI fields in the corresponding DCI format 0_0, 0_1 or 0_2 reserved for beam indication as specified in examples.

In yet another example, the UE could first receive in an uplink DCI (e.g., DCI format 0_0, 0_1 or 0_2) the first and second TCI state codepoints configured/indicated according to examples in the present disclosure, wherein a TCI state codepoint could correspond a TCI state or pair of TCI states as specified in examples and the corresponding sub-examples in the present disclosure, and one or more of the indicated TCI states or pairs of TCI states by the first or second TCI state codepoints could be associated with/mapped to one or more PUCCH transmission repetitions or PUSCH transmission repetitions as described above for the multi-TRP PUCCH or PUSCH (repetitions) transmission.

The UE could also receive in a DCI (e.g., DCI format 1_1 or 1_2 with or without DL assignment) a one-bit indicator to indicate TCI state codepoints ordering for PUCCH or PUSCH. For this design example, a new/dedicated DCI field could be used/configured in the corresponding DCI format to indicate the one-bit indicator; alternatively, one or more of the existing DCI fields in the corresponding DCI format could be used/configured to indicate the one-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation.

For instance, if the one-bit indicator is set to “0” (or “1”), or if the bit field of the SRS resource set indicator is set to “10” (or “11”) or the index of the SRS resource set indicator is set to “2” (or “3”) according to TABLE 1, the UE would first use TCI state codepoint x followed by TCI state codepoint y (a first ordering), and therefore the corresponding indicated TCI states/pair(s) of TCI states, to transmit one or more PUCCH transmission repetitions or PUSCH transmission repetitions associated with the TCI states/pair(s) of TCI states indicated by TCI state codepoint x followed by TCI state codepoint y, and if the one-bit flag indicator is set to “1” (or “0”), or if the bit field of the SRS resource set indicator is set to “11” (or “10”) or the index of the SRS resource set indicator is set to “3” (or “2”) according to TABLE 1, the UE would first use TCI state codepoint y followed by TCI state codepoint x (a second ordering), and therefore the corresponding indicated TCI states/pair(s) of TCI states, to transmit one or more PUCCH transmission repetitions or PUSCH transmission repetitions associated with the TCI states/pair(s) of TCI states indicated by TCI state codepoint y followed by TCI state codepoint x.

The first ordering of the indicated TCI state codepoints {TCI state codepoint x, TCI state codepoint y} or the second ordering of the indicated TCI state codepoints {TCI state codepoint y, TCI state codepoint x} could be determined according to at least one of: (1) fixed in the system specification(s) and (2) configured, e.g., via higher layer RRC signaling or MAC CE command or DCI based signaling, by the network. For both (1) and (2), TCI state codepoint x could correspond to the first (or second) TCI state codepoint, and TCI state codepoint y could correspond to the second (or first) TCI state codepoint. For this example, the first TCI state codepoint could be indicated by the first TCI field in the corresponding DCI format 0_0, 0_1 or 0_2 as specified in examples or by the TCI field in the corresponding DCI format 1_1 or 1_2 with or without DL assignment as specified in examples or by repurposing one or more DCI fields in the corresponding DCI format 0_0, 0_1 or 0_2 reserved for beam indication as specified in examples and the second TCI state codepoint could be indicated by the second TCI field in the corresponding DCI format 0_0, 0_1 or 0_2 as specified in examples or by repurposing one or more DCI fields in the corresponding DCI format 0_0, 0_1 or 0_2 reserved for beam indication as specified in examples in the present disclosure.

In yet another example, the UE could first receive in an uplink DCI (e.g., DCI format 0_0, 0_1 or 0_2) M=1 (or N=1) TCI state or pair of TCI states indicated by a TCI state codepoint (or a TCI field) as specified in examples and the corresponding sub-examples in the present disclosure. The UE could then receive in an uplink DCI (e.g., DCI format 0_0, 0_1 or 0_2) the first and second TCI state codepoints configured/indicated according to examples in the present disclosure, wherein a TCI state codepoint could correspond a TCI state or pair of TCI states as specified in examples and the corresponding sub-examples in the present disclosure, and one or more of the indicated TCI states or pairs of TCI states by the first or second TCI state codepoints could be associated with/mapped to one or more PUCCH transmission repetitions or PUSCH transmission repetitions as described above for the multi-TRP PUCCH or PUSCH (repetitions) transmission.

For example, the UE would follow the latest indicated TCI states or pairs of TCI states by the first and second TCI state codepoints to transmit one or more PUCCH transmission repetitions or PUSCH transmission repetitions—i.e., multi-TRP PUCCH or PUSCH (repetitions) transmission.

For another example, the UE could receive in a DCI (e.g., DCI format 1_1 or 1_2 with or without DL assignment) a one-bit flag indicator for PUCCH or PUSCH. For this design example, a new/dedicated DCI field could be used/configured in the corresponding DCI format to indicate the one-bit flag indicator; alternatively, one or more of the existing DCI fields in the corresponding DCI format could be used/configured to indicate the one-bit flag indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation.

For instance, if the one-bit flag indicator for PUCCH or PUSCH is set to “1” (or “0”) or “enabled,” or if the bit field of the SRS resource set indicator is set to “10” or “11” or the index of the SRS resource set indicator is set to “2” or “3” according to TABLE 1 or the SRS resource set indicator field is not configured/present, the UE would follow the latest indicated TCI states or pairs of TCI states by the first and second TCI state codepoints to transmit one or more PUCCH transmission repetitions or PUSCH transmission repetitions—i.e., multi-TRP PUCCH or PUSCH (repetitions) transmission. If the one-bit flag indicator for PUCCH or PUSCH is set to “0” (or “1”) or “disabled,” or if the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to transmit PUCCH(s) or PUSCH(s)—i.e., single-TRP PUCCH or PUSCH transmission.

Yet for another example, the UE could receive in a DCI (e.g., DCI format 1_1 or 1_2 with or without DL assignment) a one-bit indicator for PUCCH or PUSCH. For this design example, a new/dedicated DCI field could be used/configured in the corresponding DCI format to indicate the one-bit indicator; alternatively, one or more of the existing DCI fields in the corresponding DCI format could be used/configured to indicate the one-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation.

For instance, if the one-bit indicator for PUCCH or PUSCH is set to “0” (or “1”), or if the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to transmit PUCCH(s) or PUSCH(s)—i.e., single-TRP PUCCH or PUSCH transmission; if the one-bit indicator for PUCCH or PUSCH is set to “1” (or “0”), or if the bit field of the SRS resource set indicator is set to “10” or “11” or the index of the SRS resource set indicator is set to “2” or “3” according to TABLE 1 or the SRS resource set indicator field is not configured/present, the UE would follow the latest indicated TCI states or pairs of TCI states by the first and second TCI state codepoints to transmit one or more PUCCH transmission repetitions or PUSCH transmission repetitions—i.e., multi-TRP PUCCH or PUSCH (repetitions) transmission.

For the above design examples, the first TCI state codepoint could be indicated by the first TCI field in the corresponding DCI format 0_0, 0_1 or 0_2 as specified in examples or by the TCI field in the corresponding DCI format 0_0, 0_1 or 0_2 as specified in examples or by repurposing one or more DCI fields in the corresponding DCI format 0_0, 0_1 or 0_2 reserved for beam indication as specified in examples, and the second TCI state codepoint could be indicated by the second TCI field in the corresponding DCI format 0_0, 0_1 or 0_2 as specified in examples or by repurposing one or more DCI fields in the corresponding DCI format 0_0, 0_1 or 0_2 reserved for beam indication as specified in examples in the present disclosure.

In yet another example, the UE could first receive in an uplink DCI (e.g., DCI format 0_0, 0_1 or 0_2) the first and second TCI state codepoints configured/indicated according to examples in the present disclosure, wherein a TCI state codepoint could correspond a TCI state or pair of TCI states as specified in examples and the corresponding sub-examples in the present disclosure, and one or more of the indicated TCI states or pairs of TCI states by the first or second TCI state codepoints could be associated with/mapped to one or more PUCCH transmission repetitions or PUSCH transmission repetitions as described above for the multi-TRP PUCCH or PUSCH (repetitions) transmission. The UE could also receive in a DCI (e.g., DCI format 1_1 or 1_2 with or without DL assignment) a multi-bit (>1 bit, e.g., 2-bit) indicator for PUCCH or PUSCH. For this design example, a new/dedicated DCI field could be used/configured in the corresponding DCI format to indicate the multi-bit indicator; alternatively, one or more of the existing DCI fields in the corresponding DCI format could be used/configured to indicate the multi-bit indicator.

In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP and multi-TRP operation. The multi-bit indicator for PUCCH or PUSCH or the SRS resource set indicator could indicate one or more of: (1) single-TRP PUCCH or PUSCH transmission, (2) multi-TRP PUCCH or PUSCH (repetitions) transmission, (3) one or more orderings of the indicated TCI state codepoints for single-TRP PUCCH or PUSCH transmission or multi-TRP PUCCH or PUSCH (repetitions) transmission, and (4) one or more TCI state codepoints for single-TRP PUCCH or PUSCH transmission or multi-TRP PUCCH or PUSCH (repetitions) transmission.

For example, the multi-bit indicator could correspond to a 2-bit indicator with four states “00,” “01,” “10” and “11.” For instance, if the 2-bit indicator is set to “00” (or “01”), or if the bit field of the SRS resource set indicator is set to “00” (or “01”) or the index of the SRS resource set indicator is set to “0” (or “1”) according to TABLE 1, the UE could use the TCI state(s) or pair(s) of TCI states indicated by one of the first and second TCI state codepoints to transmit PUCCH(s) or PUSCH(s)—i.e., PUCCH or PUSCH transmission in a single-TRP system—following the design examples specified in examples in the present disclosure; if the 2-bit indicator is set to “01” (or “00”), or if the bit field of the SRS resource set indicator is set to “01” (or “00”) or the index of the SRS resource set indicator is set to “1” (or “0”) according to TABLE 1, the UE could use the TCI states or pairs of TCI states indicated by both of the first and second TCI state codepoints to transmit one or more PUCCH transmission repetitions or PUSCH transmission repetitions as described above—i.e., PUCCH or PUSCH (repetitions) transmission in a multi-TRP system. If the 2-bit indicator is set to “10” (or “11”), or if the bit field of the SRS resource set indicator is set to “10” (or “11”) or the index of the SRS resource set indicator is set to “2” (or “3”) according to TABLE 1, the UE would first use the first TCI state codepoint followed by the second TCI state codepoint, and therefore the corresponding indicated TCI states/pair(s) of TCI states, to transmit one or more PUCCH transmission repetitions or PUSCH transmission repetitions associated with the TCI states/pair(s) of TCI states indicated by the first TCI state codepoint followed by the second TCI state codepoint (according to examples in the present disclosure); if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would first use the second TCI state codepoint followed by the first TCI state codepoint, and therefore the corresponding indicated TCI states/pair(s) of TCI states, to transmit one or more PUCCH transmission repetitions or PUSCH transmission repetitions associated with the TCI states/pair(s) of TCI states indicated by the second TCI state codepoint followed by the first TCI state codepoint (according to examples in the present disclosure).

Alternatively, if the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow a first ordering of the indicated TCI state codepoints, and therefore the corresponding indicated TCI states/pair(s) of TCI states, to transmit one or more PUCCH transmission repetitions or PUSCH transmission repetitions associated with the TCI states/pair(s) of TCI states indicated by the TCI state codepoints in the first ordering; if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow a second ordering of the indicated TCI state codepoints, and therefore the corresponding indicated TCI states/pair(s) of TCI states, to transmit one or more PUCCH transmission repetitions or PUSCH transmission repetitions associated with the TCI states/pair(s) of TCI states indicated by the TCI state codepoints in the second ordering. The first and second orderings of the indicated (first and second) TCI state codepoints could be according to those specified in examples in the present disclosure. Optionally, “00” or “01” of the 2-bit indicator, or the bit fields “00” or “01” or the indexes “0” or “1” of the 2-bit SRS resource set indicator, could be used to indicate the orderings of the indicated (first and second) TCI state codepoints for multi-TRP PUCCH or PUSCH (repetitions) transmission as described above, and “10” or “11” of the 2-bit indicator, or the bit fields “10” or “11” or the indexes “2” or “3” of the 2-bit SRS resource set indicator, could be used to indicate the single-TRP PUCCH/PUSCH transmission or the multi-TRP PUCCH/PUSCH (repetitions) transmission as described above.

For another example, the multi-bit indicator could correspond to a 2-bit indicator with four states “00,” “01,” “10” and “11.” For instance, if the 2-bit indicator is set to “00” (or “01”), or if the bit field of the SRS resource set indicator is set to “00” (or “01”) or the index of the SRS resource set indicator is set to “0” (or “1”) according to TABLE 1, the UE could use the primary TCI state codepoint, and therefore the corresponding indicated TCI state(s)/pair(s) of TCI states, to transmit PUCCH(s) or PUSCH(s)—i.e., PUCCH or PUSCH transmission in a single-TRP system; if the 2-bit indicator is set to “01” (or “00”), or if the bit field of the SRS resource set indicator is set to “01” (or “00”) or the index of the SRS resource set indicator is set to “1” (or “2”) according to TABLE 1, the UE could use the secondary TCI state codepoint, and therefore the corresponding TCI state(s)/pair(s) of TCI states, to transmit PUCCH(s) or PUSCH(s)—i.e., PUCCH or PUSCH transmission in a single-TRP system; the primary and secondary TCI state codepoints could be determined/configured according to those specified in examples in the present disclosure. If the 2-bit indicator is set to “10” (or “11”), or if the bit field of the SRS resource set indicator is set to “10” (or “11”) or the index of the SRS resource set indicator is set to “2” (or “3”) according to TABLE 1, the UE would first use the first TCI state codepoint followed by the second TCI state codepoint, and therefore the corresponding indicated TCI states/pair(s) of TCI states, to transmit one or more PUCCH transmission repetitions or PUSCH transmission repetitions associated with the TCI states/pair(s) of TCI states indicated by the first TCI state codepoint followed by the second TCI state codepoint (according to examples in the present disclosure); if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would first use the second TCI state codepoint followed by the first TCI state codepoint, and therefore the corresponding indicated TCI states/pair(s) of TCI states, to transmit one or more PUCCH transmission repetitions or PUSCH transmission repetitions associated with the TCI states/pair(s) of TCI states indicated by the second TCI state codepoint followed by the first TCI state codepoint (according to examples in the present disclosure).

Alternatively, if the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow a first ordering of the indicated TCI state codepoints, and therefore the corresponding indicated TCI states/pair(s) of TCI states, to transmit one or more PUCCH transmission repetitions or PUSCH transmission repetitions associated with the TCI states/pair(s) of TCI states indicated by the TCI state codepoints in the first ordering; if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow a second ordering of the indicated TCI state codepoints, and therefore the corresponding indicated TCI states/pair(s) of TCI states, to transmit one or more PUCCH transmission repetitions or PUSCH transmission repetitions associated with the TCI states/pair(s) of TCI states indicated by the TCI state codepoints in the second ordering. The first and second orderings of the indicated (first and second) TCI state codepoints could be according to those specified in examples in the present disclosure. Optionally, “00” or “01” of the 2-bit indicator, or the bit fields “00” or “01” or the indexes “0” or “1” of the 2-bit SRS resource set indicator, could be used to indicate the orderings of the indicated (first and second) TCI state codepoints for multi-TRP PUCCH or PUSCH (repetitions) transmission as described above, and “10” or “11” of the 2-bit indicator, or the bit fields “10” or “11” or the indexes “2” or “3” of the 2-bit SRS resource set indicator, could be used to indicate the primary or secondary TCI state codepoints for single-TRP PUCCH or PUSCH transmission as described above.

Yet for another example, the multi-bit indicator could correspond to a 2-bit indicator with four states “00,” “01,” “10” and “11,” configured according to those specified in example. In addition to the 2-bit indicator or the 2-bit SRS resource set indicator configured according to examples, the UE could also receive in a DCI (e.g., DCI format 1_1 or 1_2 with or without DL assignment or DCI format 0_0, 0_1 or 0_2) a one-bit indicator. For this design example, a new/dedicated DCI field could be used/configured in the corresponding DCI format to indicate the one-bit indicator; alternatively, one or more of the existing DCI fields in the corresponding DCI format could be used/configured to indicate the one-bit indicator. When the 2-bit indicator or the 2-bit SRS resource set indicator indicates the single-TRP PUCCH or PUSCH transmission, if the one-bit indicator is set to “0” (or “1”), the UE could use the primary TCI state codepoint, and therefore the corresponding indicated TCI state(s)/pair(s) of TCI states, to transmit PUCCH(s) or PUSCH(s); if the one-bit indicator is set to “1” (or “0”), the UE could use the secondary TCI state codepoint, and therefore the corresponding indicated TCI state(s)/pair(s) of TCI states, to transmit PUCCH(s) or PUSCH(s); the primary and secondary TCI state codepoints could be determined/configured according to those specified in examples in the present disclosure.

Yet for another example, the multi-bit indicator or the SRS resource set indicator could correspond to a z-bit indicator (z>1, e.g., z=3) with 2\hat{ }z states or bit fields (e.g., 8 states or bit fields for z=3). In this example, a first state or bit field of the z-bit indicator could indicate that the single-TRP PUCCH or PUSCH transmission is enabled according to examples and the corresponding sub-examples in the present disclosure, a second state or bit field of the z-bit indicator could indicate that the multi-TRP PUCCH or PUSCH (repetitions) transmission is enabled according to examples and the corresponding sub-examples in the present disclosure, a third state or bit field of the z-bit indicator could indicate that the UE could use the primary TCI state codepoint (and therefore the corresponding indicated TCI state(s)/pair(s) of TCI states) for the single-TRP PUCCH or PUSCH transmission as discussed in examples and the corresponding sub-examples in the present disclosure, a fourth state or bit field of the z-bit indicator could indicate that the UE could use the secondary TCI state codepoint (and therefore the corresponding indicated TCI state(s)/pair(s) of TCI states) for the single-TRP PUCCH or PUSCH transmission as discussed in examples and the corresponding sub-examples in the present disclosure, a fifth state or bit field of the z-bit indicator could indicate an ordering of the indicated (first and second) TCI state codepoints for the multi-TRP PUCCH or PUSCH (repetitions) transmission as discussed in examples in the present disclosure, a sixth state or bit field of the z-bit indicator could indicate another ordering of the indicated (first and second) TCI state codepoints for the multi-TRP PUCCH or PUSCH (repetitions) transmission as discussed in examples in the present disclosure.

For the above design examples, the first TCI state codepoint could be indicated by the first TCI field in the corresponding DCI format 0_0, 0_1 or 0_2 as specified in examples or by the TCI field in the corresponding DCI format 0_0, 0_1 or 0_2 as specified in examples or by repurposing one or more DCI fields in the corresponding DCI format 0_0, 0_1 or 0_2 reserved for beam indication as specified in examples, and the second TCI state codepoint could be indicated by the second TCI field in the corresponding DCI format 0_0, 0_1 or 0_2 as specified in examples or by repurposing one or more DCI fields in the corresponding DCI format 0_0, 0_1 or 0_2 reserved for beam indication as specified in examples.

In yet another example, the UE could first receive in an uplink DCI (e.g., DCI format 0_0, 0_1 or 0_2) M=1 (or N=1) TCI state or pair of TCI states indicated by a TCI state codepoint (or a TCI field) as specified in examples and the corresponding sub-examples in the present disclosure. The UE could then receive in an uplink DCI (e.g., DCI format 0_0, 0_1 or 0_2) the first and second TCI state codepoints configured/indicated according to examples in the present disclosure, wherein a TCI state codepoint could correspond a TCI state or pair of TCI states as specified in examples and the corresponding sub-examples in the present disclosure, and one or more of the indicated TCI states or pairs of TCI states by the first or second TCI state codepoints could be associated with/mapped to one or more PUCCH transmission repetitions or PUSCH transmission repetitions as described above for the multi-TRP PUCCH or PUSCH (repetitions) transmission.

Furthermore, the UE could receive in a DCI (e.g., DCI format 1_1 or 1_2 with or without DL assignment) a multi-bit (>1 bit, e.g., 2-bit) indicator for PUCCH or PUSCH. For this design example, a new/dedicated DCI field could be used/configured in the corresponding DCI format to indicate the multi-bit indicator; alternatively, one or more of the existing DCI fields in the corresponding DCI format could be used/configured to indicate the multi-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation.

The multi-bit indicator for PUCCH or PUSCH or the SRS resource set indicator could indicate one or more of: (1) single-TRP PUCCH or PUSCH transmission, (2) multi-TRP PUCCH or PUSCH (repetitions) transmission, (3) one or more orderings of the indicated TCI state codepoints for single-TRP PUCCH or PUSCH transmission or multi-TRP PUCCH or PUSCH (repetitions) transmission, and (4) one or more TCI state codepoints for single-TRP PUCCH or PUSCH transmission or multi-TRP PUCCH or PUSCH (repetitions) transmission. The multi-bit indicator or the SRS resource set indicator could be configured according to examples in the present disclosure.

For this example, if the multi-bit indicator or the SRS resource set indicator indicates that the single-TRP PUCCH or PUSCH transmission is enabled, the UE could follow the previously indicated M=1 (or N=1) TCI state or pair of TCI states to transmit PUCCH(s) or PUSCH(s) (as discussed in examples and the corresponding sub-examples in the present disclosure).

Furthermore, for this example, the first TCI state codepoint could be indicated by the first TCI field in the corresponding DCI format 0_0, 0_1 or 0_2 as specified in examples or by the TCI field in the corresponding DCI format 0_0, 0_1 or 0_2 as specified in examples or by repurposing one or more DCI fields in the corresponding DCI format 0_0, 0_1 or 0_2 reserved for beam indication as specified in examples, and the second TCI state codepoint could be indicated by the second TCI field in the corresponding DCI format 0_0, 0_1 or 0_2 as specified in examples or by repurposing one or more DCI fields in the corresponding DCI format 0_0, 0_1 or 0_2 reserved for beam indication as specified in examples in the present disclosure.

In one embodiment, a UE could be configured with a common indicator indicating one or more of: (1) single-TRP transmission/reception or multi-TRP (repetitions) transmission/reception, (2) one or more orderings of the indicated (first and second) TCI state codepoints and (3) which TCI state codepoint(s), and therefore the corresponding indicated TCI state(s)/pair(s) of TCI states, to use if the single-TRP transmission/reception is enabled/configured, for one or more different channels. Here, the one or more different channels could correspond to: (a) PDCCH and PDSCH, (b) PDCCH and PUCCH, (c) PDCCH and PUSCH, (d) PDSCH and PUCCH, (e) PDSCH and PUSCH, (f) PUCCH and PUSCH, (g) PDCCH, PDSCH and PUCCH, (h) PDCCH, PDSCH and PUSCH, (i) PDCCH, PUCCH and PUSCH, (j) PDSCH, PUCCH and PUSCH or (k) PDCCH, PDSCH, PUCCH and PUSCH.

In this embodiment, the common indicator could correspond to following examples.

In one example, a one-bit flag indicator—as specified in examples and the corresponding sub-examples for PDCCH, examples and the corresponding sub-examples for PDSCH, or examples and the corresponding sub-examples for PUCCH or PUSCH—configured/indicated for each of the one or more channels.

In one example, a one-bit indicator—as specified in examples and the corresponding sub-examples for PDCCH, examples for PDSCH, or examples for PUCCH or PUSCH-configured/indicated for each of the one or more channels.

In one example, a multi-bit indicator—as specified in examples for PDCCH, examples for PDSCH, or examples for PUCCH or PUSCH—used/applied to indicate TCI state codepoint(s) ordering for each of the one or more channels.

In one example, of a multi-bit indicator—as specified in examples for PDCCH, examples for PDSCH, or examples for PUCCH or PUSCH—used/applied to indicate TCI state codepoint(s) ordering for each of the one or more channels.

In one example, a one-bit flag indicator—as specified in examples for PDCCH, examples for PDSCH, or examples for PUCCH or PUSCH—configured/indicated for each of the one or more channels.

In one example, a one-bit indicator—as specified in examples for PDCCH, examples for PDSCH, or examples for PUCCH or PUSCH—configured/indicated for each of the one or more channels.

In one example, a multi-bit indicator—as specified in examples and the corresponding sub-examples for PDCCH, examples and the corresponding sub-examples for PDSCH, or examples and the corresponding sub-examples for PUCCH or PUSCH—configured/indicated for each of the one or more channels.

In one example, a multi-bit indicator—as specified in examples for PDCCH, examples for PDSCH, or examples for PUCCH or PUSCH—configured/indicated for each of the one or more channels.

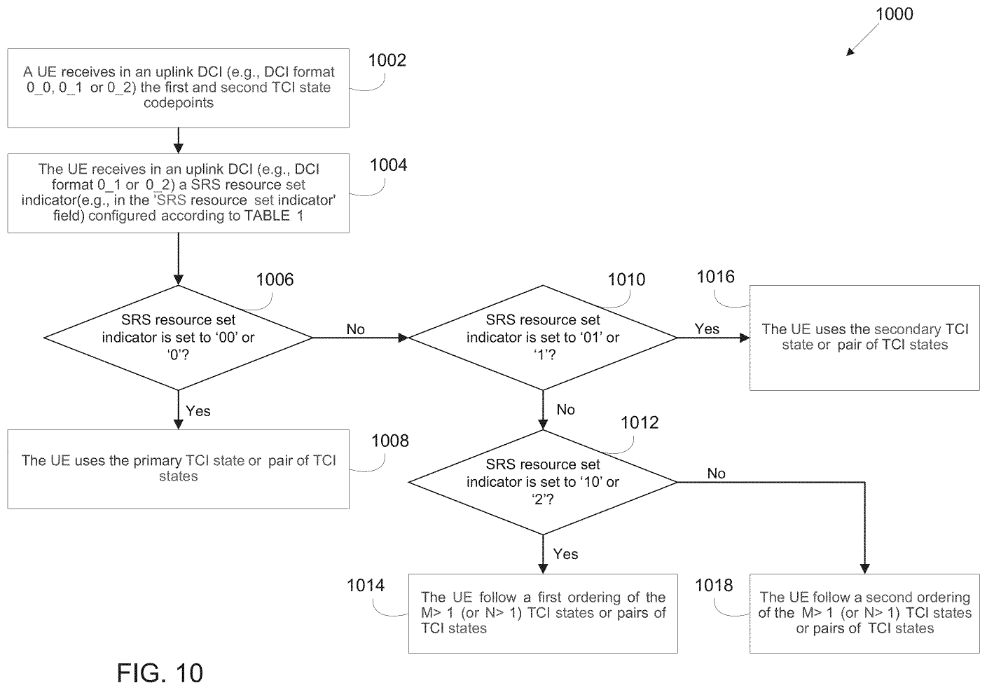

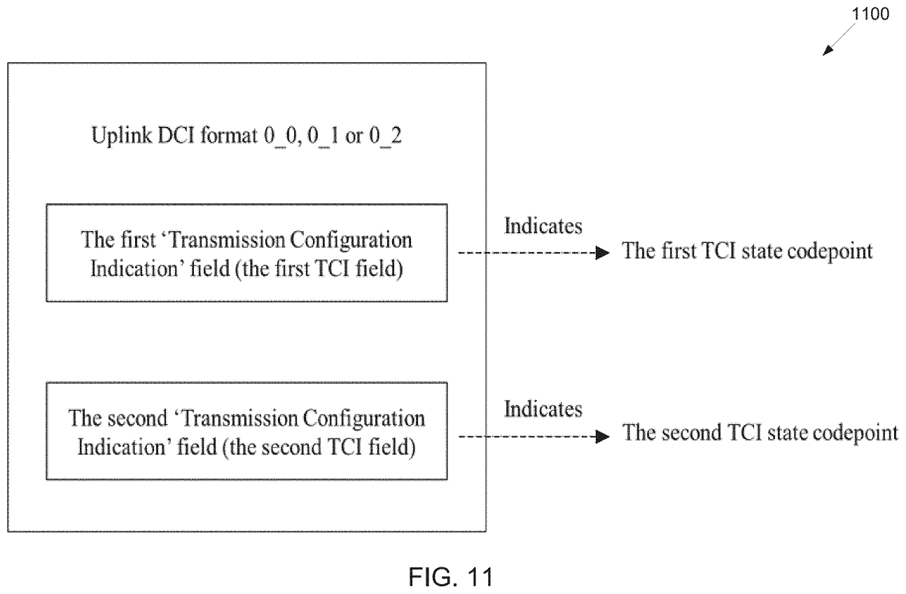

FIG. 10 illustrates a flowchart of a method 1000 of using an SRS resource set indicator to indicate associations between one or more of the indicated TCI states and each of the one or more channels according to embodiments of the present disclosure. The method 1000 as may be performed by a UE (e.g., 111-116 as illustrated in FIG. 1). An embodiment of the method 1000 shown in FIG. 10 is for illustration only.

As illustrated in FIG. 10, in block 1002, the UE receives the first and second TCI state codepoints in an uplink DCI. In block 1004, the UE receives in an uplink DCI a SRS resource set indicator configured according to TABLE 1. In block 1006, the UE determines if the SRS resource set indicator is set to “00” or “0.” In block 1008, the UE uses the primary TCI state or pair of TCI states. In block 1010, the UE determines if SRS resource set indicator is set to “01” or “1.” In block 1012, the UE determines the SRS resource set indicator is set to “10” or “2.” In block 1014, the UE follows a first ordering of the M>1 (or N>1) TCI states or pairs of TCI states. In block 1016, the UE uses the secondary TCI state or pair of TCI states. In block 1018, the UE follows a second ordering of the M>1 (or N>1) TCI states or pairs of TCI states.

Optionally, a UE could receive in an uplink DCI (e.g., DCI format 0_1 or 0_2) a SRS resource set indicator (e.g., in the “SRS resource set indicator” field) to indicate one or more SRS resource sets for single-TRP or multi-TRP operation according to TABLE 1 in the present disclosure. The SRS resource set indicator could also indicate one or more of: (1) single-TRP transmission/reception or multi-TRP (repetitions) transmission/reception, (2) one or more orderings of the indicated TCI states/pairs of TCI states and (3) which TCI state/pair of TCI states to use if the single-TRP transmission/reception is enabled/configured, for one or more different channels. As aforementioned, the one or more different channels could correspond to: (a) PDCCH and PDSCH, (b) PDCCH and PUCCH, (c) PDCCH and PUSCH, (d) PDSCH and PUCCH, (e) PDSCH and PUSCH, (f) PUCCH and PUSCH, (g) PDCCH, PDSCH and PUCCH, (h) PDCCH, PDSCH and PUSCH, (i) PDCCH, PUCCH and PUSCH, (j) PDSCH, PUCCH and PUSCH or (k) PDCCH, PDSCH, PUCCH and PUSCH.

In this embodiment, following examples can be provided.

In one example, the SRS resource set indicator—as specified in examples and the corresponding sub-examples for PDCCH, examples and the corresponding sub-examples for PDSCH, or examples and the corresponding sub-examples for PUCCH or PUSCH—could be configured/indicated for each of the one or more channels.

In one example, the SRS resource set indicator—as specified in examples and the corresponding sub-examples for PDCCH, examples for PDSCH, or examples for PUCCH or PUSCH—could be configured/indicated for each of the one or more channels.

In one example, the SRS resource set indicator—as specified in examples for PDCCH, examples for PDSCH, or examples for PUCCH or PUSCH—could be used/applied to indicate TCI state(s)/pair(s) of TCI states ordering for each of the one or more channels.

In one example, the SRS resource set indicator—as specified in examples for PDCCH, examples for PDSCH, or examples for PUCCH or PUSCH—could be used/applied to indicate TCI state(s)/pair(s) of TCI states ordering for each of the one or more channels.

In one example, the SRS resource set indicator—as specified in examples for PDCCH, examples for PDSCH, or examples for PUCCH or PUSCH—could be configured/indicated for each of the one or more channels.

In one example, the SRS resource set indicator—as specified in examples for PDCCH, examples for PDSCH, or examples for PUCCH or PUSCH—could be configured/indicated for each of the one or more channels.

In one example, the SRS resource set indicator—as specified in examples and the corresponding sub-examples for PDCCH, examples and the corresponding sub-examples for PDSCH, or examples and the corresponding sub-examples for PUCCH or PUSCH—could be configured/indicated for each of the one or more channels. A flowchart of the SRS resource set indicator configured/indicated for each of the one or more channels is illustrated in FIG. 10.

In one example, the SRS resource set indicator—as specified in the examples for PDCCH, examples for PDSCH, or examples for PUCCH or PUSCH—could be configured/indicated for each of the one or more channels.

The unified (master or main) TCI state is TCI state of UE-dedicated reception on PDSCH/PDCCH or dynamic-grant/configured-grant based PUSCH and all of dedicated PUCCH resources.

As discussed above, a UE could be provided by the network, e.g., via MAC CE or DCI (e.g., DCI format 1_1 or 1_2 with or without DL assignment) based signaling via higher layer parameters DLorJointTCIState or UL-TCIState, M>1 joint DL and UL TCI states or M>1 separate UL TCI states or a first combination of M>1 joint DL and UL TCI states and separate UL TCI states or N>1 separate DL TCI states or a second combination of N>1 joint DL and UL TCI states and separate DL TCI states or a third combination of N>1 joint DL and UL TCI states, separate DL TCI states and separate UL Rel. 17 unified TCI for UE-dedicated reception on PDSCH/PDCCH or dynamic-grant/configured-grant based PUSCH and all of dedicated PUCCH resources.

The UE could be higher layer configured by the network M>1 or N>1 pools of TCI states or TCI state identities (IDs). As aforementioned, here, a TCI state could correspond to a separate DL TCI state provided by DLorJointTCIState, or a separate UL TCI state provided by UL-TCIState, or a joint DL and UL TCI state provided by DLorJointTCIState. Each of the higher layer configured M>1 or N>1 pools of TCI states/TCI state IDs could be associated with an entity ID.

In the present disclosure, the entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. In the present disclosure, the UE could be higher layer configured by the network a list of entity IDs or a list of PCIs or a set of PCI indexes with each PCI index pointing to an entry/PCI in the list of PCIs that are higher layer configured to the UE.

In one example, the first pool of TCI states/TCI state IDs could be associated with the lowest PCI value or the first PCI value in the higher layer configured list of PCIs or the lowest PCI index or the first PCI index in the set of PCI indexes or the PCI index pointing to the lowest PCI value in the higher layer configured list of PCIs, the second pool of TCI states/TCI state IDs could be associated with the second lowest PCI value or the second PCI value in the higher layer configured list of PCIs or the second lowest PCI index or the second PCI index in the set of PCI indexes or the PCI index pointing to the second lowest PCI value in the higher layer configured list of PCIs, and so on, and the last pool of TCI states/TCI state IDs could be associated with the highest PCI value or the last PCI value in the higher layer configured list of PCIs or the highest PCI index or the last PCI index in the set of PCI indexes or the PCI index pointing to the highest PCI value in the higher layer configured list of PCIs.

Or equivalently, the m-th (or n-th) pool of TCI states/TCI state IDs could be associated with the m-th (or n-th) lowest (or highest) PCI value or the m-th (or n-th) PCI value in the higher layer configured list of PCIs or the m-th (or n-th) lowest (or highest) PCI index or the first PCI index in the set of PCI indexes or the PCI index pointing to the m-th (or n-th) lowest (or highest) PCI value in the higher layer configured list of PCIs, where m∈{1, . . . , M} and n∈{1, . . . , N}. For M=2 (or N=2), the first (or second) pool of TCI states/TCI state IDs could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) pool of TCI states/TCI state IDs could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In another example, if the UE is provided in PDCCH-Config two values of CORESETPoolIndex (i.e., 0 and 1), for M=2 (or N=2), the first (or second) pool of TCI states/TCI state IDs could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) pool of TCI states/TCI state IDs could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In yet another example, each of the M>1 (or N>1) pools of TCI states/TCI state IDs could be configured to the UE via a separate higher layer parameter. That is, the UE could be configured by the network M>1 (or N>1) separate higher layer parameters each configuring/indicating a pool of TCI states/TCI state IDs. Furthermore, the higher layer parameter that configures a pool of TCI states/TCI state IDs could also include/indicate an entity ID as described above. For this case, a pool TCI states/TCI state IDs and an entity ID are associated if the pool of TCI states/TCI state IDs and the entity ID are configured/indicated via the same higher layer parameter.

In addition, when the UE is higher layer configured by the network M>1 or N>1 pools of TCI states or TCI state IDs, where each TCI state configured therein corresponds to a separate DL TCI state provided by DLorJointTCIState, or a separate UL TCI state provided by UL-TCIState, or a joint DL and UL TCI state provided by DLorJointTCIState.

In one example, for the m-th (or n-th) pool of TCI states/TCI state IDs comprising K(m) (or K(n)) TCI states/TCI state IDs where m∈{1, . . . , M} and n∈{1, . . . , N}, the TCI state IDs in the m-th (or n-th) pool of TCI states/TCI state IDs or the TCI states in the m-th (or n-th) pool of TCI states/TCI state IDs are indexed according to 0, . . . , K(m)−1 (or K(n)−1) or 1, . . . , K(m) (or K(n)).

For example, for M=2 (or N=2), the first pool of TCI states/TCI state IDs could comprise K1 (e.g., 64) TCI states/TCI state IDs, and the second pool of TCI states/TCI state IDs could comprise K2 (e.g., 64) TCI states/TCI state IDs. For this example, the TCI state IDs in the first pool of TCI states/TCI state IDs or the TCI states in the first pool of TCI states/TCI state IDs could be indexed according to 0, . . . , K1−1 (e.g., 0, . . . , 63) or 1, . . . , K1 (e.g., 1, . . . , 64), and the TCI state IDs in the second pool of TCI states/TCI state IDs or the TCI states in the second pool of TCI states/TCI state IDs could be indexed according to 0, . . . , K2−1 (e.g., 0, . . . , 63) or 1, . . . , K2 (e.g., 1, . . . , 64).

In another example, the m-th (or n-th) pool of TCI states/TCI state IDs could comprise K(m) (or K(n)) TCI states/TCI state IDs where m∈{1, . . . , M} and n∈{1, . . . , N}. For this case, the TCI state IDs in the m-th (or n-th) pool of TCI states/TCI state IDs or the TCI states in the m-th (or n-th) pool of TCI states/TCI state IDs are indexed according to Σᵢ₌₁^{m-1}K(i) (or Σⱼ₌₁ⁿ⁻¹K(j)), Σᵢ₌₁^{m-1}K(i)+K(m)−1 (or Σⱼ₌₁ⁿ⁻¹K(j)+K(n)−1) or Σᵢ₌₁^{m-1}K(i)+1 (or Σⱼ₌₁ⁿ⁻¹K(j)+1), . . . , Σᵢ₌₁^{m-1}K(i)+K(m) (or Σⱼ₌₁ⁿ⁻¹K(j)+K(n)), where Σᵢ₌₁⁰K(i)=0 (or Σⱼ₌₁ⁿ⁻¹K(j)=0). For example, for M=2 (or N=2), the first pool of TCI states/TCI state IDs could comprise K1 (e.g., 64) TCI states/TCI state IDs, and the second pool of TCI states/TCI state IDs could comprise K2 (e.g., 64) TCI states/TCI state IDs. For this example, the TCI state IDs in the first pool of TCI states/TCI state IDs or the TCI states in the first pool of TCI states/TCI state IDs could be indexed according to 0, . . . , K1−1 (e.g., 0, . . . , 63) or 1, . . . , K1 (e.g., 1, . . . , 64), and the TCI state IDs in the second pool of TCI states/TCI state IDs or the TCI states in the second pool of TCI states/TCI state IDs could be indexed according to K1, . . . , K1+K2−1 (e.g., 64, . . . , 127) or K1+1, . . . , K1+K2 (e.g., 65, . . . , 128).

Alternatively, the UE could be higher layer configured by the network a single pool of TCI states or TCI state IDs. As aforementioned, here, a TCI state could correspond to a separate DL TCI state provided by DLorJointTCIState, or a separate UL TCI state provided by UL-TCIState, or a joint DL and UL TCI state provided by DLorJointTCIState. A TCI state or TCI state ID configured in the pool of TCI states/TCI state IDs could be associated with an entity ID. In the present disclosure, the entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc.

Furthermore, one or more of the TCI states or TCI state IDs configured in the pool of TCI states/TCI state IDs could be associated with the same entity ID, and different TCI states or TCI state IDs configured in the pool of TCI states/TCI state IDs could be associated with different entity IDs. In the present disclosure, the TCI states or TCI state IDs in the pool of TCI states/TCI state IDs could be divided/partitioned into M>1 (or N>1) TCI state groups each comprising one or more TCI states/TCI state IDs. The TCI states or TCI state IDs in the same TCI state group are associated with the same entity ID.

In one example, the m-th (or n-th) TCI state group could comprise K(m) (or K(n)) TCI states/TCI state IDs where m∈{1, . . . , M} and n∈{1, . . . , N}. For this case, the TCI state IDs in the m-th (or n-th) TCI state group or the TCI states in the m-th (or n-th) TCI state group are indexed according to Σᵢ₌₁^{m-1}K(i) (or Σⱼ₌₁ⁿ⁻¹K(j)), . . . , Σᵢ₌₁^{m-1}K(i)+K(m)−1 (or Σⱼ₌₁ⁿ⁻¹K(j)+K(n)−1) or Σᵢ₌₁^{m-1}K(i)+1 (or Σⱼ₌₁ⁿ⁻¹K(j)+1), . . . , Σᵢ₌₁^{m-1}K(i)+K(m) (or Σⱼ₌₁ⁿ⁻¹K(j)+K(n)), where Σᵢ₌₁⁰K(i)=0 (or Σⱼ₌₁ⁿ⁻¹K(j)=0). For example, for M=2 (or N=2), the first TCI state group could comprise K1 (e.g., 32) TCI states/TCI state IDs in the pool of TCI states/TCI state IDs, and the second TCI state group could comprise K2 (e.g., 32) TCI states/TCI state IDs in the pool of TCI states/TCI state IDs.

For this example, the TCI state IDs in the first TCI state group or the TCI states in the first TCI state group could be indexed according to 0, . . . , K1−1 (e.g., 0, . . . , 31) or 1, . . . , K1 (e.g., 1, . . . , 32), and the TCI state IDs in the second TCI state group or the TCI states in the second TCI state group could be indexed according to K1, . . . , K1+K2−1 (e.g., 32, . . . , 63) or K1+1, . . . , K1+K2 (e.g., 33, . . . , 65). For this example, the UE could be configured by the network, e.g., via higher layer RRC signaling, the number of TCI states/TCI state IDs (e.g., K(m) or K(n) with m∈{1, . . . , M} and n∈{1, . . . , N}) in each of the TCI state groups (e.g., the m-th or the n-th TCI state group with m∈{1, . . . , M} and n∈{1, . . . , N}) configured in the pool of TCI states/TCI state IDs.

In another example, the UE could be configured by the network M>1 (or N>1) parameters (e.g., higher layer RRC parameters) each associated with/corresponding to/configured for a TCI state group. Each parameter could include/indicate one or more TCI states/TCI state IDs. For this case, the TCI state group associated with the parameter could comprise the one or more TCI states/TCI state IDs configured in the parameter.

In the present disclosure, the UE could be higher layer configured by the network a list of entity IDs or a list of PCIs or a set of PCI indexes with each PCI index pointing to an entry/PCI in the list of PCIs that are higher layer configured to the UE.

In one example, the first TCI state group could be associated with the lowest PCI value or the first PCI value in the higher layer configured list of PCIs or the lowest PCI index or the first PCI index in the set of PCI indexes or the PCI index pointing to the lowest PCI value in the higher layer configured list of PCIs, the second TCI state group could be associated with the second lowest PCI value or the second PCI value in the higher layer configured list of PCIs or the second lowest PCI index or the second PCI index in the set of PCI indexes or the PCI index pointing to the second lowest PCI value in the higher layer configured list of PCIs, and so on, and the last TCI state group could be associated with the highest PCI value or the last PCI value in the higher layer configured list of PCIs or the highest PCI index or the last PCI index in the set of PCI indexes or the PCI index pointing to the highest PCI value in the higher layer configured list of PCIs.

Or equivalently, the m-th (or n-th) TCI state group could be associated with the m-th (or n-th) lowest (or highest) PCI value or the m-th (or n-th) PCI value in the higher layer configured list of PCIs or the m-th (or n-th) lowest (or highest) PCI index or the first PCI index in the set of PCI indexes or the PCI index pointing to the m-th (or n-th) lowest (or highest) PCI value in the higher layer configured list of PCIs, where m∈{1, . . . , M} and n∈{1, . . . , N}. For M=2 (or N=2), the first (or second) TCI state group could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state group could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In another example, if the UE is provided in PDCCH-Config two values of CORESETPoolIndex (i.e., 0 and 1), for M=2 (or N=2), the first (or second) TCI state group could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state group could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In yet another example, the (higher layer) parameter discussed in examples that indicate one or more TCI states/TCI state IDs for a TCI state group could also include/indicate an entity ID as described above. For this case, a TCI state group and an entity ID are associated if the TCI state group and the entity ID are associated with the same (higher layer) parameter specified in examples in the present disclosure.

FIG. 11 illustrates yet another example of indicating the first and second TCI state codepoints 1100 according to embodiments of the present disclosure. An embodiment of the indication of the first and second TCI state codepoints 1100 shown in FIG. 11 is for illustration only.

The UE could receive from the network one or more MAC CE sub-selection/activation commands activating one or more TCI states/TCI state IDs from the one or more TCI state pools (specified in examples in the present disclosure) or the one or more TCI state groups (specified in examples in the present disclosure), used to map up to Nc≥1 (e.g., 8, 16, 32 or 64) TCI state codepoints in a DCI format.

In one example, the UE could receive from the network a MAC CE sub-selection/activation command activating a set of Nc≥1 (e.g., 8, 16, 32 or 64) TCI state codepoints. In the present disclosure, the UE could be higher layer configured by the network a list of entity IDs or a list of PCIs or a set of PCI indexes with each PCI index pointing to an entry/PCI in the list of PCIs that are higher layer configured to the UE.

For example, a codepoint could correspond to a TCI state, wherein the TCI state could be a separate DL TCI state provided by DLorJointTCIState, a separate UL TCI state provided by UL-TCIState or a joint DL and UL TCI state provided by DLorJointTCIState.

Yet for another example, a codepoint could correspond to a pair of two TCI states, wherein the first TCI state in the pair could be a separate DL TCI state provided by DLorJointTCIState, a separate UL TCI state provided by UL-TCIState or a joint DL and UL TCI state provided by DLorJointTCIState, and the second TCI state in the pair could be a separate DL TCI state provided by DLorJointTCIState, a separate UL TCI state provided by UL-TCIState or a joint DL and UL TCI state provided by DLorJointTCIState. For instance, one TCI state in the pair could be for DL channels/signals, and the other TCI state in the pair could be for UL channels/signals.

Yet for another example, for M=2 (or N=2), a codepoint could correspond to a first TCI state and a second TCI state. For this case, the first TCI state could be a separate DL TCI state provided by DLorJointTCIState, a separate UL TCI state provided by UL-TCIState or a joint DL and UL TCI state provided by DLorJointTCIState, and the second TCI state could be a separate DL TCI state provided by DLorJointTCIState, a separate UL TCI state provided by UL-TCIState or a joint DL and UL TCI state provided by DLorJointTCIState. Furthermore, the first TCI state could be activated/selected by the MAC CE from the first (or second) TCI state pool (specified in examples) or the first (or second) TCI state group (specified in examples), and the second TCI state could be activated/selected by the MAC CE from the second (or first) TCI state pool (specified in examples) or the second (or first) TCI state group (specified in examples).

Yet for another example, for M=2 (or N=2), a codepoint could correspond to a first TCI state and a second TCI state. For this case, the first TCI state could be a separate DL TCI state provided by DLorJointTCIState, a separate UL TCI state provided by UL-TCIState or a joint DL and UL TCI state provided by DLorJointTCIState, and the second TCI state could be a separate DL TCI state provided by DLorJointTCIState, a separate UL TCI state provided by UL-TCIState or a joint DL and UL TCI state provided by DLorJointTCIState.

Furthermore, the first (or second) TCI state could be associated with the entity ID associated with the serving cell PCI/PCI index or the lowest entity ID or the first entity ID in the higher layer configured list of entity IDs, and the second (or first) TCI state could be associated with the entity ID associated with a PCI/PCI index other than the serving cell PCI/PCI index or the highest entity ID value or the last entity ID value in the higher layer configured list of entity IDs.

Alternatively, the first (or second) TCI state could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, for M=2 (or N=2), a codepoint could correspond to a first TCI state and a second TCI state. For this case, the first TCI state could be a separate DL TCI state provided by DLorJointTCIState, a separate UL TCI state provided by UL-TCIState or a joint DL and UL TCI state provided by DLorJointTCIState, and the second TCI state could be a separate DL TCI state provided by DLorJointTCIState, a separate UL TCI state provided by UL-TCIState or a joint DL and UL TCI state provided by DLorJointTCIState.

Furthermore, if the UE is provided in PDCCH-Config two values of CORESETPoolIndex (i.e., 0 and 1), the first (or second) TCI state could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, for M=2 (or N=2), a codepoint could correspond to two pairs of TCI states with each pair comprising two TCI states. The first TCI state in the first pair could be a separate DL TCI state provided by DLorJointTCIState, a separate UL TCI state provided by UL-TCIState or a joint DL and UL TCI state provided by DLorJointTCIState, and the second TCI state in the first pair could be a separate DL TCI state provided by DLorJointTCIState, a separate UL TCI state provided by UL-TCIState or a joint DL and UL TCI state provided by DLorJointTCIState. For instance, one TCI state in the first pair could be for DL channels/signals, and the other TCI state in the first pair could be for UL channels/signals.

Similarly, the first TCI state in the second pair could be a separate DL TCI state provided by DLorJointTCIState, a separate UL TCI state provided by UL-TCIState or a joint DL and UL TCI state provided by DLorJointTCIState, and the second TCI state in the second pair could be a separate DL TCI state provided by DLorJointTCIState, a separate UL TCI state provided by UL-TCIState or a joint DL and UL TCI state provided by DLorJointTCIState. For instance, one TCI state in the second pair could be for DL channels/signals, and the other TCI state in the second pair could be for UL channels/signals.

Furthermore, the first and second TCI states in the first pair could be activated/selected by the MAC CE from the first (or second) TCI state pool (specified in examples) or the first (or second) TCI state group (specified in examples), and the first and second TCI states in the second pair could be activated/selected by the MAC CE from the second (or first) TCI state pool (specified in examples) or the second (or first) TCI state group (specified in examples).

Yet for another example, for M=2 (or N=2), a codepoint could correspond to two pairs of TCI states with each pair comprising two TCI states. The first TCI state in the first pair could be a separate DL TCI state provided by DLorJointTCIState, a separate UL TCI state provided by UL-TCIState or a joint DL and UL TCI state provided by DLorJointTCIState, and the second TCI state in the first pair could be a separate DL TCI state provided by DLorJointTCIState, a separate UL TCI state provided by UL-TCIState or a joint DL and UL TCI state provided by DLorJointTCIState.

For instance, one TCI state in the first pair could be for DL channels/signals, and the other TCI state in the first pair could be for UL channels/signals. Similarly, the first TCI state in the second pair could be a separate DL TCI state provided by DLorJointTCIState, a separate UL TCI state provided by UL-TCIState or a joint DL and UL TCI state provided by DLorJointTCIState, and the second TCI state in the second pair could be a separate DL TCI state provided by DLorJointTCIState, a separate UL TCI state provided by UL-TCIState or a joint DL and UL TCI state provided by DLorJointTCIState.

For instance, one TCI state in the second pair could be for DL channels/signals, and the other TCI state in the second pair could be for UL channels/signals. Furthermore, the first and second TCI states in the first (or second) pair could be associated with the entity ID associated with the serving cell PCI/PCI index or the lowest entity ID value or the first entity ID value in the higher layer configured list of entity IDs, and the first and second TCI states in the second (or first) pair could be associated with the entity ID associated with a PCI/PCI index other than the serving cell PCI/PCI index or the highest entity ID value or the last entity ID value in the higher layer configured list of entity IDs.

Alternatively, the first and second TCI states in the first (or second) pair could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the first and second TCI states in the second (or first) pair could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, for M=2 (or N=2), a codepoint could correspond to two pairs of TCI states with each pair comprising two TCI states. The first TCI state in the first pair could be a separate DL TCI state provided by DLorJointTCIState, a separate UL TCI state provided by UL-TCIState or a joint DL and UL TCI state provided by DLorJointTCIState, and the second TCI state in the first pair could be a separate DL TCI state provided by DLorJointTCIState, a separate UL TCI state provided by UL-TCIState or a joint DL and UL TCI state provided by DLorJointTCIState. For instance, one TCI state in the first pair could be for DL channels/signals, and the other TCI state in the first pair could be for UL channels/signals.

Similarly, the first TCI state in the second pair could be a separate DL TCI state provided by DLorJointTCIState, a separate UL TCI state provided by UL-TCIState or a joint DL and UL TCI state provided by DLorJointTCIState, and the second TCI state in the second pair could be a separate DL TCI state provided by DLorJointTCIState, a separate UL TCI state provided by UL-TCIState or a joint DL and UL TCI state provided by DLorJointTCIState. For instance, one TCI state in the second pair could be for DL channels/signals, and the other TCI state in the second pair could be for UL channels/signals.

Furthermore, if the UE is provided in PDCCH-Config two values of CORESETPoolIndex (i.e., 0 and 1), the first and second TCI states in the first (or second) pair could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the first and second TCI states in the second (or first) pair could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

As aforementioned, one or more of the Nc≥1 (e.g., 8, 16, 32 or 64) TCI state codepoints activated by the MAC CE could correspond to the TCI state codepoints described in examples in the present disclosure. Furthermore, a “Transmission Configuration Indication” field (TCI field) could be configured/indicated/included in DCI format 0_0, 0_1 or 0_2 indicating a TCI state codepoint from the Nc≥1 (e.g., 8, 16, 32 or 64) activated TCI state codepoints determined according to examples in the present disclosure. Alternatively, DCI format 0_0, 0_1 or 0_2 could configure/indicate/include a first “Transmission Configuration Indication” field (or denoted by a first TCI field or TCI field 1) indicating a first TCI state codepoint, and a second “Transmission Configuration Indication” field (denoted by a second TCI field or TCI field 2) indicating a second TCI state codepoint, which is illustrated in FIG. 11.

When the two TCI fields are configured/indicated in the DCI format 0_0, 0_1 or 0_2 for beam indication, the first or the second TCI state codepoints could be from the Nc≥1 (e.g., 8, 16, 32 or 64) activated TCI state codepoints determined according to examples in the present disclosure. Optionally, the UE could receive from the network an auxiliary MAC CE sub-selection/activation command selecting/activating one or more (Nc′≥1, e.g., Nc′=8, 16, 32 or 64) TCI state codepoints from the set of Nc activated TCI state codepoints as a subset of Nc′ TCI state codepoints. For this case, the “Transmission Configuration Indication” field in DCI format 0_0, 0_1 or 0_2 could indicate a TCI state codepoint from the subset of Nc′≥1 (e.g., 8, 16, 32 or 64) TCI state codepoints, or the first or the second TCI state codepoints indicated by the first or the second TCI fields (if configured) in DCI format 0_0, 0_1 or 0_2 could correspond to a TCI state codepoint from the subset of Nc′≥1 (e.g., 8, 16, 32 or 64) TCI state codepoints.

Additionally, if the number of TCI state codepoints Nc to be activated by MAC CE is smaller than a threshold, the TCI state codepoint indicated in the “Transmission Configuration Indication” field could only correspond to/indicate a single TCI state or a single pair of TCI states (e.g., the TCI state codepoint specified in examples) for single-TRP operation. If two TCI fields are allowed to be configured in a DCI format for beam indication, and if the number of TCI state codepoints Nc to be activated by MAC CE is smaller than a threshold, only one TCI field (e.g., either TCI field 1 or TCI field 2) can be configured in the DCI format, and the TCI state codepoint (e.g., either the first TCI state codepoint or the second TCI state codepoint) indicated in the corresponding TCI field could only correspond to/indicate a single TCI state or a single pair of TCI states (e.g., the TCI state codepoint specified in examples) for single-TRP operation.

If the number of TCI state codepoints Nc to be activated by MAC CE is smaller than a threshold, each of the MAC CE activated TCI state codepoints could only correspond to/indicate a single TCI state or a single pair of TCI states (e.g., the TCI state codepoint specified in examples) for single-TRP operation. In the present disclosure, the threshold could be (1) fixed, e.g., 8, 16, 32 or 64, or (2) configured by the network via higher layer RRC signaling or/and MAC CE command or/and DCI based signaling.

In another example, for M=2 (or N=2), the UE could receive from the network a MAC CE sub-selection/activation command activating two sets of TCI state codepoints. For this case, the first set could contain Nc1≥1 (e.g., 8, 16, 32 or 64) TCI state codepoints, and the second set could contain Nc2≥1 (e.g., 8, 16, 32 or 64) TCI state codepoints. Alternatively, the UE could receive from the network a first MAC CE sub-selection/activation command activating a first set of Nc121 (e.g., 8, 16, 32 or 64) TCI state codepoints, and a second MAC CE sub-selection/activation command activating a second set of Nc2≥1 (e.g., 8, 16, 32 or 64) TCI state codepoints.

For example, a codepoint in the first set of codepoints or the second set of codepoints could correspond to a TCI state, wherein the TCI state could be a separate DL TCI state provided by DLorJointTCIState, a separate UL TCI state provided by UL-TCIState or a joint DL and UL TCI state provided by DLorJointTCIState.

Yet for another example, a codepoint in the first set of codepoints or the second set of codepoints could correspond to a pair of two TCI states, wherein the first TCI state in the pair could be a separate DL TCI state provided by DLorJointTCIState, a separate UL TCI state provided by UL-TCIState or a joint DL and UL TCI state provided by DLorJointTCIState, and the second TCI state in the pair could be a separate DL TCI state provided by DLorJointTCIState, a separate UL TCI state provided by UL-TCIState or a joint DL and UL TCI state provided by DLorJointTCIState. For instance, one TCI state in the pair could be for DL channels/signals, and the other TCI state in the pair could be for UL channels/signals.

In the present disclosure, the UE could be higher layer configured by the network a list of entity IDs or a list of PCIs or a set of PCI indexes with each PCI index pointing to an entry/PCI in the list of PCIs that are higher layer configured to the UE.

For example, the TCI states indicated by the first set of TCI state codepoints could be activated/selected by the MAC CE from the first (or second) TCI state pool (specified in examples) or the first (or second) TCI state group (specified in examples), and the TCI states indicated by the second set of TCI state codepoints could be activated/selected by the MAC CE from the second (or first) TCI state pool (specified in examples) or the second (or first) TCI state group (specified in examples).

For another example, the TCI states indicated by the first (or second) set of TCI state codepoints could be associated with the entity ID associated with the serving cell PCI/PCI index or the lowest entity ID value or the first entity ID value in the higher layer configured list of entity IDs, and the TCI states indicated by the second (or first) set of TCI state codepoints could be associated with the entity ID associated with a PCI/PCI index other than the serving cell PCI/PCI index or the highest entity ID value or the last entity ID value in the higher layer configured list of entity IDs.

Alternatively, the TCI states indicated by the first (or second) set of TCI state codepoints could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the TCI states indicated by the second (or first) set of TCI state codepoints could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, if the UE is provided in PDCCH-Config two values of CORESETPoolIndex (i.e., 0 and 1), the TCI states indicated by the first (or second) set of TCI state codepoints could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the TCI states indicated by the second (or first) set of TCI state codepoints could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, the first MAC CE sub-selection/activation command could include/indicate a first entity ID, and the second MAC CE sub-selection/activation command could include/indicate a second entity ID. In the present disclosure, the first entity ID or the second entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. For this case, the TCI states indicated by the first set of TCI state codepoints activated/selected by the first MAC CE sub-selection/activation command could be associated with the first entity ID, and the TCI states indicated by the second set of TCI state codepoints activated/selected by the second MAC CE sub-selection/activation command could be associated with the second entity ID.

For DCI based beam indication, an uplink DCI such as DCI format 0_0, 0_1 or 0_2 could configure/indicate/include a first “Transmission Configuration Indication” field (or denoted by a first TCI field or TCI field 1) indicating a first TCI state codepoint, and a second “Transmission Configuration Indication” field (denoted by a second TCI field or TCI field 2) indicating a second TCI state codepoint. Alternatively, the first TCI codepoint or the second TCI codepoint could be configured/indicated by repurposing one or more of the existing DCI fields in the DCI format 0_0, 0_1 or 0_2. In the present disclosure, the UE could be higher layer configured by the network a list of entity IDs or a list of PCIs or a set of PCI indexes with each PCI index pointing to an entry/PCI in the list of PCIs that are higher layer configured to the UE.

For example, the TCI state(s) indicated by the first TCI state codepoint/the first TCI field could be activated/selected by the MAC CE from the first (or second) TCI state pool (specified in examples) or the first (or second) TCI state group (specified in examples) and the TCI state(s) indicated by the second TCI state codepoint/the second TCI field could be activated/selected by the MAC CE from the second (or first) TCI state pool (specified in examples) or the second (or first) TCI state group (specified in examples).

For another example, the first (or second) TCI state codepoint/the first (or second) TCI field could be associated with the entity ID associated with the serving cell PCI/PCI index or the lowest entity ID value or the first entity ID value in the higher layer configured list of entity IDs, and the second (or first) TCI state codepoint/the second (or first) TCI field could be associated with the entity ID associated with a PCI/PCI index other than the serving cell PCI/PCI index or the highest entity ID value or the last entity ID value in the higher layer configured list of entity IDs.

Alternatively, the first (or second) TCI state codepoint/the first (or second) TCI field could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state codepoint/the second (or first) TCI field could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, if the UE is provided in PDCCH-Config two values of CORESETPoolIndex (i.e., 0 and 1), the first (or second) TCI state codepoint/the first (or second) TCI field could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state codepoint/the second (or first) TCI field could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In one example, the first TCI field could indicate the first TCI state codepoint from the first set of TCI state codepoints, and the second TCI field could indicate the second TCI state codepoint from the second set of TCI state codepoints.

In another example, the first TCI field could indicate the first TCI state codepoint from the second set of TCI state codepoints, and the second TCI field could indicate the second TCI state codepoint from the first set of TCI state codepoints.

In yet another example, the UE could receive a first one-bit flag for the first TCI field with “0” indicating that the first TCI state codepoint is indicated from the first (or second) set of TCI state codepoints and “1” indicating that the first TCI state codepoint is indicated from the second (or first) set of TCI state codepoints; furthermore, the UE could receive a second one-bit flag for the second TCI field with “0” indicating that the second TCI state codepoint is indicated from the first (or second) set of TCI state codepoints and “1” indicating that the second TCI state codepoint is indicated from the second (or first) set of TCI state codepoints. The UE could be configured by the network via higher layer RRC signaling or MAC CE command or DCI based signaling the first or second one-bit flag indicators.

If the number of TCI state codepoints Nc1 in the first set of TCI state codepoints to be activated by MAC CE or the number of TCI state codepoints Nc2 in the second set of TCI state codepoints to be activated by MAC CE or the total number of TCI state codepoints Nc1+Nc2 in the first and second sets of TCI state codepoints to be activated by MAC CE is smaller than a threshold, the DCI format 0_0, 0_1 or 0_2 could only indicate a single TCI field (e.g., either the first or the second TCI field), and the TCI state codepoint (e.g., either the first or the second TCI state codepoint) indicated in the TCI field could only correspond to/indicate a single TCI state or a single pair of TCI states—e.g., selected from either the first set or the second set of TCI state codepoints—for single-TRP operation. In the present disclosure, the threshold could be (1) fixed, e.g., 8, 16, 32 or 64, or (2) configured by the network via higher layer RRC signaling or/and MAC CE command or/and DCI based signaling.

For DCI based beam indication, an uplink DCI such as DCI format 0_0, 0_1 or 0_2 could configure/indicate/include a single “Transmission Configuration Indication” field indicating a TCI state codepoint. A new one-bit flag indicator could be indicated/added in the DCI format 0_0, 0_1 or 0_2; the one-bit flag indicator is used to indicate mapping/association between the TCI field and a TRP. Alternatively, the new data indicator (NDI) field in the DCI format 0_0, 0_1 or 0_2 could be used to indicate mapping/association between the TCI field and a TRP, and the NDI is toggled with every new transmission. Note that other existing one-bit flag indicator(s) in the DCI format 0_0, 0_1 or 0_2 could also be repurposed to indicate mapping/association between the TCI field and a TRP. In the present disclosure, the UE could be higher layer configured by the network a list of entity IDs or a list of PCIs or a set of PCI indexes with each PCI index pointing to an entry/PCI in the list of PCIs that are higher layer configured to the UE.

For example, if the one-bit flag indicator/NDI is set to “0” or the NDI is toggled, the TCI state(s) indicated by the TCI state codepoint/the TCI field could be activated/selected by the MAC CE from the first (or second) TCI state pool (specified in examples) or the first (or second) TCI state group (specified in examples), and if the one-bit flag indicator/NDI is set to “1” or the NDI is not toggled, the TCI state(s) indicated by the TCI state codepoint/the TCI field could be activated/selected by the MAC CE from the second (or first) TCI state pool (specified in examples) or the second (or first) TCI state group (specified in examples).

For another example, if the one-bit flag indicator/NDI is set to “0” (or “1”) or the NDI is toggled (or is not toggled), the TCI state codepoint/the TCI field could be associated with the entity ID associated with the serving cell PCI/PCI index or the lowest entity ID value or the first entity ID value in the higher layer configured list of entity IDs, and if the one-bit flag indicator/NDI is set to “1” (or “0”) or the NDI is not toggled (or is toggled), the TCI state codepoint/the TCI field could be associated with the entity ID associated with a PCI/PCI index other than the serving cell PCI/PCI index or the highest entity ID value or the last entity ID value in the higher layer configured list of entity IDs.

Alternatively, if the one-bit flag indicator/NDI is set to “0” (or “1”) or the NDI is toggled (or is not toggled), the TCI state codepoint/the TCI field could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and if the one-bit flag indicator/NDI is set to “1” (or “0”) or the NDI is not toggled (or is toggled), the TCI state codepoint/the TCI field could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, if the UE is provided in PDCCH-Config two values of CORESETPoolIndex (i.e., 0 and 1): if the one-bit flag indicator/NDI is set to “0” (or “1”) or the NDI is toggled (or is not toggled), the TCI state codepoint/the TCI field could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and if the one-bit flag indicator/NDI is set to “1” (or “0”) or the NDI is not toggled (or is toggled), the TCI state codepoint/the TCI field could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, in a single-DCI based multi-TRP system, one or more CORESETs could be configured with a same group index, denoted by CORESETGroupIndex. The CORESETs configured with the same CORESETGroupIndex value could be associated with the same TRP in a multi-TRP system. In the present disclosure, the UE could be provided by PDCCH-Config multiple (e.g., two) CORESETGroupIndex values (e.g., 0 and 1). The association of a CORESET and a CORESETGroupIndex value could be via indicating the explicit CORESETGroupIndex value (e.g., either 0 or 1) in the parameter, e.g., the higher layer parameter ControlResourceSet, configuring the CORESET.

For this case, if the UE is provided in PDCCH-Config two values of CORESETGroupIndex (i.e., 0 and 1): if the one-bit flag indicator/NDI is set to “0” (or “1”) or the NDI is toggled (or is not toggled), the TCI state codepoint/the TCI field could be associated with value 0 of CORESETGroupIndex or CORESETGroupIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and if the one-bit flag indicator/NDI is set to “1” (or “0”) or the NDI is not toggled (or is toggled), the TCI state codepoint/the TCI field could be associated with value 1 of CORESETGroupIndex or CORESETGroupIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In the present disclosure, the UE could be higher layer configured by the network a list of entity IDs or a list of PCIs or a set of PCI indexes with each PCI index pointing to an entry/PCI in the list of PCIs that are higher layer configured to the UE.

In one example, a new one-bit flag indicator could be configured/indicated/added in the DCI format 0_0, 0_1 or 0_2; the one-bit flag indicator is used to indicate mapping/association between the TCI field/TCI codepoint and a set of codepoints (e.g., the first or second set of codepoints). Alternatively, the new data indicator (NDI) field in the DCI format 0_0, 0_1 or 0_2 could be used to indicate mapping/association between the TCI field/TCI state codepoint and a set of codepoints (e.g., the first or second set of codepoints), and the NDI is toggled with every new transmission. Note that other existing one-bit flag indicator(s) in the DCI format 0_0, 0_1 or 0_2 could also be repurposed to indicate mapping/association between the TCI field/TCI state codepoint and a set of codepoints (e.g., the first or second set of codepoints). For this case, if the one-bit flag indicator/NDI is set to “0” (or “1”) or the NDI is toggled (or is not toggled), the TCI field could indicate the TCI state codepoint from the first set of TCI state codepoints, and if the one-bit flag indicator/NDI is set to “1” (or “0”) or the NDI is not toggled (or is toggled), the TCI field could indicate the TCI state codepoint from the second set of TCI state codepoints.

In another example, the TCI field could indicate the TCI state codepoint from a third set of TCI state codepoints, wherein the third set of TCI state codepoints comprises one or more TCI state codepoints from the first set of TCI state codepoints and one or more TCI state codepoints from the second set of TCI state codepoints. For instance, the first set of TCI state codepoints could comprise 8 TCI state codepoints, denoted by TCI_0, TCI_1, TCI_2, TCI_3, TCI_4, TCI_5, TCI_6 or TCI_7, and the second set of TCI state codepoints could comprise 8 TCI state codepoints, denoted by TCI_A, TCI_B, TCI_C, TCI_D, TCI_E, TCI_F, TCI_G or TCI_H. The third set of TCI state codepoints could then comprise TCI_0, TCI_1, TCI_2, TCI_3, TCI_A, TCI_B, TCI_C, TCI_D. The third set of TCI state codepoints could comprise any combinations of TCI state codepoints from the first or the second sets. The TCI state codepoints configured in the first or the second sets can be determined/selected into the third set according to at least one of: (1) fixed in the system specifications or (2) configured by the network via higher layer RRC signaling, MAC CE command or dynamic DCI based signaling.

If the number of TCI state codepoints Nc1 in the first set of TCI state codepoints to be activated by MAC CE or the number of TCI state codepoints Nc2 in the second set of TCI state codepoints to be activated by MAC CE or the total number of TCI state codepoints Nc1+Nc2 in the first and second sets of TCI state codepoints to be activated by MAC CE is smaller than a threshold, the TCI state codepoint indicated in the “Transmission Configuration Indication” field could only correspond to/indicate a single TCI state or a single pair of TCI states—e.g., selected from either the first set or the second set of TCI state codepoints—for single-TRP operation. In the present disclosure, the threshold could be (1) fixed, e.g., 8, 16, 32 or 64, or (2) configured by the network via higher layer RRC signaling or/and MAC CE command or/and DCI based signaling.

A UE could receive in an uplink DCI, e.g., DCI format 0_1 or 0_2, a “SRS resource set indicator” field to indicate one or more SRS resource sets for single-TRP or multi-TRP operations. Alternatively, one or more existing fields in DCI format 0_1 or 0_2 could be used/repurposed to indicate one or more SRS resource sets for single-TRP or multi-TRP operations. Specifically, the “SRS resource set indicator” field in DCI format 0_1 or 0_2 could be a 0-bit or 2-bit indicator configured as following examples.

In one example, if (1) the higher layer parameter txConfig is set to nonCodeBook, and there are two SRS resource sets configured by srs-ResourceSetToAddModList and associated with the usage of value “nonCodeBook,” or (2) the higher layer parameter txConfig is set to codebook, and there are two SRS resource sets configured by srs-ResourceSetToAddModList and associated with the usage of value “codebook,” the “SRS resource set indicator” corresponds to a 2-bit indicator. Otherwise, the “SRS resource set indicator” corresponds to a 0-bit indicator.

When the “SRS resource set indicator” field in DCI format 0_1 or 0_2 is a 2-bit indicator, the corresponding bit fields/indexes could be configured according to TABLE 1.

In TABLE 1, the first and the second SRS resource sets are respectively the ones with lower and higher srs-ResourceSetId of the two SRS resources sets configured by higher layer parameter srs-ResourceSetToAddModList or srs-ResourceSetToAddModListDCI-0-2, and associated with the higher layer parameter usage of value “nonCodeBook” if txConfig=nonCodebook or “codeBook” if txConfig=codebook. When only one SRS resource set is configured by higher layer parameter srs-ResourceSetToAddModList or srs-ResourceSetToAddModListDCI-0-2, and associated with the higher layer parameter usage of value “codeBook” or “nonCodeBook” respectively, the first SRS resource set is the SRS resource set.

Furthermore, for DCI format 0_2, the first and second SRS resource sets configured by higher layer parameter srs-ResourceSetToAddModListDCI-0-2 are composed of the first N_{SRS,0_2} SRS resources together with other configurations in the first and second SRS resource sets configured by higher layer parameter srs-ResourceSetToAddModList, if any, and associated with the higher layer parameter usage of value “codeBook” or “nonCodeBook,” respectively, except for the higher layer parameters “srs-ResourceSetId” and “srs-ResourceIdList.”

In one embodiment, a UE could receive in one or more CORESETs one or more PDCCH candidates from one or more search space sets configured with a higher layer parameter searchSpaceLinking. The one or more PDCCH candidates configured with the same higher layer parameter searchSpaceLinking could contain/carry/convey the same DCI payload. In the present disclosure, the same DCI payload could correspond to any DCI format, e.g., DCI format 1_1 or 1_2 with or without DL assignment for beam indication or DCI format 0_0, 0_1 or 0_2. As aforementioned, the UE could receive in an uplink DCI (e.g., DCI format 0_0, 0_1 or 0_2) M>1 (or N>1) TCI states or M>1 (or N>1) pairs of TCI states indicated by one or more TCI state codepoints (or one or more TCI fields) in the corresponding DCI.

One or more of the indicated M>1 (or N>1) TCI states or pairs of TCI states could be associated with/mapped to the one or more CORESETs, in which the one or more PDCCH candidates from the one or more search space sets configured with the same higher layer parameter searchSpaceLinking are received—also referred to as beam indication for PDCCH repetitions. Furthermore, the UE could receive in a DCI (e.g., DCI format 1_1 or 1_2 with or without DL assignment) one or more bits to indicate at least one of: (1) switching between single-TRP PDCCH reception and multi-TRP PDCCH (repetitions) reception, (2) one or more of the indicated M>1 (or N>1) TCI states or pairs of TCI states to use for the single-TRP PDCCH reception, and (3) switching the order of the indicated M>1 (or N>1) TCI states or pairs of TCI states.

One or more new/dedicated DCI fields could be added/included/incorporated in the corresponding DCI format to indicate the one or more bits. Alternatively, one or more of the existing DCI fields in the corresponding DCI format could be repurposed to indicate the one or more bits. In addition, as discussed above, the UE could receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. In the present disclosure, the SRS resource set indicator in DCI format 0_1 or 0_2 could also be used/applied to indicate at least one of: (1) switching between single-TRP PDCCH reception and multi-TRP PDCCH (repetitions) reception, (2) one or more of the indicated M>1 (or N>1) TCI states or pairs of TCI states to use for the single-TRP PDCCH reception, and (3) switching the order of the indicated M>1 (or N>1) TCI states or pairs of TCI states.

In one example, the UE could first receive in an uplink DCI (e.g., DCI format 0_0, 0_1 or 0_2) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received. The UE could also receive in a DCI (e.g., DCI format 1_1 or 1_2 with or without DL assignment) a one-bit flag indicator for PDCCH.

For this design example, a new/dedicated DCI field could be used/configured in the corresponding DCI format to indicate the one-bit flag indicator; alternatively, one of more of the existing DCI fields in the corresponding DCI format could be used/configured to indicate the one-bit flag indicator. Optionally, the UE could receive in an uplink DCI (e.g., DCI format 0_1 or 0_2) a SRS resource set indicator (e.g., in the “SRS resource set indicator” field).

For instance, if the one-bit flag indicator for PDCCH is set to “1” (or “0”) or “enabled,” or if the bit field of the SRS resource set indicator is set to “00” or “01” or the index of the SRS resource set indicator is set to “0” or “1” according to TABLE 1 or the SRS resource set indicator field is not configured/present, the UE could use only one of the indicated M>1 (or N>1) TCI states or pairs of TCI states to receive/monitor one or more PDCCH candidates in one or more CORESETs—i.e., PDCCH reception in a single-TRP system; if the one-bit flag indicator for PDCCH is set to “0” (or “1”) or “disabled,” or if the bit field of the SRS resource set indicator is set to “10” or “11” or the index of the SRS resource set indicator is set to “2” or “3” according to TABLE 1 or the SRS resource set indicator is not configured/present, the UE could use one or more of the indicated M>1 (or N>1) TCI states or pairs of TCI states to receive/monitor one or more PDCCH candidates from one or more search space sets configured with the same higher layer parameter searchSpaceLinking in one or more CORESETs—i.e., PDCCH repetitions reception in a multi-TRP system.

More specifically, if the one-bit flag indicator for PDCCH is set to “1” (or “0”) or “enabled,” or when the bit field of the SRS resource set indicator is set to “00” or “10” or the index of the SRS resource set indicator is set to “0” or “1” according to TABLE 1 or the SRS resource set indicator is not configured/present (i.e., for the PDCCH reception in a single-TRP system).

For example, the UE could use the first TCI state or the TCI state with the lowest (or highest) TCI state ID among the indicated M>1 (or N>1) TCI states or the separate DL TCI state or the joint DL and UL TCI state in the first pair of TCI states or the separate DL TCI state or the joint DL and UL TCI state in the pair of TCI states associated with the lowest (or highest) TCI state ID among the indicated M>1 (or N>1) pairs of TCI states to receive/monitor one or more PDCCH candidates in one or more CORESETs.

For another example, the UE could use the second TCI state or the TCI state with the second lowest (or second highest) TCI state ID among the indicated M>1 (or N>1) TCI states or the separate DL TCI state or the joint DL and UL TCI state in the second pair of TCI states or the separate DL TCI state or the joint DL and UL TCI state in the pair of TCI states associated with the second lowest (or second highest) TCI state ID among the indicated M>1 (or N>1) pairs of TCI states to receive/monitor one or more PDCCH candidates in one or more CORESETs.

Yet for another example, the UE could use the last TCI state or the TCI state with the highest (or lowest) TCI state ID among the indicated M>1 (or N>1) TCI states or the separate DL TCI state or the joint DL and UL TCI state in the last pair of TCI states or the separate DL TCI state or the joint DL and UL TCI state in the pair of TCI states associated with the highest (or lowest) TCI state ID among the indicated M>1 (or N>1) pairs of TCI states to receive/monitor one or more PDCCH candidates in one or more CORESETs.

Yet for another example, the UE could use the m-th (or n-th) TCI state or the TCI state with the m-th (or n-th) lowest (or highest) TCI state ID among the indicated M>1 (or N>1) TCI states or the separate DL TCI state or the joint DL and UL TCI state in the m-th (or n-th) pair of TCI states or the separate DL TCI state or the joint DL and UL TCI state in the pair of TCI states associated with the m-th (or n-th) lowest (or highest) TCI state ID among the indicated M>1 (or N>1) pairs of TCI states to receive/monitor one or more PDCCH candidates in one or more CORESETs, where m∈{1, . . . , M} and n∈{1, . . . , N}. In this example, the index m (or n) could be determined according to at least one of: (1) fixed in the system specification(s) and (2) configured, e.g., via higher layer RRC signaling or MAC CE command or DCI based signaling, by the network.

Yet for another example, the UE could use the separate DL TCI state or the joint DL and UL TCI state among the indicated M>1 (or N>1) TCI states to receive/monitor one or more PDCCH candidates in one or more CORESETs. In this example, only one of the indicated M>1 (or N>1) TCI states could correspond to a separate DL TCI state or a joint DL and UL TCI state.

Yet for another example, the UE could be higher layer configured by the network a list of K entity IDs. In the present disclosure, an entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. The UE could use the TCI state or the pair of TCI states that is associated with the first entity ID or the second entity ID or the last entity ID or the lowest entity ID or the highest entity ID or the second lowest (or second highest) entity ID or the entity ID associated with the serving cell PCI/PCI index or the entity ID associated with a PCI/PCI index different from the serving cell PCI/PCI index or the k-th entity ID or the k-th lowest (or highest) entity ID among the list of K entity IDs to receive/monitor one or more PDCCH candidates in one or more CORESETs, where k∈{1, . . . , K}.

In this example, the index k could be determined according to at least one of: (1) fixed in the system specification(s) and (2) configured, e.g., via higher layer RRC signaling or MAC CE command or DCI based signaling, by the network. Furthermore, K could be equal to M (or N).

Yet for another example, the UE could be higher layer configured by the network a list of L PCIs. The UE could use the TCI state or the pair of TCI states that is associated with the first PCI or the second PCI or the last PCI or the lowest PCI or the highest PCI or the second lowest (or second highest) PCI or the serving cell PCI or a PCI different from the serving cell PCI or the l-th PCI or the l-th lowest (or highest) PCI among the list of L PCIs to receive/monitor one or more PDCCH candidates in one or more CORESETs, where l∈{1, . . . , L}.

Alternatively, the UE could determine a list of L PCI indexes 0, . . . , L−1 or 1, . . . , L with each PCI index pointing to an entry in the list of L PCIs. For this case, the UE could use the TCI state or the pair of TCI states that is associated with the first PCI index or the second PCI index or the last PCI index or the lowest PCI index or the highest PCI index or the second lowest (or second highest) PCI index or the serving cell PCI index or a PCI index different from the serving cell PCI index or the l-th PCI index or the l-th lowest (or highest) PCI index among the list of L PCI indexes to receive/monitor one or more PDCCH candidates in one or more CORESETs, where l∈{1, . . . , L}. In this example, the index l could be determined according to at least one of: (1) fixed in the system specification(s) and (2) configured, e.g., via higher layer RRC signaling or MAC CE command or DCI based signaling, by the network. Furthermore, L could be equal to M (or N).

Yet for another example, the UE could be provided in PDCCH-Config two values of CORESETPoolIndex (i.e., 0 and 1) for one or more CORESETs. The UE could use the TCI state or the pair of TCI states that is associated with value 0 of CORESETPoolIndex or value 1 of CORESETPoolIndex or value x of CORESETPoolIndex to receive/monitor one or more PDCCH candidates in one or more CORESETs, where x∈{0, 1}. In this example, the value x could be determined according to at least one of: (1) fixed in the system specification(s) and (2) configured, e.g., via higher layer RRC signaling or MAC CE command or DCI based signaling, by the network.

In another example, the UE could first receive in an uplink DCI (e.g., DCI format 0_0, 0_1 or 0_2) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received. The UE could also receive in a DCI (e.g., DCI format 1_1 or 1_2 with or without DL assignment) a one-bit indicator for PDCCH.

For this design example, a new/dedicated DCI field could be used/configured in the corresponding DCI format to indicate the one-bit indicator; alternatively, one of more of the existing DCI fields in the corresponding DCI format could be used/configured to indicate the one-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation.

If the one-bit indicator for PDCCH is set to “0” (or “1”), or if the bit field of the SRS resource set indicator is set to “00” (or “01”) or the index of the SRS resources set indicator is set to “0” (or “1”) according to TABLE 1, the UE could use one of the indicated M>1 (or N>1) TCI states or pairs of TCI states—a primary TCI state or pair of TCI states—to receive/monitor one or more PDCCH candidates in one or more CORESETs—i.e., PDCCH reception in a single-TRP system; if the one-bit indicator is set to “1” (or “0”) for PDCCH, or if the bit field of the SRS resource set indicator is set to “01” (or “00”) or the index of the SRS resources set indicator is set to “1” (or “0”) according to TABLE 1, the UE could use another one of the indicated M>1 (or N>1) TCI states or pairs of TCI states—a secondary TCI state or pair of TCI states—to receive/monitor one or more PDCCH candidates in one or more CORESETs—i.e., PDCCH reception in a single-TRP system. Various design examples of determining the primary TCI state or pair of TCI states or the secondary TCI state or pair of TCI states are provided below.

For example, the primary TCI state or pair of TCI states could correspond to the first (or second) TCI state or the TCI state with the lowest (or second lowest/highest) TCI state ID among the indicated M>1 (or N>1) TCI states or the separate DL TCI state or the joint DL and UL TCI state in the first (or second) pair of TCI states or the separate DL TCI state or the joint DL and UL TCI state in the pair of TCI states associated with the lowest (or second lowest/highest) TCI state ID among the indicated M>1 (or N>1) pairs of TCI states, and the secondary TCI state or pair of TCI states could correspond to the second (or first) TCI state or the TCI state with the second lowest/highest (or lowest) TCI state ID among the indicated M>1 (or N>1) TCI states or the separate DL TCI state or the joint DL and UL TCI state in the second (or first) pair of TCI states or the separate DL TCI state or the joint DL and UL TCI state in the pair of TCI states associated with the second lowest/highest (or lowest) TCI state ID among the indicated M>1 (or N>1) pairs of TCI states.

For another example, the primary TCI state or pair of TCI states could correspond to the first (or last) TCI state or the TCI state with the lowest (or highest) TCI state ID among the indicated M>1 (or N>1) TCI states or the separate DL TCI state or the joint DL and UL TCI state in the first (or last) pair of TCI states or the separate DL TCI state or the joint DL and UL TCI state in the pair of TCI states associated with the lowest (or highest) TCI state ID among the indicated M>1 (or N>1) pairs of TCI states, and the secondary TCI state or pair of TCI states could correspond to the last (or first) TCI state or the TCI state with the highest (or lowest) TCI state ID among the indicated M>1 (or N>1) TCI states or the separate DL TCI state or the joint DL and UL TCI state in the last (or first) pair of TCI states or the separate DL TCI state or the joint DL and UL TCI state in the pair of TCI states associated with the highest (or lowest) TCI state ID among the indicated M>1 (or N>1) pairs of TCI states.

Yet for another example, the primary TCI state or pair of TCI states could correspond to the m-th (or n-th) TCI state or the TCI state with the m-th (or n-th) lowest (or highest) TCI state ID among the indicated M>1 (or N>1) TCI states or the separate DL TCI state or the joint DL and UL TCI state in the m-th (or n-th) pair of TCI states or the separate DL TCI state or the joint DL and UL TCI state in the pair of TCI states associated with the m-th (or n-th) lowest (or highest) TCI state ID among the indicated M>1 (or N>1) pairs of TCI states, and the secondary TCI state or pair of TCI states could correspond to the m′-th (or n′-th) TCI state or the TCI state with the m′-th (or n′-th) lowest (or highest) TCI state ID among the indicated M>1 (or N>1) TCI states or the separate DL TCI state or the joint DL and UL TCI state in the m′-th (or n′-th) pair of TCI states or the separate DL TCI state or the joint DL and UL TCI state in the pair of TCI states associated with the m′-th (or n′-th) lowest (or highest) TCI state ID among the indicated M>1 (or N>1) pairs of TCI states, where m∈{1, . . . , M}, n∈{1, . . . , N}, m′∈{1, . . . , M} and n′∈{1, . . . , N}. In this example, the index m (or n) and the index m′ (or n′) could be determined according to at least one of: (1) fixed in the system specification(s) and (2) configured, e.g., via higher layer RRC signaling or MAC CE command or DCI based signaling, by the network.

Yet for another example, the primary TCI state or pair of TCI states could correspond to the first (or second) separate DL TCI state or the first (or second) joint DL and UL TCI state among the indicated M>1 (or N>1) TCI states or the pair of TCI states containing the first (or second) separate DL TCI state or the first (or second) joint DL and UL TCI state among the indicated M>1 (or N>1) pairs of TCI states, and the secondary TCI state or pair of TCI states could correspond to the second (or first) separate DL TCI state or the second (or first) joint DL and UL TCI state among the indicated M>1 (or N>1) TCI states or the pair of TCI states containing the second (or first) separate DL TCI state or the second (or first) joint DL and UL TCI state among the indicated M>1 (or N>1) pairs of TCI states.

In this example, for beam indication for downlink channels/signals, only the first separate DL TCI state, the second separate DL TCI state, the first joint DL and UL TCI state or the second joint DL and UL TCI state (among the indicated M>1 or N>1 TCI states or pairs of TCI states) are configured/indicated.

Yet for another example, the UE could be higher layer configured by the network a list of K entity IDs. In the present disclosure, an entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. In one example, the primary TCI state or pair of TCI states could correspond to the TCI state or the pair of TCI states that is associated with the first (or second) entity ID or the lowest (or second lowest/highest) entity ID or the entity ID associated with the serving cell PCI/PCI index (or a PCI/PCI index different from the serving cell PCI/PCI index), and the secondary TCI state or pair of TCI states could correspond to the TCI state or the pair of TCI states that is associated with the second (or first) entity ID or the second lowest/highest (or lowest) entity ID or the entity ID associated with a PCI/PCI index different from the serving cell PCI/PCI index (or the serving cell PCI/PCI index).

In another example, the primary TCI state or pair of TCI states could correspond to the TCI state or the pair of TCI states that is associated with the first (or last) entity ID or the lowest (or highest) entity ID, and the secondary TCI state or pair of TCI states could correspond to the TCI state or the pair of TCI states that is associated with the last (or first) entity ID or the highest (or lowest) entity ID. In yet another example, the primary TCI state or pair of TCI states could correspond to the TCI state or the pair of TCI states that is associated with the k-th entity ID or the k-th lowest (or highest) entity ID, and the secondary TCI state or pair of TCI states could correspond to the TCI state or the pair of TCI states that is associated with the k′-th entity ID or the k′-th lowest (or highest) entity ID, where k∈{1, . . . , K} and k′∈{1, . . . , K}. For this case, the index k or the index k′ could be determined according to at least one of: (1) fixed in the system specification(s) and (2) configured, e.g., via higher layer RRC signaling or MAC CE command or DCI based signaling, by the network. Furthermore, K could be equal to M (or N).

Yet for another example, the UE could be higher layer configured by the network a list of L PCIs. In one example, the primary TCI state or pair of TCI states could correspond to the TCI state or the pair of TCI states that is associated with the first (or second) PCI or the lowest (or second lowest/highest) PCI or the serving cell PCI (or a PCI different from the serving cell PCI), and the secondary TCI state or pair of TCI states could correspond to the TCI state or the pair of TCI states that is associated with the second (or first) PCI or the second lowest/highest (or lowest) PCI or a PCI different from the serving cell PCI (or the serving cell PCI). In another example, the primary TCI state or pair of TCI states could correspond to the TCI state or the pair of TCI states that is associated with the first (or last) PCI or the lowest (or highest) PCI, and the secondary TCI state or pair of TCI states could correspond to the TCI state or the pair of TCI states that is associated with the last (or first) PCI or the highest (or lowest) PCI.

In yet another example, the primary TCI state or pair of TCI states could correspond to the TCI state or the pair of TCI states that is associated with the l-th PCI or the l-th lowest (or highest) PCI, and the secondary TCI state or pair of TCI states could correspond to the TCI state or the pair of TCI states that is associated with the l′-th PCI or the l′-th lowest (or highest) PCI, where l∈{1, . . . , L} and l′∈{1, . . . , L}. Alternatively, the UE could determine a list of L PCI indexes 0, . . . , L−1 or 1, . . . , L with each PCI index pointing to an entry in the list of L PCIs. For this case, in one example, the primary TCI state or pair of TCI states could correspond to the TCI state or the pair of TCI states that is associated with the first (or second) PCI index or the lowest (or second lowest/highest) PCI index or the serving cell PCI index (or a PCI index different from the serving cell PCI index), and the secondary TCI state or pair of TCI states could correspond to the TCI state or the pair of TCI states that is associated with the second (or first) PCI index or the second lowest/highest (or lowest) PCI index or a PCI index different from the serving cell PCI index (or the serving cell PCI index); in another example, the primary TCI state or pair of TCI states could correspond to the TCI state or the pair of TCI states that is associated with the first (or last) PCI index or the lowest (or highest) PCI index, and the secondary TCI state or pair of TCI states could correspond to the TCI state or the pair of TCI states that is associated with the last (or first) PCI index or the highest (or lowest) PCI index; in yet another example, the primary TCI state or pair of TCI states could correspond to the TCI state or the pair of TCI states that is associated with the l-th PCI index or the l-th lowest (or highest) PCI index, and the secondary TCI state or pair of TCI states could correspond to the TCI state or the pair of TCI states that is associated with the l′-th PCI index or the l′-th lowest (or highest) PCI index, where l∈{1, . . . , L} and l′∈{1, . . . , L}.

For this case, the index l or the index l′ could be determined according to at least one of: (1) fixed in the system specification(s) and (2) configured, e.g., via higher layer RRC signaling or MAC CE command or DCI based signaling, by the network. Furthermore, L could be equal to M (or N).

Yet for another example, the UE could be provided in PDCCH-Config two values of CORESETPoolIndex (i.e., 0 and 1) for one or more CORESETs. The primary TCI state or pair of TCI states could correspond to the TCI state or the pair of TCI states that is associated with value 0 (or 1) of CORESETPoolIndex or value x of CORESETPoolIndex, and the secondary TCI state or pair of TCI states could correspond to the TCI state or the pair of TCI states that is associated with value 1 (or 0) of CORESETPoolIndex or value x′ of CORESETPoolIndex, where x∈{0, 1} and x′∈{0, 1}. In this example, the value x or the value x′ could be determined according to at least one of: (1) fixed in the system specification(s) and (2) configured, e.g., via higher layer RRC signaling or MAC CE command or DCI based signaling, by the network.

In yet another example, the UE could first receive in an uplink DCI (e.g., DCI format 0_0, 0_1 or 0_2) M>1 (or N>1) TCI states or pairs of TCI states—denoted and ordered by {TCI state/TCI states pair #a1, TCI state/TCI states pair #a2, . . . , TCI state/TCI states pair #aM (or #aN)}—indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received.

The UE could also receive in a DCI (e.g., DCI format 1_1 or 1_2 with or without DL assignment) a one-bit flag indicator to indicate TCI state(s)/pair(s) of TCI states ordering for PDCCH. For this design example, a new/dedicated DCI field could be used/configured in the corresponding DCI format to indicate the one-bit flag indicator; alternatively, one of more of the existing DCI fields in the corresponding DCI format could be used/configured to indicate the one-bit flag indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation.

For instance, if the one-bit flag indicator is set to “1” (or “0”) or “enabled,” or if the bit field of the SRS resource set indicator is set to “11” (or “10”) or the index of the SRS resource set indicator is set to “3” (or “2”) according to TABLE 1 or the SRS resource set indicator field is not configured/present, the ordering of the indicated M>1 (or N>1) TCI states or pairs of TCI states are reversed, and the UE would follow the order-reversed M>1 (or N>1) TCI states or pairs of TCI states to receive/monitor one or more PDCCH candidates from one or more search space sets configured with the same higher layer parameter searchSpaceLinking in one or more CORESETs associated with the order-reversed M>1 (or N>1) TCI states or pairs of TCI states, and if the one-bit flag indicator is set to “0” (or “1”) or “disabled,” or if the bit field of the SRS resource set indicator is set to “10” (or “11”) or the index of the SRS resource set indicator is set to “2” (or “3”) according to TABLE 1 or the SRS resource set indicator field is not configured/present, the UE would follow the indicated M>1 (or N>1) TCI states or pairs of TCI states to receive/monitor one or more PDCCH candidates from one or more search space sets configured with the same higher layer parameter searchSpaceLinking in one or more CORESETs associated with the indicated M>1 (or N>1) TCI states or pairs of TCI states.

If the indicated M>1 (or N>1) TCI states or pairs of TCI states are (ordered as) {TCI state/TCI states pair #a1, TCI state/TCI states pair #a2, . . . , TCI state/TCI states pair #aM (or #aN)}, when the one-bit flag indicator is set to “1” (or “0”) or “enabled,” or when the bit field of the SRS resource set indicator is set to “11” (or “10”) or the index of the SRS resource set indicator is set to “3” (or “2”) according to TABLE 1 or the SRS resource set indicator field is not configured/present, the (order-reversed) M>1 (or N>1) TCI states or pairs of TCI states would become to {TCI state/TCI states pair #b1, TCI state/TCI states pair #b2, . . . , TCI state/TCI states pair #bM (or #bN)}, where b1=aM (or aN), b2=a(M−1) or (a(N−1)), . . . , bM (or bN)=a1.

For M=2 (or N=2), the UE could first receive in an uplink DCI (e.g., DCI format 0_0, 0_1 or 0_2) two TCI states or pairs of TCI states—denoted and ordered by {TCI state/TCI states pair #a1, TCI state/TCI states pair #a2}; if the one-bit flag indicator is set to “1” (or “0”) or “enabled,” or if the bit field of the SRS resource set indicator is set to “11” (or “10”) or the index of the SRS resource set indicator is set to “3” (or “2”) according to TABLE 1 or the SRS resource set indicator field is not configured/present, the UE would follow the order-reversed two TCI states or pairs of TCI states {TCI state/TCI state pair #a2, TCI state/TCI state pair #a1} to receive/monitor one or more PDCCH candidates from one or more search space sets configured with the same higher layer parameter searchSpaceLinking in one or more CORESETs associated with the order-reversed TCI states or pairs of TCI states {TCI state/TCI state pair #a2, TCI state/TCI state pair #a1}, and if the one-bit flag indicator is set to “0” or (“1”) or “disabled,” or if the bit field of the SRS resource set indicator is set to “10” (or “11”) or the index of the SRS resource set indicator is set to “2” (or “3”) according to TABLE 1 or the SRS resource set indicator field is not configured/present, the UE would follow the indicated two TCI states or pairs of TCI states {TCI state/TCI state pair #a1, TCI state/TCI state pair #a2} to receive/monitor one or more PDCCH candidates from one or more search space sets configured with the same higher layer parameter searchSpaceLinking in one or more CORESETs associated with the indicated TCI states or pairs of TCI states {TCI state/TCI state pair #a1, TCI state/TCI state pair #a2}.

In yet another example, the UE could first receive in an uplink DCI (e.g., DCI format 0_0, 0_1 or 0_2) M>1 (or N>1) TCI states or pairs of TCI states—denoted by {TCI state/TCI states pair #a1, TCI state/TCI states pair #a2, . . . , TCI state/TCI states pair #aM (or #aN)}—indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received.

The UE could also receive in a DCI (e.g., DCI format 1_1 or 1_2 with or without DL assignment) a one-bit indicator to indicate TCI state(s)/pair(s) of TCI states ordering for PDCCH. For this design example, a new/dedicated DCI field could be used/configured in the corresponding DCI format to indicate the one-bit indicator; alternatively, one of more of the existing DCI fields in the corresponding DCI format could be used/configured to indicate the one-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation.

For instance, if the one-bit indicator is set to “0” (or “1”), or if the bit field of the SRS resource set indicator is set to “10” (or “11”) or the index of the SRS resource set indicator is set to “2” (or “3”) according to TABLE 1, the UE would follow the M>1 (or N>1) TCI states or pairs of TCI states ordered by {TCI state/TCI states pair #a1, TCI state/TCI states pair #a2, . . . , TCI state/TCI states #aM (or #aN)}—a first ordering—to receive/monitor one or more PDCCH candidates from one or more search space sets configured with the same higher layer parameter searchSpaceLinking in one or more CORESETs associated with the M>1 (or N>1) TCI states or pairs of TCI states ordered by {TCI state/TCI states pair #a1, TCI state/TCI states pair #a2, . . . , TCI state/TCI states #aM (or #aN)}, and if the one-bit flag indicator is set to “1” (or “0”), or if the bit field of the SRS resource set indicator is set to “11” (or “10”) or the index of the SRS resource set indicator is set to “3” (or “2”) according to TABLE 1, the UE would follow the M>1 (or N>1) TCI states or pairs of TCI states ordered by {TCI state/TCI states pair #b1, TCI state/TCI states pair #b2, . . . , TCI state/TCI states #bM (or #bN)}—a second ordering—to receive/monitor one or more PDCCH candidates from one or more search space sets configured with the same higher layer parameter searchSpaceLinking in one or more CORESETs associated with the M>1 (or N>1) TCI states or pairs of TCI states ordered by {TCI state/TCI states pair #b1, TCI state/TCI states pair #b2, . . . , TCI state/TCI states #bM (or #bN)}. The first ordering of the TCI states/pairs of TCI states {TCI state/TCI states pair #a1, TCI state/TCI states pair #a2, . . . , TCI state/TCI states #aM (or #aN)} or the second ordering of the TCI states/pairs of TCI states {TCI state/TCI states pair #b1, TCI state/TCI states pair #b2, . . . , TCI state/TCI states #bM (or #bN)} could be determined according to at least one of: (1) fixed in the system specification(s) and (2) configured, e.g., via higher layer RRC signaling or MAC CE command or DCI based signaling, by the network.

For both (1) and (2), b1 could be equal to aM (or aN), b2 could be equal to a(M−1) or (a(N−1)), . . . , bM (or bN) could be equal to a1. For M=2 (or N=2), the UE could first receive in an uplink DCI (e.g., DCI format 0_0, 0_1 or 0_2) two TCI states or pairs of TCI states—denoted by {TCI state/TCI states pair #a1, TCI state/TCI states pair #a2}; if the one-bit flag indicator is set to “0” (or “1”), or if the bit field of the SRS resource set indicator is set to “10” (or “11”) or the index of the SRS resource set indicator is set to “2” (or “3”) according to TABLE 1, the UE would follow the two TCI states or pairs of TCI states ordered by {TCI state/TCI state pair #a1, TCI state/TCI state pair #a2} to receive/monitor one or more PDCCH candidates from one or more search space sets configured with the same higher layer parameter searchSpaceLinking in one or more CORESETs associated with the two TCI states or pairs of TCI states ordered by {TCI state/TCI state pair #a1, TCI state/TCI state pair #a2}, and if the one-bit flag indicator is set to “1” or (“0”), or if the bit field of the SRS resource set indicator is set to “11” (or “10”) or the index of the SRS resource set indicator is set to “3” (or “2”) according to TABLE 1, the UE would follow the two TCI states or pairs of TCI states ordered by {TCI state/TCI state pair #a2, TCI state/TCI state pair #a1} to receive/monitor one or more PDCCH candidates from one or more search space sets configured with the same higher layer parameter searchSpaceLinking in one or more CORESETs associated with the two TCI states or pairs of TCI states {TCI state/TCI state pair #a2, TCI state/TCI state pair #a1}.

In yet another example, the UE could first receive in an uplink DCI (e.g., DCI format 0_0, 0_1 or 0_2) M=1 (or N=1) TCI state or pair of TCI states indicated by a TCI state codepoint (or a TCI field) as specified in examples and the corresponding sub-examples in the present disclosure. The UE could then receive in an uplink DCI (e.g., DCI format 0_0, 0_1 or 0_2) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received.

For example, the UE would follow the latest indicated M>1 (or N>1) TCI states or pairs of TCI states to receive/monitor one or more PDCCH candidates from one or more search space sets configured with the same higher layer parameter searchSpaceLinking in one or more CORESETs associated with the latest indicated M>1 (or N>1) TCI states or pairs of TCI states—i.e., multi-TRP PDCCH (repetitions) reception.

For another example, the UE could receive in a DCI (e.g., DCI format 1_1 or 1_2 with or without DL assignment) a one-bit flag indicator for PDCCH. For this design example, a new/dedicated DCI field could be used/configured in the corresponding DCI format to indicate the one-bit flag indicator; alternatively, one of more of the existing DCI fields in the corresponding DCI format could be used/configured to indicate the one-bit flag indicator. In addition, the UE could receive in an uplink DCI (e.g., DCI format 0_1 or 0_2) a SRS resource set indicator (e.g., in the “SRS resource set indicator” field) to indicate one or more SRS resource sets for single-TRP or multi-TRP operation.

For instance, if the one-bit flag indicator for PDCCH is set to “1” (or “0”) or “enabled,” or if the bit field of the SRS resource set indicator is set to “10” or “11” or the index of the SRS resource set indicator is set to “2” or “3” according to TABLE 1 or the SRS resource set indicator field is not configured/present, the UE would follow the latest indicated M>1 (or N>1) TCI states or pairs of TCI states to receive/monitor one or more PDCCH candidates from one or more search space sets configured with the same higher layer parameter searchSpaceLinking in one or more CORESETs associated with the latest indicated M>1 (or N>1) TCI states or pairs of TCI states—i.e., multi-TRP PDCCH (repetitions) reception.

If the one-bit flag indicator for PDCCH is set to “0” (or “1”) or “disabled,” or if the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to receive/monitor one or more PDCCH candidates in one or more CORESETs—i.e., single-TRP PDCCH reception.

Yet for another example, the UE could receive in a DCI (e.g., DCI format 1_1 or 1_2 with or without DL assignment) a one-bit indicator for PDCCH. For this design example, a new/dedicated DCI field could be used/configured in the corresponding DCI format to indicate the one-bit indicator; alternatively, one of more of the existing DCI fields in the corresponding DCI format could be used/configured to indicate the one-bit indicator. In addition, the UE could receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit indicator for PDCCH is set to “0” (or “1”), or if the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to receive/monitor one or more PDCCH candidates in one or more CORESETs—i.e., single-TRP PDCCH reception; if the one-bit indicator for PDCCH is set to “1” (or “0”), or if the bit field of the SRS resource set indicator is set to “10” or “11” or the index of the SRS resource set indicator is set to “2” or “3” according to TABLE 1 or the SRS resource set indicator field is not configured/present, the UE would follow the latest indicated M>1 (or N>1) TCI states or pairs of TCI states to receive/monitor one or more PDCCH candidates from one or more search space sets configured with the same higher layer parameter searchSpaceLinking in one or more CORESETs associated with the latest indicated M>1 (or N>1) TCI states or pairs of TCI states—i.e., multi-TRP PDCCH (repetitions) reception.

In yet another example, the UE could first receive in an uplink DCI (e.g., DCI format 0_0, 0_1 or 0_2) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received.

The UE could also receive in a DCI (e.g., DCI format 1_1 or 1_2 with or without DL assignment) a multi-bit (>1 bit, e.g., 2-bit) indicator for PDCCH. For this design example, a new/dedicated DCI field could be used/configured in the corresponding DCI format to indicate the multi-bit indicator; alternatively, one of more of the existing DCI fields in the corresponding DCI format could be used/configured to indicate the multi-bit indicator.

In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The multi-bit indicator for PDCCH or the SRS resource set indicator could indicate one or more of: (1) single-TRP PDCCH reception, (2) multi-TRP PDCCH (repetitions) reception, (3) one or more orderings of the indicated TCI states or pairs of TCI states for single-TRP PDCCH reception or multi-TRP PDCCH (repetitions) reception, and (4) one or more TCI states or pairs of TCI states for single-TRP PDCCH reception or multi-TRP PDCCH (repetitions) reception.

For example, the multi-bit indicator could correspond to a 2-bit indicator with four states “00,” “01,” “10” and “11.” For instance, if the 2-bit indicator is set to “00” (or “01”), or if the bit field of the SRS resource set indicator is set to “00” (or “01”) or the index of the SRS resource set indicator is set to “0” (or “1”) according to TABLE 1, the UE could use only one of the indicated M>1 (or N>1) TCI states or pairs of TCI states to receive/monitor one or more PDCCH candidates in one or more CORESETs—i.e., PDCCH reception in a single-TRP system—following the design examples specified in examples in the present disclosure; if the 2-bit indicator is set to “01” (or “00”), or if the bit field of the SRS resource set indicator is set to “01” (or “00”) or the index of the SRS resource set indicator is set to “1” (or “0”) according to TABLE 1, the UE could use one or more of the indicated M>1 (or N>1) TCI states or pairs of TCI states to receive/monitor one or more PDCCH candidates from one or more search space sets configured with the same higher layer parameter searchSpaceLinking in one or more CORESETs—i.e., PDCCH repetitions reception in a multi-TRP system.

If the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow the ordering of the indicated M>1 (or N>1) TCI states or pairs of TCI states to receive/monitor one or more PDCCH candidates from one or more search space sets configured with the same higher layer parameter searchSpaceLinking in one or more CORESETs associated with the indicated M>1 (or N>1) TCI states or pairs of TCI states (according to examples in the present disclosure); if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow the order-reversed M>1 (or N>1) TCI states or pairs of TCI states to receive/monitor one or more PDCCH candidates from one or more search space sets configured with the same higher layer parameter searchSpaceLinking in one or more CORESETs associated with the order-reversed M>1 (or N>1) TCI states or pairs of TCI states (according to examples in the present disclosure).

Alternatively, if the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow a first ordering of the M>1 (or N>1) TCI states or pairs of TCI states to receive/monitor one or more PDCCH candidates from one or more search space sets configured with the same higher layer parameter searchSpaceLinking in one or more CORESETs associated with the M>1 (or N>1) TCI states or pairs of TCI states in the first ordering; if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow a second ordering of the M>1 (or N>1) TCI states or pairs of TCI states to receive/monitor one or more PDCCH candidates from one or more search space sets configured with the same higher layer parameter searchSpaceLinking in one or more CORESETs associated with the M>1 (or N>1) TCI states or pairs of TCI states in the second ordering. The first and second orderings of TCI states/pairs of TCI states could be according to those specified in examples in the present disclosure.

Optionally, “00” or “01” of the 2-bit indicator, or the bit fields “00” or “01” or the indexes “0” or “1” of the 2-bit SRS resource set indicator in TABLE 1, could be used to indicate the orderings of the M>1 (or N>1) TCI states or pairs of TCI states for multi-TRP PDCCH (repetitions) reception as described above, and “10” or “11” of the 2-bit indicator, or the bit fields “10” or “11” or the indexes “2” or “3” of the 2-bit SRS resource set indicator in TABLE 1, could be used to indicate the single-TRP PDCCH reception or the multi-TRP PDCCH (repetitions) reception as described above.

For another example, the multi-bit indicator could correspond to a 2-bit indicator with four states “00,” “01,” “10” and “11.” For instance, if the 2-bit indicator is set to “00” (or “01”), or if the bit field of the SRS resource set indicator is set to “00” (or “01”) or the index of the SRS resource set indicator is set to “0” (or “1”) according to TABLE 1, the UE could use the primary TCI state or pair of TCI states determined from the indicated M>1 (or N>1) TCI states or pairs of TCI states to receive/monitor one or more PDCCH candidates in one or more CORESETs—i.e., PDCCH reception in a single-TRP system; if the 2-bit indicator is set to “01” (or “00”), or if the bit field of the SRS resource set indicator is set to “01” (or “00”) or the index of the SRS resource set indicator is set to “1” (or “0”) according to TABLE 1, the UE could use the secondary TCI state or pair of TCI states determined from the indicated M>1 (or N>1) TCI states or pairs of TCI states to receive/monitor one or more PDCCH candidates in one or more CORESETs—i.e., PDCCH reception in a single-TRP system; the primary and secondary TCI states/pairs of TCI states could be determined/configured according to those specified in examples in the present disclosure. If the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow the ordering of the indicated M>1 (or N>1) TCI states or pairs of TCI states to receive/monitor one or more PDCCH candidates from one or more search space sets configured with the same higher layer parameter searchSpaceLinking in one or more CORESETs associated with the indicated M>1 (or N>1) TCI states or pairs of TCI states (according to examples in the present disclosure); if the 2-bit indicator is set to “11” (or “10”), or if the bit field of the SRS resource set indicator is set to “11” (or “10”) or the index of the SRS resource set indicator is set to “1” (or “0”) according to TABLE 1, the UE would follow the order-reversed M>1 (or N>1) TCI states or pairs of TCI states to receive/monitor one or more PDCCH candidates from one or more search space sets configured with the same higher layer parameter searchSpaceLinking in one or more CORESETs associated with the order-reversed M>1 (or N>1) TCI states or pairs of TCI states (according to examples in the present disclosure).

Alternatively, if the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow a first ordering of the M>1 (or N>1) TCI states or pairs of TCI states to receive/monitor one or more PDCCH candidates from one or more search space sets configured with the same higher layer parameter searchSpaceLinking in one or more CORESETs associated with the M>1 (or N>1) TCI states or pairs of TCI states in the first ordering; if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow a second ordering of the M>1 (or N>1) TCI states or pairs of TCI states to receive/monitor one or more PDCCH candidates from one or more search space sets configured with the same higher layer parameter searchSpaceLinking in one or more CORESETs associated with the M>1 (or N>1) TCI states or pairs of TCI states in the second ordering.

The first and second orderings of TCI states/pairs of TCI states could be according to those specified in examples in the present disclosure. Optionally, “00” or “01” of the 2-bit indicator, or the bit fields “00” or “01” or the indexes “0” or “1” of the 2-bit SRS resource set indicator in TABLE 1, could be used to indicate the orderings of the M>1 (or N>1) TCI states or pairs of TCI states for multi-TRP PDCCH (repetitions) reception as described above, and “10” or “11” of the 2-bit indicator, or the bit fields “10” or “11” or the indexes “2” or “3” of the 2-bit SRS resource set indicator in TABLE 1, could be used to indicate the primary or secondary TCI states/pairs of TCI states for single-TRP PDCCH reception as described above.

Yet for another example, the multi-bit indicator could correspond to a 2-bit indicator with four states “00,” “01,” “10” and “11,” configured according to those specified in the examples. In addition to the 2-bit indicator or the 2-bit SRS resource set indicator configured according to examples, the UE could also receive in a DCI (e.g., DCI format 1_1 or 1_2 with or without DL assignment or DCI format 0_0, 0_1 or 0_2) a one-bit indicator. For this design example, a new/dedicated DCI field could be used/configured in the corresponding DCI format to indicate the one-bit indicator; alternatively, one of more of the existing DCI fields in the corresponding DCI format could be used/configured to indicate the one-bit indicator.

When the 2-bit indicator or the 2-bit SRS resource set indicator indicates the single-TRP PDCCH reception, if the one-bit indicator is set to “0” (or “1”), the UE could use the primary TCI state or pair of TCI states determined from the indicated M>1 (or N>1) TCI states or pairs of TCI states to receive/monitor one or more PDCCH candidates in one or more CORESETs; if the one-bit indicator is set to “1” (or “0”), the UE could use the secondary TCI state or pair of TCI states determined from the indicated M>1 (or N>1) TCI states or pairs of TCI states to receive/monitor one or more PDCCH candidates in one or more CORESETs; the primary and secondary TCI states/pairs of TCI states could be determined/configured according to those specified in examples in the present disclosure.

Yet for another example, the multi-bit indicator or the SRS resource set indicator indicated in DCI format 0_1 or 0_2 (e.g., in the “SRS resource set indicator” field) could correspond to a z-bit indicator (z>1, e.g., z=3) with 2\hat{ }z states (e.g., 8 states for z=3). In this example, a first state or bit field of the z-bit indicator could indicate that the single-TRP PDCCH reception is enabled according to examples and the corresponding sub-examples in the present disclosure, a second state or bit field of the z-bit indicator could indicate that the multi-TRP PDCCH (repetitions) reception is enabled according to examples and the corresponding sub-examples in the present disclosure, a third state or bit field of the z-bit indicator could indicate that the UE could use the primary TCI state or pair of TCI states for the single-TRP PDCCH reception as discussed in examples and the corresponding sub-examples in the present disclosure, a fourth state or bit field of the z-bit indicator could indicate that the UE could use the secondary TCI state or pair of TCI states for the single-TRP PDCCH reception as discussed in examples and the corresponding sub-examples in the present disclosure, a fifth state or bit field of the z-bit indicator could indicate an ordering of the M>1 (or N>1) TCI states or pairs of TCI states for the multi-TRP PDCCH (repetitions) reception as discussed in examples in the present disclosure, a sixth state of the z-bit indicator could indicate another ordering of the M>1 (or N>1) TCI states or pairs of TCI states for the multi-TRP PDCCH (repetitions) reception as discussed in examples in the present disclosure.

In yet another example, the UE could first receive in an uplink DCI (e.g., DCI format 0_0, 0_1 or 0_2) M=1 (or N=1) TCI state or pair of TCI states indicated by a TCI state codepoint (or a TCI field) as specified in examples and the corresponding sub-examples in the present disclosure. The UE could then receive in an uplink DCI (e.g., DCI format 0_0, 0_1 or 0_2) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received.

Furthermore, the UE could receive in a DCI (e.g., DCI format 1_1 or 1_2 with or without DL assignment) a multi-bit (>1 bit, e.g., 2-bit) indicator for PDCCH. For this design example, a new/dedicated DCI field could be used/configured in the corresponding DCI format to indicate the multi-bit indicator; alternatively, one of more of the existing DCI fields in the corresponding DCI format could be used/configured to indicate the multi-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The multi-bit indicator for PDCCH or the SRS resource set indicator could indicate one or more of: (1) single-TRP PDCCH reception, (2) multi-TRP PDCCH (repetitions) reception, (3) one or more orderings of the indicated TCI states or pairs of TCI states for single-TRP PDCCH reception or multi-TRP PDCCH (repetitions) reception, and (4) one or more TCI states or pairs of TCI states for single-TRP PDCCH reception or multi-TRP PDCCH (repetitions) reception.

The multi-bit indicator or the SRS resource set indicator could be configured according to examples in the present disclosure. For this example, if the multi-bit indicator or the SRS resource set indicator indicates that the single-TRP PDCCH reception is enabled, the UE could follow the previously indicated M=1 (or N=1) TCI state or pair of TCI states to receive/monitor one or more PDCCH candidates in one or more CORESETs (as discussed in examples and the corresponding sub-examples in the present disclosure).

The UE could receive from the network one or more MAC CE activation/sub-selection commands activating one or more sets of TCI states/TCI state IDs from the one or more TCI state pools (specified in examples in the present disclosure) or the one or more TCI state groups (specified in examples in the present disclosure), with each set of activated/selected TCI states/TCI state IDs used to map up to Nc≥1 (e.g., 8, 16, 32 or 64) TCI state codepoints in a DCI format. Here, a TCI state codepoint could be configured according to examples and the corresponding sub-examples in the present disclosure. Furthermore, the one or more sets of activated/selected TCI state codepoints could include/contain/comprise one or more of the following examples.

A first set of TCI state codepoints for single-TRP PDCCH reception: the UE could receive in an uplink DCI (e.g., DCI format 0_0, 0_1 or 0_2) M=1 (or N=1) TCI state or pair of TCI states indicated by a TCI state codepoint from the first set of TCI state codepoints; the UE could use the indicated TCI state or pair of TCI states for the single-TRP PDCCH reception

A second set of TCI state codepoints for single-TRP PDCCH reception: the UE could receive in an uplink DCI (e.g., DCI format 0_0, 0_1 or 0_2) M=1 (or N=1) TCI state or pair of TCI states indicated by a TCI state codepoint from the second set of TCI state codepoints; the UE could use the indicated TCI state or pair of TCI states as the primary TCI state or pair of TCI states as discussed in examples and the corresponding sub-examples in the present disclosure for the single-TRP PDCCH reception.

A third set of TCI state codepoints for single-TRP PDCCH reception: the UE could receive in an uplink DCI (e.g., DCI format 0_0, 0_1 or 0_2) M=1 (or N=1) TCI state or pair of TCI states indicated by a TCI state codepoint from the third set of TCI state codepoints; the UE could use the indicated TCI state or pair of TCI states as the secondary TCI state or pair of TCI states as discussed in examples and the corresponding sub-examples in the present disclosure for the single-TRP PDCCH reception.

A fourth set of TCI state codepoints for multi-TRP PDCCH (repetitions) reception: the UE could receive in an uplink DCI (e.g., DCI format 0_0, 0_1 or 0_2) M>1 (or N>1) TCI states or pairs of TCI states indicated by one or more TCI state codepoints from the fourth set of TCI state codepoints, wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received.

A fifth set of TCI state codepoints for multi-TRP PDCCH (repetitions) reception: the UE could receive in an uplink DCI (e.g., DCI format 0_0, 0_1 or 0_2) M>1 (or N>1) TCI states or pairs of TCI states indicated by one or more TCI state codepoints from the fifth set of TCI state codepoints, wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received. The ordering of the indicated M>1 (or N>1) TCI states or pairs of TCI states from the fifth set could correspond to an ordering of M>1 (or N>1) TCI states or pairs of TCI states (e.g., the first ordering) discussed in examples in the present disclosure.

A sixth set of TCI state codepoints for multi-TRP PDCCH (repetitions) reception: the UE could receive in an uplink DCI (e.g., DCI format 0_0, 0_1 or 0_2) M>1 (or N>1) TCI states or pairs of TCI states indicated by one or more TCI state codepoints from the sixth set of TCI state codepoints, wherein one or more of the indicated M>1 (or N>1) TCI states or pairs of TCI states could be associated with/mapped to one or more CORESETs, in which one or more PDCCH candidates in one or more search space sets configured with the higher layer parameter searchSpaceLinking are received. The ordering of the indicated M>1 (or N>1) TCI states or pairs of TCI states from the sixth set could correspond to an ordering of M>1 (or N>1) TCI states or pairs of TCI states (e.g., the second ordering) discussed in examples in the present disclosure.

The UE could be indicated by the network from which set(s) of TCI state codepoints the indicated one or more TCI states or pairs of TCI states are selected. This indication could be via higher layer RRC signaling or MAC CE command or dynamic DCI based signaling. For instance, a y-bit (y≥1) indicator could be configured/included/incorporated in a DCI format (e.g., DCI format 1_1 or 1_2 with or without DL assignment) to indicate the set(s) of TCI state codepoints.

For this design example, a new/dedicated DCI field could be used/configured in the corresponding DCI format to indicate the y-bit indicator; alternatively, one of more of the existing DCI fields in the corresponding DCI format could be used/configured to indicate the y-bit indicator. In addition, as discussed above, the UE could receive in an uplink DCI (e.g., DCI format 0_1 or 0_2) a y-bit (y≥1) SRS resource set indicator (e.g., in the “SRS resource set indicator” field) to indicate one or more SRS resource sets. Here, the SRS resource set indicator could also be used to indicate the set(s) of TCI state codepoints. Each state/bit field/index of the y-bit indicator or the y-bit SRS resources set indicator (a total of 2\hat{ }y states or bit fields for the y-bit indicator or the y-bit SRS resource set indicator) could correspond to a set of TCI state codepoints (e.g., the first set, the second set, the third set, the fourth set, the fifth set or the sixth set as specified above).

For example, if a UE receives in the DCI format for beam indication (e.g., DCI format 1_1 or 1_2 with or without DL assignment) the y-bit indicator (e.g., set to a state), or in DCI format 0_1 or 0_2 the y-bit SRS resource set indicator in the “SRS resource set indicator” field (e.g., set to a state or bit field value), the UE could determine the set of TCI state codepoints corresponding to the indicated state or bit field value of the y-bit indicator or the y-bit SRS resource set indicator, from which the indicated one or more TCI states or pairs of TCI states are selected. According to the determined set of TCI state codepoints, the UE could perform/conduct the corresponding single-TRP PDCCH reception or multi-TRP PDCCH (repetitions) reception as discussed above.

In one embodiment, when a UE is configured/provided by the network higher layer parameter repetitionScheme set to one of “fdmSchemeA,” “fdmSchemeB” and “tdmSchemeA” or higher layer parameter repetitionNumber in PDSCH-TimeDomainResourceAllocation, the UE could expect to receive PDSCH repetitions in overlapped or non-overlapped time or frequency domain resources.

When a UE is configured/provided by the network the higher layer parameter repetitionScheme set to “fdmSchemeA” and N>1 (or M>1) TCI states or pairs of TCI states indicated by one or more TCI state codepoints (or one or more TCI fields) in a DCI format (e.g., DCI format 1_1 or 1_2 with or without DL assignment), the UE could receive a single PDSCH transmission occasion of the transport block (TB) with each indicated TCI state or pairs of TCI states associated to a non-overlapping frequency domain resource allocation. A UE may assume that precoding granularity is P_{BWP} resource blocks in the frequency domain, where P_{BWP} can be equal to one of the values among {2, 4, wideband}. For N=2 or M=2, if P_{BWP} is configured/determined as “wideband,” the first ┌n_{PRB}/2┐ PRBs—referred to as a first PDSCH transmission in the present disclosure—are assigned to a first indicated TCI state/pair of TCI states, and the remaining └n_{PRB}/2┘ PRBs—referred to as a second PDSCH transmission in the present disclosure—are assigned to a second indicated TCI state/pair of TCI states, where n_{PRB} is the total number of allocated PRBs for the UE; if P_{BWP} is configured/determined as one of the values among {2, 4}, even precoding resource block groups (PRGs) within the allocated frequency domain resources—referred to as a first PDSCH transmission in the present disclosure—are assigned to a first indicated TCI state/pair of TCI states, and odd PRGs within the allocated frequency domain resources—referred to as a second PDSCH transmission in the present disclosure—are assigned to a second indicated TCI state/pair of TCI states, wherein the PRGs are numbered continuously in increasing order with the first PRG index equal to 0. In the present disclosure, the first (or second) indicated TCI state/pair of TCI states could correspond to any of the indicated M=2 (or N=2) TCI states/pairs of TCI states.

When a UE is configured/provided by the network the higher layer parameter repetitionScheme set to “fdmSchemeB” and N>1 (or M>1) TCI states or pairs of TCI states indicated by one or more TCI state codepoints (or one or more TCI fields) in a DCI format (e.g., DCI format 1_1 or 1_2 with or without DL assignment), the UE could receive two PDSCH transmission occasions of the same TB with each indicated TCI state/pair of TCI states associated to a PDSCH transmission occasion which has non-overlapping frequency domain resource allocation with respect to the other PDSCH transmission occasion. A UE may assume that precoding granularity is P_{BWP} resource blocks in the frequency domain, where P_{BWP} can be equal to one of the values among {2, 4, wideband}.

For N=2 or M=2, if P_{BWP} is configured/determined as “wideband,” the first ┌n_{PRB}/2┐ PRBs—referred to as a first PDSCH transmission in the present disclosure—are assigned to a first indicated TCI state/pair of TCI states, and the remaining └n_{PRB}/2┘ PRBs—referred to as a second PDSCH transmission in the present disclosure—are assigned to a second indicated TCI state/pair of TCI states, where n_{PRB} is the total number of allocated PRBs for the UE; if P_{BWP} is configured/determined as one of the values among {2, 4}, even precoding resource block groups (PRGs) within the allocated frequency domain resources—referred to as a first PDSCH transmission in the present disclosure—are assigned to a first indicated TCI state/pair of TCI states, and odd PRGs within the allocated frequency domain resources—referred to as a second PDSCH transmission in the present disclosure—are assigned to a second indicated TCI state/pair of TCI states, wherein the PRGs are numbered continuously in increasing order with the first PRG index equal to 0. In the present disclosure, the first (or second) indicated TCI state/pair of TCI states could correspond to any of the indicated M=2 (or N=2) TCI states/pairs of TCI states.

When a UE is configured/provided by the network the higher layer parameter repetitionScheme set to “tdmSchemeA” and N>1 (or M>1) TCI states or pairs of TCI states indicated by one or more TCI state codepoints (or one or more TCI fields) in a DCI format (e.g., DCI format 1_1 or 1_2 with or without DL assignment), the UE could receive two PDSCH transmission occasions of the TB with each indicated TCI state/pair of TCI states associated to a PDSCH transmission occasion which has non-overlapping time domain resource allocation with respect to the other PDSCH transmission occasion and both PDSCH transmission occasions may be received within a given slot. For M=2 or N=2, a first indicated TCI state/pair of TCI states could be applied to the first PDSCH transmission occasion; a second indicated TCI state/pair of TCI states could be applied to the second PDSCH transmission occasion, and the second PDSCH transmission occasion shall have the same number of symbols as the first PDSCH transmission occasion. In the present disclosure, the first (or second) indicated TCI state/pair of TCI states could correspond to any of the indicated M=2 (or N=2) TCI states/pairs of TCI states.

When a UE is configured/provided by the network the higher layer parameter repetitionNumber in PDSCH-TimeDomainResourceAllocation, and N>1 (or M>1) TCI states or pairs of TCI states indicated by one or more TCI state codepoints (or one or more TCI fields) in a DCI format (e.g., DCI format 1_1 or 1_2 with or without DL assignment), the UE may expect to receive multiple slot level PDSCH transmission occasions of the same TB with the indicated M>1 (or N>1) TCI states/pairs of TCI states used across multiple PDSCH transmission occasions in the repetitionNumber consecutive slots. For N=2 or M=2, when the value indicated by repetitionNumber in PDSCH-TimeDomainResourceAllocation equals to two, a first indicated TCI state is applied to the first PDSCH transmission occasion; a second indicated TCI state/pair of TCI states is applied to the second PDSCH transmission occasion.

When the value of repetitionNumber in PDSCH-TimeDomainResourceAllocation is larger than two, the UE may be further configured to enable cyclicMapping or sequentialMapping. When cyclicMapping is enabled, a first indicated TCI state/pair of TCI states and a second indicated TCI state/pair of TCI states are applied to the first PDSCH transmission occasion and the second PDSCH transmission occasion, respectively, and the same TCI mapping pattern continues to the remaining PDSCH transmission occasions. When sequentialMapping is enabled, a first indicated TCI state/pair of TCI states is applied to the first and second PDSCH transmission occasions, and a second indicated TCI state/pair of TCI states is applied to the third and fourth PDSCH transmission occasions, and the same TCI mapping pattern continues to the remaining PDSCH transmission occasions. In the present disclosure, the first (or second) indicated TCI state/pair of TCI states could correspond to any of the indicated M=2 (or N=2) TCI states/pairs of TCI states.

In a multi-TRP system, when a UE is not configured/provided by the network higher layer parameter repetitionScheme or repetitionNumber in PDSCH-TimeDomainResourceAllocation and the UE is indicated by the network M=2 (or N=2) TCI states or pairs of TCI states by one or more TCI state codepoints (or one or more TCI fields) in a DCI format (e.g., DCI format 1_1 or 1_2 with or without DL assignment) and DM-RS port(s) within two CDM groups in the DCI field “Antenna Port(s),” a first indicated TCI state/pair of TCI states could correspond to the CDM group of the first antenna port indicated by the antenna port indication table—referred to as a first PDSCH transmission in the present disclosure, and a second TCI state/pair of TCI states could correspond to the other CDM group—referred to as a second PDSCH transmission in the present disclosure. In the present disclosure, the first (or second) indicated TCI state/pair of TCI states could correspond to any of the indicated M=2 (or N=2) TCI states/pairs of TCI states.

As mentioned in the present disclosure, the UE could receive in an uplink DCI (e.g., DCI format 0_0, 0_1 or 0_2) M>1 (or N>1) TCI states or M>1 (or N>1) pairs of TCI states indicated by one or more TCI state codepoints (or one or more TCI fields) in the corresponding DCI. One or more of the indicated M>1 (or N>1) TCI states or pairs of TCI states could be associated with/mapped to the one or more PDSCH transmissions/transmission occasions.

Furthermore, the UE could receive in a DCI (e.g., DCI format 1_1 or 1_2 with or without DL assignment) one or more bits to indicate at least one of: (1) switching between single-TRP PDSCH reception and multi-TRP PDSCH (repetitions) reception, (2) one or more of the indicated M>1 (or N>1) TCI states or pairs of TCI states to use for the single-TRP PDSCH reception, and (3) switching the order of the indicated M>1 (or N>1) TCI states or pairs of TCI states. One or more new/dedicated DCI fields could be added/included/incorporated in the corresponding DCI format to indicate the one or more bits.

Alternatively, one or more of the existing DCI fields in the corresponding DCI format could be repurposed to indicate the one or more bits. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The SRS resource set indicator could indicate at least one of: (1) switching between single-TRP PDSCH reception and multi-TRP PDSCH (repetitions) reception, (2) one or more of the indicated M>1 (or N>1) TCI states or pairs of TCI states to use for the single-TRP PDSCH reception, and (3) switching the order of the indicated M>1 (or N>1) TCI states or pairs of TCI states.

In one example, the UE could first receive in an uplink DCI (e.g., DCI format 0_0, 0_1 or 0_2) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more PDSCH transmissions/transmission occasions as described above for the multi-TRP PDSCH (repetitions) reception. The UE could also receive in a DCI (e.g., DCI format 1_1 or 1_2 with or without DL assignment) a one-bit flag indicator for PDSCH. For this design example, a new/dedicated DCI field could be used/configured in the corresponding DCI format to indicate the one-bit flag indicator; alternatively, one of more of the existing DCI fields in the corresponding DCI format could be used/configured to indicate the one-bit flag indicator.

In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit flag indicator for PDSCH is set to “1” (or “0”) or “enabled,” or if the bit field of the SRS resource set indicator is set to “00” or “01” or the index of the SRS resource set indicator is set to “0” or “1” according to TABLE 1 or the SRS resource set indicator field is not configured/present, the UE could use only one of the indicated M>1 (or N>1) TCI states or pairs of TCI states to receive one or more PDSCHs or one or more layers of a PDSCH—i.e., PDSCH reception in a single-TRP system; if the one-bit flag indicator for PDSCH is set to “0” (or “1”) or “disabled,” or if the bit field of the SRS resource set indicator is set to “10” or “11” or the index of the SRS resource set indicator is set to “2” or “3” according to TABLE 1 or the SRS resource set indicator field is not configured/present, the UE could use one or more of the indicated M>1 (or N>1) TCI states or pairs of TCI states to receive PDSCH transmissions/transmission occasions—i.e., PDSCH (repetitions) reception in a multi-TRP system.

More specifically, if the one-bit flag indicator for PDSCH is set to “1” (or “0”) or “enabled,” or if the bit field of the SRS resource set indicator is set to “00” or “01” or the index of the SRS resource set indicator is set to “0” or “1” according to TABLE 1 or the SRS resource set indicator field is not configured/present (i.e., for the PDSCH reception in a single-TRP system),

For example, the UE could use the first TCI state or the TCI state with the lowest (or highest) TCI state ID among the indicated M>1 (or N>1) TCI states or the separate DL TCI state or the joint DL and UL TCI state in the first pair of TCI states or the separate DL TCI state or the joint DL and UL TCI state in the pair of TCI states associated with the lowest (or highest) TCI state ID among the indicated M>1 (or N>1) pairs of TCI states to receive one or more PDSCHs or one or more layers of a PDSCH.

For another example, the UE could use the second TCI state or the TCI state with the second lowest (or second highest) TCI state ID among the indicated M>1 (or N>1) TCI states or the separate DL TCI state or the joint DL and UL TCI state in the second pair of TCI states or the separate DL TCI state or the joint DL and UL TCI state in the pair of TCI states associated with the second lowest (or second highest) TCI state ID among the indicated M>1 (or N>1) pairs of TCI states to receive one or more PDSCHs or one or more layers of a PDSCH.

Yet for another example, the UE could use the last TCI state or the TCI state with the highest (or lowest) TCI state ID among the indicated M>1 (or N>1) TCI states or the separate DL TCI state or the joint DL and UL TCI state in the last pair of TCI states or the separate DL TCI state or the joint DL and UL TCI state in the pair of TCI states associated with the highest (or lowest) TCI state ID among the indicated M>1 (or N>1) pairs of TCI states to receive one or more PDSCHs or one or more layers of a PDSCH.

Yet for another example, the UE could use the m-th (or n-th) TCI state or the TCI state with the m-th (or n-th) lowest (or highest) TCI state ID among the indicated M>1 (or N>1) TCI states or the separate DL TCI state or the joint DL and UL TCI state in the m-th (or n-th) pair of TCI states or the separate DL TCI state or the joint DL and UL TCI state in the pair of TCI states associated with the m-th (or n-th) lowest (or highest) TCI state ID among the indicated M>1 (or N>1) pairs of TCI states to receive one or more PDSCHs or one or more layers of a PDSCH, where m∈{1, . . . , M} and n∈{1, . . . , N}. In this example, the index m (or n) could be determined according to at least one of: (1) fixed in the system specification(s) and (2) configured, e.g., via higher layer RRC signaling or MAC CE command or DCI based signaling, by the network.

Yet for another example, the UE could use the separate DL TCI state or the joint DL and UL TCI state among the indicated M>1 (or N>1) TCI states to receive one or more PDSCHs or one or more layers of a PDSCH. In this example, only one of the indicated M>1 (or N>1) TCI states could correspond to a separate DL TCI state or a joint DL and UL TCI state.

Yet for another example, the UE could be higher layer configured by the network a list of K entity IDs. In the present disclosure, an entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. The UE could use the TCI state or the pair of TCI states that is associated with the first entity ID or the second entity ID or the last entity ID or the lowest entity ID or the highest entity ID or the second lowest (or second highest) entity ID or the entity ID associated with the serving cell PCI/PCI index or the entity ID associated with a PCI/PCI index different from the serving cell PCI/PCI index or the k-th entity ID or the k-th lowest (or highest) entity ID among the list of K entity IDs to receive one or more PDSCHs or one or more layers of a PDSCH, where k∈{1, . . . , K}. In this example, the index k could be determined according to at least one of: (1) fixed in the system specification(s) and (2) configured, e.g., via higher layer RRC signaling or MAC CE command or DCI based signaling, by the network. Furthermore, K could be equal to M (or N).

Yet for another example, the UE could be higher layer configured by the network a list of L PCIs. The UE could use the TCI state or the pair of TCI states that is associated with the first PCI or the second PCI or the last PCI or the lowest PCI or the highest PCI or the second lowest (or second highest) PCI or the serving cell PCI or a PCI different from the serving cell PCI or the l-th PCI or the l-th lowest (or highest) PCI among the list of L PCIs to receive one or more PDSCHs or one or more layers of a PDSCH, where l∈{1, . . . , L}. Alternatively, the UE could determine a list of L PCI indexes 0, . . . , L−1 or 1, . . . , L with each PCI index pointing to an entry in the list of L PCIs. For this case, the UE could use the TCI state or the pair of TCI states that is associated with the first PCI index or the second PCI index or the last PCI index or the lowest PCI index or the highest PCI index or the second lowest (or second highest) PCI index or the serving cell PCI index or a PCI index different from the serving cell PCI index or the l-th PCI index or the l-th lowest (or highest) PCI index among the list of L PCI indexes to receive one or more PDSCHs or one or more layers of a PDSCH, where l∈{1, . . . , L}. In this example, the index l could be determined according to at least one of: (1) fixed in the system specification(s) and (2) configured, e.g., via higher layer RRC signaling or MAC CE command or DCI based signaling, by the network. Furthermore, L could be equal to M (or N).

Yet for another example, the UE could be provided in PDCCH-Config two values of CORESETPoolIndex (i.e., 0 and 1) for one or more CORESETs. The UE could use the TCI state or the pair of TCI states that is associated with value 0 of CORESETPoolIndex or value 1 of CORESETPoolIndex or value x of CORESETPoolIndex to receive one or more PDSCHs or one or more layers of a PDSCH, where x∈{0, 1}. In this example, the value x could be determined according to at least one of: (1) fixed in the system specification(s) and (2) configured, e.g., via higher layer RRC signaling or MAC CE command or DCI based signaling, by the network.

In another example, the UE could first receive in an uplink DCI (e.g., DCI format 0_0, 0_1 or 0_2) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more PDSCH transmissions/transmission occasions as described above for the multi-TRP PDSCH (repetitions) reception. The UE could also receive in a DCI (e.g., DCI format 1_1 or 1_2 with or without DL assignment) a one-bit indicator for PDSCH. For this design example, a new/dedicated DCI field could be used/configured in the corresponding DCI format to indicate the one-bit indicator; alternatively, one of more of the existing DCI fields in the corresponding DCI format could be used/configured to indicate the one-bit indicator.

In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. If the one-bit indicator for PDSCH is set to “0” (or “1”), or if the bit field of the SRS resource set indicator is set to “00” (or “01”) or the index of the SRS resource set indicator is set to “0” (or “1”) according to TABLE 1, the UE could use one of the indicated M>1 (or N>1) TCI states or pairs of TCI states—a primary TCI state or pair of TCI states—to receive one or more PDSCHs or one or more layers of a PDSCH—i.e., PDSCH reception in a single-TRP system; if the one-bit indicator for PDSCH is set to “1” (or “O”), or if the bit field of the SRS resource set indicator is set to “01” (or “00”) or the index of the SRS resource set indicator is set to “1” (or “0”), the UE could use another one of the indicated M>1 (or N>1) TCI states or pairs of TCI states—a secondary TCI state or pair of TCI states—to receive one or more PDSCHs or one or more layers of a PDSCH—i.e., PDSCH reception in a single-TRP system. Various design examples of determining the primary TCI state or pair of TCI states or the secondary TCI state or pair of TCI states are provided in examples in the present disclosure.

In yet another example, the UE could first receive in an uplink DCI (e.g., DCI format 0_0, 0_1 or 0_2) M>1 (or N>1) TCI states or pairs of TCI states—denoted and ordered by {TCI state/TCI states pair #a1, TCI state/TCI states pair #a2, . . . , TCI state/TCI states pair #aM (or #aN)}—indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more PDSCH transmissions/PDSCH transmission occasions as described above for the multi-TRP PDSCH (repetitions) reception. The UE could also receive in a DCI (e.g., DCI format 1_1 or 1_2 with or without DL assignment) a one-bit flag indicator to indicate TCI state(s)/pair(s) of TCI states ordering for PDSCH.

For this design example, a new/dedicated DCI field could be used/configured in the corresponding DCI format to indicate the one-bit flag indicator; alternatively, one of more of the existing DCI fields in the corresponding DCI format could be used/configured to indicate the one-bit flag indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit flag indicator is set to “1” (or “0”) or “enabled,” or if the bit field of the SRS resource set indicator is set to “11” (or “10”) or the index of the SRS resource set indicator is set to “3” (or “2”) according to TABLE 1 or the SRS resource set indicator field is not configured/present, the ordering of the indicated M>1 (or N>1) TCI states or pairs of TCI states are reversed, and the UE would follow the order-reversed M>1 (or N>1) TCI states or pairs of TCI states to receive one or more PDSCH transmissions/PDSCH transmission occasions associated with the order-reversed M>1 (or N>1) TCI states or pairs of TCI states, and if the one-bit flag indicator is set to “0” (or “1”) or “disabled,” or if the bit field of the SRS resource set indicator is set to “10” (or “11”) or the index of the SRS resource set indicator is set to “2” (or “3”) according to TABLE 1 or the SRS resource set indicator field is not configured/present, the UE would follow the indicated M>1 (or N>1) TCI states or pairs of TCI states to receive one or more PDSCH transmissions/PDSCH transmission occasions associated with the indicated M>1 (or N>1) TCI states or pairs of TCI states. If the indicated M>1 (or N>1) TCI states or pairs of TCI states are (ordered as) {TCI state/TCI states pair #a1, TCI state/TCI states pair #a2, . . . , TCI state/TCI states pair #aM (or #aN)}, when the one-bit flag indicator is set to “1” (or “0”) or “enabled,” or when the bit field of the SRS resource set indicator is set to “11” (or “10”) or the index of the SRS resource set indicator is set to “3” (or “2”) according to TABLE 1 or the SRS resource set indicator field is not configured/present, the (order-reversed) M>1 (or N>1) TCI states or pairs of TCI states would become to {TCI state/TCI states pair #b1, TCI state/TCI states pair #b2, . . . , TCI state/TCI states pair #bM (or #bN)}, where b1=aM (or aN), b2=a(M−1) or (a(N−1)), . . . , bM (or bN)=a1. For M=2 (or N=2), the UE could first receive in an uplink DCI (e.g., DCI format 0_0, 0_1 or 0_2) two TCI states or pairs of TCI states—denoted and ordered by {TCI state/TCI states pair #a1, TCI state/TCI states pair #a2}; if the one-bit flag indicator is set to “1” (or “0”) or “enabled,” or if the bit field in the SRS resource set indicator is set to “11” (or “10”) or the index of the SRS resource set indicator is set to “3” (or “2”) according to TABLE 1 or the SRS resource set indicator field is not configured/present, the UE would follow the order-reversed two TCI states or pairs of TCI states {TCI state/TCI state pair #a2, TCI state/TCI state pair #a1} to receive one or more PDSCH transmissions/PDSCH transmission occasions (e.g., the first and second PDSCH transmissions or the first and second PDSCH transmission occasions as described above) associated with the order-reversed TCI states or pairs of TCI states {TCI state/TCI state pair #a2, TCI state/TCI state pair #a1}, and if the one-bit flag indicator is set to “0” or (“1”) or “disabled,” or if the bit field of the SRS resource set indicator is set to “10” (or “11”) or the index of the SRS resource set indicator is set to “2” (or “3”) or the SRS resource set indicator field is not configured/present, the UE would follow the indicated two TCI states or pairs of TCI states {TCI state/TCI state pair #a1, TCI state/TCI state pair #a2} to receive one or more PDSCH transmissions/PDSCH transmission occasions (e.g., the first and second PDSCH transmissions or the first and second PDSCH transmission occasions as described above) associated with the indicated TCI states or pairs of TCI states {TCI state/TCI state pair #a1, TCI state/TCI state pair #a2}.

In yet another example, the UE could first receive in an uplink DCI (e.g., DCI format 0_0, 0_1 or 0_2) M>1 (or N>1) TCI states or pairs of TCI states—denoted by {TCI state/TCI states pair #a1, TCI state/TCI states pair #a2, . . . , TCI state/TCI states pair #aM (or #aN)}—indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more PDSCH transmissions/PDSCH transmission occasions as described above for the multi-TRP PDSCH (repetitions) reception. The UE could also receive in a DCI (e.g., DCI format 1_1 or 1_2 with or without DL assignment) a one-bit indicator to indicate TCI state(s)/pair(s) of TCI states ordering for PDSCH. For this design example, a new/dedicated DCI field could be used/configured in the corresponding DCI format to indicate the one-bit indicator; alternatively, one of more of the existing DCI fields in the corresponding DCI format could be used/configured to indicate the one-bit indicator.

In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit indicator is set to “0” (or “1”), or if the bit field of the SRS resource set indicator is set to “10” (or “11”) or the index of the SRS resource set indicator is set to “2” (or “3”) according to TABLE 1, the UE would follow the M>1 (or N>1) TCI states or pairs of TCI states ordered by {TCI state/TCI states pair #a1, TCI state/TCI states pair #a2, . . . , TCI state/TCI states #aM (or #aN)}—a first ordering—to receive one or more PDSCH transmissions/transmission occasions associated with the M>1 (or N>1) TCI states or pairs of TCI states ordered by {TCI state/TCI states pair #a1, TCI state/TCI states pair #a2, . . . , TCI state/TCI states #aM (or #aN)}, and if the one-bit flag indicator is set to “1” (or “0”), or if the bit field of the SRS resource set indicator is set to “11” (or “10”) or the index of the SRS resource set indicator is set to “3” (or “2”) according to TABLE 1, the UE would follow the M>1 (or N>1) TCI states or pairs of TCI states ordered by {TCI state/TCI states pair #b1, TCI state/TCI states pair #b2, . . . , TCI state/TCI states #bM (or #bN)}—a second ordering—to receive one or more PDSCH transmissions/transmission occasions associated with the M>1 (or N>1) TCI states or pairs of TCI states ordered by {TCI state/TCI states pair #b1, TCI state/TCI states pair #b2, . . . , TCI state/TCI states #bM (or #bN)}. The first ordering of the TCI states/pairs of TCI states {TCI state/TCI states pair #a1, TCI state/TCI states pair #a2, . . . , TCI state/TCI states #aM (or #aN)} or the second ordering of the TCI states/pairs of TCI states {TCI state/TCI states pair #b1, TCI state/TCI states pair #b2, . . . , TCI state/TCI states #bM (or #bN)} could be determined according to at least one of: (1) fixed in the system specification(s) and (2) configured, e.g., via higher layer RRC signaling or MAC CE command or DCI based signaling, by the network. For both (1) and (2), b1 could be equal to aM (or aN), b2 could be equal to a(M−1) or (a(N−1)), . . . , bM (or bN) could be equal to a1. For M=2 (or N=2), the UE could first receive in an uplink DCI (e.g., DCI format 0_0, 0_1 or 0_2) two TCI states or pairs of TCI states—denoted by {TCI state/TCI states pair #a1, TCI state/TCI states pair #a2}; if the one-bit flag indicator is set to “0” (or “1”), or if the bit field of the SRS resource set indicator is set to “10” (or “11”) or the index of the SRS resource set indicator is set to “2” (or “3”) according to TABLE 1, the UE would follow the two TCI states or pairs of TCI states ordered by {TCI state/TCI state pair #a1, TCI state/TCI state pair #a2} to receive one or more PDSCH transmissions/transmission occasions (e.g., the first and second PDSCH transmissions or the first and second PDSCH transmission occasions as described above) associated with the two TCI states or pairs of TCI states ordered by {TCI state/TCI state pair #a1, TCI state/TCI state pair #a2}, and if the one-bit flag indicator is set to “1” or (“0”), or if the bit field of the SRS resource set indicator is set to “11” (or “10”) or the index of the SRS resource set indicator is set to “3” (or “2”) according to TABLE 1, the UE would follow the two TCI states or pairs of TCI states ordered by {TCI state/TCI state pair #a2, TCI state/TCI state pair #a1} to receive one or more PDSCH transmissions/transmission occasions (e.g., the first and second PDSCH transmissions or the first and second PDSCH transmission occasions as described above) associated with the two TCI states or pairs of TCI states {TCI state/TCI state pair #a2, TCI state/TCI state pair #a1}.

In yet another example, the UE could first receive in an DCI (e.g., DCI format 0_0, 0_1 or 0_2) M=1 (or N=1) TCI state or pair of TCI states indicated by a TCI state codepoint (or a TCI field) as specified in examples and the corresponding sub-examples in the present disclosure. The UE could then receive in an uplink DCI (e.g., DCI format 0_0, 0_1 or 0_2) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more PDSCH transmissions/transmission occasions as described above for the multi-TRP PDSCH (repetitions) reception.

For example, the UE would follow the latest indicated M>1 (or N>1) TCI states or pairs of TCI states to receive one or more PDSCH transmissions/transmission occasions associated with the latest indicated M>1 (or N>1) TCI states or pairs of TCI states—i.e., multi-TRP PDSCH (repetitions) reception.

For another example, the UE could receive in a DCI (e.g., DCI format 1_1 or 1_2 with or without DL assignment) a one-bit flag indicator for PDSCH. For this design example, a new/dedicated DCI field could be used/configured in the corresponding DCI format to indicate the one-bit flag indicator; alternatively, one of more of the existing DCI fields in the corresponding DCI format could be used/configured to indicate the one-bit flag indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit flag indicator for PDSCH is set to “1” (or “0”) or “enabled,” or if the bit field of the SRS resource set indicator is set to “10” or “11” or the index of the SRS resource set indicator is set to “2” or “3” according to TABLE 1 or the SRS resource set indicator field is not configured/present, the UE would follow the latest indicated M>1 (or N>1) TCI states or pairs of TCI states to receive one or more PDSCH transmissions/PDSCH transmission occasions associated with the latest indicated M>1 (or N>1) TCI states or pairs of TCI states—i.e., multi-TRP PDSCH (repetitions) reception. If the one-bit flag indicator for PDSCH is set to “0” (or “1”) or “disabled,” or if the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to receive one or more PDSCHs or one or more layers of a PDSCH—i.e., single-TRP PDSCH reception.

Yet for another example, the UE could receive in a DCI (e.g., DCI format 1_1 or 1_2 with or without DL assignment) a one-bit indicator for PDSCH. For this design example, a new/dedicated DCI field could be used/configured in the corresponding DCI format to indicate the one-bit indicator; alternatively, one of more of the existing DCI fields in the corresponding DCI format could be used/configured to indicate the one-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation.

For instance, if the one-bit indicator for PDSCH is set to “0” (or “1”), or if the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to receive one or more PDSCHs or one or more layers of a PDSCH—i.e., single-TRP PDSCH reception; if the one-bit indicator for PDSCH is set to “1” (or “0”), or if the bit field of the SRS resource set indicator is set to “10” or “11” or the index of the SRS resources set indicator is set to “2” or “3” according to TABLE 1 or the SRS resource set indicator field is not configured/present, the UE would follow the latest indicated M>1 (or N>1) TCI states or pairs of TCI states to receive one or more PDSCH transmissions/transmission occasions associated with the latest indicated M>1 (or N>1) TCI states or pairs of TCI states—i.e., multi-TRP PDSCH (repetitions) reception.

In yet another example, the UE could first receive in an uplink DCI (e.g., DCI format 0_0, 0_1 or 0_2) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more PDSCH transmissions/transmission occasions as described above for the multi-TRP PDSCH (repetitions) reception. The UE could also receive in a DCI (e.g., DCI format 1_1 or 1_2 with or without DL assignment) a multi-bit (>1 bit, e.g., 2-bit) indicator for PDSCH.

For this design example, a new/dedicated DCI field could be used/configured in the corresponding DCI format to indicate the multi-bit indicator; alternatively, one of more of the existing DCI fields in the corresponding DCI format could be used/configured to indicate the multi-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The multi-bit indicator for PDSCH or the SRS resource set indicator could indicate one or more of: (1) single-TRP PDSCH reception, (2) multi-TRP PDSCH (repetitions) reception, (3) one or more orderings of the indicated TCI states or pairs of TCI states for single-TRP PDSCH reception or multi-TRP PDSCH (repetitions) reception, and (4) one or more TCI states or pairs of TCI states for single-TRP PDSCH reception or multi-TRP PDSCH (repetitions) reception.

For example, the multi-bit indicator could correspond to a 2-bit indicator with four states “00,” “01,” “10” and “11.” For instance, if the 2-bit indicator is set to “00” (or “01”), or if the bit field of the SRS resource set indicator is set to “00” (or “01”) or the index of the SRS resource set indicator is set to “0” (or “1”) according to TABLE 1, the UE could use only one of the indicated M>1 (or N>1) TCI states or pairs of TCI states to receive one or more PDSCHs or one or more layers of a PDSCH—i.e., PDSCH reception in a single-TRP system—following the design examples specified in examples in the present disclosure; if the 2-bit indicator is set to “01” (or “00”), or if the bit field of the SRS resource set indicator is set to “01” (or “00”) or the index of the SRS resource set indicator is set to “1” (or “0”) according to TABLE 1, the UE could use one or more of the indicated M>1 (or N>1) TCI states or pairs of TCI states to receive one or more PDSCH transmissions/transmission occasions as described above—i.e., PDSCH (repetitions) reception in a multi-TRP system. If the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow the ordering of the indicated M>1 (or N>1) TCI states or pairs of TCI states to receive one or more PDSCH transmissions/transmission occasions associated with the indicated M>1 (or N>1) TCI states or pairs of TCI states (according to examples in the present disclosure); if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow the order-reversed M>1 (or N>1) TCI states or pairs of TCI states to receive one or more PDSCH transmissions/transmission occasions associated with the order-reversed M>1 (or N>1) TCI states or pairs of TCI states (according to examples in the present disclosure). Alternatively, if the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow a first ordering of the M>1 (or N>1) TCI states or pairs of TCI states to receive one or more PDSCH transmissions/transmission occasions associated with the M>1 (or N>1) TCI states or pairs of TCI states in the first ordering; if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow a second ordering of the M>1 (or N>1) TCI states or pairs of TCI states to receive one or more PDSCH transmissions/transmission occasions associated with the M>1 (or N>1) TCI states or pairs of TCI states in the second ordering.

The first and second orderings of TCI states/pairs of TCI states could be according to those specified in examples in the present disclosure. Optionally, “00” or “01” of the 2-bit indicator, or the bit fields “00” or “01” or the indexes “0” or “1” of the 2-bit SRS resource set indicator, could be used to indicate the orderings of the M>1 (or N>1) TCI states or pairs of TCI states for multi-TRP PDSCH (repetitions) reception as described above, and “10” or “11” of the 2-bit indicator, or the bit fields “10” or “11” or the indexes “2” or “3” of the 2-bit SRS resource set indicator, could be used to indicate the single-TRP PDSCH reception or the multi-TRP PDSCH (repetitions) reception as described above.

For another example, the multi-bit indicator could correspond to a 2-bit indicator with four states “00,” “01,” “10” and “11.” For instance, if the 2-bit indicator is set to “00” (or “01”), or if the bit field of the SRS resource set indicator is set to “00” (or “01”) or the index of the SRS resource set indicator is set to “0” (or “1”) according to TABLE 1, the UE could use the primary TCI state or pair of TCI states determined from the indicated M>1 (or N>1) TCI states or pairs of TCI states to receive one or more PDSCHs or one or more layers of a PDSCH—i.e., PDSCH reception in a single-TRP system; if the 2-bit indicator is set to “01” (or “00”), or if the bit field of the SRS resource set indicator is set to “10” (or “00”) or the index of the SRS resource set indicator is set to “1” (or “0”) according to TABLE 1, the UE could use the secondary TCI state or pair of TCI states determined from the indicated M>1 (or N>1) TCI states or pairs of TCI states to receive one or more PDSCHs or one or more layers of a PDSCH—i.e., PDSCH reception in a single-TRP system; the primary and secondary TCI states/pairs of TCI states could be determined/configured according to those specified in examples in the present disclosure. If the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow the ordering of the indicated M>1 (or N>1) TCI states or pairs of TCI states to receive one or more PDSCH transmissions/transmission occasions associated with the indicated M>1 (or N>1) TCI states or pairs of TCI states (according to examples in the present disclosure); if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow the order-reversed M>1 (or N>1) TCI states or pairs of TCI states to receive one or more PDSCH transmissions/transmission occasions associated with the order-reversed M>1 (or N>1) TCI states or pairs of TCI states (according to examples in the present disclosure).

Alternatively, if the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow a first ordering of the M>1 (or N>1) TCI states or pairs of TCI states to receive one or more PDSCH transmissions/transmission occasions associated with the M>1 (or N>1) TCI states or pairs of TCI states in the first ordering; if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow a second ordering of the M>1 (or N>1) TCI states or pairs of TCI states to receive one or more PDSCH transmissions/transmission occasions associated with the M>1 (or N>1) TCI states or pairs of TCI states in the second ordering. The first and second orderings of TCI states/pairs of TCI states could be according to those specified in examples in the present disclosure.

Optionally, “00” or “01” of the 2-bit indicator, or the bit fields “00” or “01” or the indexes “0” or “1” of the 2-bit SRS resource set indicator, could be used to indicate the orderings of the M>1 (or N>1) TCI states or pairs of TCI states for multi-TRP PDSCH (repetitions) reception as described above, and “10” or “11” of the 2-bit indicator, or the bit fields “10” or “11” or the indexes “2” or “3” of the 2-bit SRS resource set indicator, could be used to indicate the primary or secondary TCI states/pairs of TCI states for single-TRP PDSCH reception as described above.

Yet for another example, the multi-bit indicator could correspond to a 2-bit indicator with four states “00,” “01,” “10” and “11,” configured according to those specified in examples. In addition to the 2-bit indicator or the 2-bit SRS resource set indicator configured according to examples, the UE could also receive in a DCI (e.g., DCI format 1_1 or 1_2 with or without DL assignment or DCI format 0_0, 0_1 or 0_2) a one-bit indicator.

For this design example, a new/dedicated DCI field could be used/configured in the corresponding DCI format to indicate the one-bit indicator; alternatively, one of more of the existing DCI fields in the corresponding DCI format could be used/configured to indicate the one-bit indicator. When the 2-bit indicator or the 2-bit SRS resource set indicator indicates the single-TRP PDSCH reception, if the one-bit indicator is set to “0” (or “1”), the UE could use the primary TCI state or pair of TCI states determined from the indicated M>1 (or N>1) TCI states or pairs of TCI states to receive one or more PDSCHs or one or more layers of a PDSCH; if the one-bit indicator is set to “1” (or “0”), the UE could use the secondary TCI state or pair of TCI states determined from the indicated M>1 (or N>1) TCI states or pairs of TCI states to receive one or more PDSCHs or one or more layers of a PDSCH; the primary and secondary TCI states/pairs of TCI states could be determined/configured according to those specified in examples in the present disclosure.

Yet for another example, the multi-bit indicator or the SRS resource set indicator indicated in DCI format 0_1 or 0_2 (e.g., in the “SRS resource set indicator” field) could correspond to a z-bit indicator (z>1, e.g., z=3) with 2\hat{ }z states (e.g., 8 states or bit fields for z=3). In this example, a first state or bit field of the z-bit indicator could indicate that the single-TRP PDSCH reception is enabled according to examples and the corresponding sub-examples in the present disclosure, a second state or bit field of the z-bit indicator could indicate that the multi-TRP PDSCH (repetitions) reception is enabled according to examples and the corresponding sub-examples in the present disclosure, a third state or bit field of the z-bit indicator could indicate that the UE could use the primary TCI state or pair of TCI states for the single-TRP PDSCH reception as discussed in examples and the corresponding sub-examples in the present disclosure, a fourth state or bit field of the z-bit indicator could indicate that the UE could use the secondary TCI state or pair of TCI states for the single-TRP PDSCH reception as discussed in examples and the corresponding sub-examples in the present disclosure, a fifth state or bit field of the z-bit indicator could indicate an ordering of the M>1 (or N>1) TCI states or pairs of TCI states for the multi-TRP PDSCH (repetitions) reception as discussed in examples in the present disclosure, a sixth state or bit field of the z-bit indicator could indicate another ordering of the M>1 (or N>1) TCI states or pairs of TCI states for the multi-TRP PDSCH (repetitions) reception as discussed in examples in the present disclosure.

In yet another example, the UE could first receive in an uplink DCI (e.g., DCI format 0_0, 0_1 or 0_2) M=1 (or N=1) TCI state or pair of TCI states indicated by a TCI state codepoint (or a TCI field) as specified in examples and the corresponding sub-examples in the present disclosure. The UE could then receive in an uplink DCI (e.g., DCI format 0_0, 0_1 or 0_2) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more PDSCH transmissions/PDSCH transmission occasions as described above for the multi-TRP PDSCH (repetitions) reception.

Furthermore, the UE could receive in a DCI (e.g., DCI format 1_1 or 1_2 with or without DL assignment) a multi-bit (>1 bit, e.g., 2-bit) indicator for PDSCH. For this design example, a new/dedicated DCI field could be used/configured in the corresponding DCI format to indicate the multi-bit indicator; alternatively, one of more of the existing DCI fields in the corresponding DCI format could be used/configured to indicate the multi-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The multi-bit indicator for PDSCH or the SRS resource set indicator could indicate one or more of: (1) single-TRP PDSCH reception, (2) multi-TRP PDSCH (repetitions) reception, (3) one or more orderings of the indicated TCI states or pairs of TCI states for single-TRP PDSCH reception or multi-TRP PDSCH (repetitions) reception, and (4) one or more TCI states or pairs of TCI states for single-TRP PDSCH reception or multi-TRP PDSCH (repetitions) reception. The multi-bit indicator or the SRS resource set indicator could be configured according to examples in the present disclosure. For this example, if the multi-bit indicator or the SRS resource set indicator indicates that the single-TRP PDSCH reception is enabled, the UE could follow the previously indicated M=1 (or N=1) TCI state or pair of TCI states to receive one or more PDSCHs or one or more layers of a PDSCH (as discussed in examples and the corresponding sub-examples in the present disclosure).’

The UE could receive from the network one or more MAC CE activation/sub-selection commands activating one or more sets of TCI states/TCI state IDs from the one or more TCI state pools (specified in examples in the present disclosure) or the one or more TCI state groups (specified in examples in the present disclosure), with each set of activated/selected TCI states/TCI state IDs used to map up to Nc≥1 (e.g., 8, 16, 32 or 64) TCI state codepoints in a DCI format. Here, a TCI state codepoint could be configured according to examples and the corresponding sub-examples in the present disclosure. Furthermore, the one or more sets of activated/selected TCI state codepoints could include/contain/comprise one or more of the following examples.

In one example of a first set of TCI state codepoints for single-TRP PDSCH reception, the UE could receive in an uplink DCI (e.g., DCI format 0_0, 0_1 or 0_2) M=1 (or N=1) TCI state or pair of TCI states indicated by a TCI state codepoint from the first set of TCI state codepoints; the UE could use the indicated TCI state or pair of TCI states for the single-TRP PDSCH reception.

In one example of a second set of TCI state codepoints for single-TRP PDSCH reception, the UE could receive in an uplink DCI (e.g., DCI format 0_0, 0_1 or 0_2) M=1 (or N=1) TCI state or pair of TCI states indicated by a TCI state codepoint from the second set of TCI state codepoints; the UE could use the indicated TCI state or pair of TCI states as the primary TCI state or pair of TCI states as discussed in examples and the corresponding sub-examples in the present disclosure for the single-TRP PDSCH reception.

In one example of a third set of TCI state codepoints for single-TRP PDSCH reception, the UE could receive in an uplink DCI (e.g., DCI format 0_0, 0_1 or 0_2) M=1 (or N=1) TCI state or pair of TCI states indicated by a TCI state codepoint from the third set of TCI state codepoints; the UE could use the indicated TCI state or pair of TCI states as the secondary TCI state or pair of TCI states as discussed in examples and the corresponding sub-examples in the present disclosure for the single-TRP PDSCH reception.

In one example of a fourth set of TCI state codepoints for multi-TRP PDSCH (repetitions) reception, the UE could receive in an uplink DCI (e.g., DCI format 0_0, 0_1 or 0_2) M>1 (or N>1) TCI states or pairs of TCI states indicated by one or more TCI state codepoints from the fourth set of TCI state codepoints, wherein one or more of the indicated M>1 (or N>1) TCI states or pairs of TCI states could be associated with/mapped to one or more PDSCH transmissions/transmission occasions as described above for the multi-TRP PDSCH (repetitions) reception.

In one example of a fifth set of TCI state codepoints for multi-TRP PDSCH (repetitions) reception, the UE could receive in an uplink DCI (e.g., DCI format 0_0, 0_1 or 0_2) M>1 (or N>1) TCI states or pairs of TCI states indicated by one or more TCI state codepoints from the fifth set of TCI state codepoints, wherein one or more of the indicated M>1 (or N>1) TCI states or pairs of TCI states could be associated with/mapped to one or more PDSCH transmissions/transmission occasions as described above for the multi-TRP PDSCH (repetitions) reception. The ordering of the indicated M>1 (or N>1) TCI states or pairs of TCI states from the fifth set could correspond to an ordering of M>1 (or N>1) TCI states or pairs of TCI states (e.g., the first ordering) discussed in examples in the present disclosure.

In one example of a sixth set of TCI state codepoints for multi-TRP PDSCH (repetitions) reception, the UE could receive in an uplink DCI (e.g., DCI format 0_0, 0_1 or 0_2) M>1 (or N>1) TCI states or pairs of TCI states indicated by one or more TCI state codepoints from the sixth set of TCI state codepoints, wherein one or more of the indicated M>1 (or N>1) TCI states or pairs of TCI states could be associated with/mapped to one or more PDSCH transmissions/transmission occasions as described above for the multi-TRP PDSCH (repetitions) reception. The ordering of the indicated M>1 (or N>1) TCI states or pairs of TCI states from the sixth set could correspond to an ordering of M>1 (or N>1) TCI states or pairs of TCI states (e.g., the second ordering) discussed in examples in the present disclosure.

The UE could be indicated by the network from which set(s) of TCI state codepoints the indicated one or more TCI states or pairs of TCI states are selected. This indication could be via higher layer RRC signaling or MAC CE command or dynamic DCI based signaling. For instance, a y-bit (y≥1) indicator could be configured/included/incorporated in a DCI format (e.g., DCI format 1_1 or 1_2 with or without DL assignment) to indicate the set(s) of TCI state codepoints. For this design example, a new/dedicated DCI field could be used/configured in the corresponding DCI format to indicate the y-bit indicator; alternatively, one of more of the existing DCI fields in the corresponding DCI format could be used/configured to indicate the y-bit indicator.

In addition, as discussed above, the UE could receive in an uplink DCI (e.g., DCI format 0_1 or 0_2) a y-bit (y≥1) SRS resource set indicator (e.g., in the “SRS resource set indicator” field) to indicate one or more SRS resource sets. Here, the SRS resource set indicator could also be used to indicate the set(s) of TCI state codepoints. Each state/bit field/index of the y-bit indicator or the y-bit SRS resources set indicator (a total of 2\hat{ }y states or bit fields for the y-bit indicator or the y-bit SRS resource set indicator) could correspond to a set of TCI state codepoints (e.g., the first set, the second set, the third set, the fourth set, the fifth set or the sixth set as specified above).

For example, if a UE receives in the DCI format for beam indication (e.g., DCI format 1_1 or 1_2 with or without DL assignment) the y-bit indicator (e.g., set to a state), or in DCI format 0_1 or 0_2 the y-bit SRS resource set indicator in the “SRS resource set indicator” field (e.g., set to a state or bit field value), the UE could determine the set of TCI state codepoints corresponding to the indicated state or bit field value of the y-bit indicator or the y-bit SRS resource set indicator, from which the indicated one or more TCI states or pairs of TCI states are selected. According to the determined set of TCI state codepoints, the UE could perform/conduct the corresponding single-TRP PDSCH reception or multi-TRP PDSCH (repetitions) reception as discussed above.

In one embodiment, a UE could be configured with a number of slots, denoted by N_{pucch}, for PUCCH transmission repetitions. The UE could also be configured with two SRS resource sets (e.g., provided by srs-ResourceSetToAddModList or srs-ResourceSetToAddModListDCI-0-2) with higher layer parameter usage in SRS-ResourceSet set to “codebook” or “noncodebook” for PUSCH transmission repetitions. As aforementioned, the UE could receive in a DCI (e.g., DCI format 1_1 or 1_2 with or without DL assignment) M>1 (or N>1) TCI states or M>1 (or N>1) pairs of TCI states indicated by one or more TCI state codepoints (or one or more TCI fields) in the corresponding DCI. One or more of the indicated M>1 (or N>1) TCI states or pairs of TCI states could be associated with/mapped to one or more PUCCH transmission repetitions or one or more PUSCH transmission repetitions.

When a UE is configured with a number of slots N_{pucch} for PUCCH transmission repetitions, the indicated N>1 (or M>1) TCI states or pairs of TCI states could be alternated per N_{pucch} repetitions of the PUCCH transmission, where N_{pucch}=1 if higher layer parameter mappingPattern=“cyclicMapping”; else, N_{pucch}=N (or M). For instance, for N=2 (or M=2), a first and a second indicated TCI states/pairs of TCI states could be alternated per N_{pucch} repetitions of the PUCCH transmission, where N_{pucch}=1 if the higher layer parameter mappingPattern=“cyclicMapping”; else, N_{pucch}=2. In the present disclosure, the first (or second) indicated TCI state/pair of TCI states could correspond to any of the indicated M=2 (or N=2) TCI states/pairs of TCI states.

When a UE is configured with two SRS resource sets (e.g., provided by srs-ResourceSetToAddModList or srs-ResourceSetToAddModListDCI-0-2) with higher layer parameter usage in SRS-ResourceSet set to “codebook” or “noncodebook,” for PUSCH repetition Type A, in case K>1 consecutive slots, the same symbol allocation is applied across the K consecutive slots and the PUSCH is limited to a single transmission layer. The UE shall repeat the TB across the K consecutive slots applying the same symbol allocation in each slot—also referred to as PUSCH transmission repetitions.

In one example, (1) when K=2, M=2 or N=2, a first and a second indicated TCI states/pairs of TCI states are applied to the first and second slots of 2 consecutive slots, respectively; (2) when K>2 and cyclicMapping in PUSCH-Config is enabled, the indicated TCI state/pair of TCI states n (or m) is applied to the n-th (or m-th) slot of K consecutive slots, and the same TCI state(s) mapping pattern continues to the remaining slots of K consecutive slots. For M=2 or N=2, a first and a second indicated TCI states/pairs of TCI states are applied to the first and second slots of K consecutive slots, respectively, and the same TCI state(s) mapping pattern continues to the remaining slots of K consecutive slots; (3) when K>2 and sequentialMapping in PUSCH-Config is enabled, the indicated TCI state/pair of TCI states n (or m) is applied to the n-th (or m-th) and (n+1)-th (or (m+1)-th) slots of K consecutive slots, and the same TCI state(s) mapping pattern continues to the remaining slots of K consecutive slots. For M=2 or N=2, a first indicated TCI state/pair of TCI states is applied to the first and second slots of K consecutive slots, and a second indicated TCI state/pair of TCI states is applied to the third and fourth slots of K consecutive slots, and the same TCI state(s) mapping pattern continues to the remaining slots of K consecutive slots.

In the present disclosure, the first (or second) indicated TCI state/pair of TCI states could correspond to any of the indicated M=2 (or N=2) TCI states/pairs of TCI states. In this example, the first and second indicated TCI states/pairs of TCI states could correspond to the first and second TCI states/pairs of TCI states of/within the indicated M=2 (or N=2) TCI states/pairs of TCI states, respectively.

In another example, (1) when K=2, M=2 or N=2, a second and a first indicated TCI states/pairs of TCI states are applied to the first and second slots of 2 consecutive slots, respectively; (2) when K>2 and cyclicMapping in PUSCH-Config is enabled, for M=2 or N=2, a second and a first indicated TCI states/pairs of TCI states are applied to the first and second slots of K consecutive slots, respectively, and the same TCI state(s) mapping pattern continues to the remaining slots of K consecutive slots; (3) when K>2 and sequentialMapping in PUSCH-Config is enabled, for M=2 or N=2, a second indicated TCI state/pair of TCI states is applied to the first and second slots of K consecutive slots, and a first indicated TCI state/pair of TCI states is applied to the third and fourth slots of K consecutive slots, and the same TCI state(s) mapping pattern continues to the remaining slots of K consecutive slots. In the present disclosure, the first (or second) indicated TCI state/pair of TCI states could correspond to any of the indicated M=2 (or N=2) TCI states/pairs of TCI states. In this example, the first and second indicated TCI states/pairs of TCI states could correspond to the first and second TCI states/pairs of TCI states of/within the indicated M=2 (or N=2) TCI states/pairs of TCI states, respectively.

When a UE is configured with two SRS resource sets (e.g., provided by srs-ResourceSetToAddModList or srs-ResourceSetToAddModListDCI-0-2) with higher layer parameter usage in SRS-ResourceSet set to “codebook” or “noncodebook,” for PUSCH repetition Type B, in case K>1 consecutive slots, the same symbol allocation is applied across the K consecutive slots and the PUSCH is limited to a single transmission layer. The UE shall repeat the TB across the K consecutive slots applying the same symbol allocation in each slot—also referred to as PUSCH (nominal) transmission repetitions. One or more of the indicated M>1 (or N>1) TCI states/pairs of TCI states could be associated/mapped to nominal PUSCH repetitions. The association/mapping between the indicated TCI states/pairs of TCI states and the nominal PUSCH repetitions could follow those specified in examples in the present disclosure (for PUSCH Type A repetition) by considering nominal repetitions instead of slots.

Furthermore, the UE could receive in a DCI (e.g., DCI format 1_1 or 1_2 with or without DL assignment) one or more bits to indicate at least one of: (1) switching between single-TRP PUCCH or PUSCH transmission and multi-TRP PUCCH or PUSCH (repetitions) transmission, (2) one or more of the indicated M>1 (or N>1) TCI states or pairs of TCI states to use for the single-TRP PUCCH or PUSCH transmission, and (3) switching the order of the indicated M>1 (or N>1) TCI states or pairs of TCI states for multi-TRP PUCCH or PUSCH (repetitions) transmission. One or more new/dedicated DCI fields could be added/included/incorporated in the corresponding DCI format to indicate the one or more bits.

Alternatively, one or more of the existing DCI fields in the corresponding DCI format could be repurposed to indicate the one or more bits. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The SRS resource set indicator could also indicate one or more of: (1) switching between single-TRP PUCCH or PUSCH transmission and multi-TRP PUCCH or PUSCH (repetitions) transmission, (2) one or more of the indicated M>1 (or N>1) TCI states or pairs of TCI states to use for the single-TRP PUCCH or PUSCH transmission, and (3) switching the order of the indicated M>1 (or N>1) TCI states or pairs of TCI states for multi-TRP PUCCH or PUSCH (repetitions) transmission.

In one example, the UE could first receive in an uplink DCI (e.g., DCI format 0_0, 0_1 or 0_2) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission. The UE could also receive in a DCI (e.g., DCI format 1_1 or 1_2 with or without DL assignment) a one-bit flag indicator for PUCCH or PUSCH. For this design example, a new/dedicated DCI field could be used/configured in the corresponding DCI format to indicate the one-bit flag indicator; alternatively, one of more of the existing DCI fields in the corresponding DCI format could be used/configured to indicate the one-bit flag indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit flag indicator for PUCCH or PUSCH is set to “1” (or “0”) or “enabled,” or if the bit field of the SRS resource set indicator is set to “00” or “01” or the index of the SRS resource set indicator is set to “0” or “1” according to TABLE 1 or the SRS resource set indicator field is not configured/present, the UE could use only one of the indicated M>1 (or N>1) TCI states or pairs of TCI states to transmit PUCCH(s) or PUSCH(s)—i.e., PUCCH or PUSCH transmission in a single-TRP system; if the one-bit flag indicator for PUCCH or PUSCH is set to “0” (or “1”) or “disabled,” or if the bit field of the SRS resource set indicator is set to “10” or “11” or the index of the SRS resource set indicator is set to “2” or “3” or the SRS resource set indicator field is not configured/present, the UE could use one or more of the indicated M>1 (or N>1) TCI states or pairs of TCI states to transmit PUCCH transmission repetitions or PUSCH transmission repetitions—i.e., PUCCH or PUSCH (repetitions) transmission in a multi-TRP system.

More specifically, if the one-bit flag indicator for PUCCH or PUSCH is set to “1” (or “0”) or “enabled,” or if the bit field of the SRS resource set indicator is set to “00” or “01” or the index of the SRS resource set indicator is set to “0” or “1” according to TABLE 1 or the SRS resource set indicator field is not configured/present (i.e., for the PUCCH or PUSCH transmission in a single-TRP system),

For example, the UE could use the first TCI state or the TCI state with the lowest (or highest) TCI state ID among the indicated M>1 (or N>1) TCI states or the separate UL TCI state or the joint DL and UL TCI state in the first pair of TCI states or the separate UL TCI state or the joint DL and UL TCI state in the pair of TCI states associated with the lowest (or highest) TCI state ID among the indicated M>1 (or N>1) pairs of TCI states to transmit the PUCCH(s) or PUSCH(s).

For another example, the UE could use the second TCI state or the TCI state with the second lowest (or second highest) TCI state ID among the indicated M>1 (or N>1) TCI states or the separate UL TCI state or the joint DL and UL TCI state in the second pair of TCI states or the separate UL TCI state or the joint DL and UL TCI state in the pair of TCI states associated with the second lowest (or second highest) TCI state ID among the indicated M>1 (or N>1) pairs of TCI states to transmit the PUCCH(s) or PUSCH(s).

Yet for another example, the UE could use the last TCI state or the TCI state with the highest (or lowest) TCI state ID among the indicated M>1 (or N>1) TCI states or the separate UL TCI state or the joint DL and UL TCI state in the last pair of TCI states or the separate UL TCI state or the joint DL and UL TCI state in the pair of TCI states associated with the highest (or lowest) TCI state ID among the indicated M>1 (or N>1) pairs of TCI states to transmit the PUCCH(s) or PUSCH(s).

Yet for another example, the UE could use the m-th (or n-th) TCI state or the TCI state with the m-th (or n-th) lowest (or highest) TCI state ID among the indicated M>1 (or N>1) TCI states or the separate UL TCI state or the joint DL and UL TCI state in the m-th (or n-th) pair of TCI states or the separate UL TCI state or the joint DL and UL TCI state in the pair of TCI states associated with the m-th (or n-th) lowest (or highest) TCI state ID among the indicated M>1 (or N>1) pairs of TCI states to transmit the PUCCH(s) or PUSCH(s), where m∈{1, . . . , M} and n∈{1, . . . , N}. In this example, the index m (or n) could be determined according to at least one of: (1) fixed in the system specification(s) and (2) configured, e.g., via higher layer RRC signaling or MAC CE command or DCI based signaling, by the network.

Yet for another example, the UE could use the separate UL TCI state or the joint DL and UL TCI state among the indicated M>1 (or N>1) TCI states to transmit the PUCCH(s) or PUSCH(s). In this example, only one of the indicated M>1 (or N>1) TCI states could correspond to a separate UL TCI state or a joint DL and UL TCI state.

Yet for another example, the UE could be higher layer configured by the network a list of K entity IDs. In the present disclosure, an entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. The UE could use the TCI state or the pair of TCI states that is associated with the first entity ID or the second entity ID or the last entity ID or the lowest entity ID or the highest entity ID or the second lowest (or second highest) entity ID or the entity ID associated with the serving cell PCI/PCI index or the entity ID associated with a PCI/PCI index different from the serving cell PCI/PCI index or the k-th entity ID or the k-th lowest (or highest) entity ID among the list of K entity IDs to transmit the PUCCH(s) or PUSCH(s), where k∈{1, . . . , K}.

In this example, the index k could be determined according to at least one of: (1) fixed in the system specification(s) and (2) configured, e.g., via higher layer RRC signaling or MAC CE command or DCI based signaling, by the network. Furthermore, K could be equal to M (or N).

Yet for another example, the UE could be higher layer configured by the network a list of L PCIs. The UE could use the TCI state or the pair of TCI states that is associated with the first PCI or the second PCI or the last PCI or the lowest PCI or the highest PCI or the second lowest (or second highest) PCI or the serving cell PCI or a PCI different from the serving cell PCI or the l-th PCI or the l-th lowest (or highest) PCI among the list of L PCIs to transmit the PUCCH(s) or PUSCH(s), where l∈{1, . . . , L}.

Alternatively, the UE could determine a list of L PCI indexes 0, . . . , L−1 or 1, . . . , L with each PCI index pointing to an entry in the list of L PCIs. For this case, the UE could use the TCI state or the pair of TCI states that is associated with the first PCI index or the second PCI index or the last PCI index or the lowest PCI index or the highest PCI index or the second lowest (or second highest) PCI index or the serving cell PCI index or a PCI index different from the serving cell PCI index or the l-th PCI index or the l-th lowest (or highest) PCI index among the list of L PCI indexes to transmit the PUCCH(s) or PUSCH(s), where l∈{1, . . . , L}. In this example, the index l could be determined according to at least one of: (1) fixed in the system specification(s) and (2) configured, e.g., via higher layer RRC signaling or MAC CE command or DCI based signaling, by the network. Furthermore, L could be equal to M (or N).

Yet for another example, the UE could be provided in PDCCH-Config two values of CORESETPoolIndex (i.e., 0 and 1) for one or more CORESETs. The UE could use the TCI state or the pair of TCI states that is associated with value 0 of CORESETPoolIndex or value 1 of CORESETPoolIndex or value x of CORESETPoolIndex to transmit the PUCCH(s) or PUSCH(s), where x∈{0, 1}. In this example, the value x could be determined according to at least one of: (1) fixed in the system specification(s) and (2) configured, e.g., via higher layer RRC signaling or MAC CE command or DCI based signaling, by the network.

In another example, the UE could first receive in an uplink DCI (e.g., DCI format 0_0, 0_1 or 0_2) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission. The UE could also receive in a DCI (e.g., DCI format 1_1 or 1_2 with or without DL assignment) a one-bit indicator for PUCCH or PUSCH. For this design example, a new/dedicated DCI field could be used/configured in the corresponding DCI format to indicate the one-bit indicator; alternatively, one of more of the existing DCI fields in the corresponding DCI format could be used/configured to indicate the one-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP and multi-TRP operation. If the one-bit indicator for PUCCH or PUSCH is set to “0” (or “1”), or if the bit field of the SRS resource set indicator is set to “00” (or “01”) or the index of the SRS resource set indicator is set to “0” (or “1”) according to TABLE 1, the UE could use one of the indicated M>1 (or N>1) TCI states or pairs of TCI states—a primary TCI state or pair of TCI states—to transmit PUCCH(s) or PUSCH(s)—i.e., PUCCH or PUSCH transmission in a single-TRP system; if the one-bit indicator for PUCCH or PUSCH is set to “1” (or “0”), or if the bit field of the SRS resource set indicator is set to “01” (or “00”) or the index of the SRS resource set indicator is set to “1” (or “0”) according to TABLE 1, the UE could use another one of the indicated M>1 (or N>1) TCI states or pairs of TCI states—a secondary TCI state or pair of TCI states—to transmit PUCCH(s) or PUSCH(s)—i.e., PUCCH or PUSCH transmission in a single-TRP system.

Various design examples of determining the primary TCI state or pair of TCI states or the secondary TCI state or pair of TCI states are provided in examples in the present disclosure.

In yet another example, the UE could first receive in an uplink DCI (e.g., DCI format 0_0, 0_1 or 0_2) M>1 (or N>1) TCI states or pairs of TCI states—denoted and ordered by {TCI state/TCI states pair #a1, TCI state/TCI states pair #a2, . . . , TCI state/TCI states pair #aM (or #aN)}—indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) reception. The UE could also receive in a DCI (e.g., DCI format 1_1 or 1_2 with or without DL assignment) a one-bit flag indicator to indicate TCI state(s)/pair(s) of TCI states ordering for PUCCH or PUSCH. For this design example, a new/dedicated DCI field could be used/configured in the corresponding DCI format to indicate the one-bit flag indicator; alternatively, one of more of the existing DCI fields in the corresponding DCI format could be used/configured to indicate the one-bit flag indicator.

In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit flag indicator is set to “1” (or “0”) or “enabled,” or if the bit field of the SRS resource set indicator is set to “11” (or “10”) or the index of the SRS resource set indicator is set to “3” (or “2”) according to TABLE 1 or the SRS resource set indicator field is not configured/present, the ordering of the indicated M>1 (or N>1) TCI states or pairs of TCI states are reversed, and the UE would follow the order-reversed M>1 (or N>1) TCI states or pairs of TCI states to transmit one or more PUCCH transmission repetitions or PUSCH transmission repetitions associated with the order-reversed M>1 (or N>1) TCI states or pairs of TCI states, and if the one-bit flag indicator is set to “0” (or “1”) or “disabled,” or if the bit field of the SRS resource set indicator is set to “10” (or “11”) or the index of the SRS resource set indicator is set to “2” (or “3”) according to TABLE 1 or the SRS resource set indicator field is not configured/present, the UE would follow the indicated M>1 (or N>1) TCI states or pairs of TCI states to transmit one or more PUCCH transmission repetitions or PUSCH transmission repetitions associated with the indicated M>1 (or N>1) TCI states or pairs of TCI states. If the indicated M>1 (or N>1) TCI states or pairs of TCI states are (ordered as) {TCI state/TCI states pair #a1, TCI state/TCI states pair #a2, . . . , TCI state/TCI states pair #aM (or #aN)}, when the one-bit flag indicator is set to “1” (or “0”) or “enabled,” or when the bit field of the SRS resource set indicator is set to “11” (or “10”) or the index of the SRS resource set indicator is set to “3” (or “2”) according to TABLE 1 or the SRS resource set indicator field is not configured/present, the (order-reversed) M>1 (or N>1) TCI states or pairs of TCI states would become to {TCI state/TCI states pair #b1, TCI state/TCI states pair #b2, . . . , TCI state/TCI states pair #bM (or #bN)}, where b1=aM (or aN), b2=a(M−1) or (a(N−1)), . . . , bM (or bN)=a1. For M=2 (or N=2), the UE could first receive in an uplink DCI (e.g., DCI format 0_0, 0_1 or 0_2) two TCI states or pairs of TCI states—denoted and ordered by {TCI state/TCI states pair #a1, TCI state/TCI states pair #a2}; if the one-bit flag indicator is set to “1” (or “0”) or “enabled,” or if the bit field of the SRS resource set indicator is set to “11” (or “10”) or the index of the SRS resource set indicator is set to “3” (or “2”) according to TABLE 1 or the SRS resource set indicator field is not configured/present, the UE would follow the order-reversed two TCI states or pairs of TCI states {TCI state/TCI state pair #a2, TCI state/TCI state pair #a1} to transmit one or more PUCCH transmission repetitions or PUSCH transmission repetitions associated with the order-reversed TCI states or pairs of TCI states {TCI state/TCI state pair #a2, TCI state/TCI state pair #a1}, and if the one-bit flag indicator is set to “0” or (“1”) or “disabled,” or if the bit field of the SRS resource set indicator is set to “10” (or “11”) or the index of the SRS resource set indicator is set to “2” (or “3”) according to TABLE 1 or the SRS resource set indicator field is not configured/present, the UE would follow the indicated two TCI states or pairs of TCI states {TCI state/TCI state pair #a1, TCI state/TCI state pair #a2} to transmit one or more PUCCH transmission repetitions or PUSCH transmission repetitions associated with the indicated TCI states or pairs of TCI states {TCI state/TCI state pair #a1, TCI state/TCI state pair #a2}.

In yet another example, the UE could first receive in an uplink DCI (e.g., DCI format 0_0, 0_1 or 0_2) M>1 (or N>1) TCI states or pairs of TCI states—denoted by {TCI state/TCI states pair #a1, TCI state/TCI states pair #a2, . . . , TCI state/TCI states pair #aM (or #aN)}—indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission. The UE could also receive in a DCI (e.g., DCI format 1_1 or 1_2 with or without DL assignment) a one-bit indicator to indicate TCI state(s)/pair(s) of TCI states ordering for PUCCH or PUSCH.

For this design example, a new/dedicated DCI field could be used/configured in the corresponding DCI format to indicate the one-bit indicator; alternatively, one of more of the existing DCI fields in the corresponding DCI format could be used/configured to indicate the one-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit indicator is set to “0” (or “1”), or if the bit field of the SRS resource set indicator is set to “10” (or “11”) or the index of the SRS resource set indicator is set to “2” (or “3”) according to TABLE 1, the UE would follow the M>1 (or N>1) TCI states or pairs of TCI states ordered by {TCI state/TCI states pair #a1, TCI state/TCI states pair #a2, . . . , TCI state/TCI states #aM (or #aN)}—a first ordering—to transmit one or more PUCCH transmission repetitions or PUSCH transmission repetitions associated with the M>1 (or N>1) TCI states or pairs of TCI states ordered by {TCI state/TCI states pair #a1, TCI state/TCI states pair #a2, . . . , TCI state/TCI states #aM (or #aN)}, and if the one-bit flag indicator is set to “1” (or “0”), or if the bit field of the SRS resource set indicator is set to “11” (or “10”) or the index of the SRS resource set indicator is set to “3” (or “2”) according to TABLE 1, the UE would follow the M>1 (or N>1) TCI states or pairs of TCI states ordered by {TCI state/TCI states pair #b1, TCI state/TCI states pair #b2, . . . , TCI state/TCI states #bM (or #bN)}—a second ordering—to transmit one or more PUCCH transmission repetitions or PUSCH transmission repetitions associated with the M>1 (or N>1) TCI states or pairs of TCI states ordered by {TCI state/TCI states pair #b1, TCI state/TCI states pair #b2, . . . , TCI state/TCI states #bM (or #bN)}. The first ordering of the TCI states/pairs of TCI states {TCI state/TCI states pair #a1, TCI state/TCI states pair #a2, . . . , TCI state/TCI states #aM (or #aN)} or the second ordering of the TCI states/pairs of TCI states {TCI state/TCI states pair #b1, TCI state/TCI states pair #b2, . . . , TCI state/TCI states #bM (or #bN)} could be determined according to at least one of: (1) fixed in the system specification(s) and (2) configured, e.g., via higher layer RRC signaling or MAC CE command or DCI based signaling, by the network.

For both (1) and (2), b1 could be equal to aM (or aN), b2 could be equal to a(M−1) or (a(N−1)), . . . , bM (or bN) could be equal to a1. For M=2 (or N=2), the UE could first receive in an uplink DCI (e.g., DCI format 0_0, 0_1 or 0_2) two TCI states or pairs of TCI states—denoted by {TCI state/TCI states pair #a1, TCI state/TCI states pair #a2}; if the one-bit flag indicator is set to “0” (or “1”), or if the bit field of the SRS resource set indicator is set to “10” (or “11”) or the index of the SRS resource set indicator is set to “2” (or “3”) according to TABLE 1, the UE would follow the two TCI states or pairs of TCI states ordered by {TCI state/TCI state pair #a1, TCI state/TCI state pair #a2} to transmit one or more PUCCH transmission repetitions or PUSCH transmission repetitions associated with the two TCI states or pairs of TCI states ordered by {TCI state/TCI state pair #a1, TCI state/TCI state pair #a2}, and if the one-bit flag indicator is set to “1” or (“0”), or if the bit field of the SRS resource set indicator is set to “11” (or “10”) or the index of the SRS resource set indicator is set to “3” (or “2”) according to TABLE 1, the UE would follow the two TCI states or pairs of TCI states ordered by {TCI state/TCI state pair #a2, TCI state/TCI state pair #a1} to transmit one or more PUCCH transmission repetitions or PUSCH transmission repetitions associated with the two TCI states or pairs of TCI states {TCI state/TCI state pair #a2, TCI state/TCI state pair #a1}.

In yet another example, the UE could first receive in an uplink DCI (e.g., DCI format 0_0, 0_1 or 0_2) M=1 (or N=1) TCI state or pair of TCI states indicated by a TCI state codepoint (or a TCI field) as specified in examples and the corresponding sub-examples in the present disclosure. The UE could then receive in an uplink DCI (e.g., DCI format 0_0, 0_1 or 0_2) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission.

For example, the UE would follow the latest indicated M>1 (or N>1) TCI states or pairs of TCI states to transmit one or more PUCCH transmission repetitions or PUSCH transmission repetitions associated with the latest indicated M>1 (or N>1) TCI states or pairs of TCI states—i.e., multi-TRP PUCCH or PUSCH (repetitions) transmission.

For another example, the UE could receive in a DCI (e.g., DCI format 1_1 or 1_2 with or without DL assignment) a one-bit flag indicator for PUCCH or PUSCH. For this design example, a new/dedicated DCI field could be used/configured in the corresponding DCI format to indicate the one-bit flag indicator; alternatively, one of more of the existing DCI fields in the corresponding DCI format could be used/configured to indicate the one-bit flag indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit flag indicator for PUCCH or PUSCH is set to “1” (or “0”) or “enabled,” or if the bit field of the SRS resource set indicator is set to “10” or “11” or the index of the SRS resource set indicator is set to “2” or “3” according to TABLE 1 or the SRS resource set indicator field is not configured/present, the UE would follow the latest indicated M>1 (or N>1) TCI states or pairs of TCI states to transmit one or more PUCCH transmission repetitions or PUSCH transmission repetitions associated with the latest indicated M>1 (or N>1) TCI states or pairs of TCI states—i.e., multi-TRP PUCCH or PUSCH (repetitions) transmission.

If the one-bit flag indicator for PUCCH or PUSCH is set to “0” (or “1”) or “disabled,” or if the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to transmit PUCCH(s) or PUSCH(s)—i.e., single-TRP PUCCH or PUSCH transmission.

Yet for another example, the UE could receive in a DCI (e.g., DCI format 1_1 or 1_2 with or without DL assignment) a one-bit indicator for PUCCH or PUSCH. For this design example, a new/dedicated DCI field could be used/configured in the corresponding DCI format to indicate the one-bit indicator; alternatively, one of more of the existing DCI fields in the corresponding DCI format could be used/configured to indicate the one-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. For instance, if the one-bit indicator for PUCCH or PUSCH is set to “0” (or “1”), or if the bit field of the SRS resource set indicator is set to “00” or “01” or the index of the SRS resource set indicator is set to “0” or “1” according to TABLE 1 or the SRS resource set indicator field is not configured/present, the UE would follow the previously indicated M=1 (or N=1) TCI state or pair of TCI states to transmit PUCCH(s) or PUSCH(s)—i.e., single-TRP PUCCH or PUSCH transmission; if the one-bit indicator for PUCCH or PUSCH is set to “1” (or “0”), or if the bit field of the SRS resource set indicator is set to “10” or “11” or the index of the SRS resource set indicator is set to “2” or “3” according to TABLE 1 or the SRS resource set indicator field is not configured/present, the UE would follow the latest indicated M>1 (or N>1) TCI states or pairs of TCI states to transmit one or more PUCCH transmission repetitions or PUSCH transmission repetitions associated with the latest indicated M>1 (or N>1) TCI states or pairs of TCI states—i.e., multi-TRP PUCCH or PUSCH (repetitions) transmission.

In yet another example, the UE could first receive in an uplink DCI (e.g., DCI format 0_0, 0_1 or 0_2) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission. The UE could also receive in a DCI (e.g., DCI format 1_1 or 1_2 with or without DL assignment) a multi-bit (>1 bit, e.g., 2-bit) indicator for PUCCH or PUSCH. For this design example, a new/dedicated DCI field could be used/configured in the corresponding DCI format to indicate the multi-bit indicator; alternatively, one of more of the existing DCI fields in the corresponding DCI format could be used/configured to indicate the multi-bit indicator.

In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP and multi-TRP operation. The multi-bit indicator for PUCCH or PUSCH or the SRS resource set indicator could indicate one or more of: (1) single-TRP PUCCH or PUSCH transmission, (2) multi-TRP PUCCH or PUSCH (repetitions) transmission, (3) one or more orderings of the indicated TCI states or pairs of TCI states for single-TRP PUCCH or PUSCH transmission or multi-TRP PUCCH or PUSCH (repetitions) transmission, and (4) one or more TCI states or pairs of TCI states for single-TRP PUCCH or PUSCH transmission or multi-TRP PUCCH or PUSCH (repetitions) transmission.

For example, the multi-bit indicator could correspond to a 2-bit indicator with four states “00,” “01,” “10” and “11.” For instance, if the 2-bit indicator is set to “00” (or “01”), or if the bit field of the SRS resource set indicator is set to “00” (or “01”) or the index of the SRS resource set indicator is set to “0” (or “1”) according to TABLE 1, the UE could use only one of the indicated M>1 (or N>1) TCI states or pairs of TCI states to transmit PUCCH(s) or PUSCH(s)—i.e., PUCCH or PUSCH transmission in a single-TRP system—following the design examples specified in examples in the present disclosure; if the 2-bit indicator is set to “01” (or “00”), or if the bit field of the SRS resource set indicator is set to “01” (or “00”) or the index of the SRS resource set indicator is set to “1” (or “0”) according to TABLE 1, the UE could use one or more of the indicated M>1 (or N>1) TCI states or pairs of TCI states to transmit one or more PUCCH transmission repetitions or PUSCH transmission repetitions as described above—i.e., PUCCH or PUSCH (repetitions) transmission in a multi-TRP system. If the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow the ordering of the indicated M>1 (or N>1) TCI states or pairs of TCI states to transmit one or more PUCCH transmission repetitions or PUSCH transmission repetitions associated with the indicated M>1 (or N>1) TCI states or pairs of TCI states (according to examples in the present disclosure); if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow the order-reversed M>1 (or N>1) TCI states or pairs of TCI states to transmit one or more PUCCH transmission repetitions or PUSCH transmission repetitions associated with the order-reversed M>1 (or N>1) TCI states or pairs of TCI states (according to examples in the present disclosure).

Alternatively, if the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow a first ordering of the M>1 (or N>1) TCI states or pairs of TCI states to transmit one or more PUCCH transmission repetitions or PUSCH transmission repetitions associated with the M>1 (or N>1) TCI states or pairs of TCI states in the first ordering; if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow a second ordering of the M>1 (or N>1) TCI states or pairs of TCI states to transmit one or more PUCCH transmission repetitions or PUSCH transmission repetitions associated with the M>1 (or N>1) TCI states or pairs of TCI states in the second ordering. The first and second orderings of TCI states/pairs of TCI states could be according to those specified in examples in the present disclosure.

Optionally, “00” or “01” of the 2-bit indicator, or the bit fields “00” or “01” or the indexes “0” or “1” of the 2-bit SRS resource set indicator, could be used to indicate the orderings of the M>1 (or N>1) TCI states or pairs of TCI states for multi-TRP PUCCH or PUSCH (repetitions) transmission as described above, and “10” or “11” of the 2-bit indicator, or the bit fields “10” or “11” or the indexes “2” or “3” of the 2-bit SRS resource set indicator, could be used to indicate the single-TRP PUCCH/PUSCH transmission or the multi-TRP PUCCH/PUSCH (repetitions) transmission as described above.

For another example, the multi-bit indicator could correspond to a 2-bit indicator with four states “00,” “01,” “10” and “11.” For instance, if the 2-bit indicator is set to “00” (or “01”), or if the bit field of the SRS resource set indicator is set to “00” (or “01”) or the index of the SRS resource set indicator is set to “0” (or “1”) according to TABLE 1, the UE could use the primary TCI state or pair of TCI states determined from the indicated M>1 (or N>1) TCI states or pairs of TCI states to transmit PUCCH(s) or PUSCH(s)—i.e., PUCCH or PUSCH transmission in a single-TRP system; if the 2-bit indicator is set to “01” (or “00”), or if the bit field of the SRS resource set indicator is set to “01” (or “00”) or the index of the SRS resource set indicator is set to “1” (or “2”) according to TABLE 1, the UE could use the secondary TCI state or pair of TCI states determined from the indicated M>1 (or N>1) TCI states or pairs of TCI states to transmit PUCCH(s) or PUSCH(s)—i.e., PUCCH or PUSCH transmission in a single-TRP system; the primary and secondary TCI states/pairs of TCI states could be determined/configured according to those specified in examples in the present disclosure.

If the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow the ordering of the indicated M>1 (or N>1) TCI states or pairs of TCI states to transmit one or more PUCCH transmission repetitions or PUSCH transmission repetitions associated with the indicated M>1 (or N>1) TCI states or pairs of TCI states (according to examples in the present disclosure); if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow the order-reversed M>1 (or N>1) TCI states or pairs of TCI states to transmit one or more PUCCH transmission repetitions or PUSCH transmission repetitions associated with the order-reversed M>1 (or N>1) TCI states or pairs of TCI states (according to examples in the present disclosure).

Alternatively, if the 2-bit indicator is set to “10” (or “11”), or if the bit field of the SRS resource set indicator is set to “10” (or “11”) or the index of the SRS resource set indicator is set to “2” (or “3”) according to TABLE 1, the UE would follow a first ordering of the M>1 (or N>1) TCI states or pairs of TCI states to transmit one or more PUCCH transmission repetitions or PUSCH transmission repetitions associated with the M>1 (or N>1) TCI states or pairs of TCI states in the first ordering; if the 2-bit indicator is set to “11” (or “10”), or if the bit field of the SRS resource set indicator is set to “11” (or “10”) or the index of the SRS resource set indicator is set to “3” (or “2”) according to TABLE 1, the UE would follow a second ordering of the M>1 (or N>1) TCI states or pairs of TCI states to transmit one or more PUCCH transmission repetitions or PUSCH transmission repetitions associated with the M>1 (or N>1) TCI states or pairs of TCI states in the second ordering.

The first and second orderings of TCI states/pairs of TCI states could be according to those specified in examples in the present disclosure. Optionally, “00” or “01” of the 2-bit indicator, or the bit fields “00” or “01” or the indexes “0” or “1” of the 2-bit SRS resource set indicator, could be used to indicate the orderings of the M>1 (or N>1) TCI states or pairs of TCI states for multi-TRP PUCCH or PUSCH (repetitions) transmission as described above, and “10” or “11” of the 2-bit indicator, or the bit fields “10” or “11” or the indexes “2” or “3” of the 2-bit SRS resource set indicator, could be used to indicate the primary or secondary TCI states/pairs of TCI states for single-TRP PUCCH or PUSCH transmission as described above.

Yet for another example, the multi-bit indicator could correspond to a 2-bit indicator with four states “00,” “01,” “10” and “11,” configured according to those specified in examples. In addition to the 2-bit indicator or the 2-bit SRS resource set indicator configured according to examples in the present disclosure, the UE could also receive in a DCI (e.g., DCI format 1_1 or 1_2 with or without DL assignment or DCI format 0_0, 0_1 or 0_2) a one-bit indicator. For this design example, a new/dedicated DCI field could be used/configured in the corresponding DCI format to indicate the one-bit indicator; alternatively, one of more of the existing DCI fields in the corresponding DCI format could be used/configured to indicate the one-bit indicator.

When the 2-bit indicator or the 2-bit SRS resource set indicator indicates the single-TRP PUCCH or PUSCH transmission, if the one-bit indicator is set to “0” (or “1”), the UE could use the primary TCI state or pair of TCI states determined from the indicated M>1 (or N>1) TCI states or pairs of TCI states to transmit PUCCH(s) or PUSCH(s); if the one-bit indicator is set to “1” (or “0”), the UE could use the secondary TCI state or pair of TCI states determined from the indicated M>1 (or N>1) TCI states or pairs of TCI states to transmit PUCCH(s) or PUSCH(s); the primary and secondary TCI states/pairs of TCI states could be determined/configured according to those specified in examples in the present disclosure.

Yet for another example, the multi-bit indicator or the SRS resource set indicator indicated in DCI format 0_1 or 0_2 (e.g., in the “SRS resource set indicator” field) could correspond to a z-bit indicator (z>1, e.g., z=3) with 2\hat{ }z states (e.g., 8 states or bit fields for z=3). In this example, a first state or bit field of the z-bit indicator could indicate that the single-TRP PUCCH or PUSCH transmission is enabled according to examples and the corresponding sub-examples in the present disclosure, a second state or bit field of the z-bit indicator could indicate that the multi-TRP PUCCH or PUSCH (repetitions) transmission is enabled according to examples and the corresponding sub-examples in the present disclosure, a third state or bit field of the z-bit indicator could indicate that the UE could use the primary TCI state or pair of TCI states for the single-TRP PUCCH or PUSCH transmission as discussed in examples and the corresponding sub-examples in the present disclosure, a fourth state or bit field of the z-bit indicator could indicate that the UE could use the secondary TCI state or pair of TCI states for the single-TRP PUCCH or PUSCH transmission as discussed in examples and the corresponding sub-examples in the present disclosure, a fifth state or bit field of the z-bit indicator could indicate an ordering of the M>1 (or N>1) TCI states or pairs of TCI states for the multi-TRP PUCCH or PUSCH (repetitions) transmission as discussed in examples in the present disclosure, a sixth state or bit field of the z-bit indicator could indicate another ordering of the M>1 (or N>1) TCI states or pairs of TCI states for the multi-TRP PUCCH or PUSCH (repetitions) transmission as discussed in examples in the present disclosure.

In yet another example, the UE could first receive in an uplink DCI (e.g., DCI format 0_0, 0_1 or 0_2) M=1 (or N=1) TCI state or pair of TCI states indicated by a TCI state codepoint (or a TCI field) as specified in examples and the corresponding sub-examples in the present disclosure. The UE could then receive in an uplink DCI (e.g., DCI format 0_0, 0_1 or 0_2) M>1 (or N>1) TCI states or pairs of TCI states indicated by one or more TCI state codepoints (or one or more TCI fields) as specified in examples and the corresponding sub-examples in the present disclosure, wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission.

Furthermore, the UE could receive in a DCI (e.g., DCI format 1_1 or 1_2 with or without DL assignment) a multi-bit (>1 bit, e.g., 2-bit) indicator for PUCCH or PUSCH. For this design example, a new/dedicated DCI field could be used/configured in the corresponding DCI format to indicate the multi-bit indicator; alternatively, one of more of the existing DCI fields in the corresponding DCI format could be used/configured to indicate the multi-bit indicator. In addition, as discussed above, the UE could also receive in an uplink DCI (e.g., DCI format 0_1 or 0_2) a SRS resource set indicator (e.g., in the “SRS resource set indicator” field) to indicate one or more SRS resource sets for single-TRP or multi-TRP operation. The multi-bit indicator for PUCCH or PUSCH or the SRS resource set indicator could indicate one or more of: (1) single-TRP PUCCH or PUSCH transmission, (2) multi-TRP PUCCH or PUSCH (repetitions) transmission, (3) one or more orderings of the indicated TCI states or pairs of TCI states for single-TRP PUCCH/PUSCH transmission or multi-TRP PUCCH/PUSCH (repetitions) transmission, and (4) one or more TCI states or pairs of TCI states for single-TRP PUCCH/PUSCH transmission or multi-TRP PUCCH/PUSCH (repetitions) transmission.

The multi-bit indicator or the SRS resource set indicator could be configured according to examples in the present disclosure. For this example, if the multi-bit indicator or the SRS resource set indicator indicates that the single-TRP PUCCH or PUSCH transmission is enabled, the UE could follow the previously indicated M=1 (or N=1) TCI state or pair of TCI states to transmit PUCCH(s) or PUSCH(s) (as discussed in examples and the corresponding sub-examples in the present disclosure).

The UE could receive from the network one or more MAC CE activation/sub-selection commands activating one or more sets of TCI states/TCI state IDs from the one or more TCI state pools (specified in examples in the present disclosure) or the one or more TCI state groups (specified in examples in the present disclosure), with each set of activated/selected TCI states/TCI state IDs used to map up to Nc≥1 (e.g., 8, 16, 32 or 64) TCI state codepoints in a DCI format. Here, a TCI state codepoint could be configured according to examples and the corresponding sub-examples in the present disclosure. Furthermore, the one or more sets of activated/selected TCI state codepoints could include/contain/comprise one or more of the following examples.

In one example of a first set of TCI state codepoints for single-TRP PUCCH or PUSCH transmission, the UE could receive in an uplink DCI (e.g., DCI format 0_0, 0_1 or 0_2) M=1 (or N=1) TCI state or pair of TCI states indicated by a TCI state codepoint from the first set of TCI state codepoints; the UE could use the indicated TCI state or pair of TCI states for the single-TRP PUCCH or PUSCH transmission.

In one example of a second set of TCI state codepoints for single-TRP PUCCH or PUSCH transmission, the UE could receive in an uplink DCI (e.g., DCI format 0_0, 0_1 or 0_2) M=1 (or N=1) TCI state or pair of TCI states indicated by a TCI state codepoint from the second set of TCI state codepoints; the UE could use the indicated TCI state or pair of TCI states as the primary TCI state or pair of TCI states as discussed in examples and the corresponding sub-examples in the present disclosure for the single-TRP PUCCH or PUSCH transmission.

In one example of a third set of TCI state codepoints for single-TRP PUCCH or PUSCH transmission, the UE could receive in an uplink DCI (e.g., DCI format 0_0, 0_1 or 0_2) M=1 (or N=1) TCI state or pair of TCI states indicated by a TCI state codepoint from the third set of TCI state codepoints; the UE could use the indicated TCI state or pair of TCI states as the secondary TCI state or pair of TCI states as discussed in examples and the corresponding sub-examples in the present disclosure for the single-TRP PUCCH or PUSCH transmission.

In one example of a fourth set of TCI state codepoints for multi-TRP PUCCH or PUSCH (repetitions) transmission, the UE could receive in an uplink DCI (e.g., DCI format 0_0, 0_1 or 0_2) M>1 (or N>1) TCI states or pairs of TCI states indicated by one or more TCI state codepoints from the fourth set of TCI state codepoints, wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission.

In one example of a fifth set of TCI state codepoints for multi-TRP PUCCH or PUSCH (repetitions) transmission, the UE could receive in an uplink DCI (e.g., DCI format 0_0, 0_1 or 0_2) M>1 (or N>1) TCI states or pairs of TCI states indicated by one or more TCI state codepoints from the fifth set of TCI state codepoints, wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission. The ordering of the indicated M>1 (or N>1) TCI states or pairs of TCI states from the fifth set could correspond to an ordering of M>1 (or N>1) TCI states or pairs of TCI states (e.g., the first ordering) discussed in examples in the present disclosure.

In one example of a sixth set of TCI state codepoints for multi-TRP PUCCH or PUSCH (repetitions) transmission, the UE could receive in an uplink DCI (e.g., DCI format 0_0, 0_1 or 0_2) M>1 (or N>1) TCI states or pairs of TCI states indicated by one or more TCI state codepoints from the sixth set of TCI state codepoints, wherein one or more of the indicated M>1 (or N>1) TCI states or pairs of TCI states could be associated with/mapped to one or more PUCCH transmission repetitions or PUSCH transmission repetitions as described above for the multi-TRP PUCCH or PUSCH (repetitions) transmission. The ordering of the indicated M>1 (or N>1) TCI states or pairs of TCI states from the sixth set could correspond to an ordering of M>1 (or N>1) TCI states or pairs of TCI states (e.g., the second ordering) discussed in examples in the present disclosure.

The UE could be indicated by the network from which set(s) of TCI state codepoints the indicated one or more TCI states or pairs of TCI states are selected. This indication could be via higher layer RRC signaling or MAC CE command or dynamic DCI based signaling. For instance, a y-bit (y≥1) indicator could be configured/included/incorporated in a DCI format (e.g., DCI format 1_1 or 1_2 with or without DL assignment) to indicate the set(s) of TCI state codepoints. For this design example, a new/dedicated DCI field could be used/configured in the corresponding DCI format to indicate the y-bit indicator; alternatively, one of more of the existing DCI fields in the corresponding DCI format could be used/configured to indicate the y-bit indicator. In addition, as discussed above, the UE could receive in an uplink DCI (e.g., DCI format 0_1 or 0_2) a y-bit (y≥1) SRS resource set indicator (e.g., in the “SRS resource set indicator” field) to indicate one or more SRS resource sets.

Here, the SRS resource set indicator could also be used to indicate the set(s) of TCI state codepoints. Each state/bit field/index of the y-bit indicator or the y-bit SRS resources set indicator (a total of 2^{A}y states or bit fields for the y-bit indicator or the y-bit SRS resource set indicator) could correspond to a set of TCI state codepoints (e.g., the first set, the second set, the third set, the fourth set, the fifth set or the sixth set as specified above). For example, if a UE receives in the DCI format for beam indication (e.g., DCI format 1_1 or 1_2 with or without DL assignment) the y-bit indicator (e.g., set to a state), or in DCI format 0_1 or 0_2 the y-bit SRS resource set indicator in the “SRS resource set indicator” field (e.g., set to a state or bit field value), the UE could determine the set of TCI state codepoints corresponding to the indicated state or bit field value of the y-bit indicator or the y-bit SRS resource set indicator, from which the indicated one or more TCI states or pairs of TCI states are selected. According to the determined set of TCI state codepoints, the UE could perform/conduct the corresponding single-TRP PUCCH or PUSCH transmission or multi-TRP PUCCH or PUSCH (repetitions) transmission as discussed above.

According to the design examples specified in embodiments of the present disclosure, a UE could be configured with separate indicators with each indicator indicating one or more of: (1) single-TRP transmission/reception or multi-TRP (repetitions) transmission/reception, (2) one or more orderings of the indicated TCI states/pairs of TCI states and (3) which TCI state/pair of TCI states to use if the single-TRP transmission/reception is enabled/configured, for a different channel (e.g., PDCCH, PDSCH, PUCCH or PUSCH).

In one embodiment, a UE could be configured with a common indicator indicating one or more of: (1) single-TRP transmission/reception or multi-TRP (repetitions) transmission/reception, (2) one or more orderings of the indicated TCI states/pairs of TCI states and (3) which TCI state/pair of TCI states to use if the single-TRP transmission/reception is enabled/configured, for one or more different channels. Here, the one or more different channels could correspond to: (a) PDCCH and PDSCH, (b) PDCCH and PUCCH, (c) PDCCH and PUSCH, (d) PDSCH and PUCCH, (e) PDSCH and PUSCH, (f) PUCCH and PUSCH, (g) PDCCH, PDSCH and PUCCH, (h) PDCCH, PDSCH and PUSCH, (i) PDCCH, PUCCH and PUSCH, (j) PDSCH, PUCCH and PUSCH or (k) PDCCH, PDSCH, PUCCH and PUSCH.

The common indicator could correspond to: (1) a one-bit flag indicator—as specified in examples and the corresponding sub-examples for PDCCH, examples and the corresponding sub-examples for PDSCH, or examples and the corresponding sub-examples for PUCCH or PUSCH-configured/indicated for each of the one or more channels; (2) a one-bit indicator—as specified in examples and the corresponding sub-examples for PDCCH, examples for PDSCH, or examples for PUCCH or PUSCH—configured/indicated for each of the one or more channels; (3) a multi-bit indicator—as specified in examples for PDCCH, examples for PDSCH, or examples for PUCCH or PUSCH—to indicate TCI state(s)/pair(s) of TCI states ordering for each of the one or more channels; (4) a multi-bit indicator—as specified in examples for PDCCH, examples for PDSCH, or examples for PUCCH or PUSCH—to indicate TCI state(s)/pair(s) of TCI states ordering for each of the one or more channels; (5) a one-bit flag indicator—as specified in the examples for PDCCH, examples for PDSCH, or examples for PUCCH or PUSCH—configured/indicated for each of the one or more channels; (6) a one-bit indicator—as specified in the examples for PDCCH, examples for PDSCH, or examples for PUCCH or PUSCH—configured/indicated for each of the one or more channels; (7) a multi-bit indicator—as specified in the examples and the corresponding sub-examples for PDCCH, examples and the corresponding sub-examples for PDSCH, or examples and the corresponding sub-examples for PUCCH or PUSCH—configured/indicated for each of the one or more channels; and (8) a multi-bit indicator—as specified in examples for PDCCH, examples for PDSCH, or examples for PUCCH or PUSCH—configured/indicated for each of the one or more channels.

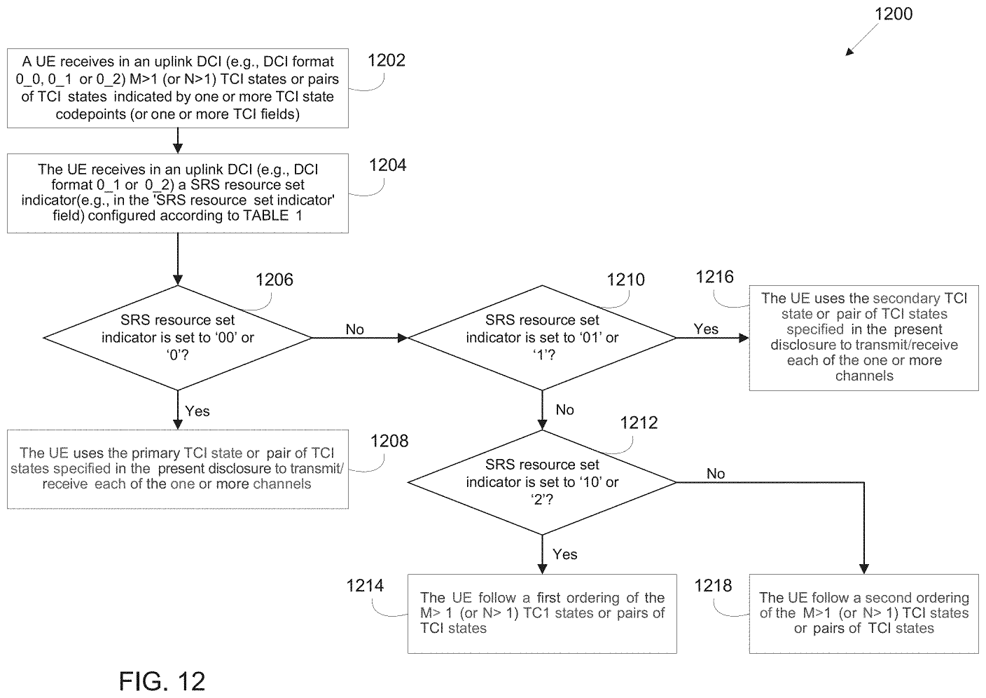

FIG. 12 illustrates a flowchart of another method 1200 of using an SRS resource set indicator to indicate associations between one or more of the indicated TCI states and each of the one or more channels according to embodiments of the present disclosure. The method 1200 as may be performed by a UE (e.g., 111-116 as illustrated in FIG. 1). An embodiment of the method 1200 shown in FIG. 12 is for illustration only.

As illustrated in FIG. 12, in block 1202, the UE receives TCI states or pairs of TCI states indicated by one or more TCI state codepoints in an uplink DCI. In block 1204, the UE receives in an uplink DCI a SRS resource set indicator configured according to TABLE 1. In block 1206, the UE determines if the SRS resource set indicator is set to “00” or “0.” In block 1208, the UE uses the primary TCI state or pair of TCI states to transmit and receive each of the one or more channels. In block 1210, the UE determines if SRS resource set indicator is set to “01” or “1.” In block 1212, the UE determines the SRS resource set indicator is set to “10” or “2.” In block 1214, the UE follows a first ordering of the M>1 (or N>1) TCI states or pairs of TCI states. In block 1216, the UE uses the secondary TCI state or pair of TCI states to transmit and receive each of the one or more channels. In block 1218, the UE follows a second ordering of the M>1 (or N>1) TCI states or pairs of TCI states.

Optionally, a UE could receive in an uplink DCI (e.g., DCI format 0_1 or 0_2) a SRS resource set indicator (e.g., in the “SRS resource set indicator” field) to indicate one or more SRS resource sets for single-TRP or multi-TRP operation according to TABLE 1 in the present disclosure. The SRS resource set indicator could also indicate one or more of: (1) single-TRP transmission/reception or multi-TRP (repetitions) transmission/reception, (2) one or more orderings of the indicated TCI states/pairs of TCI states and (3) which TCI state/pair of TCI states to use if the single-TRP transmission/reception is enabled/configured, for one or more different channels. As aforementioned, the one or more different channels could correspond to: (a) PDCCH and PDSCH, (b) PDCCH and PUCCH, (c) PDCCH and PUSCH, (d) PDSCH and PUCCH, (e) PDSCH and PUSCH, (f) PUCCH and PUSCH, (g) PDCCH, PDSCH and PUCCH, (h) PDCCH, PDSCH and PUSCH, (i) PDCCH, PUCCH and PUSCH, (j) PDSCH, PUCCH and PUSCH or (k) PDCCH, PDSCH, PUCCH and PUSCH.

In this embodiment following examples can be provided.

In one example, the SRS resource set indicator—as specified in examples and the corresponding sub-examples for PDCCH, examples and the corresponding sub-examples for PDSCH, or examples and the corresponding sub-examples for PUCCH or PUSCH—could be configured/indicated for each of the one or more channels.

In one example, the SRS resource set indicator—as specified in the examples and the corresponding sub-examples for PDCCH, examples for PDSCH, or examples for PUCCH or PUSCH—could be configured/indicated for each of the one or more channels.

In one example, the SRS resource set indicator—as specified in the examples for PDCCH, examples for PDSCH, or examples for PUCCH or PUSCH—could be used/applied to indicate TCI state(s)/pair(s) of TCI states ordering for each of the one or more channels.

In one example, the SRS resource set indicator—as specified in the examples for PDCCH, examples for PDSCH, or examples for PUCCH or PUSCH—could be used/applied to indicate TCI state(s)/pair(s) of TCI states ordering for each of the one or more channels.

In one example, the SRS resource set indicator—as specified in the examples for PDCCH, examples for PDSCH, or examples for PUCCH or PUSCH—could be configured/indicated for each of the one or more channels.

In one example, the SRS resource set indicator—as specified in the examples for PDCCH, examples for PDSCH, or examples for PUCCH or PUSCH—could be configured/indicated for each of the one or more channels.

In one example, the SRS resource set indicator—as specified in the examples and the corresponding sub-examples for PDCCH, examples and the corresponding sub-examples for PDSCH, or examples and the corresponding sub-examples for PUCCH or PUSCH—could be configured/indicated for each of the one or more channels. A flowchart of the SRS resource set indicator configured/indicated for each of the one or more channels is illustrated in FIG. 12.

In one example, the SRS resource set indicator—as specified in the examples for PDCCH, examples for PDSCH, or examples for PUCCH or PUSCH—could be configured/indicated for each of the one or more channels.

The UE could receive from the network one or more MAC CE activation/sub-selection commands activating one or more sets of TCI states/TCI state IDs from the one or more TCI state pools (specified in examples in the present disclosure) or the one or more TCI state groups (specified in examples in the present disclosure), with each set of activated/selected TCI states/TCI state IDs used to map up to Nc≥1 (e.g., 8, 16, 32 or 64) TCI state codepoints in a DCI format.

Here, a TCI state codepoint could be configured according to examples and the corresponding sub-examples in the present disclosure. Furthermore, the one or more sets of activated/selected TCI state codepoints could include/contain/comprise one or more of the following example.

In one example of a first set of TCI state codepoints for single-TRP transmission/reception of each of the one or more channels, the UE could receive in an uplink DCI (e.g., DCI format 0_0, 0_1 or 0_2) M=1 (or N=1) TCI state or pair of TCI states indicated by a TCI state codepoint from the first set of TCI state codepoints; the UE could use the indicated TCI state or pair of TCI states for the single-TRP transmission/reception of each of the one or more channels.

In one example of a second set of TCI state codepoints for single-TRP transmission/reception of each of the one or more channels, the UE could receive in an uplink DCI (e.g., DCI format 0_0, 0_1 or 0_2) M=1 (or N=1) TCI state or pair of TCI states indicated by a TCI state codepoint from the second set of TCI state codepoints; the UE could use the indicated TCI state or pair of TCI states as the primary TCI state or pair of TCI states as discussed in examples and the corresponding sub-examples in the present disclosure for the single-TRP transmission/reception of each of the one or more channels.

In one example of a third set of TCI state codepoints for single-TRP transmission/reception of each of the one or more channels, the UE could receive in an uplink DCI (e.g., DCI format 0_0, 0_1 or 0_2) M=1 (or N=1) TCI state or pair of TCI states indicated by a TCI state codepoint from the third set of TCI state codepoints; the UE could use the indicated TCI state or pair of TCI states as the secondary TCI state or pair of TCI states as discussed in examples and the corresponding sub-examples in the present disclosure for the single-TRP transmission/reception of each of the one or more channels.

In one example of a fourth set of TCI state codepoints for multi-TRP (repetitions) transmission/reception of each of the one or more channels, the UE could receive in an uplink DCI (e.g., DCI format 0_0, 0_1 or 0_2) M>1 (or N>1) TCI states or pairs of TCI states indicated by one or more TCI state codepoints from the fourth set of TCI state codepoints, wherein one or more of the indicated M>1 (or N>1) TCI states or pairs of TCI states could be used for the multi-TRP (repetitions) transmission/reception of each of the one or more channels.

In one example of a fifth set of TCI state codepoints for multi-TRP (repetitions) transmission/reception of each of the one or more channels, the UE could receive in an uplink DCI (e.g., DCI format 0_0, 0_1 or 0_2) M>1 (or N>1) TCI states or pairs of TCI states indicated by one or more TCI state codepoints from the fifth set of TCI state codepoints, wherein one or more of the indicated M>1 (or N>1) TCI states or pairs of TCI states could be used for the multi-TRP (repetitions) transmission/reception of each of the one or more channels. The ordering of the indicated M>1 (or N>1) TCI states or pairs of TCI states from the fifth set could correspond to an ordering of M>1 (or N>1) TCI states or pairs of TCI states (e.g., the first ordering) discussed in the present disclosure.

In one example of a sixth set of TCI state codepoints for multi-TRP (repetitions) transmission/reception of each of the one or more channels, the UE could receive in an uplink DCI (e.g., DCI format 0_0, 0_1 or 0_2) M>1 (or N>1) TCI states or pairs of TCI states indicated by one or more TCI state codepoints from the sixth set of TCI state codepoints, wherein one or more of the indicated M>1 (or N>1) TCI states or pairs of TCI states could be used for the multi-TRP (repetitions) transmission/reception of each of the one or more channels. The ordering of the indicated M>1 (or N>1) TCI states or pairs of TCI states from the sixth set could correspond to an ordering of M>1 (or N>1) TCI states or pairs of TCI states (e.g., the second ordering) discussed in the present disclosure.

In one example, the UE could be indicated by the network from which set(s) of TCI state codepoints the indicated one or more TCI states or pairs of TCI states are selected. This indication could be via higher layer RRC signaling or MAC CE command or dynamic DCI based signaling. For instance, a y-bit (y≥1) indicator could be configured/included/incorporated in a DCI format (e.g., DCI format 1_1 or 1_2 with or without DL assignment) to indicate the set(s) of TCI state codepoints. For this design example, a new/dedicated DCI field could be used/configured in the corresponding DCI format to indicate the y-bit indicator; alternatively, one of more of the existing DCI fields in the corresponding DCI format could be used/configured to indicate the y-bit indicator.

In addition, as discussed above, the UE could receive in an uplink DCI (e.g., DCI format 0_1 or 0_2) a y-bit (y≥1) SRS resource set indicator (e.g., in the “SRS resource set indicator” field) to indicate one or more SRS resource sets. Here, the SRS resource set indicator could also be used to indicate the set(s) of TCI state codepoints. Each state/bit field/index of the y-bit indicator or the y-bit SRS resources set indicator (a total of 2\hat{ }y states or bit fields for the y-bit indicator or the y-bit SRS resource set indicator) could correspond to a set of TCI state codepoints (e.g., the first set, the second set, the third set, the fourth set, the fifth set or the sixth set as specified above).

For example, if a UE receives in the DCI format for beam indication (e.g., DCI format 1_1 or 1_2 with or without DL assignment) the y-bit indicator (e.g., set to a state), or in DCI format 0_1 or 0_2 the y-bit SRS resource set indicator in the “SRS resource set indicator” field (e.g., set to a state or bit field value), the UE could determine the set of TCI state codepoints corresponding to the indicated state or bit field value of the y-bit indicator or the y-bit SRS resource set indicator, from which the indicated one or more TCI states or pairs of TCI states are selected. According to the determined set of TCI state codepoints, the UE could perform/conduct the corresponding single-TRP PDCCH or PDSCH reception or PUCCH or PUSCH transmission or multi-TRP PDCCH or PDSCH (repetitions) reception or PUCCH or PUSCH (repetitions) transmission as discussed above.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive radio resource control (RRC) signaling including a parameter indicating a first group of transmission configuration indication (TCI) states and a second group of TCI states;
receive, in a first downlink control information (DCI), a first indicator and a TCI state update; and
receive, in a second DCI, a second indicator; and
a processor operably coupled to the transceiver, the processor configured to:
identify a first TCI state from the first group of TCI states and a second TCI state from the second group of TCI states;
determine, based on the first indicator, whether the TCI state update belongs to the first group of TCI states or the second group of TCI states; and
identify, based on the second indicator, the first TCI state or the second TCI state to be used for receiving a physical downlink shared channel (PDSCH) or transmitting a physical uplink shared channel (PUSCH).

2. The UE of claim 1, wherein:
when the first DCI is an uplink (UL) DCI, the TCI state update is indicated by a field in the first DCI, and
the field is (1) a dedicated TCI field or (2) repurposed using one or more bits of one or more existing fields in the first DCI.

3. The UE of claim 1, wherein:
the first indicator is a 1-bit indicator;
when the first indicator is set to ‘0’, the processor is further configured to apply the TCI state update to the first TCI state; and
when the first indicator is set to ‘1’, the processor is further configured to apply the TCI state update to the second TCI state.

4. The UE of claim 1, wherein:
the second indicator is a 2-bit indicator;
when the second DCI is an uplink (UL) DCI, the second indicator is a sounding reference signal (SRS) resource set indicator;
when the second indicator is set to ‘00’, the first TCI state is used for receiving the PDSCH;
when the second indicator is set to ‘01’, the second TCI state is used for receiving the PDSCH;
when the second indicator is set to ‘10’, the first TCI state is used for receiving the PDSCH and the second TCI state is used for receiving a second PDSCH; and
when the second indicator is set to ‘11’, the first TCI state is used for receiving the second PDSCH and the second TCI state is used for receiving the PDSCH.

5. The UE of claim 4, wherein:
when first and second code-division multiplexing (CDM) groups are configured, the processor is further configured to identify that:
a demodulation-reference signal (DM-RS) of the PDSCH is associated with the first CDM group, and
a DM-RS of the second PDSCH is associated with the second CDM group; and
when higher layer parameter repetitionScheme is configured, the processor is further configured to identify that:
the PDSCH corresponds to a first PDSCH transmission occasion, and
the second PDSCH corresponds to a second PDSCH transmission occasion.

6. The UE of claim 1, wherein:
the second indicator is a 2-bit indicator;
when the second DCI is an uplink (UL) DCI, the second indicator is a sounding reference signal (SRS) resource set indicator;
when the second indicator is set to ‘00’, the first TCI state is used for transmitting the PUSCH;
when the second indicator is set to ‘01’, the second TCI state is used for transmitting the PUSCH;
when the second indicator is set to ‘10’, the first TCI state is used for transmitting the PUSCH and the second TCI state is used for transmitting a second PUSCH; and
when the second indicator is set to ‘11’, the first TCI state is used for transmitting the second PUSCH and the second TCI state is used for transmitting the PUSCH.

7. The UE of claim 6, wherein:
when first and second sounding reference signal (SRS) resource sets are configured, the processor is further configured to identify that:
the PUSCH is associated with the first SRS resource set; and
the second PUSCH is associated with the second SRS resource set.

8. The UE of claim 1, wherein:
the transceiver is further configured to:
receive, in the first DCI, a first identifier; and
receive, in the second DCI, a second identifier; and
when the first identifier and the second identifier are identical, the processor is further configured to identify, based on the second indicator in the second DCI, which of the first and second TCI states in the first DCI to use for receiving the PDSCH and transmitting the PUSCH.

9. A method performed by a user equipment (UE), the method comprising:
receiving radio resource control (RRC) signaling including a parameter indicating a first group of transmission configuration indication (TCI) states and a second group of TCI states;
receiving, in a first downlink control information (DCI), a first indicator and a TCI state update;
receiving, in a second DCI, a second indicator;
identifying a first TCI state from the first group of TCI states and a second TCI state from the second group of TCI states;
determining, based on the first indicator, whether the TCI state update belongs to the first group of TCI states or the second group of TCI states; and
identifying, based on the second indicator, the first TCI state or the second TCI state to be used for receiving a physical downlink shared channel (PDSCH) or transmitting a physical uplink shared channel (PUSCH).

10. The method of claim 9, wherein:
when the first DCI is an uplink (UL) DCI, the TCI state update is indicated by a field in the first DCI, and
the field is (1) a dedicated TCI field or (2) repurposed using one or more bits of one or more existing fields in the first DCI.

11. The method of claim 9, wherein:
the first indicator is a 1-bit indicator; and
the method further comprises:
when the first indicator is set to ‘0’, applying the TCI state update to the first TCI state; and
when the first indicator is set to ‘1’, applying the TCI state update to the second TCI state.

12. The method of claim 9, wherein:
the second indicator is a 2-bit indicator;
when the second DCI is an uplink (UL) DCI, the second indicator is a sounding reference signal (SRS) resource set indicator;
when the second indicator is set to ‘00’, the first TCI state is used for receiving the PDSCH;
when the second indicator is set to ‘01’, the second TCI state is used for receiving the PDSCH;
when the second indicator is set to ‘10’, the first TCI state is used for receiving the PDSCH and the second TCI state is used for receiving a second PDSCH; and
when the second indicator is set to ‘11’, the first TCI state is used for receiving the second PDSCH and the second TCI state is used for receiving the PDSCH.

13. The method of claim 12, further comprising:
when first and second code-division multiplexing (CDM) groups are configured, identifying that:
a demodulation-reference signal (DM-RS) of the PDSCH is associated with the first CDM group, and
a DM-RS of the second PDSCH is associated with the second CDM group; and
when higher layer parameter repetitionScheme is configured, identifying that:
the PDSCH corresponds to a first PDSCH transmission occasion, and
the second PDSCH corresponds to a second PDSCH transmission occasion.

14. The method of claim 9, wherein:
the second indicator is a 2-bit indicator;
when the second DCI is an uplink (UL) DCI, the second indicator is a sounding reference signal (SRS) resource set indicator;
when the second indicator is set to ‘00’, the first TCI state is used for transmitting the PUSCH;
when the second indicator is set to ‘01’, the second TCI state is used for transmitting the PUSCH;
when the second indicator is set to ‘10’, the first TCI state is used for transmitting the PUSCH and the second TCI state is used for transmitting a second PUSCH; and
when the second indicator is set to ‘11’, the first TCI state is used for transmitting the second PUSCH and the second TCI state is used for transmitting the PUSCH.

15. The method of claim 14, further comprising:
when first and second sounding reference signal (SRS) resource sets are configured, identifying that:
the PUSCH is associated with the first SRS resource set; and
the second PUSCH is associated with the second SRS resource set.

16. A base station (BS), comprising:
a transceiver configured to:
transmit radio resource control (RRC) signaling including a parameter indicating a first group of transmission configuration indication (TCI) states and a second group of TCI states;
transmit, in a first downlink control information (DCI), a first indicator and a TCI state update; and
transmit, in a second DCI, a second indicator,
wherein the first indicator indicates whether the TCI state update belongs to the first group of TCI states or the second group of TCI states; and
the second indicator indicates whether a first TCI state from the first group of TCI states or a second TCI state from the second group of TCI states is for a physical downlink shared channel (PDSCH) or for a physical uplink shared channel (PUSCH).

17. The BS of claim 16, wherein:
when the first DCI is an uplink (UL) DCI, the TCI state update is indicated by a field in the first DCI, and
the field is (1) a dedicated TCI field or (2) repurposed using one or more bits of one or more existing fields in the first DCI.

18. The BS of claim 16, wherein:
the first indicator is a 1-bit indicator;
when the first indicator is set to ‘0’, the TCI state update is for the first TCI state; and
when the first indicator is set to ‘1’, the TCI state update is for the second TCI state.

19. The BS of claim 16, wherein:
the second indicator is a 2-bit indicator;
when the second DCI is an uplink (UL) DCI, the second indicator is a sounding reference signal (SRS) resource set indicator;
when the second indicator is set to ‘00’, the first TCI state is for the PDSCH;
when the second indicator is set to ‘01’, the second TCI state is for the PDSCH;
when the second indicator is set to ‘10’, the first TCI state is for the PDSCH and the second TCI state is for a second PDSCH; and
when the second indicator is set to ‘11’, the first TCI state is for the second PDSCH and the second TCI state is for the PDSCH.

20. The BS of claim 19, wherein:
when first and second code-division multiplexing (CDM) groups are configured, a demodulation-reference signal (DM-RS) of the PDSCH is associated with the first CDM group, and a DM-RS of the second PDSCH is associated with the second CDM group; and
when higher layer parameter repetitionScheme is configured, the PDSCH corresponds to a first PDSCH transmission occasion and the second PDSCH corresponds to a second PDSCH transmission occasion.
